(19) United States
(12) Patent Application Publication
(10) Pub. No.: US 2003/0053614 A1
(43) Pub. Date: Mar. 20, 2003

(54) Method of changing the function of a telephone apparatus, a customer center for carrying out the method, and an user system including the telephone apparatus, and a method of changing the number of telephone lines, a customer center for carrying out the method, and an user system including the telephone apparatus, and a method of changing the function of a terminal, a customer center for carrying out the method, and an user system including the terminal

(75) Inventors: Norimasa Niiya, Hino-shi (JP); Yasuo Funato, Hachioji-shi (JP)

Correspondence Address: Finnegan, Henderson, Farabow,, Garrett & Dunner, L.L.P., 1300 I Street, N.W., Washington, DC, 20005-3315, US

(73) Assignee: Kabushiki Kaisha Toshiba

(21) Appl. No.: 10/242,629

(22) Filed: Sep. 13, 2002

(30) Foreign Application Priority Data
Sep. 14, 2001 (JP) 2001-280560

(51) Int. Cl. H04M 3/42; H04M 3/00

(52) U.S. Cl. 379/265.01; 379/201.02

(57) ABSTRACT

To add new functions to key telephone apparatuses, the user PC in the user system transmits a function add request to the customer center. The function add request includes information on the functions to be added and the telephone numbers of the key telephone apparatuses. Then, the customer center accesses the user's key telephone apparatuses via a public network on the basis of the received telephone numbers, acquires function information about the key telephone apparatuses, and determines whether the functions can be added, on the basis of the function information. Then, if the functions can be added, the customer center sends license codes for the functions to be added to the user's key telephone apparatuses via the public network, thereby additionally setting the functions.

### CROSS-REFERENCE TO RELATED APPLICATIONS

This application is based upon and claims the benefit of priority from the prior Japanese Patent Application No. 2001-280560, filed Sep. 14, 2001, the entire contents of which are incorporated herein by reference.

### BACKGROUND OF THE INVENTION

1. Field of the Invention

This invention relates to a method of changing the function of a telephone apparatus used in changing the function of, for example, an electronic private branch exchange or a key telephone apparatus, a method of changing the number of telephone lines which are usable used in changing the number of lines, a method of changing the function of a terminal provided for a telephone apparatus, and a customer center which performs the function changing control and the-number-of-telephone-lines changing control, and an user system including the telephone apparatus.

2. Description of the Related Art

In offices, schools, and the like, electronic private branch exchanges and key telephone apparatuses have been widely used. When purchasing such telephone apparatuses, users generally select those with the necessary functions at that time.

After the telephone apparatuses start to be used, it may be necessary to add another function of the apparatus or lines according to an increase in the personnel, a change in the contents of business, and the like or to eliminate the unnecessary functions or lines which are usable. In this case, for example, the user informs the maker's customer center or the like that the user wants to add functions or lines which are usable. Depending on the contents, the maintenance man is dispatched to the installation place of the telephone apparatus and does the work of adding to the telephone apparatus the functions or lines the user wants.

In the conventional changing method, most of the work ranging from the user's function changing request or the user's number-of-lines changing request to the changing of the function of the telephone apparatus or the changing of the number of lines is carried out manually by the maintenance man dispatched from the customer center. Consequently, it takes a lot of time and labor from when the user informs the customer center of the function changing request until the function is changed or the number of lines is changed.

Therefore, the user not only cannot use the new functions or the new lines immediately but also has to pay the traveling expenses and installation expenses in addition to the cost of the added functions, resulting in an increase in the expenses. On the other hand, the customer center must estimate the number of occurrences of function changing requests or the number-of-lines changing requests and secure as many maintenance men as correspond to the number of occurrences, which causes the problems of increasing the cost and permitting variations in the quality of work to take place depending on the maintenance man.

### BRIEF SUMMARY OF THE INVENTION

It is accordingly an object of the present invention to provide a method of changing the function of a telephone apparatus, a method of changing the number of telephone lines which are usable, and a method of changing the function of a terminal provided for a telephone apparatus which make it possible to lighten the expenses the user pays, shorten the time required to make changes, decrease costs and labor at a customer center by changing the functions of a plurality of telephone apparatuses the user has, the number of telephone lines, and the function of a terminal provided for a telephone apparatus in unison quickly and suitably without human intervention, and a customer center which performs the function changing control and the-number-of-telephone-lines changing control, and an user system including the telephone apparatus

To accomplish the foregoing object, a first aspect of the present invention changes the function as follows.

A method of changing functions of a plurality of telephone apparatuses by making an exchange of information via a communication network between an user system that includes the plurality of telephone apparatuses, and a customer center that supports the operation of the plurality of telephone apparatuses, the method comprising: causing the user system to transmit to the customer center a function change request which includes a identification information to identify the telephone apparatuses whose functions are to be changed, a function change description of each of the telephone apparatuses whose functions are to be changed, and subscriber information allocated by the communication network to each of the telephone apparatuses; and causing the customer center to create function change control information on each telephone apparatus on the basis of the identification information and the function change descriptions of the telephone apparatuses included in the function change request and transmit the plurality of pieces of function change control information via the communication network to the corresponding telephone apparatuses and thereby changing the function of each of the telephone apparatuses on the basis of the plurality of pieces of function change control information.

To accomplish the foregoing object, a second aspect of the present invention changes the function as follows.

A method of changing the number of lines which are usable in a telephone apparatus by making an exchange of information via a communication network between an user system includes the telephone apparatus that includes line interface of at least one type, and a customer center that supports the operation of the telephone apparatus, the method comprising: causing the user system to transmit to the customer center a number-of-lines change request which includes a number-of-lines change description of each line type of the telephone apparatus and subscriber information allocated by the communication network to the telephone apparatus; and causing the customer center to create number-of-lines change control information on the basis of the change description included in the number-of-lines change request and transmit the number-of-lines change control information via the communication network to the corresponding telephone apparatus and thereby changing the number of lines which are usable on the basis of the number-of-lines change control information.

To accomplish the foregoing object, a third aspect of the present invention changes the function as follows.

A method of changing functions of terminal by making an exchange of information via a communication network between an user system includes a main apparatus that connect at least one terminal via line, and a customer center that supports the operation of the terminals, the method comprising: causing the user system to transmit to the customer center a function change request which includes a function change description of the terminal and subscriber information allocated by the communication network to the main apparatuses; and causing the customer center to create function change control information on the basis of the function change description of the terminal included in the function change request, and transmit the function change control information via the communication network to the corresponding terminal, and thereby changing the function of the terminal on the basis of the function change control information.

### BRIEF DESCRIPTION OF THE SEVERAL VIEWS OF THE DRAWING

FIG. 1 schematically shows the configuration of a system that carries out a function changing method according to a first embodiment of the present invention;

FIG. 2A is a block diagram showing a functional configuration of the function information and system ID transmission/reception setting section, an important part of the key telephone apparatus shown in FIG. 1;

FIG. 2B is a block diagram showing a functional configuration of the function information and system ID transmission/reception setting section, an important part of the key telephone apparatus shown in FIG. 1;

FIG. 3A is a block diagram showing a functional configuration of the function information storage area and function enabling section, an important part of the key telephone apparatus shown in FIG. 1;

FIG. 3B is a block diagram showing a functional configuration of the function information storage area and function enabling section, an important part of the key telephone apparatus shown in FIG. 1;

FIG. 4 is a sequence diagram to help explain a first modification of the function changing method according to the first embodiment;

FIG. 5 is a sequence diagram to help explain the first modification of the function changing method according to the first embodiment;

FIG. 6 is a sequence diagram to help explain a second modification of the function changing method according to the first embodiment;

FIG. 7 is a sequence diagram to help explain the second modification of the function changing method according to the first embodiment;

FIG. 8A is a block diagram showing a functional configuration of each section of the system shown in FIG. 1;

FIG. 8B is a block diagram showing a functional configuration of each section of the system shown in FIG. 1;

FIG. 9 is a flowchart for the procedure for processing at the customer center of the system shown in FIG. 1;

FIG. 10 shows examples of the display screen on the user PC shown in FIG. 1;

FIG. 11 shows an example of the display screen on the user PC shown in FIG. 1;

FIG. 12 is a diagram to help explain operations taking place when an extension terminal sends a call pickup request and a call forward setting request to the key telephone apparatus;

FIG. 13 is a diagram to help explain operations taking place when a maintenance terminal sends a multi-appearance setting request and an extension representative group setting request to the key telephone apparatus;

FIG. 14 is a diagram to help explain outgoing and incoming call processing operations taking place between the key telephone apparatus and an extension terminal;

FIG. 15 schematically shows the configuration of a system that carries out a function changing method according to a second embodiment of the present invention;

FIG. 16 is a signal sequence diagram to help explain the function changing method according to the second embodiment;

FIG. 17 is a signal sequence diagram to help explain the function changing method according to the second embodiment;

FIG. 18A is a block diagram showing a functional configuration of each section in the system shown in FIG. 15;

FIG. 18B is a block diagram showing a functional configuration of each section in the system shown in FIG. 15;

FIG. 19 is a flowchart for the procedure for processing at the customer center of the system shown in FIG. 15;

FIG. 20 schematically shows the configuration of a system that carries out a function changing method according to a third embodiment of the present invention;

FIG. 21 is a signal sequence diagram to help explain the function changing method according to the third embodiment;

FIG. 22 is a signal sequence diagram to help explain the function changing method according to the third embodiment;

FIG. 23 is a signal sequence diagram to help explain the function changing method according to the third embodiment;

FIG. 24A is a block diagram showing a functional configuration of each section in the system shown in FIG. 20;

FIG. 24B is a block diagram showing a functional configuration of each section in the system shown in FIG. 20;

FIG. 25 is a flowchart for the procedure for processing at the customer center of the system shown in FIG. 20;

FIG. 26 is a flowchart for the procedure for processing at the dealer in the system shown in FIG. 20;

FIG. 27 schematically shows the configuration of a system that carries out a function changing method according to a fourth embodiment of the present invention;

FIG. 28 is a signal sequence diagram to help explain the function changing method according to the fourth embodiment;

FIG. 29 is a signal sequence diagram to help explain the function changing method according to the fourth embodiment;

FIG. 30 is a signal sequence diagram to help explain the function changing method according to the fourth embodiment;

FIG. 31A is a block diagram showing a functional configuration of each section in the system shown in FIG. 27;

FIG. 31B is a block diagram showing a functional configuration of each section in the system shown in FIG. 27;

FIG. 32 is a flowchart for the procedure for processing at the customer center of the system shown in FIG. 27;

FIG. 33 schematically shows the configuration of a system that carries out a function changing method according to a fifth embodiment of the present invention;

FIG. 34 is a sequence diagram to help explain the function changing method according to the fifth embodiment;

FIG. 35 is a sequence diagram to help explain the function changing method according to the fifth embodiment;

FIG. 36 is a sequence diagram to help explain the function changing method according to the fifth embodiment;

FIG. 37A is a block diagram showing a functional configuration of each section in the system shown in FIG. 33;

FIG. 37B is a block diagram showing a functional configuration of each section in the system shown in FIG. 33;

FIG. 38 is a sequence diagram to help explain a first modification of the function changing method according to the fifth embodiment;

FIG. 39 is a sequence diagram to help explain the first modification of the function changing method according to the fifth embodiment;

FIG. 40 is a sequence diagram to help explain the first modification of the function changing method according to the fifth embodiment;

FIG. 41 is a sequence diagram to help explain a second modification of the function changing method according to the fifth embodiment;

FIG. 42 is a sequence diagram to help explain the second modification of the function changing method according to the fifth embodiment;

FIG. 43 is a sequence diagram to help explain the second modification of the function changing method according to the fifth embodiment;

FIG. 44 schematically shows the configuration of a system that carries out a function changing method according to a sixth embodiment of the present invention;

FIG. 45 is a sequence diagram to help explain the function changing method according to the sixth embodiment;

FIG. 46 is a sequence diagram to help explain the function changing method according to the sixth embodiment;

FIG. 47 is a sequence diagram to help explain the function changing method according to the sixth embodiment;

FIG. 48A is a block diagram showing a functional configuration of each section in the system shown in FIG. 44;

FIG. 48B is a block diagram showing a functional configuration of each section in the system shown in FIG. 44;

FIG. 49 is a sequence diagram to help explain a first modification of the function changing method according to the sixth embodiment;

FIG. 50 is a sequence diagram to help explain the first modification of the function changing method according to the sixth embodiment;

FIG. 51 is a sequence diagram to help explain the first modification of the function changing method according to the sixth embodiment;

FIG. 52 schematically shows the configuration of a system that carries out a number-of-lines changing method according to a seventh embodiment of the present invention;

FIG. 53 shows an example of the contents of a line information setting table provided in the key telephone apparatus shown in FIG. 52;

FIG. 54 is a signal sequence diagram to help explain the number-of-lines changing method according to the seventh embodiment;

FIG. 55 is a signal sequence diagram to help explain the number-of-lines changing method according to the seventh embodiment;

FIG. 56A is a block diagram showing a functional configuration of each section in the system shown in FIG. 52;

FIG. 56B is a block diagram showing a functional configuration of each section in the system shown in FIG. 52;

FIG. 57 is a flowchart for the procedure for processing at the customer center of the system shown in FIG. 52;

FIG. 58 schematically shows the configuration of a system that carries out a number-of-lines changing method according to an eighth embodiment of the present invention;

FIG. 59 is a signal sequence diagram to help explain the number-of-lines changing method according to the eighth embodiment;

FIG. 60 is a signal sequence diagram to help explain the number-of-lines changing method according to the eighth embodiment;

FIG. 61A is a block diagram showing a functional configuration of each section in the system shown in FIG. 58;

FIG. 61B is a block diagram showing a functional configuration of each section in the system shown in FIG. 58;

FIG. 62 is a flowchart for the procedure for processing at the customer center of the system shown in FIG. 58;

FIG. 63 schematically shows the configuration of a system that carries out a number-of-lines changing method according to a ninth embodiment of the present invention;

FIG. 64 is a signal sequence diagram to help explain the number-of-lines changing method according to the ninth embodiment;

FIG. 65 is a signal sequence diagram to help explain the number-of-lines changing method according to the ninth embodiment;

FIG. 66 is a signal sequence diagram to help explain the number-of-lines changing method according to the ninth embodiment;

FIG. 67A is a block diagram showing a functional configuration of each section in the system shown in FIG. 63;

FIG. 67B is a block diagram showing a functional configuration of each section in the system shown in FIG. 63;

FIG. 68 is a flowchart for the procedure for processing at the customer center of the system shown in FIG. 63;

FIG. 69 is a flowchart for the procedure for processing at the dealer in the system shown in FIG. 63;

FIG. 70 schematically shows the configuration of a system that carries out a number-of-lines changing method according to a tenth embodiment of the present invention;

FIG. 71 is a signal sequence diagram to help explain the number-of-lines changing method according to the tenth embodiment;

FIG. 72 is a signal sequence diagram to help explain the number-of-lines changing method according to the tenth embodiment;

FIG. 73 is a signal sequence diagram to help explain the number-of-lines changing method according to the tenth embodiment;

FIG. 74A is a block diagram showing a functional configuration of each section in the system shown in FIG. 70;

FIG. 74B is a block diagram showing a functional configuration of each section in the system shown in FIG. 70;

FIG. 75 is a flowchart for the procedure for processing at the customer center of the system shown in FIG. 70;

FIG. 76 schematically shows the configuration of a system that carries out a number-of-lines changing method according to an eleventh embodiment of the present invention;

FIG. 77 is a signal sequence diagram to help explain the number-of-lines changing method according to the eleventh embodiment;

FIG. 78 is a signal sequence diagram to help explain the number-of-lines changing method according to the eleventh embodiment;

FIG. 79 is a signal sequence diagram to help explain the number-of-lines changing method according to the eleventh embodiment;

FIG. 80A is a block diagram showing a functional configuration of each section in the system shown in FIG. 76;

FIG. 80B is a block diagram showing a functional configuration of each section in the system shown in FIG. 76;

FIG. 81 schematically shows the configuration of a system that carries out a number-of-lines changing method according to a twelfth embodiment of the present invention;

FIG. 82 is a signal sequence diagram to help explain the number-of-lines changing method according to the twelfth embodiment;

FIG. 83 is a signal sequence diagram to help explain the number-of-lines changing method according to the twelfth embodiment;

FIG. 84 is a signal sequence diagram to help explain the number-of-lines changing method according to the twelfth embodiment;

FIG. 85A is a block diagram showing a functional configuration of each section in the system shown in FIG. 81;

FIG. 85B is a block diagram showing a functional configuration of each section in the system shown in FIG. 81;

FIG. 86 schematically shows the configuration of a system that carries out a method of changing the function of a terminal according to a thirteenth embodiment of the present invention;

FIG. 87 is a signal sequence diagram to help explain the method of changing the function of a terminal according to the thirteenth embodiment;

FIG. 88 is a signal sequence diagram to help explain the method of changing the function of a terminal according to the thirteenth embodiment;

FIG. 89A is a block diagram showing a functional configuration of each section in the system shown in FIG. 86;

FIG. 89B is a block diagram showing a functional configuration of each section in the system shown in FIG. 86;

FIG. 90 schematically shows the configuration of a system that carries out a method of changing the function of a terminal according to a fourteenth embodiment of the present invention;

FIG. 91 is a signal sequence diagram to help explain the method of changing the function of a terminal according to the fourteenth embodiment;

FIG. 92 is a signal sequence diagram to help explain the method of changing the function of a terminal according to the fourteenth embodiment;

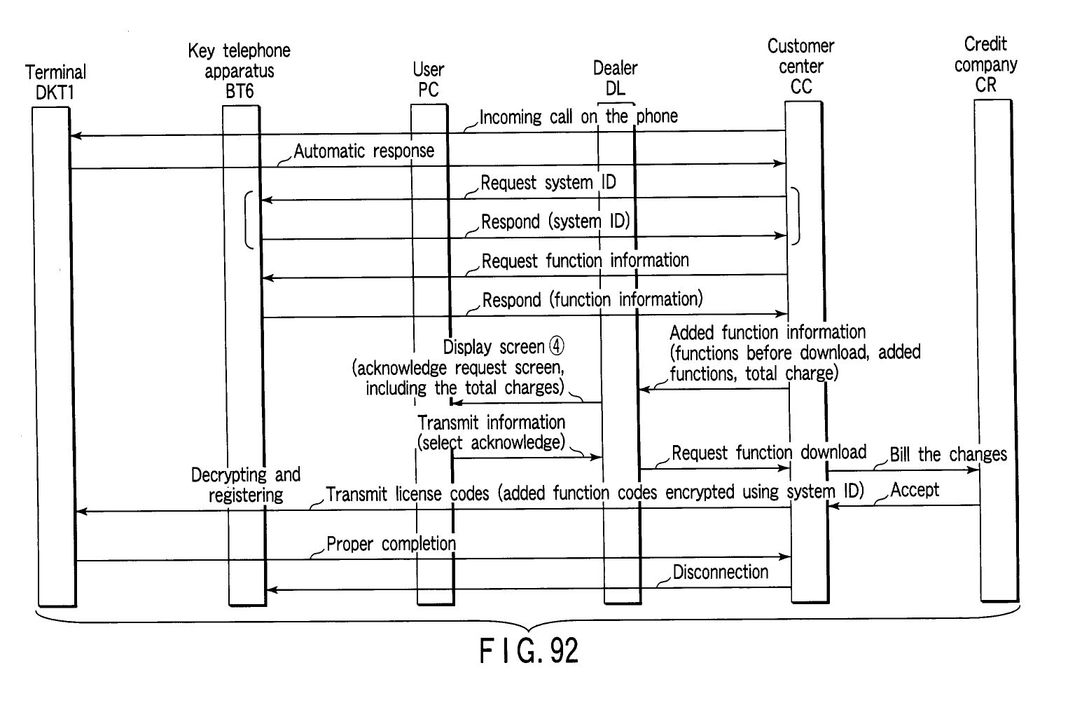

FIG. 93 is a signal sequence diagram to help explain the method of changing the function of a terminal according to the fourteenth embodiment;

FIG. 94A is a block diagram showing a functional configuration of each section in the system shown in FIG. 90;

FIG. 94B is a block diagram showing a functional configuration of each section in the system shown in FIG. 90;

FIG. 95 schematically shows the configuration of a system that carries out a method of changing the function of a terminal according to a fifteenth embodiment of the present invention;

FIG. 96 is a signal sequence diagram to help explain the method of changing the function of a terminal according to the fifteenth embodiment;

FIG. 97 is a signal sequence diagram to help explain the method of changing the function of a terminal according to the fifteenth embodiment;

FIG. 98 is a signal sequence diagram to help explain the method of changing the function of a terminal according to the fifteenth embodiment;

FIG. 99A is a block diagram showing a functional configuration of each section in the system shown in FIG. 95; and

FIG. 99B is a block diagram showing a functional configuration of each section in the system shown in FIG. 95; and

FIG. 100 schematically shows the configuration of a system that carries out a method of changing the function of a terminal according to another embodiment of the present invention.

### DETAILED DESCRIPTION OF THE INVENTION

Hereinafter, referring to the accompanying drawings, embodiments will be explained in detail.

(First Embodiment)

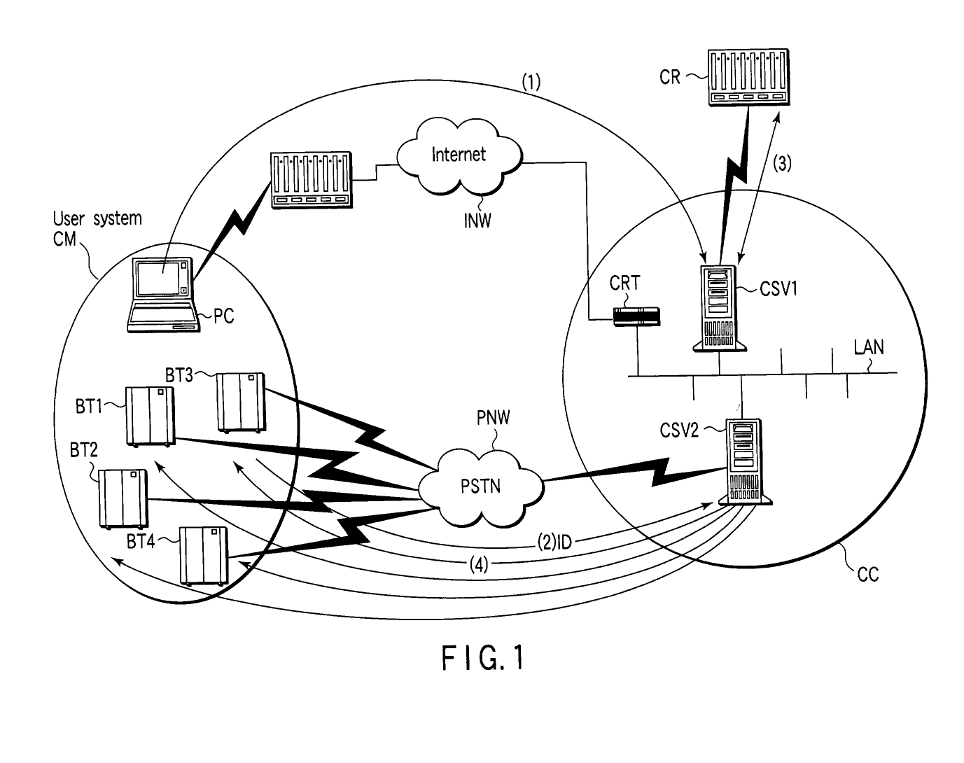

FIG. 1 schematically shows the configuration of a support system that carries out a function changing method according a first embodiment of the present invention, wherein CM indicates an user system, CC a customer center, and CR a credit company.

The user system CM includes key telephone apparatuses BT1 to BT4 and a maintenance personal computer PC. The basic function of each of the key telephone apparatuses BT1 to BT4 is to switch between a plurality of extension terminals (not shown) and between those extension terminals and subscribers to a public network PNW according to outgoing or incoming calls. Each of the key telephone apparatuses BT1 to BT4 further has a plurality of optional service functions related to the switching process. The optional service functions include, for example, a call pickup function, a call forward function, and a multi-appearance function.

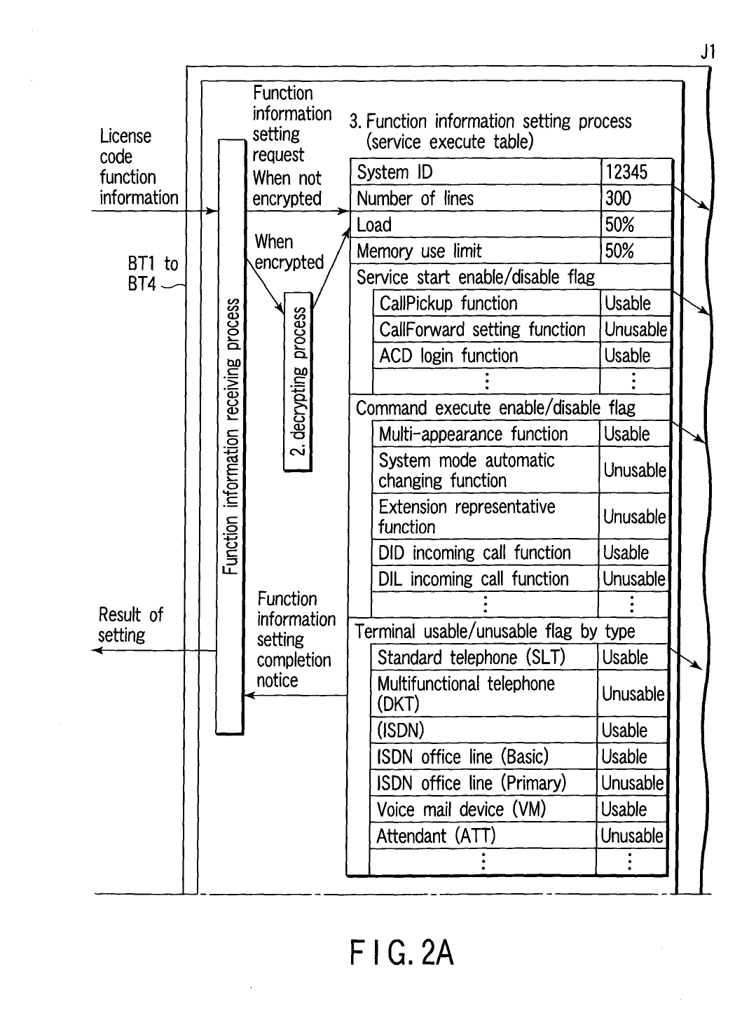

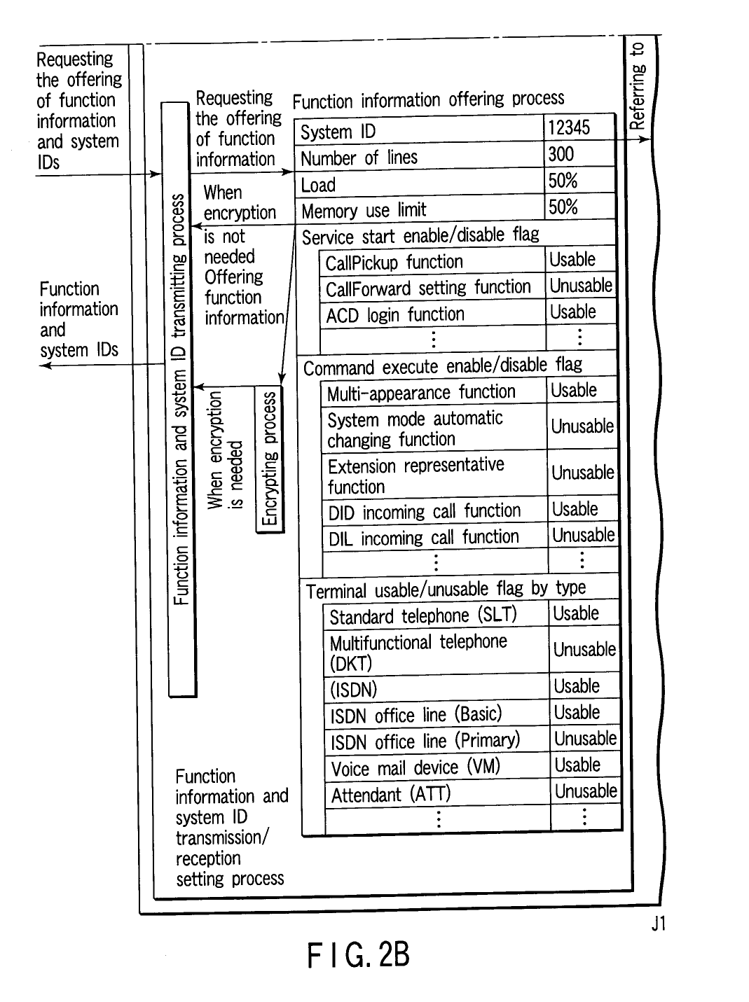

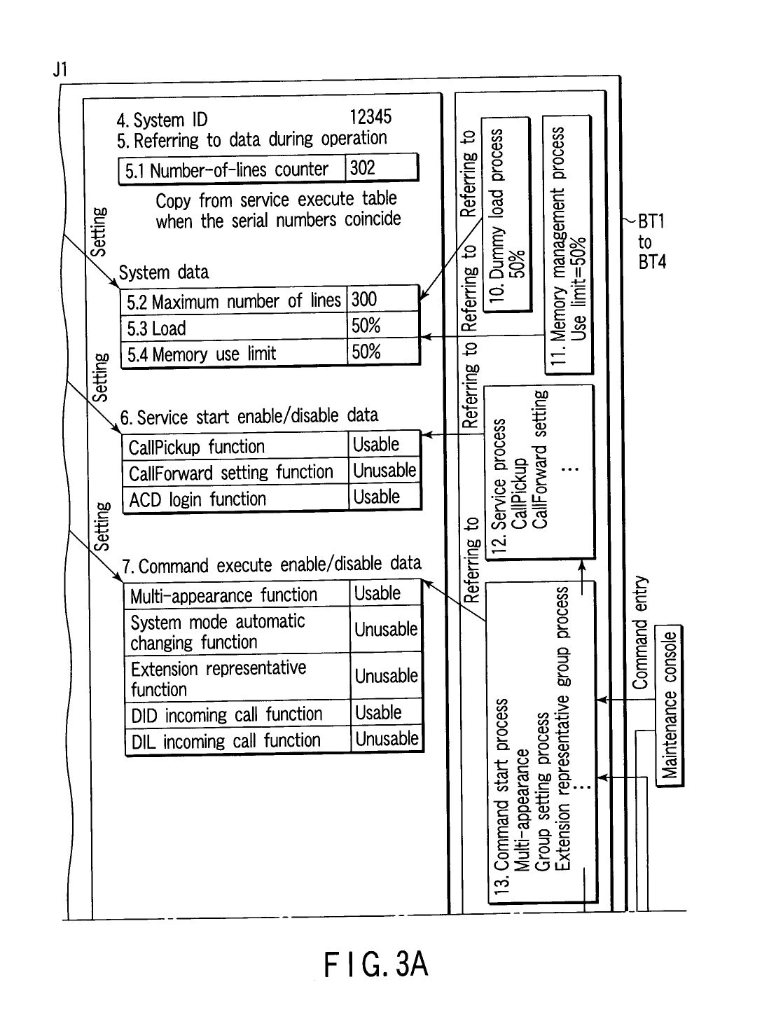

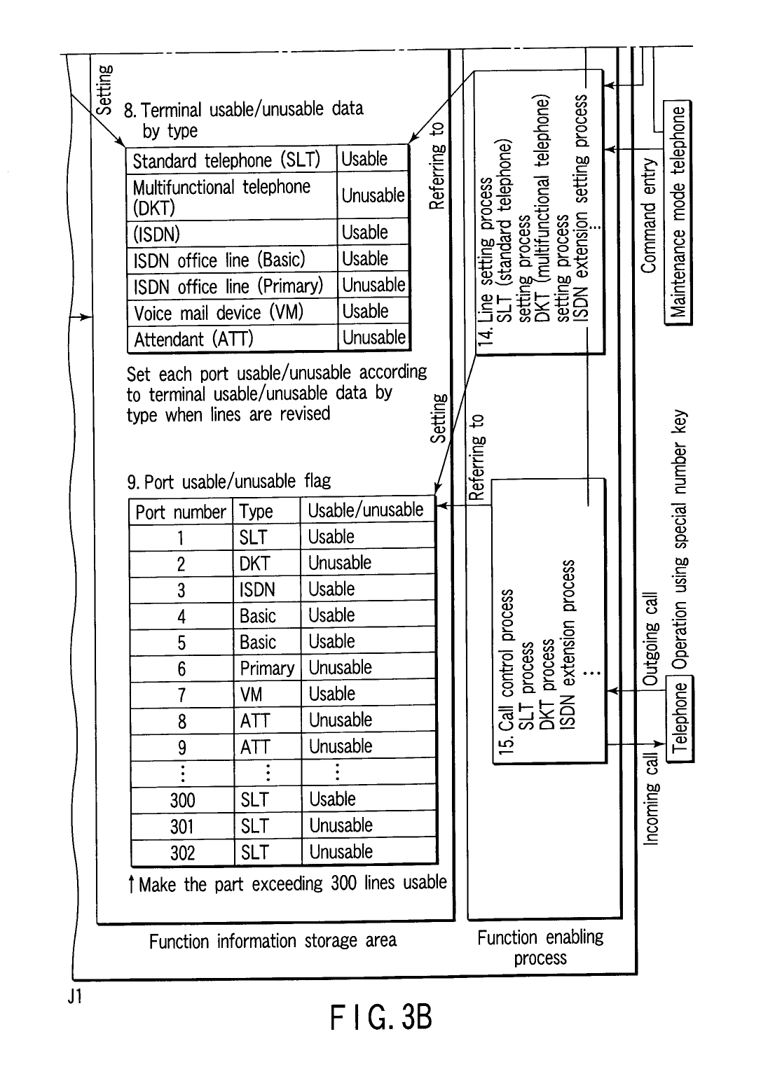

All of the programs that realize those optional service functions are stored beforehand in the program memories of the key telephone apparatuses BT1 to BT4. To manage the setting state of the optional service functions, there is provided a function information setting table (or service execute table) in each of the key telephone apparatuses BT1 to BT4. FIGS. 2 and 3 show examples of the table, in which flags indicating whether use is allowed or not are stored in such a manner that they correspond to the respective optional service functions. When a usable/unusable flag is set to “usable,” the function is executable. On the other hand, it is set to “unusable,” the function is inexecutable.

The maintenance personal computer PC is connected to the Internet INW via a provider ISP. The computer PC is further connected to the customer center CC via the Internet INW.

The customer center CC, which includes a reception/charging server CSV1, a license server CSV2, and a router CRT, connects these one another via a LAN. The reception/charging server CSV1, which is connected to the Internet INW via the router CRT, receives a function add request from the maintenance personal computer PC of the user system CM. Furthermore, the reception/charging server CSV1 is connected to the credit company CR via, for example, an exclusive line, thereby settling the charge for the added functions with the credit company CR.

The license server CSV2 is connected to the key telephone apparatuses BT1 to BT4 of the user system CM via the public network PNW. The license server CSV2 has device identification numbers (or system IDs) uniquely assigned to the individual key telephone apparatuses BT1 to BT4, the function of acquiring function information from each of the key telephone apparatuses BT1 to BT4, and the function of setting the addition of a function by sending a license code to each of the key telephone apparatuses BT1 to BT4. The function information is created on the basis of the function information setting table (see FIGS. 2 and 3) provided in the key telephone apparatuses BT1 to BT4. The function information is composed of a list of already usable functions and additionally usable functions. In the license code, an instruction code for activating an additional function and a system ID are inserted.

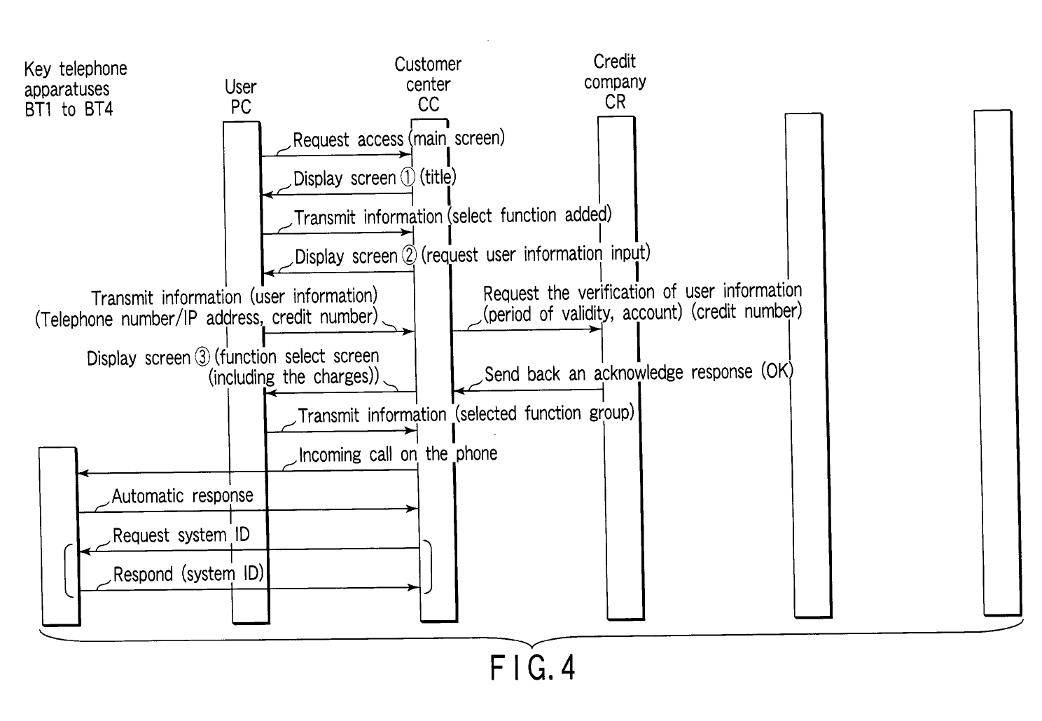

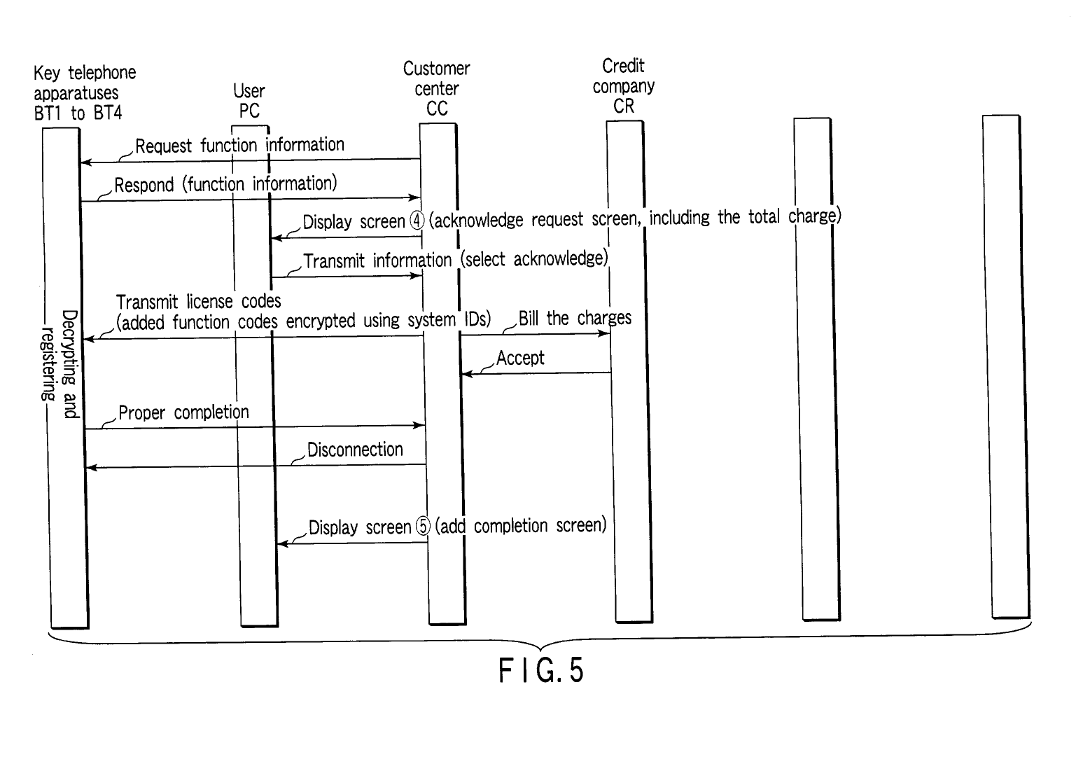

Next, the procedure for adding a function to the key telephone apparatuses BT1 to BT4 in the system will be explained. FIGS. 4 and 5 are schematic sequence diagrams to help explain the operation of transmitting and receiving information between the maintenance personal computer PC (or user PC) of the user system CM, the customer center CC, and the credit company CR.

To add a function to the key telephone apparatuses BT1 to BT4, the user uses the maintenance personal computer PC to access the customer center CC by way of the Internet INW and inputs the necessary items related to the addition of functions according to the guidance on the screen downloaded from the customer center CC. The necessary items inputted include the number of key telephone apparatuses BT1 to BT4 to which functions are to be added function information indicating the functions to be added, the credit number, and the telephone numbers or IP addresses allocated by the public network PNW to the key telephone apparatuses BT1 to BT4. After having inputted these necessary items, the user transmits a function add request including these pieces of information to the customer center CC.

Receiving the function add request, the customer center CC first accesses the credit company CR via the exclusive line and inquire about the credit of the user on the basis of the user's credit number. On inquiry, the credit company CR determines whether the account corresponding to the credit number is present, whether the expiration date of the credit is within the period of validity, and whether the cessation of use is set. Then, the credit company CR sends the reply to the customer center CC.

On the basis of the reply from the credit company CR, the customer center CC judges the credit of the user. If there is no problem, the customer center CC accesses each of the key telephone apparatuses BT1 to BT4 of the user via the public network PNW on the basis of the telephone numbers included in the function add request and acquires the function information and system IDs from the key telephone apparatuses BT1 to BT4. Then, on the basis of the acquired function information, the customer center CC determines whether the functions the user wants to add are already in use. If they are not in use, the customer center CC determines whether the functions can be added. Then, the customer center CC notifies the user's maintenance personal computer PC of the result of the determination and the expenses needed to add the functions.

Receiving the acknowledge response to the notice from the user, the customer center CC transmits via the public network PNW to each of the user's key telephone apparatuses BT1 to BT4 a license code as function change control information for each of the key telephone apparatuses BT1 to BT4. In the license code, an instruction code for setting the functions to be added to “usable” is inserted. At this time, the instruction code is encrypted using the system IDs acquired form each of the key telephone apparatuses BT1 to BT4.

Before transmitting the license codes, the customer center CC accesses the credit company CR to ask the company CR to settle the charges for added functions. At that time, the customer center CC calculates the amount billed for each function actually set usable and makes a detailed electronic bill. For example, when the user wants to add function 1 and function 2, the customer center CC adds an additional charge (=Y1000) for function 1 and an additional charge (=Y2000) for function 2 and makes a detailed electronic bill for them. Then, the customer center CC includes the detailed electronic bill in the settlement request information and transmits the resulting information to the credit company CR.

Receiving the settlement request information, the credit company CR authenticates the user on the basis of the user's credit number included in the settlement request information and determines whether to conduct a transaction. If it is possible to conduct a transaction, the credit company CR accepts the settlement of the charges on the basis of the detailed electronic bill included in the settlement request information. After finishing the acceptance of the settlement, the credit company CR sends back to the customer center CC a reply to the effect that the company CR has accepted the settlement request.

Receiving the reply to the settlement request from the credit company CR, the customer center CC transmits information to the effect that the function adding process is completed to the user's maintenance personal computer PC and causes the computer PC to display the information.

Receiving the license codes from the customer center CC, the key telephone apparatuses BT1 to BT4 decrypt the instruction codes included in the license codes using the system IDs of their own. Then, according to the decrypted instruction codes, the key telephone apparatuses BT1 to BT4 change the flag for the corresponding function in the function information setting table from “unusable” to “usable.” After finishing the process of setting the addition of functions, the key telephone apparatuses BT1 to BT4 send back to the customer center CC information to the effect that the function adding process is completed properly.

Receiving a notice of the completion of the addition of functions from the key telephone apparatuses BT1 to BT4, the customer center CC disconnects the lines with the key telephone apparatuses BT1 to BT4.

As a result, the functions the user wants to add are set in the key telephone apparatuses BT1 to BT4 in such a manner that they are usable. Thereafter, in the key telephone apparatuses BT1 to BT4, the added new optional service functions can be used.

The configuration of each section of the support system that realizes the above-described function changing method is as follows.

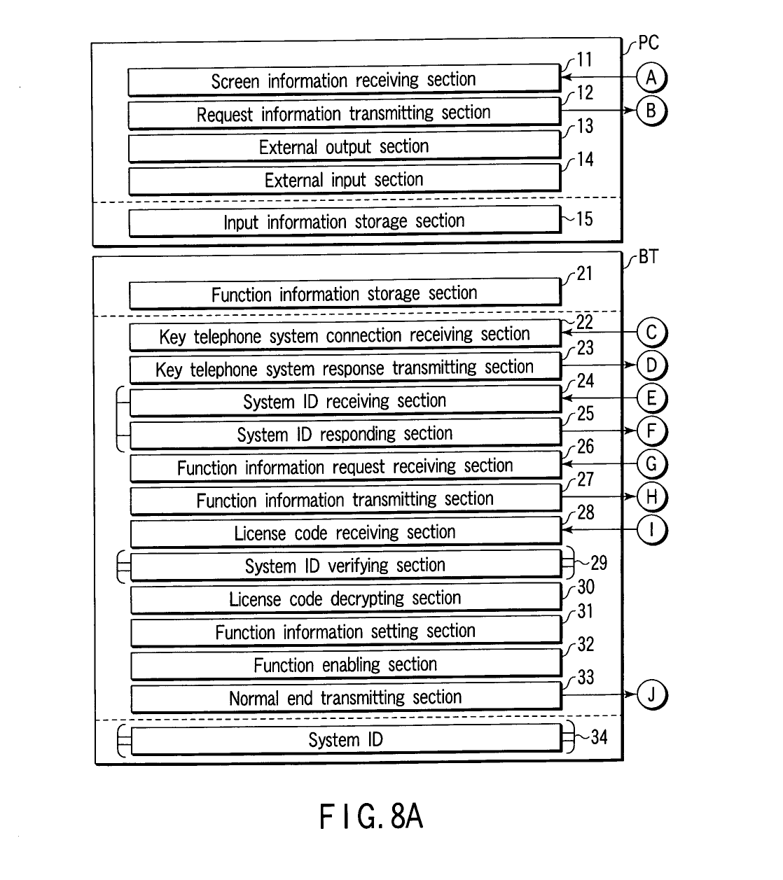

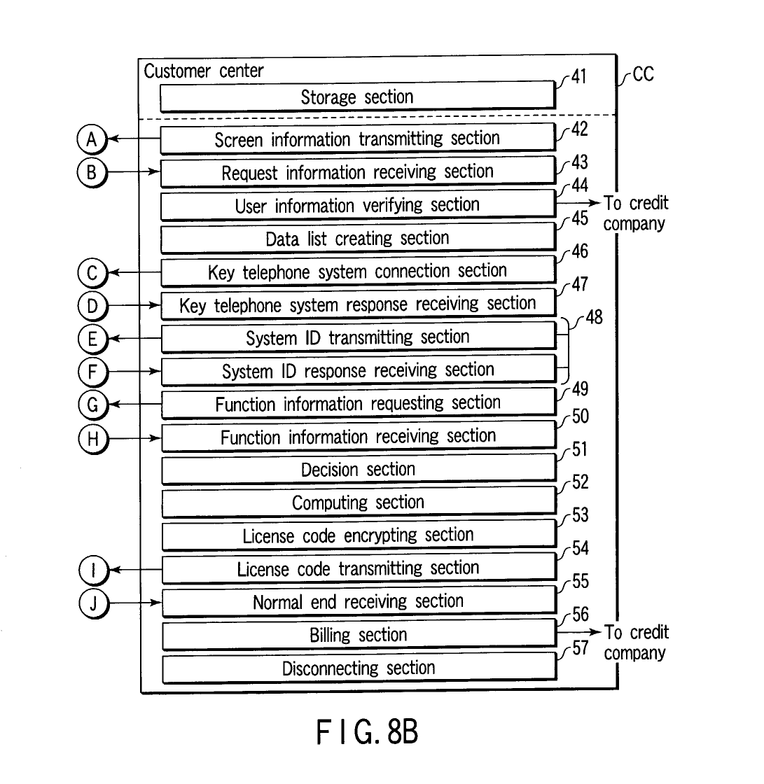

FIG. 8 is a block diagram showing a functional configuration of the maintenance personal computer PC, key telephone apparatuses BT1 to BT4, and customer center CC. In FIG. 8, explanation will be given, centering on the key telephone apparatus BT1 as the representative of the rest.

The maintenance personal computer PC includes a screen information receiving section 11, a request information transmitting section 12, an external output section 13, an external input section 14, and an input information storage section 15.

The screen information receiving section 11 receives various pieces of screen information downloaded from the customer center CC in the course of executing the procedure for adding functions and displays them. The request information transmitting section 12 inserts information indicating the additional functions the user has inputted, the credit number, and the telephone number or IP address of each of the key telephone apparatuses BT1 to BT4 into the request information and transmits the resulting request information to the customer center CC.

The key telephone apparatuses BT1 to BT4 include, as functions related to the present invention, a function information storage section 21, a key telephone system connection receiving section 22, a key telephone system automatic response transmitting section 23, a system ID request receiving section 24, a system ID transmitting section 25, a function information request receiving section 26, a function information transmitting section 27, a license code receiving section 28, a system ID verifying section 29, a license code decrypting section 30, a function information setting section 31, a function enabling section 32, a normal end transmitting section 33, and a system ID storage section 34.

In the function information storage section 21, the function information shown in FIGS. 2 and 3 is stored. In the system ID storage section 34, the unique system ID fixedly assigned to its own apparatus is stored. For example, the serial number of the key telephone apparatus is used as the system ID.

The key telephone system connection receiving section 22 and key telephone system automatic response transmitting section 23 receive and respond to an incoming call when the call arrives from the customer center CC. The system ID request receiving section 24 and system ID transmitting section 25 receive a system ID acquisition request and transmit the system ID when the acquisition request arrives from the customer center CC. The function information request receiving section 26 and function information transmitting section 27 receive a function information acquisition request and transmit a function information list when the acquisition request arrives from the customer center CC.

The license code decrypting section 30 decrypts the license code received by the license code receiving section 28, using its own apparatus' system ID. The function information setting section 31 and function enabling section 32 set the flag for the function to be added to “usable” according to the decrypted license code.

The customer center CC includes a function list storage section 41, a screen information transmitting section 42, a request information receiving section 43, an user information verifying section 44, a data list creating section 45, a key telephone system connection section 46, a key telephone system response receiving section 47, a system ID requesting section and system ID receiving section 48, a function information requesting section 49, a function information receiving section 50, a requested function decision section 51, an additional function charge computing section 52, a license code encrypting section 53, a license code transmitting section 54, a normal end receiving section 55, and a billing section 56, and a disconnecting section 57.

The screen information transmitting section 42, when being accessed by the user's maintenance personal computer PC, transmits screen information to cause the maintenance personal computer PC to input a function add request and transmit it. The request information receiving section 43 receives information about the function add request sent from the maintenance personal computer PC. The user information verifying section 44 accesses the credit company CR on the basis of the credit number included in the received function add request information and inquires about the credit of the user.

The key telephone system connection section 46 and key telephone system response receiving section 47 access the key telephone apparatuses BT1 to BT4 via the public network PNW on the basis of the telephone number included in the received function add request information and receive each response. The system ID requesting section and system ID receiving section 48 not only transmits a system ID transmit request to the key telephone apparatuses BT1 to BT4 but also receives the respective system IDs from the key telephone apparatuses BT1 to BT4.

The function information requesting section 49 and function information receiving section 50 not only transmit a function information transmit request to the key telephone apparatuses BT1 to BT4 but also receive the function information from each of the key telephone apparatuses BT1 to BT4. The decision section 51, on the basis of the received function information list, determines whether the requested function can be added. The computing section 52 calculates the charges for the added functions on the basis of the list of functions.

The license code encrypting section 53 and license code transmitting section 54 encrypt the license code for each of the key telephone apparatuses, using the system IDs acquired from the key telephone apparatuses BT1 to BT4 and transmit the encrypted license codes to the key telephone apparatuses BT1 to BT4. The normal end receiving section 55 receives normal end signals sent from the key telephone apparatuses BT1 to BT4 after the function adding process and informs the maintenance personal PC that the normal end signals have been received. The billing section 56 transmits to the credit company CR a bill for the charges calculated previously at the added function charge computing section 52.

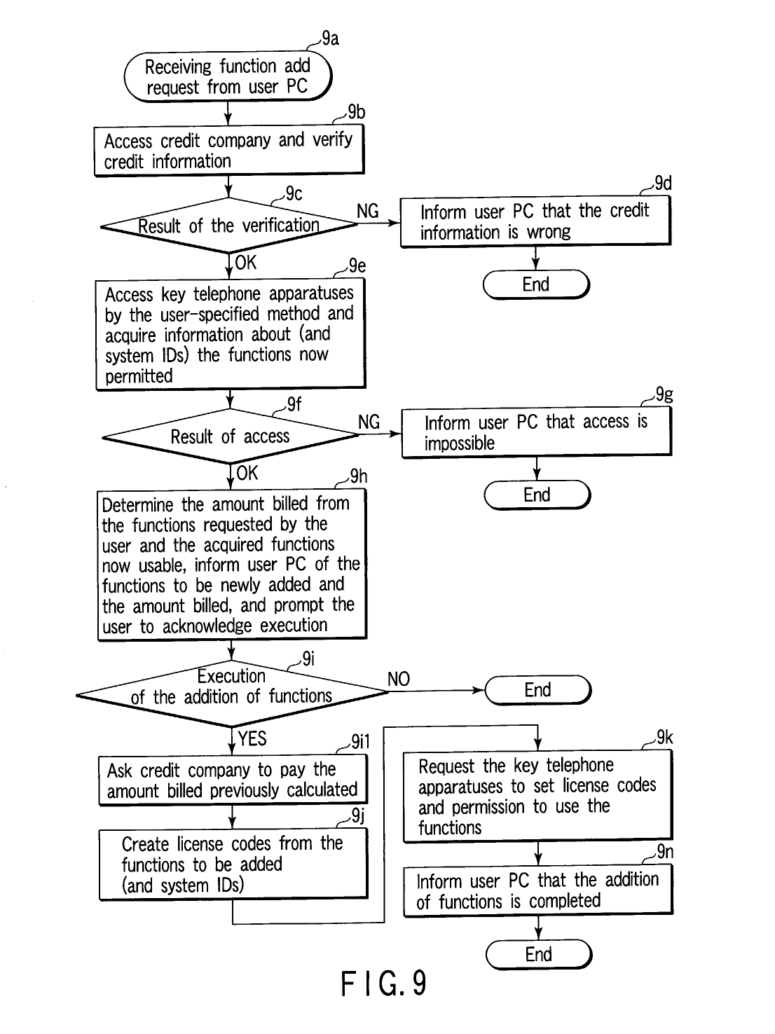

FIG. 9 is a flowchart for the operation of the customer center CC. The process of adding functions is carried out according to the procedure shown in step 9a to step 9n.

When receiving a function add request from the user's maintenance personal computer PC via the Internet INW in step 9a, the customer center CC accesses the credit company CR in step 9b to verify the credit information. If the credit information is invalid, the customer center CC passes control from step 9c to step 9d, where the customer center CC informs the requesting maintenance personal computer PC that the credit execute information is wrong.

On the other hand, if the credit information is valid, the customer center CC passes control from step 9c to step 9e, where the customer center CC accesses each of the user's key telephone apparatuses BT1 to BT4, using the telephone number or mail address of each of the key telephone apparatuses BT1 to BT4 sent from the user, and acquires information about the functions allowed to be used now and the system IDs from the key telephone apparatuses BT1 to BT4. When the key telephone apparatuses BT1 to BT4 cannot be accessed, the customer center CC passes control from step 9f to step 9g, where the center CC informs the user that the key telephone apparatuses BT1 to BT4 cannot be accessed.

Next, the customer center CC, in step 9h, calculates the amount billed on the basis of the functions required by the user and the pieces of function information acquired from the key telephone apparatuses BT1 to BT4, informs the user's maintenance personal computer PC of the newly added functions and the amount billed, and inquires whether to execute the addition of the functions. When the user transmits an execute request in response to the inquiry, the customer center CC passes control from step 9i to 9i1, where the center CC transmits to the credit company CR settlement request information about the amount billed previously calculated. When receiving from the credit company CR a reply to the effect that the company CR has accepted the settlement request, the customer center passes control to step 9j, where the center CC creates a license code for each of the key telephone apparatuses on the basis of the added functions and the system IDs of the key telephone apparatuses BT1 to BT4 and, in step 9k, sends to the key telephone apparatuses BT1 to BT4 a request for setting use of the license codes and functions possible.

Then, after the setting of the additional functions is completed in the key telephone apparatuses BT1 to BT4, the customer center CC, in step 9n, informs the requesting user's maintenance personal computer PC that the addition of the functions is completed.

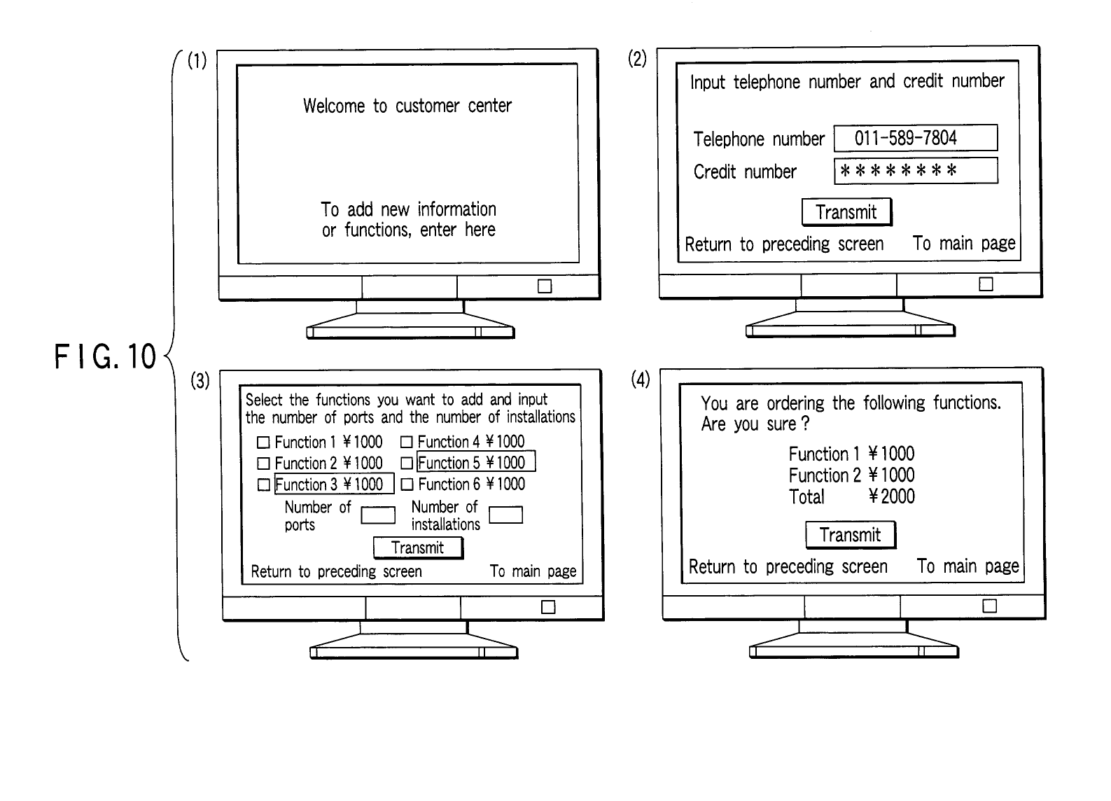

On the other hand, when the user accesses the customer center CC, the maintenance personal computer PC downloads a title screen as shown in FIG. 10(1) from the customer center CC by way of the Internet INW and then downloads an user information input request screen as shown in FIG. 10(2). The user inputs the credit number, the telephone numbers or IP addresses allocated by the public network PNW to the key telephone apparatuses BT1 to BT4 repeatedly according to the guidance on the user information input request screen for the key telephone apparatuses BT1 to BT4. Then, after finishing the input, the user clicks “Transmit” on the screen.

Then, the maintenance personal computer PC transmits the inputted information to the customer center CC.

Then, the maintenance personal computer PC downloads a function select screen including charges as shown in FIG. 10(3) from the customer center CC by way of the Internet INW. According to the function select screen, the user inputs information about the functions the use wants to add, repeatedly for the key telephone apparatuses BT1 to BT4. Then, after finishing the input, the user clicks “Transmit” on the screen.

Then, the maintenance personal computer PC transmits the inputted information to the customer center CC.

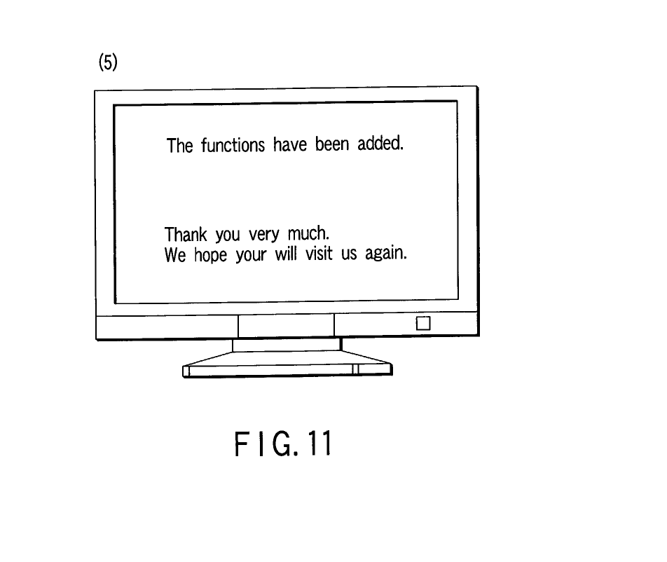

When the customer center CC determines that the functions the user wants are not in use and can be added, the maintenance personal computer PC downloads a verify request screen as shown in FIG. 10(4) from the customer center CC by way of the Internet INW. Then, when the user has verified the contents and clicked “Transmit” on the screen, the maintenance personal computer PC transmits the verify information to the customer center CC. Thereafter, the maintenance personal computer PC downloads an add completion screen as shown in FIG. 11(5) form the customer center CC.

As described above, according to the function changing method of the first embodiment, a series of procedures ranging from the transmission of a function add request by the user to the process of setting the addition of functions on the user's key telephone apparatuses BT1 to BT4, and to the process of settling the charges for added functions is performed in unison automatically via communication networks, including the Internet INV and public network PNW, without human intervention. This eliminates business trips of maintenance servicemen, changing work with the hands, and the work of billing the expenses by the person in charge, which enables the user to add functions to the user's key telephone apparatuses BT1 to BT4 in a short time at less expenses. On the other hand, the customer center CC can reduce the labor and cost required to add functions.

Since the license setup for the key telephone apparatuses BT1 to BT4 is carried out using the existing lines, special lines for the license setup and an interface circuit for connecting the lines need not be newly provided and functions can be changed easily from the customer center in a remote control manner, which is advantageous in costs.

Before the execution of the process of adding functions to the key telephone apparatuses BT1 to BT4, the customer center CC accesses each of the key telephone apparatuses BT1 to BT4 to acquire their function information, that is, a list of the functions already set and the functions that can be newly set, and, on the basis of the list, determines whether functions can be added. Therefore, functions can be added properly to each of the key telephone apparatuses BT1 to BT4. This makes it possible to add functions with high reliability.

The license codes, when being transferred from the customer center CC to the key telephone apparatuses BT1 to BT4, are encrypted using the corresponding system IDs acquired from the key telephone apparatuses BT1 to BT4. This prevents the wrong function or an unauthorized function from being added, even when the license codes are transferred erroneously to the key telephone apparatuses BT1 to BT4, or when another user tries to add functions to his or her key telephone apparatuses BT1 to BT4 by stealing the license codes addressed to the authorized key telephone apparatuses BT1 to BT4.

Furthermore, since the telephone numbers of and the function information about the user's key telephone apparatuses BT1 to BT4 are acquired from the user or the key telephone apparatuses BT1 to BT4, there is no need to provide an user database for accumulating and managing those pieces of user information. This helps simplify the user management and the system configuration.

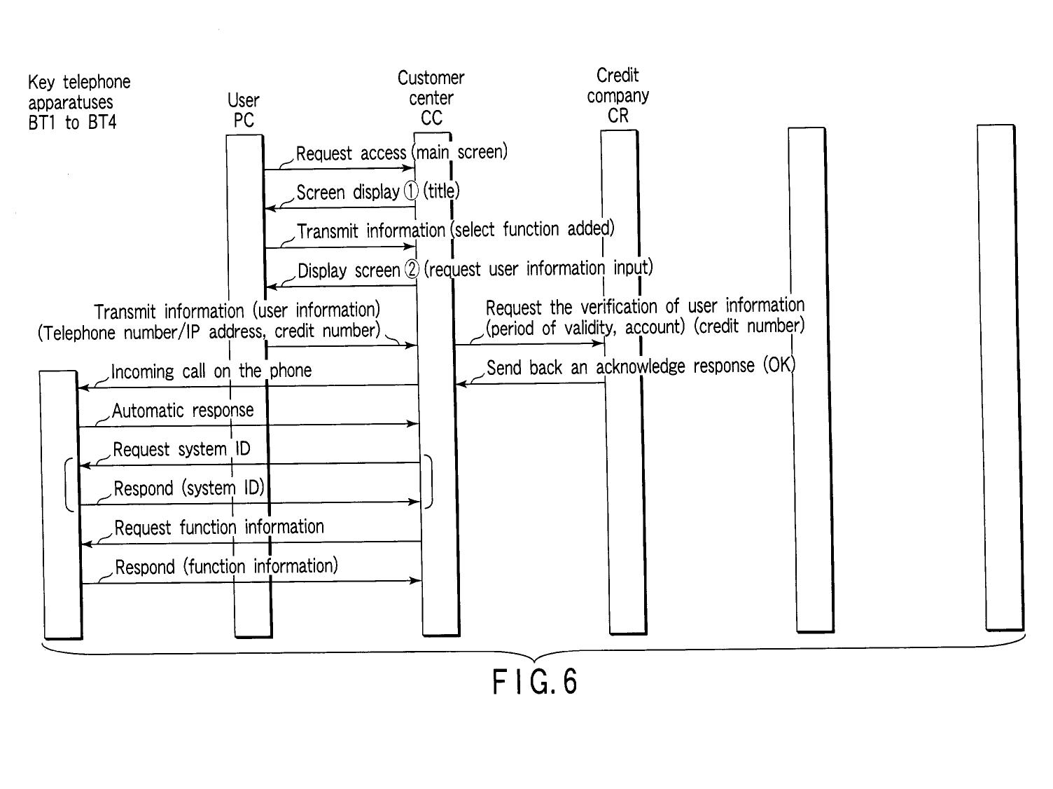

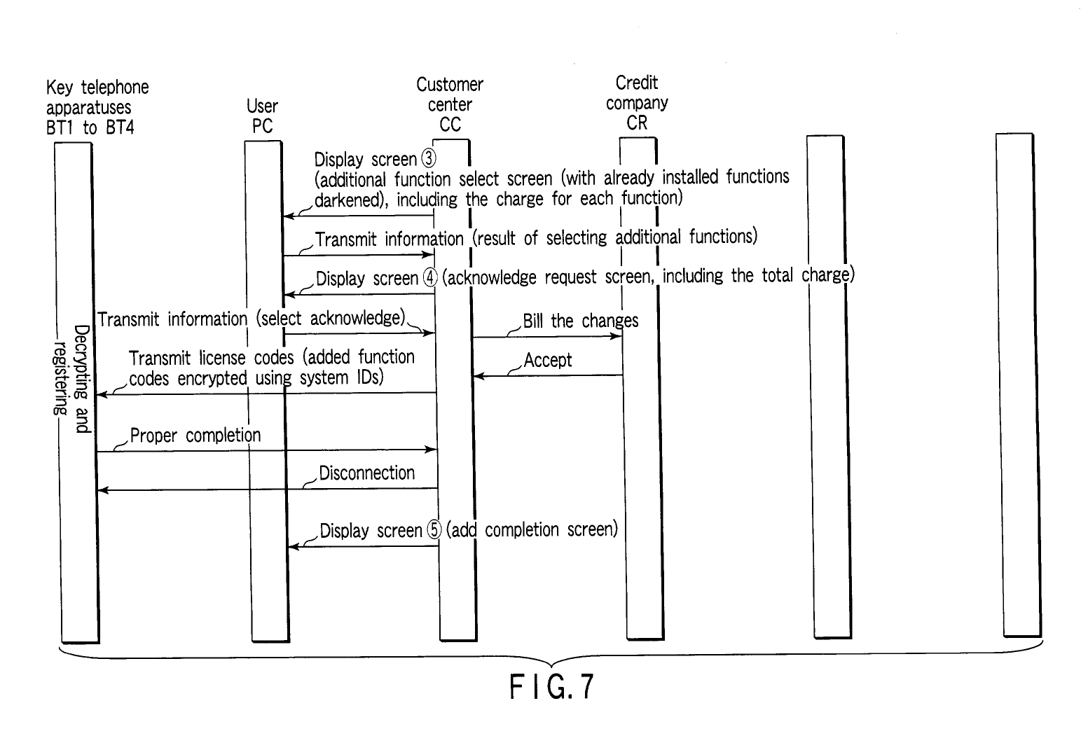

While in the above explanation, the user has inputted the functions the user wants to add from the initial screen, the customer center CC may transfer the function information acquired from each of the key telephone apparatuses BT1 to BT4 to the user and cause the user to display the information. On the basis of the information, the user may verify the functions that are already set and the functions that can be additionally set and then specify the functions the user wants to add. FIGS. 6 and 7 show the sequence of carrying out the function changing method according to the procedure.

By doing this, the user can send a function add request after verifying the functions that are already set and the functions that can be additionally set, thereby always making a function add request accurately.

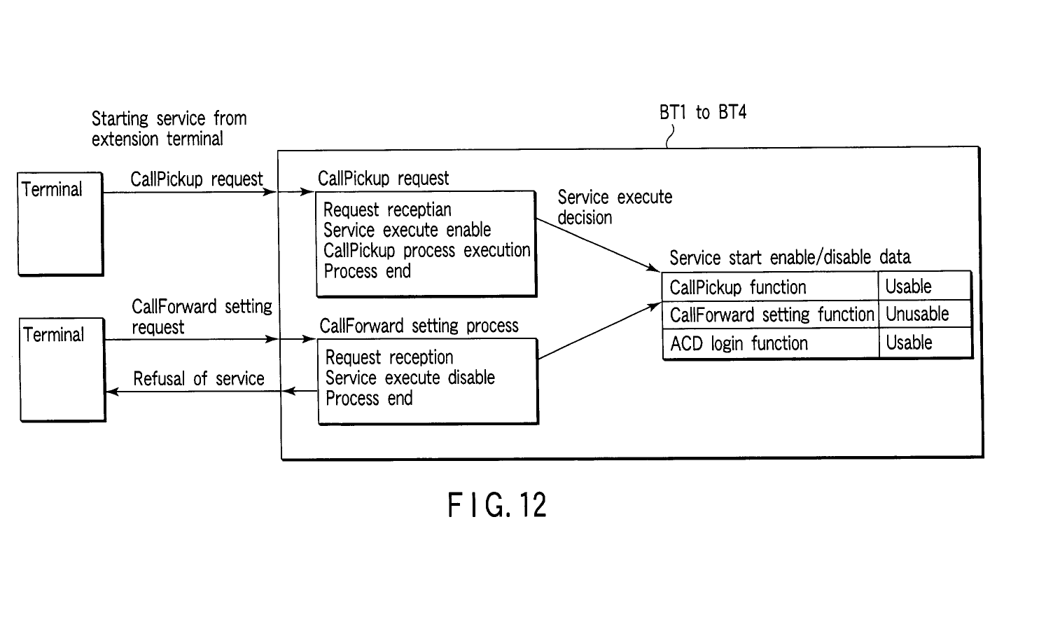

The various optional service functions of the key telephone apparatuses BT1 to BT4 additionally set as described above are implemented as follows. FIGS. 12 to 14 schematically show the operations.

For example, when a call pickup request or a call forward setting request arrives from an extension terminal, the service execute table is accessed as shown in FIG. 12 and it is determined whether the function is “usable” or “unusable,” from the usable/unusable flag corresponding to the call pickup function or call forward setting function. If the function is “usable,” the request is accepted and the corresponding process is executed. On the other hand, if the function is “unusable,” a refusal of service is sent back to the requesting extension terminal.

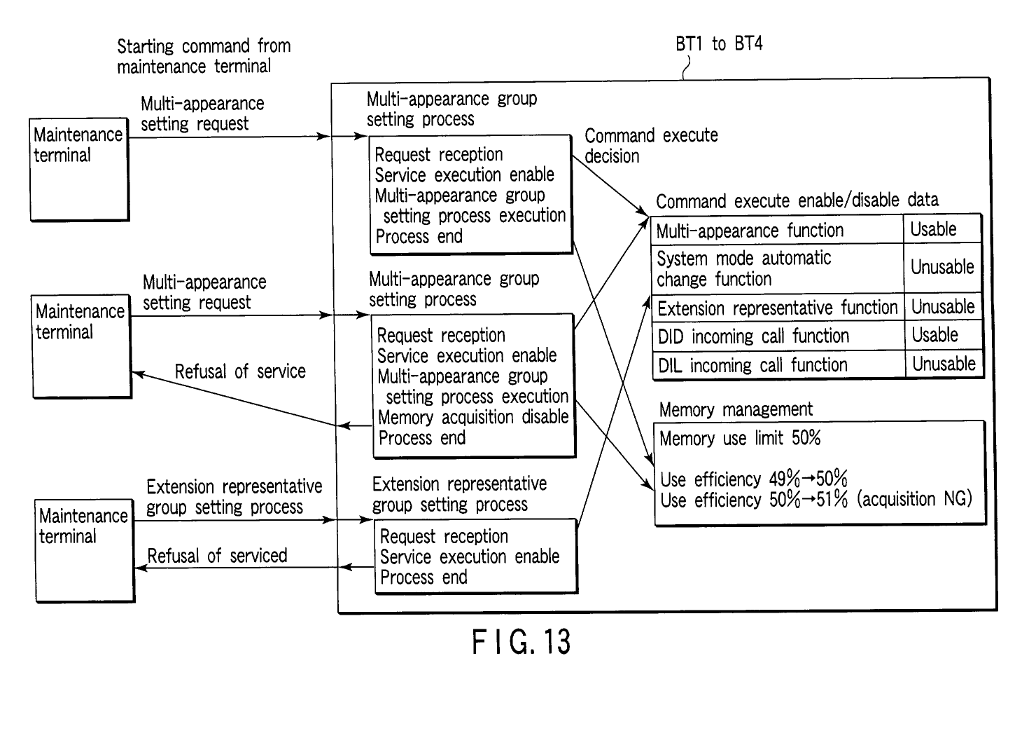

When a multi-appearance setting request or an extension representative group setting request arrives from the maintenance terminal, or the maintenance personal computer PC, the service execute table is accessed as shown in FIG. 13 and it is determined whether the function is “usable” or “unusable,” from the usable/unusable flag corresponding to the multi appearance function or the extension representative function. If the function is “usable,” the request is accepted and the corresponding process is executed. On the other hand, if the function is “unusable,” a refusal of service is sent back to the requesting extension terminal

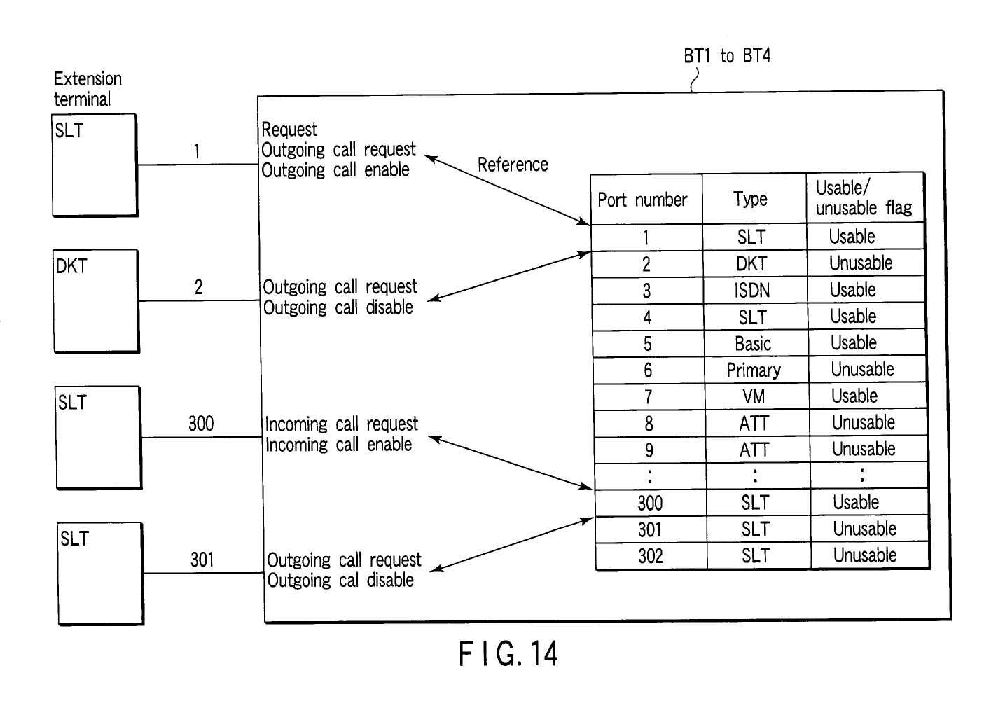

Furthermore, when an outgoing call request from an extension terminal (SLT) arrives or an incoming call request to an extension terminal arrives, the key telephone apparatuses BT, as shown in FIG. 14, determine whether the port at which the outgoing call request has arrived or the call incoming port is usable, on the basis of the port usable/unusable flag provided in the function information storage area shown in FIG. 3. If the result of the determination shows “usable,” the outgoing call request or the incoming call request is accepted and the corresponding outgoing call process or incoming call process is carried out. On the other hand, when the result shows “unusable,” a refusal to make an outgoing call or a refusal to make an incoming call is sent back to the terminal requesting an outgoing call or the terminal requesting an incoming call.

(Second Embodiment)

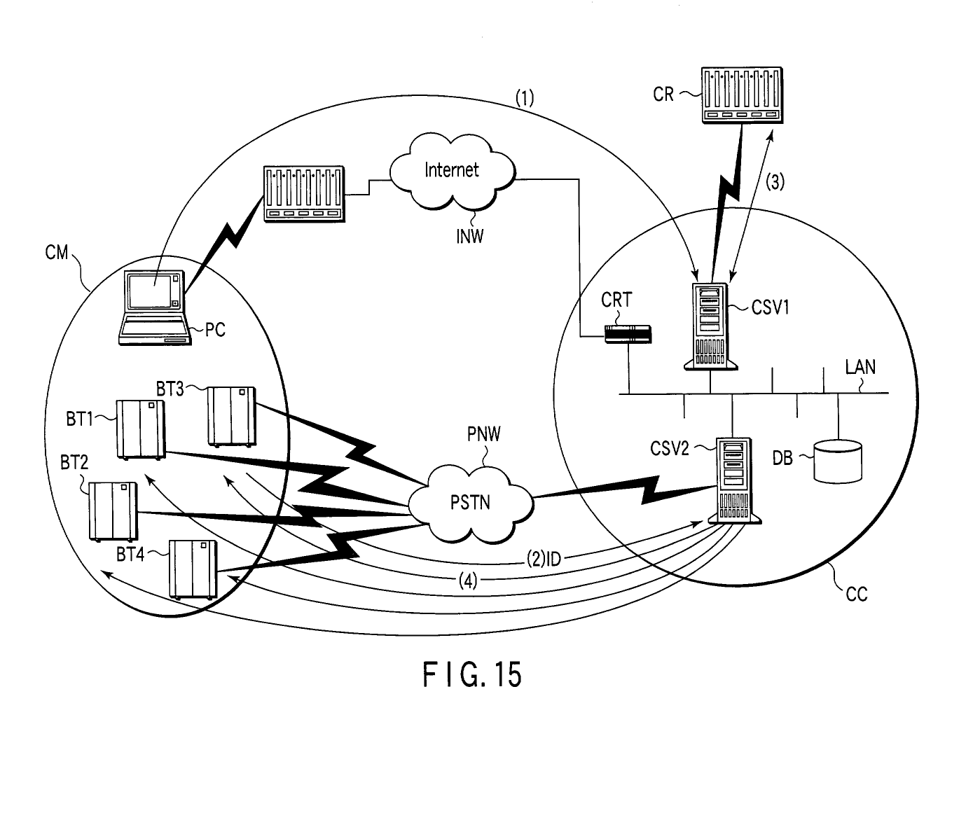

FIG. 15 schematically shows the configuration of a support system for realizing a second embodiment of the present invention. In FIG. 15, the same parts as those in FIG. 1 are indicated by the same reference numerals. A detailed explanation of them will not be given.

In the customer center CC, there is provided an user database DB. In the user database DB, the system IDs of, function information about, and telephone numbers of the key telephone apparatuses BT1 to BT4 the user has are stored in such a manner that they are caused to correspond to the individual identification number (or user number) assigned to each user.

When a function add request has arrived from the user, the reception/charging server CSV1 or license server CSV2 of the customer center CC accesses the user database DB on the basis of the user ID included in the function add request and reads the systems ID of, function information about, and telephone numbers of the key telephone apparatuses BT1 to BT4 the user has. Then, using the read-out information, the server CSV1 or CSV2 determines whether the functions the user wants can be added, accesses each of the key telephone apparatuses BT1 to BT4, and transmits a license code.

Next, the procedure for adding functions to the key telephone apparatuses BT1 to BT4 in the above system will be explained.

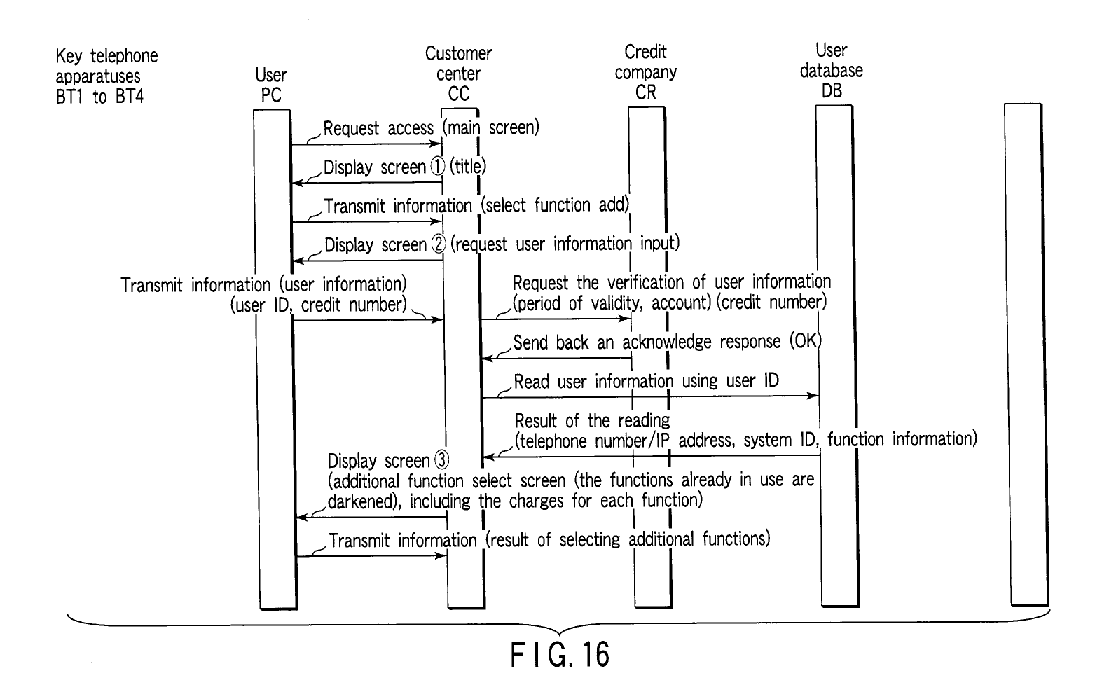

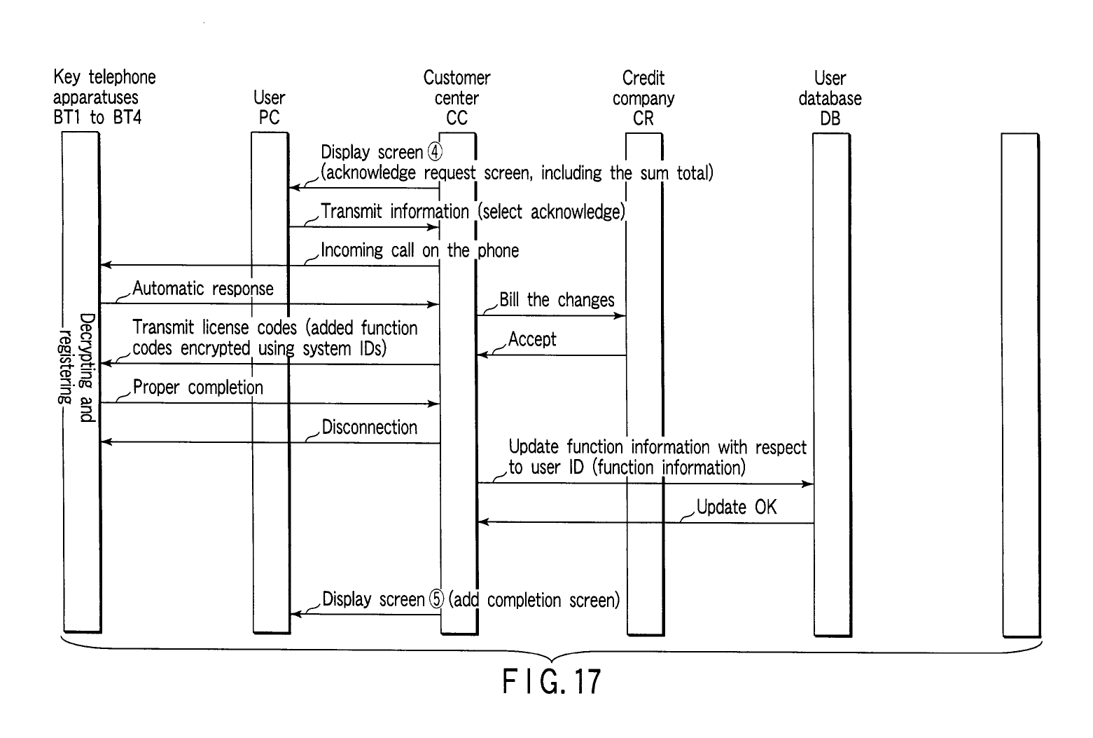

FIGS. 16 and 17 are schematic sequence diagrams to help explain the operation of transmitting and receiving signals between the maintenance personal computer PC (or user PC) of the user system CM, the customer center CC, and the credit company CR.

To add functions to the key telephone apparatuses BT, the user uses the maintenance personal computer PC to access the home page of the customer center CC by way of the Internet INW and inputs the necessary items related to the addition of functions according to the guidance on the screen downloaded from the customer center CC. The necessary items to be inputted include information representing the functions to be added, the user ID, and the credit number. After finishing the input of the necessary items, the user transmits a function add request including those pieces of information to the customer center CC.

Receiving the function add request, the customer center CC accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the customer center CC.

On the basis of the reply from the credit company CR, the customer center CC judges the credit of the user. If there is no problem, the customer center CC accesses the user database DB on the basis of the user ID included in the function add request sent from the user and reads the system IDs of, function information about, and telephone numbers of the key telephone apparatuses BT1 to BT4 the user has. Then, on the basis of the function information, the customer center CC determines whether the functions the user wants can Is be added. Then, the customer center CC transmits the result of the determination, the functions already usable, the functions required to be added, and the charges for the added functions to the user's maintenance personal computer PC.

Receiving the acknowledge response to the notice from the user, the customer center CC not only accesses each of the user's key telephone apparatuses BT1 to BT4 via the public network PNW on the basis of the telephone numbers read from the user database DB but also asks the credit company CR via an exclusive line to settle the charges for the added functions. Then, when receiving from the credit company CR a response to the effect that the settlement request has been accepted, the customer center CC transmits a license code to each of the key telephone apparatuses BT1 to BT4. In the license code, an instruction code to set the function to be added “usable” is inserted. At this time, the instruction code is encrypted using the system ID read form the user database DB.

When receiving the license code from the customer center CC, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT1 to BT4 send back to the customer center CC information to the effect that the function adding process is completed properly.

When receiving a notice of the completion of the addition of functions from the key telephone apparatuses BT1 to BT4, the customer center CC disconnects the lines with the key telephone apparatuses BT. Thereafter, the customer center CC accesses the user database DB and updates the information about the additionally set functions by setting them “usable.” Then, the customer center CC receives an update completion notice from the user database DB. Thereafter, the customer center CC transmits to the user's maintenance personal computer PC information to the effect that the function adding process is completed and causes the computer PC to display the information.

As a result, the functions the user wants to add are set in the key telephone apparatuses BT1 to BT4 in such a manner that they are usable. Thereafter, in the key telephone apparatuses BT, the added new optional service functions can be used.

The configuration of each section of the support system that realizes the above-described function changing method is as follows.

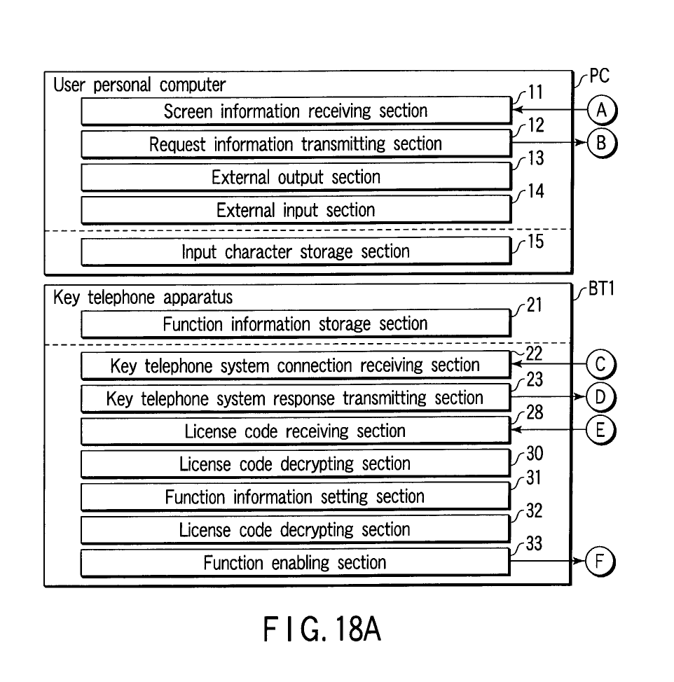

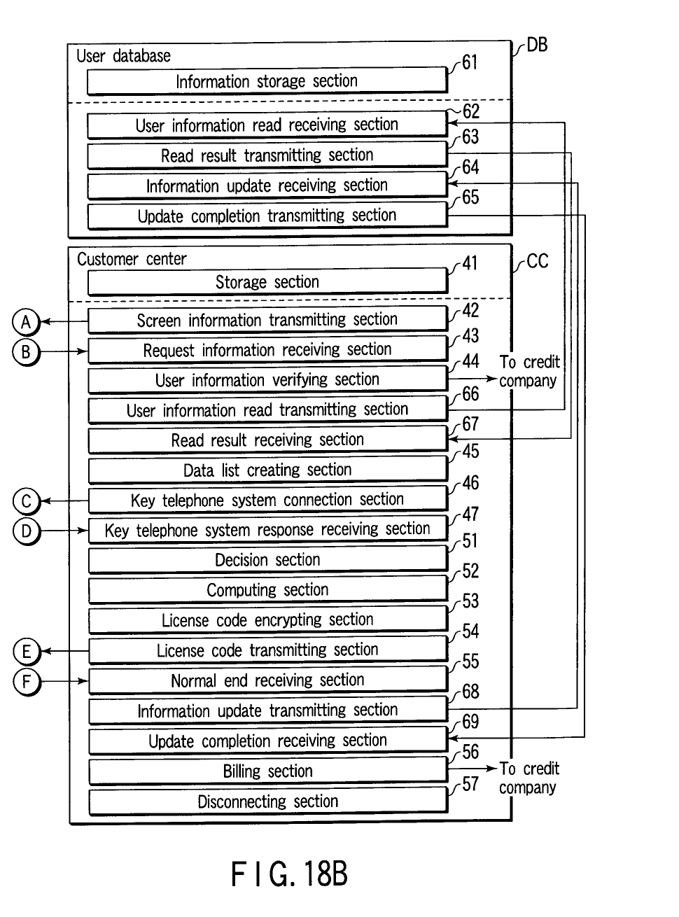

FIG. 18 is a block diagram showing a functional configuration of the maintenance personal computer PC, key telephone apparatus BT1, customer center CC, and user database DB. In FIG. 18, the same parts as those in FIG. 8 are indicated by the same reference numerals. A detailed explanation of them will not be given.

The user database DB includes an user information storage section 61, an user information read receiving section 62, a read result transmitting section 63, a function information update receiving section 64, and an update completion transmitting section 65.

In the user information storage section 61, the system IDs of, function information about, and telephone numbers of the key telephone apparatuses BT1 to BT4 the user has are stored in such a manner that they are caused to correspond to the user ID unique to each user. The user information read receiving section 62 and read result transmitting section 63 read the corresponding storage information according to access by the reception/charging server CSV1 or license setting server CSV2 and send back the read-out storage information to the accessing reception/charging server CSV1 or license setting server CSV2.

When the setting of the addition of functions to the key telephone apparatuses BT1 to BT4 is completed, the function information update receiving section 64 and update completion transmitting section 65 update the corresponding function information according to access by the license setting server CSV2. Then, the function information update receiving section 64 and update completion transmitting section 65 send back update completion to the license setting server CSV2.

The customer center CC further include an user information read transmitting section 66 that has the function of accessing the user database DB, a read result receiving section 67, a function information update transmission control section 68, and an update completion receiving section 69.

The user information read transmitting section 66 and read result receiving section 67 access the user database DB using the user ID as an address and receive the storage information read from the user database through the access. The function information update transmission control section 68 and update completion receiving section 69, after the setting of the addition of functions to the key telephone apparatuses BT1 to BT4 is completed, update the storage information by giving the updated function information to the user database DB and receives the update completion notice.

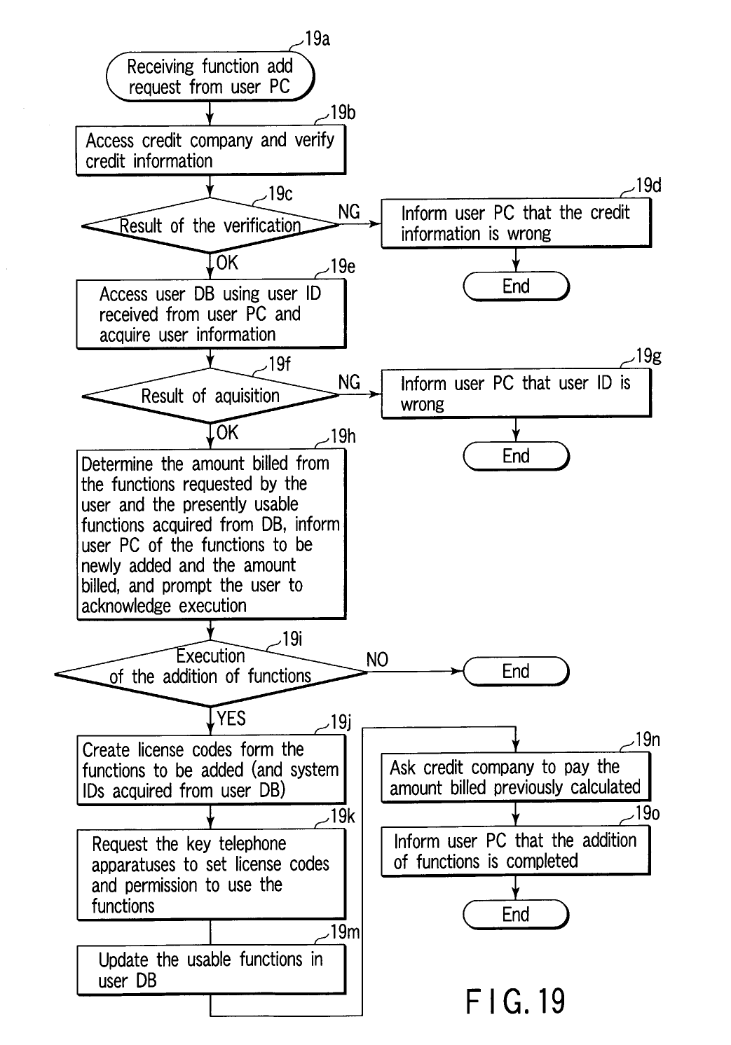

FIG. 19 is a flowchart for the operation of the customer center CC. The process of adding functions is carried out according to the procedure shown in step 19a to step 19o.

When receiving a function add request from the user's maintenance personal computer PC via the Internet INW in step 19a, the customer center CC accesses the credit company CR in step 19b to verify the credit information. If the credit information is invalid, the customer center CC passes control from step 19c to step 19d, where the customer center CC informs the requesting maintenance personal computer PC that the credit execute information is wrong.

On the other hand, if the credit information is valid, the customer center CC passes control from step 19c to step 19e, where the customer center CC access the user database DB on the basis of the user ID sent from the user's maintenance personal computer PC and acquires the user information. The user information includes function information about each of the key telephone apparatuses BT1 to BT4 the user has. If the user database DB cannot be accessed, the customer center CC passes control from step 19f to step 19g, where the customer center CC informs the user's maintenance personal computer PC that the user ID is wrong.

Next, the customer center CC, in step 19h, calculates the amount billed on the basis of the functions required by the user and the pieces of function information read from the user database DB, informs the user's maintenance personal computer PC of the names of the newly added functions and the amount billed, and inquires whether to execute the addition of the functions. When the user transmits an execute request in response to the inquiry, the customer center CC passes control from step 19i to 19j, where the center CC creates a license code for each of the key telephone apparatuses BT1 to BT4 on the basis of the added functions and the system IDs of the key telephone apparatuses BT1 to BT4. In step 19k, the customer center CC transmits to the key telephone apparatuses BT1 to BT4 the license codes and a request to set the functions usable.

Then, when the setting of the addition of functions is completed in the key telephone apparatuses BT1 to BT4, the customer center CC, in step 19m, updates the function information of the corresponding user stored in the user database DB. Thereafter, in step 19n, the customer center CC transmits to the credit company CR settlement request information about the amount billed previously calculated. When receiving from the credit company CR a reply to the effect that the company CR has accepted the settlement request, the customer center CC, in step 19o, informs the requesting user's maintenance personal computer PC that the addition of the functions is completed.

In the user's maintenance personal computer PC, the procedure for processing in receiving the title screen, user information input screen, function select screen, verify request screen, add completion screen, user information reenter screen, and function adding process NG from the customer center CC is the same as in the first embodiment.

As described above, according to the function changing method of the second embodiment, a series of processes ranging from the user requesting the addition of functions to adding functions to the user's key telephone apparatuses BT1 to BT4 is performed in unison automatically via a communication network without human intervention as in the first embodiment. This enables the time required to add functions to be shortened, the expenses the user pays to be reduced, and the labor and cost needed to change the functions at the customer center CC to be reduced remarkably.

Since it is determined whether functions can be added, on the basis of function information about each of the key telephone apparatuses BT1 to BT4, the function adding process can be carried out properly for each of the key telephone apparatuses BT1 to BT4. In addition, since the license codes are encrypted using the system IDs of the key telephone apparatuses BT1 to BT4 and transferred to the key telephone apparatuses BT1 to BT4, it is possible to prevent the wrong function or an unauthorized function from being added.

Furthermore, in the second embodiment, it is determined whether the communication between the customer center CC and the key telephone apparatuses BT1 to BT4 can be performed or whether functions can be changed, on the basis of the user information accumulated and managed in the user database DB. This makes it unnecessary to acquire information about functions from the key telephone apparatuses BT1 to BT4 each time the user uses the telephone apparatus. As a result, a suitable function changing process can be carried out according to a simple procedure.

Moreover, after the process of adding functions to the key telephone apparatuses BT1 to BT4 is completed, the customer center CC updates the corresponding function information in the user database DB. This makes it possible to always update the accumulated management information in the user database DB to the latest one automatically without the maintenance man in charge carrying out the updating process manually.

(Third Embodiment)

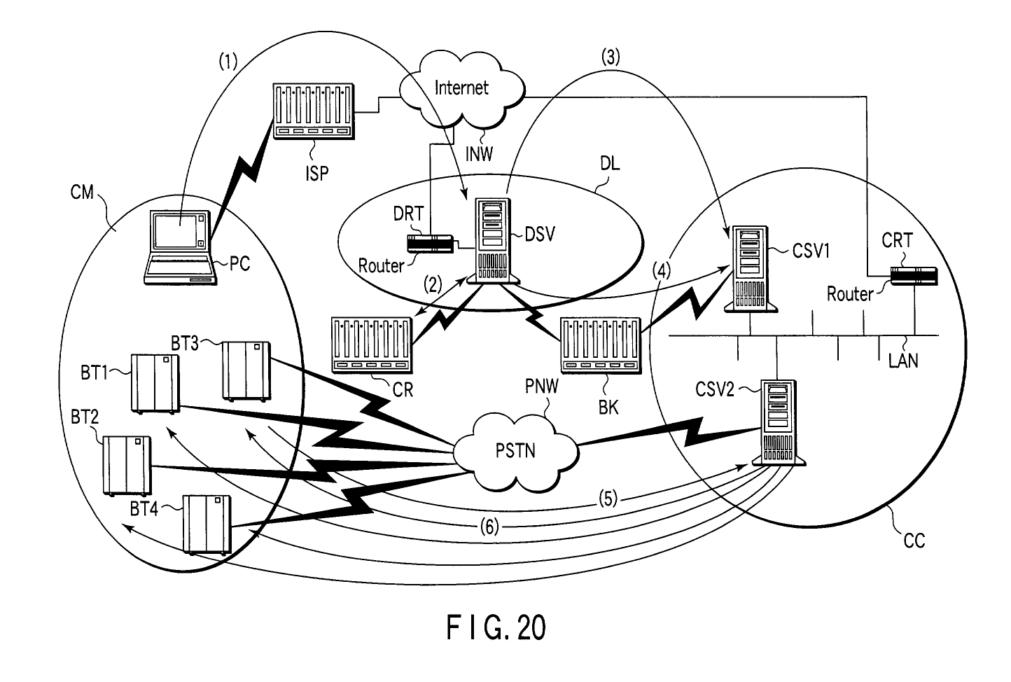

FIG. 20 schematically shows the configuration of a support system that carries out a function changing method according to a third embodiment of the present invention. In FIG. 20, the same parts as those in FIG. 1 are indicated by the same reference numerals. A detailed explanation of them will not be given.

In the support system of the third embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a function adding process with the maintenance personal computer PC and customer center CC.

Furthermore, the reception/charging/notifying server DSV is connected via an exclusive line to the credit company CR or the bank BK. The server DSV inquires of the credit company CR or bank BK the credit of the user and bills the charges for the addition of functions.

Next, the procedure for adding functions to the key telephone apparatuses BT1 to BT4 in the above system will be explained.

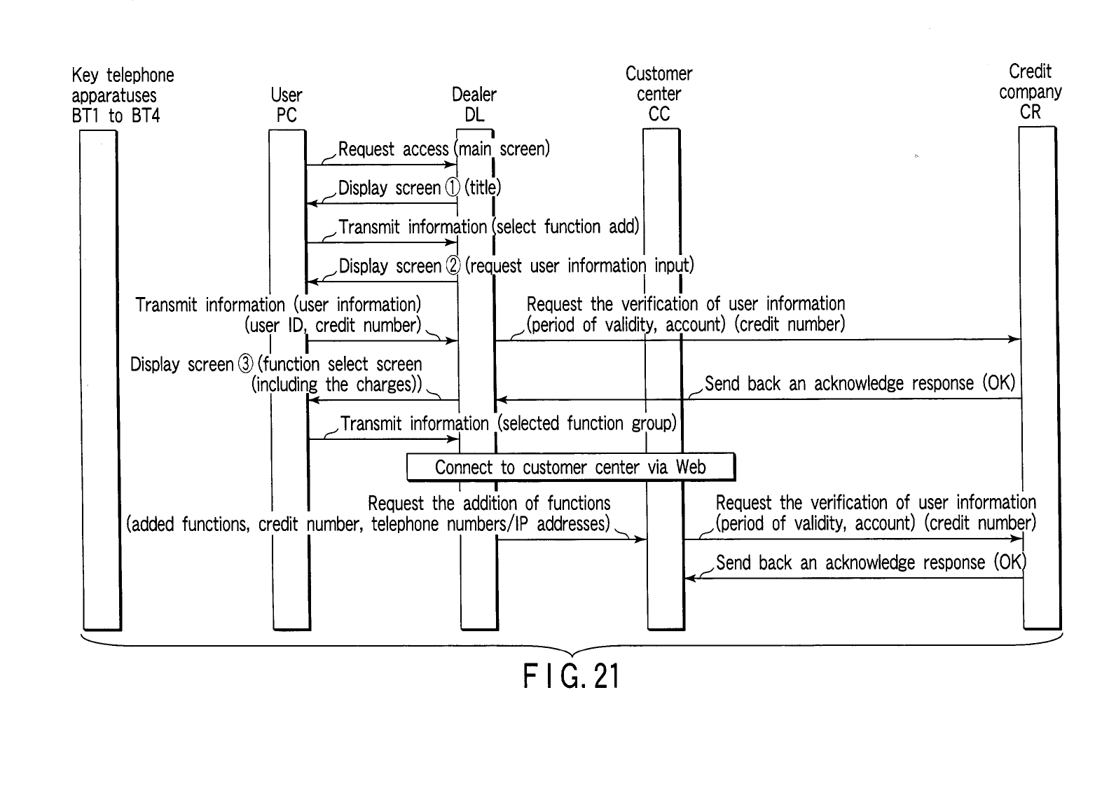

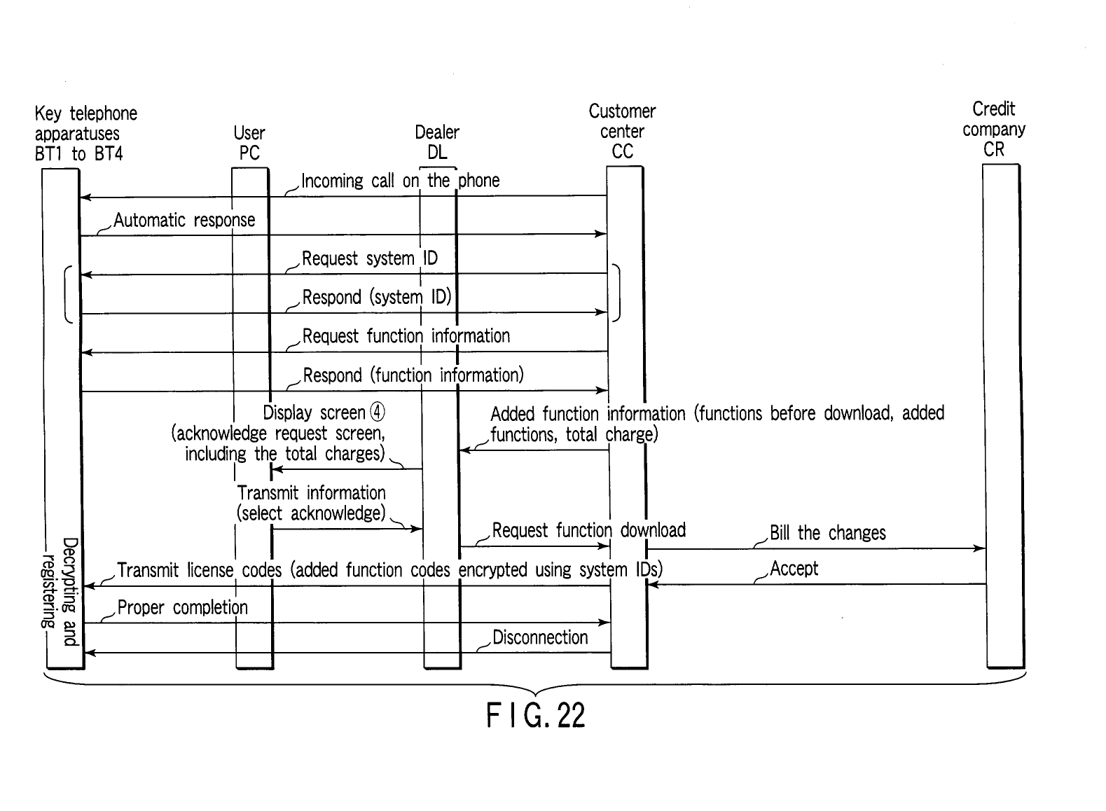

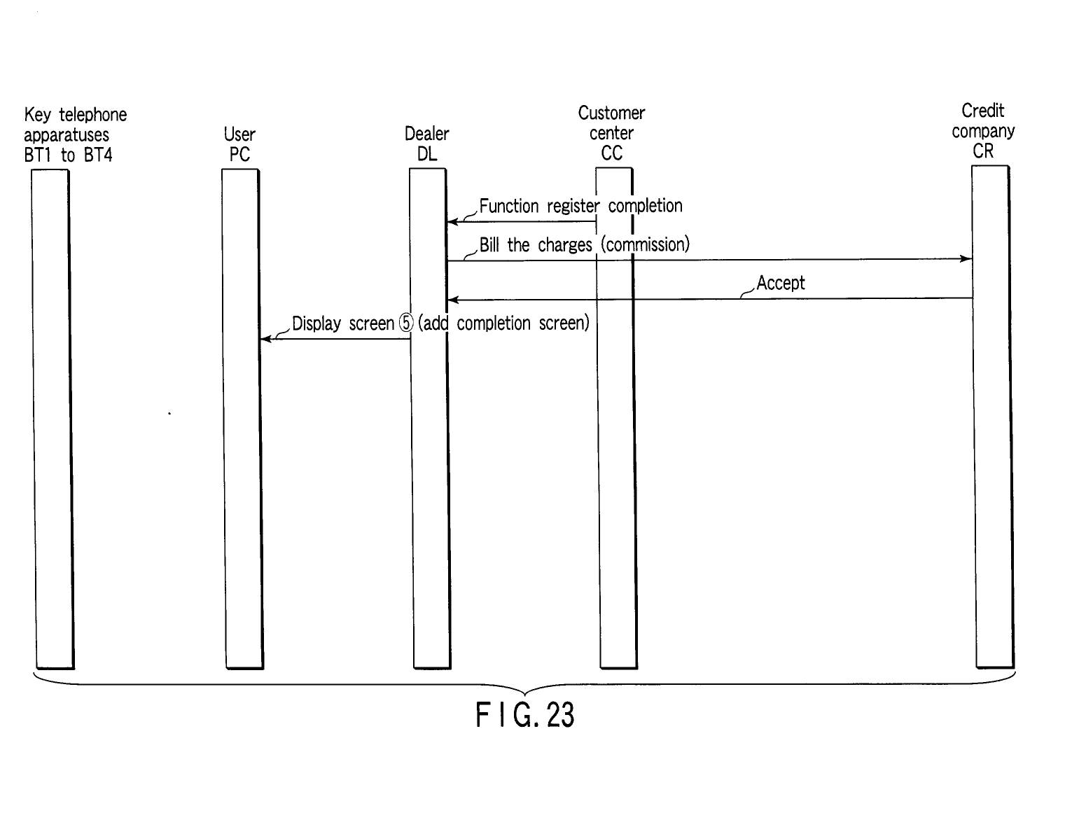

FIGS. 21 to 23 are schematic sequence diagrams to help explain the operation of transmitting and receiving signals between the maintenance personal computer PC (or user PC) of the user system CM, the dealer DL, the customer center CC, and the credit company CR.

To add functions to the key telephone apparatuses BT1 to BT4, the user uses the maintenance personal computer PC to access the home page of the dealer DL by way of the Internet INW and inputs the necessary items related to the addition of functions according to the guidance on the screen downloaded from the dealer DL. The necessary items to be inputted include information representing the functions to be added, the user's credit number, and the telephone numbers or IP addresses allocated by the public network PNW to the key telephone apparatuses BT1 to BT4. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses each of the user's key telephone apparatuses BT1 to BT4 via the public network PNW on the basis of the telephone numbers included in the function add request and acquires the function information and system IDs from the key telephone apparatuses BT1 to BT4. The customer center CC determines on the basis of the acquired function information whether the functions the user wants to add are already in use and, if they are not in use, whether they can be added.

Then, on the basis of the result of the judgment, the customer center CC informs the dealer DL by way of the Internet INW of a list of the functions already in use and the addable functions and a table of the charges for adding functions. The dealer DL transfers the notified function list and table of charges to the user's maintenance personal computer PC by way of the Internet INW. When receiving an acknowledge response from the user to the function list and table of charges, the dealer DL transmits a function download request to the customer center CC.

When receiving the function download request from the dealer DL, the customer center CC accesses the credit company CR to ask the company CR to pay the charges for the added functions. Then, receiving from the credit company CR a reply to the effect that the settlement request has been accepted, the customer center CC transmits the license codes to the user's key telephone apparatuses BT1 to BT4 via the public network PNW. In the license codes, instruction codes for setting the functions to be added “usable” are inserted. At this time, the instruction codes are encrypted using the system IDs previously acquired from the key telephone apparatuses BT1 to BT4.

When receiving the license code from the customer center CC, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT send back to the customer center CC information to the effect that the function adding process is completed properly.

When receiving a notice of the completion of the addition of functions from the key telephone apparatuses BT1 to BT4, the customer center CC disconnects the lines with the key telephone apparatuses BT1 to BT4 and informs the dealer DL of the completion of the function adding process. Receiving the notice of the completion of the process, the dealer DL asks the credit company CR to pay the agent's commission.

As a result, the functions the user wants to add are set in the key telephone apparatuses BT1 to BT4 in such a manner that they are usable. Thereafter, in the key telephone apparatuses BT1 to BT4, the added optional service functions can be used.

The customer center CC's request to the credit company CR for a credit check of the user may be omitted. Instead of the customer center CC, the dealer DL may charge the expenses. Furthermore, the bank may settle the expenses in place of the credit company CR.

The configuration of each section of the support system that carries out the above-described function changing method is as follows.

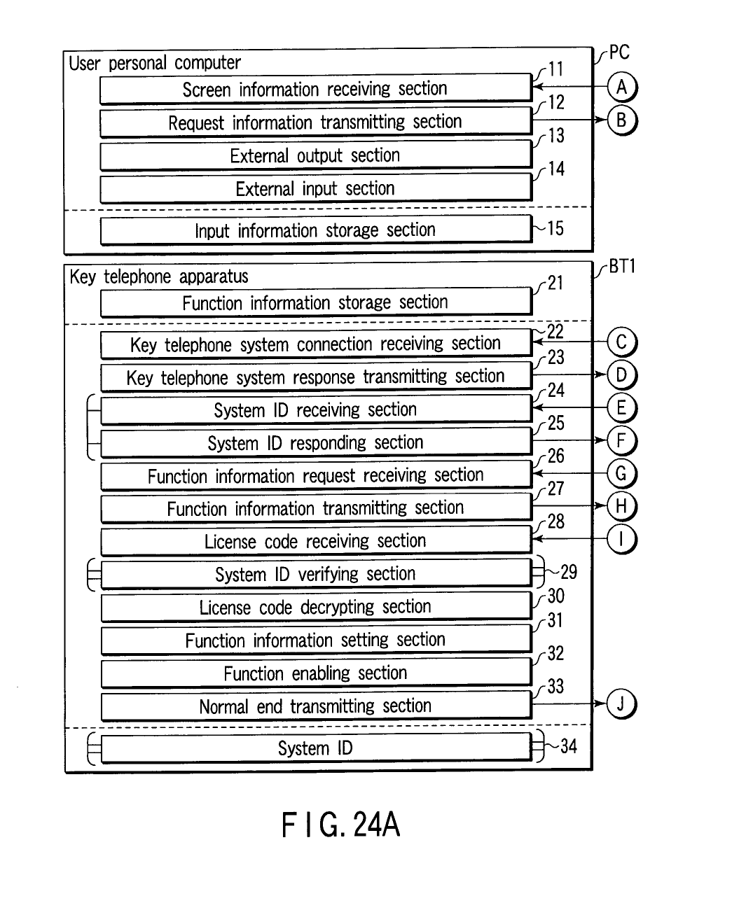

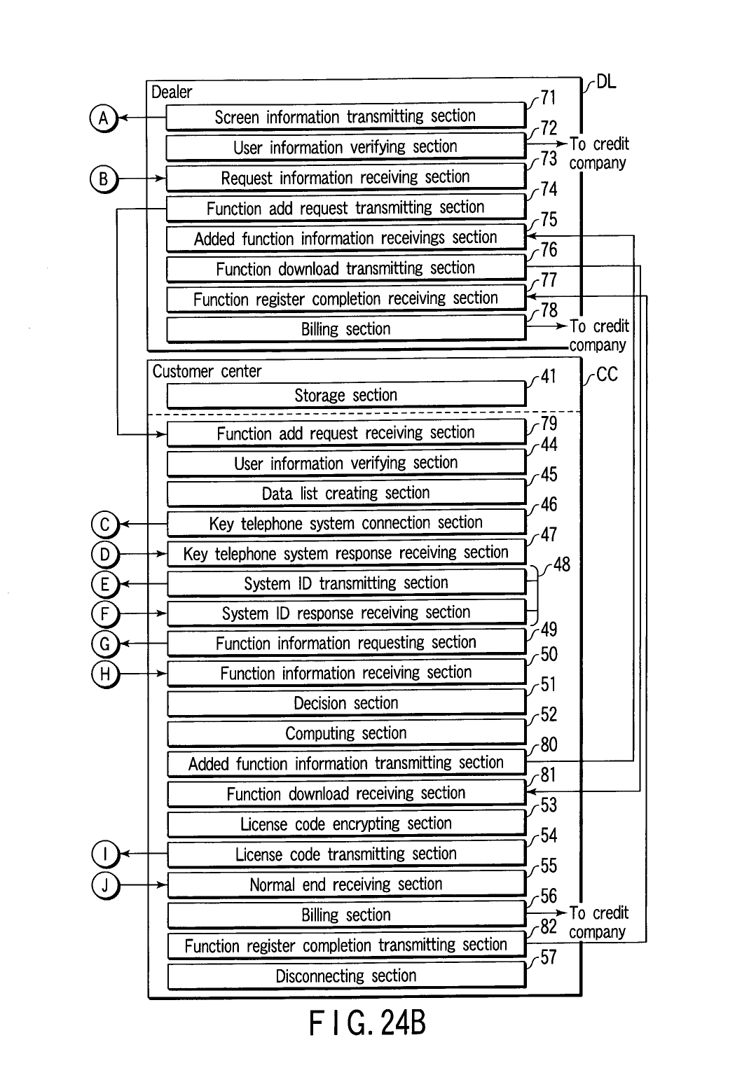

FIG. 24 is a block diagram showing a functional configuration of the maintenance personal computer PC, key telephone apparatus BT1, dealer DL, and customer center CC. In FIG. 24, the same parts as those in FIG. 8 are indicated by the same reference numerals. A detailed explanation of them will not be given.

The dealer DL includes a screen information transmitting section 71, an user information verifying section 72, a request information receiving section 73, a function add request transmitting section 74, an added function information receiving section 75, a function download transmitting section 76, a function register completion receiving section 77, and a billing section 78.

The screen information transmitting section 71, when being accessed by the user's maintenance personal computer PC, transmits a series of pieces of screen information for a function add request to the maintenance personal computer PC. The user information verify section 72 accesses the credit company CR on the basis of the credit number included in the received function add request information and inquires about the credit of the user. The request information receiving section 73 receives the function add request information sent from the maintenance personal computer PC.

The function add request transmitting section 74 transfers the function add request information coming from the user's maintenance personal computer PC to the customer center CC. The added function information receiving section 75 receives the added function notice information sent from the customer center CC and transfers this information to the requesting user's maintenance personal computer PC. When the maintenance personal computer PC sends back an acknowledge reply in response to the transfer of the added function notice information, the function download transmitting section 76 transmits a function download request to the customer center CC.

The function register completion receiving section 77 receives the function register completion notice sent from the customer center CC. After receiving the function register completion notice, the billing section 78 asks the credit company CR to bill the charges for the addition of functions.

The customer center CC includes as means for transmitting and receiving information to and from the dealer DL a function add request receiving section 79, an added function information transmitting section 80, a function download receiving section 81, and a function register completion transmitting section 82.

The function add request receiving section 79 receives the function add request information sent from the dealer DL. The added function information transmitting section 80 sends the function information acquired from the key telephone apparatuses BT1 to BT4 to the dealer DL. When the dealer DL sends a function down load request, the function download receiving section 81 receives this request and starts a function downloading process, or a license code transmitting process to the key telephone apparatuses BT1 to BT4. The function register completion transmitting section 82 transmits a function register completion notice to the dealer DL after the functions have been downloaded to the key telephone apparatuses BT1 to BT4 and the credit company CR has been asked to bill the charges.

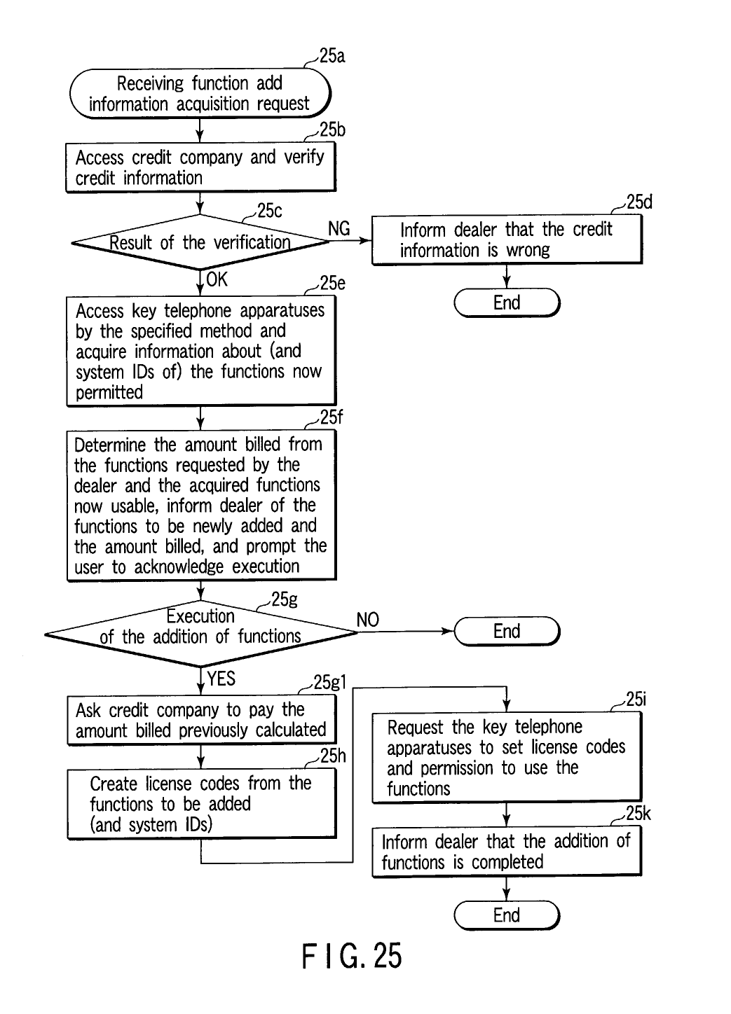

FIG. 25 is a flowchart for the operation of the customer center CC. The process of adding functions is carried out according to the procedure shown in step 25a to step 25k.

When receiving a function add request of the user from the dealer DL via the Internet INW in step 25a, the customer center CC accesses the credit company CR in step 25b to verify the credit information. If the credit information is invalid, the customer center CC passes control from step 25c to step 25d, where the customer center CC informs the requesting maintenance personal computer PC that the credit execute information is wrong.

On the other hand, if the credit information is valid, the customer center CC passes control from step 25c to step 25e, where the customer center CC accesses each of the user's key telephone apparatuses BT1 to BT4 using the telephone number or mail address of each of the key telephone apparatuses BT1 to BT4 sent from the user and acquires information about the functions allowed to be used now and the system IDs from the key telephone apparatuses BT1 to BT4.

Next, the customer center CC, in step 25f, calculates the amount billed on the basis of the functions required by the dealer DL and the pieces of function information acquired from the key telephone apparatuses BT1 to BT4, informs the dealer DL of the names of the newly added functions and the amount billed, and inquires whether to execute the addition of the functions. When the dealer DL transmits an execute request in response to the inquiry, the customer center CC passes control from step 25g to 25g1, where the center CC transmits settlement request information about the amount billed previously calculated to the credit company CR. When receiving from the credit company CR a reply to the effect that the company CR has accepted the settlement request, the customer center passes control to step 25h, where the center CC creates a license code for each of the key telephone apparatuses on the basis of the added functions and the system IDs of the key telephone apparatuses BT1 to BT4 and, in step 25i, sends to the key telephone apparatuses BT1 to BT4 a request for setting use of the license codes and functions possible.

Then, after the setting of the additional functions is completed in the key telephone apparatuses BT1 to BT4, the customer center CC, in step 25k, informs the requesting user's maintenance personal computer PC that the addition of the functions is completed.

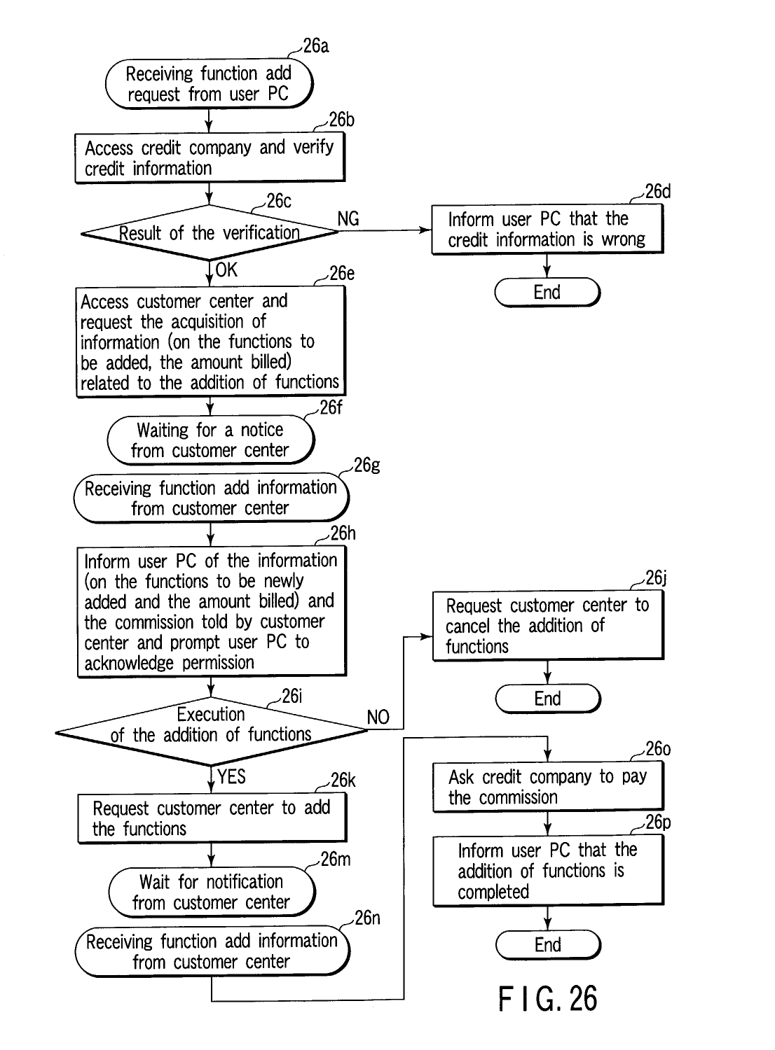

On the other hand, FIG. 26 is a flowchart for the processing operation at the dealer DL. A series of processing operations for adding functions is carried out according to the procedure shown in step 26a to step 26p.

When receiving a function add request from the user's maintenance personal computer PC via the Internet INW in step 26a, the dealer DL accesses the credit company CR in step 26b to verify the credit information. If the credit information is invalid, the dealer DL passes control from step 26c to step 26d, where the dealer DL informs the requesting maintenance personal computer PC that the credit execute information is wrong.

On the other hand, if the credit information is valid, the dealer DL passes control from step 26c to step 26e, where the dealer DL accesses the customer center CC and requests information about the addition of functions, that is, the functions to be added and the charges. Then, in step 26f, the dealer DL waits for a notice from the customer center CC.

In this state, when receiving the function add information from the customer center CC, the dealer DL passes control from step 26g to step 26h, where the dealer DL informs the user's maintenance personal computer PC of the function add information notified by the customer center CC, that is, the names of the functions newly added and the amount billed for the functions. Then, the dealer DL inquires whether to execute the addition of the functions. When the user transmits an execute request in response to the inquiry, the dealer DL passes control from step 26i to 26k, where the dealer DL transmits a function add execute request to the customer center CC. Then, in step 26m, the dealer DL waits for a notice from the customer center CC. When the user transmits a function add cancel request, the dealer DL passes control from step 26i to step 26j, where the dealer DL informs the customer center CC of the cancellation of the addition of functions.

When receiving the function add information from the customer center CC, the dealer DL receives the information in step 26n and passes control to step 26o, where the dealer DL transmits to the credit company CR the settlement request information about the amount billed previously calculated. When receiving from the credit company CR a reply to the effect that the company CR has accepted the settlement request, the dealer DL, in step 26p, informs the requesting user's maintenance personal computer PC that the addition of functions is completed.

The procedure for the maintenance personal computer PC making an access request for the main page and the procedure for receiving the user information are the same as the procedure for processing at the customer center CC of the first embodiment.

The procedure for processing at the maintenance personal computer PC when receiving the title screen, user information input request screen, function select screen, acknowledge request screen, add completion screen, user information reenter request screen, and function adding process NG screen is the same as the procedure for processing at the maintenance personal computer PC when receiving a display screen sent from the customer center CC in the first embodiment. Moreover, the procedure for processing at the key telephone apparatuses BT and the procedure for processing at the credit company are the same as those in the first embodiment.

As described above, according to the function changing method of the third embodiment, a series of processes ranging from the user's request for the change of functions to the addition of functions to the user's key telephone apparatuses BT1 to BT4 is performed in unison automatically via a communication network without human intervention, with the dealer DL intervening between the user and the customer CC. This enables the time required to add functions to be shortened, the expenses the user pays to be reduced, and the labor and costs needed to change the functions at the dealer DL or the customer center CC to be reduced remarkably.

Since it is determined whether functions can be added, on the basis of function information acquired from each of the key telephone apparatuses BT1 to BT4 to which the functions to be added, the function adding process can be carried out properly for each of the key telephone apparatuses BT1 to BT4. In addition, since the license codes are encrypted using the system IDs of the key telephone apparatuses BT1 to BT4 and sent to the key telephone apparatuses BT1 to BT4, it is possible to prevent the wrong function or an unauthorized function from being added.

(Fourth Embodiment)

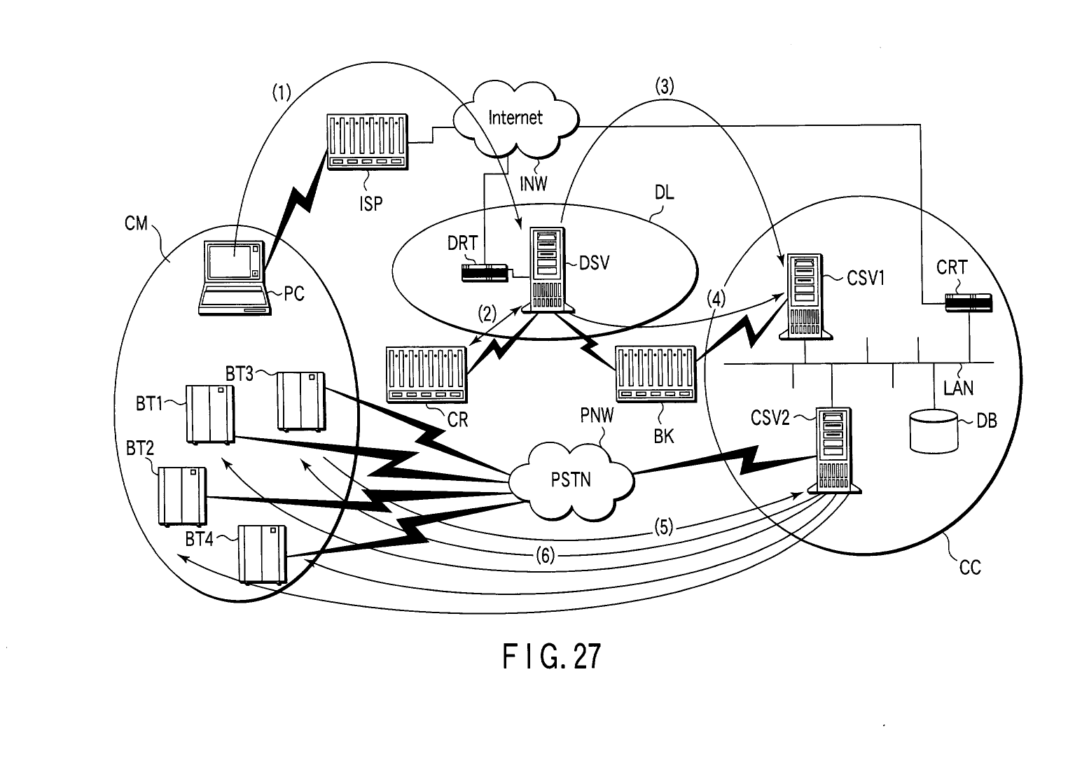

FIG. 27 schematically shows the configuration of a support system that carries out a function changing method according to a fourth embodiment of the present invention. In FIG. 27, the same parts as those in FIGS. 15 and 20 are indicated by the same reference numerals.

In the support system of the fourth embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a function adding process with the maintenance personal computer PC and customer center CC.

Furthermore, the reception/charging/notifying server DSV is connected via an exclusive line to the credit company CR or the bank BK. The server DSV inquires of the credit company CR or bank BK the credit of the user and bills the charges for the addition of functions.

On the other hand, in the customer center CC, there is provided an user database. In the user database DB, the system IDs of, function information about, and telephone numbers of the key telephone apparatuses BT the user has are stored in such a manner that they are caused to correspond to the user ID uniquely assigned to each user.

When a function add request has been transferred from the dealer DL, the reception/charging server CSV1 or license server CSV2 of the customer center CC accesses the user database DB on the basis of the user ID included in the function add request and reads the systems IDs of, function information about, and telephone numbers of the key telephone apparatuses BT1 to BT4 the user has. Then, using the read-out information, the server CSV1 or CSV2 determines whether the functions the user wants can be added, accesses each of the key telephone apparatuses BT1 to BT4, and transmits a license code.

Next, the procedure for adding functions to the key telephone apparatuses BT1 to BT4 in the above system will be explained.

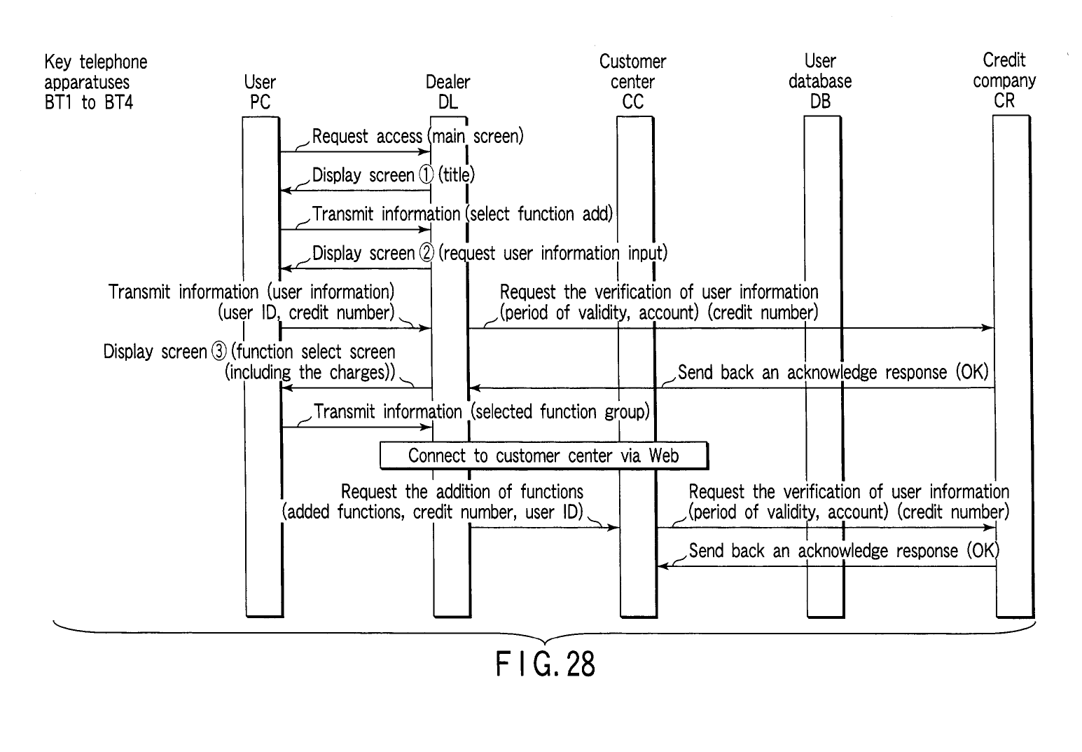

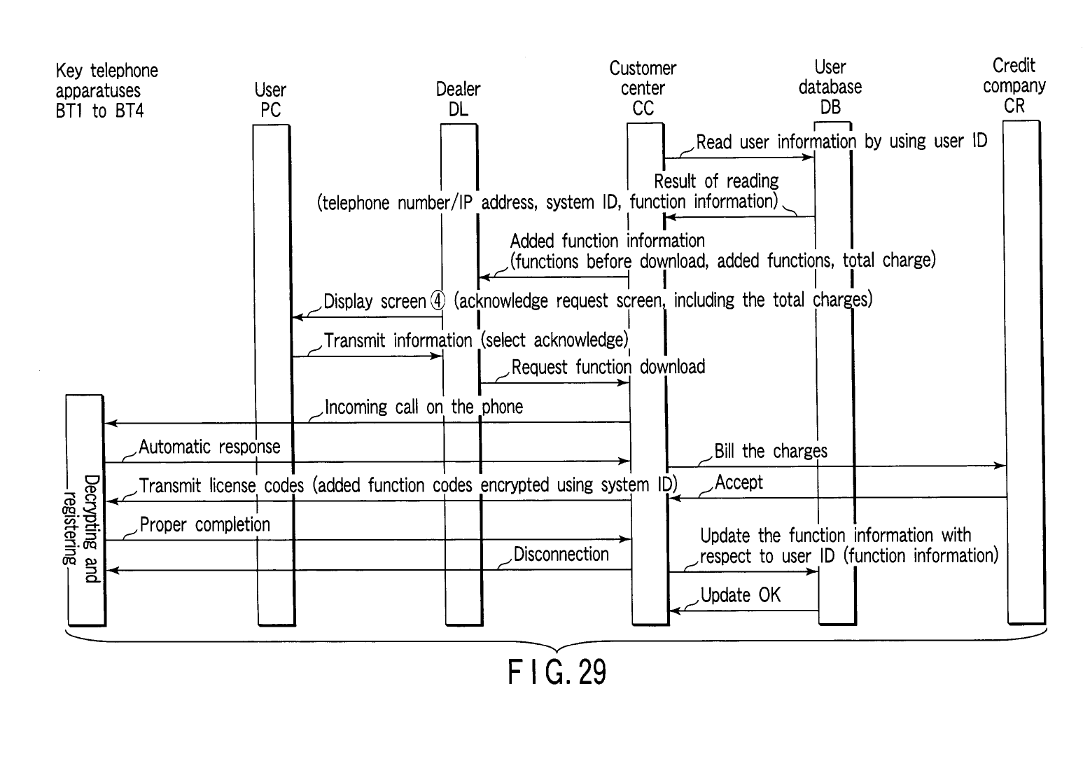

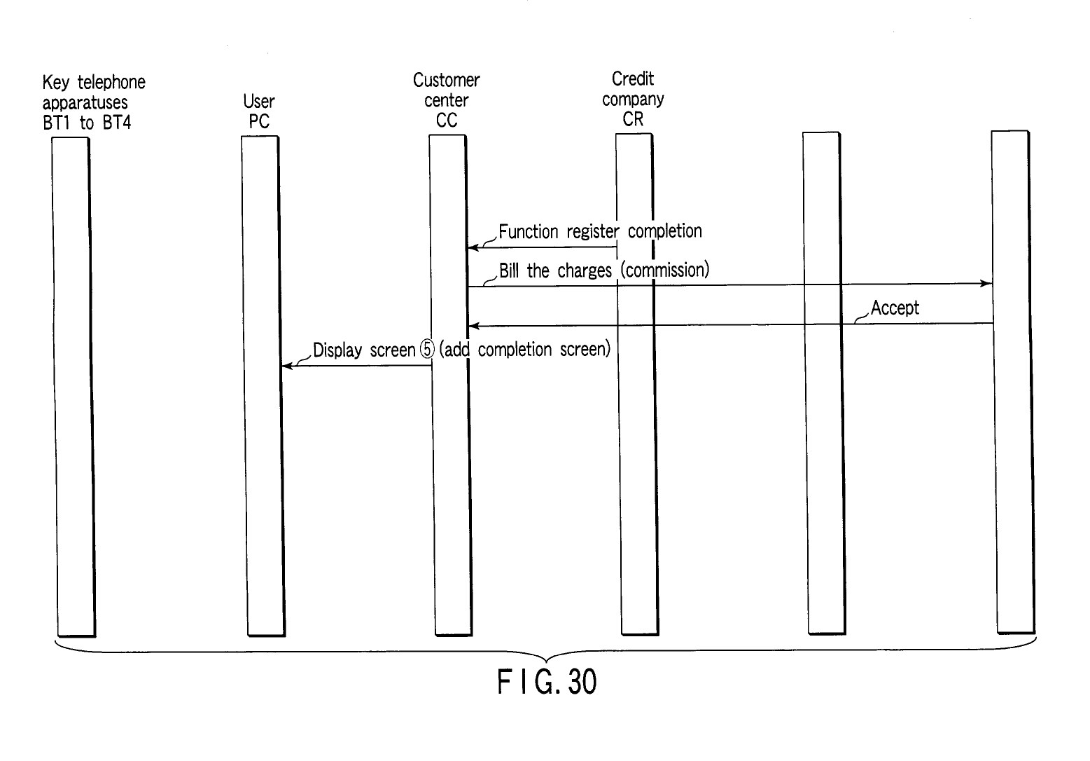

FIGS. 28 to 30 are schematic sequence diagrams to help explain the operation of transmitting and receiving signals between the maintenance personal computer PC (or user PC) of the user system CM, the dealer DL, the customer center CC, and the credit company CR.

To add functions to the key telephone apparatuses BT, the user uses the maintenance personal computer PC to access the home page of the dealer DL by way of the Internet INW and inputs the necessary items related to the addition of functions according to the guidance on the screen downloaded from the dealer DL. The necessary items to be inputted include information representing the functions to be added, the user ID, and the credit number. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses the user database DB on the basis of the user ID included in the function add request and reads the system IDs of, function information about, and telephone numbers of the telephone apparatuses BT1 to BT4 the user has.

Next, on the basis of the read-out function information, the customer center CC determines whether the functions the user wants can be added, and, on the basis of the result of the determination, informs the dealer DL via the Internet INW of a list of the functions already in use and the addable functions and a list of the charges for adding functions. The dealer DL transfers the notified function list and the list of the charges to the user's maintenance personal computer PC by way of the Internet INW. Receiving an acknowledge response to a notice of the function list and the list of charges from the user, the dealer DL transmits a function download request to the customer center CC.

When receiving the function download request from the dealer DL, the customer center CC accesses the credit company CR to ask the company CR to pay the charges for the added functions. Then, receiving from the credit company CR a reply to the effect that the settlement request has been accepted, the customer center CC calls up each of the key telephone apparatuses BT1 to BT4 via the public network PNW on the basis of the telephone numbers of the key telephone apparatuses BT1 to BT4 read from the user database DB and transmits the respective license codes to the key telephone apparatuses BT1 to BT4. In the license codes, instruction codes for setting the functions to be added “usable” are inserted. At this time, the instruction codes are encrypted using the system IDs of the key telephone apparatuses BT previously read from the user database DB.

When receiving the license code from the customer center CC, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT1 to BT4 send back to the customer center CC information to the effect that the function adding process is completed properly.

When receiving a notice of the completion of the addition of functions from the key telephone apparatuses BT, the customer center CC disconnects the lines with the key telephone apparatuses BT1 to BT4 and informs the dealer DL of the completion of the function adding process. Receiving the notice of the completion of the process, the dealer DL asks the credit company CR to pay the agent's commission.

As a result, the functions the user wants to add are set in the key telephone apparatuses BT1 to BT4 in such a manner that they are usable. Thereafter, in the user's key telephone apparatuses BT1 to BT4, the added optional service functions can be used.

As described in the third embodiment, the customer center CC's request to the credit company CR for a credit check of the user may be omitted. Instead of the customer center CC, the dealer DL may charge the expenses. Furthermore, the bank BK may settle the expenses in place of the credit company CR.

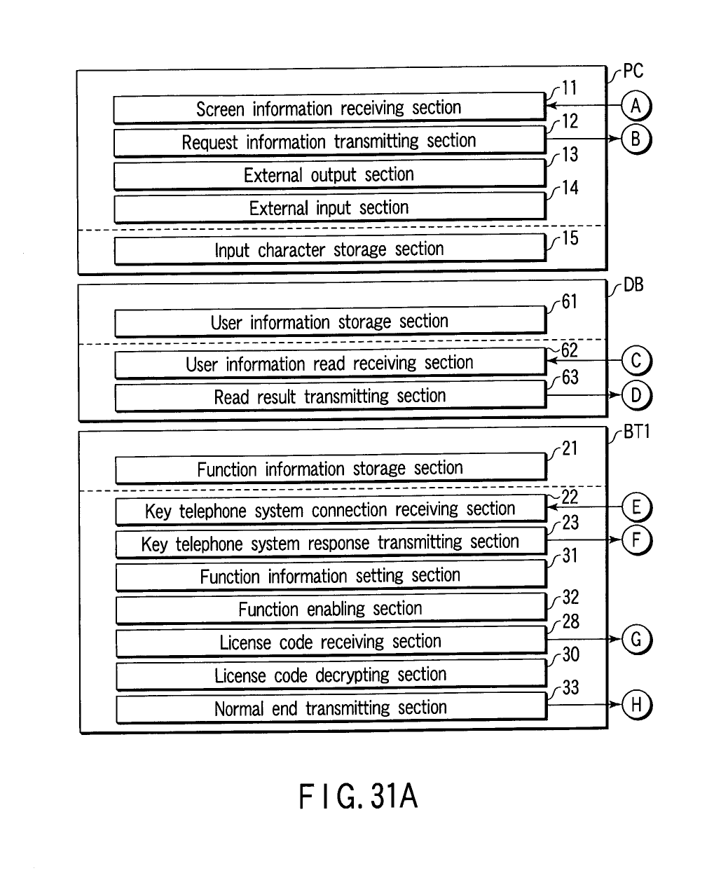

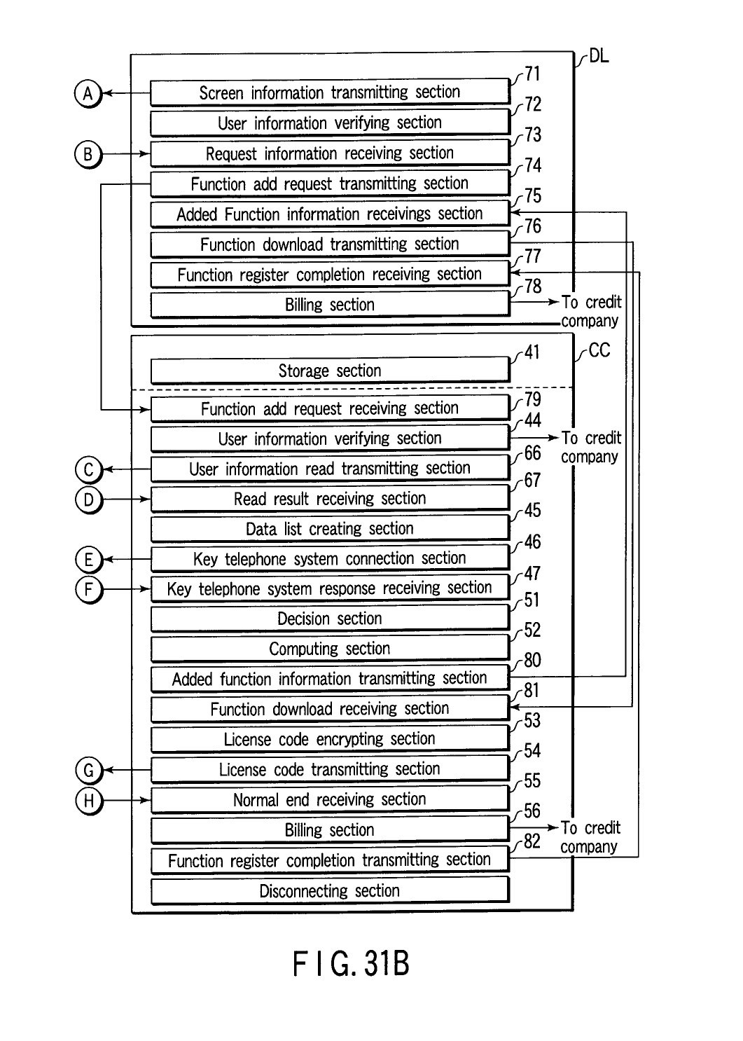

The configuration of each section of the support system that carries out the above-described function changing method is as shown in, for example, FIG. 31. Since the functional configuration shown in FIG. 31 is the same as those in FIGS. 18 and 24 in the second and third embodiments, its explanation will be omitted.

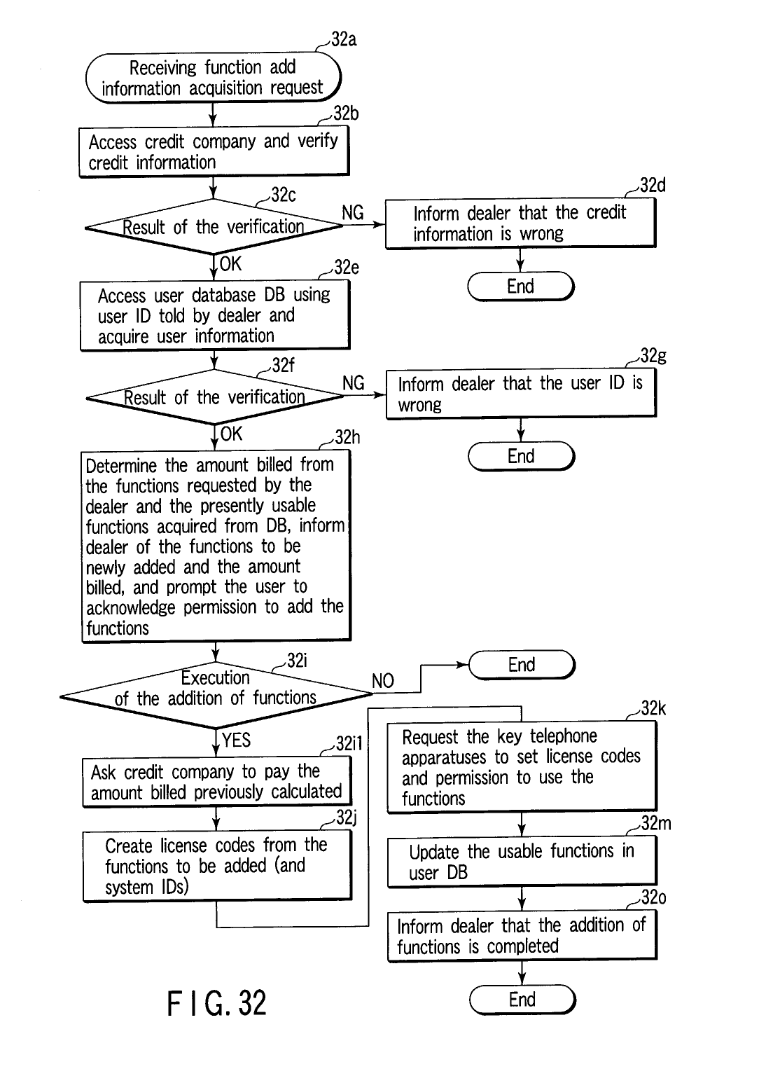

FIG. 32 is a flowchart for the operation of the customer center CC. The process of adding functions is carried out according to the procedure shown in step 32a to step 32o.

When receiving a function add request of the user from the dealer DL via the Internet INW in step 32a, the customer center CC accesses the credit company CR in step 32b to verify the credit information. If the credit information is invalid, the customer center CC passes control from step 32c to step 32d, where the customer center CC informs the dealer DL that the credit execute information is wrong. On the other hand, if the credit information is valid, the customer center CC passes control from step 32c to step 32e, where the customer center CC accesses the user database DB on the basis of the user ID sent from the dealer DL and acquires user information. The user information includes function information about the key telephone apparatuses BT1 to BT4 the user has. If the user database DB cannot be accessed, the customer center CC passes control from step 32f to step 32g, where the customer center CC informs the dealer that the user ID is wrong.

Next, the customer center CC, in step 32h, calculates the amount billed, on the basis of the functions required by the dealer DL and the pieces of function information read from the user database DB, informs the dealer DL of the names of the newly added functions and the amount billed, and inquires whether to execute the addition of the functions. When the dealer DL transmits an execute request in response to the inquiry, the customer center CC passes control from step 32i to 32i1, where the center CC transmits settlement request information about the amount billed previously calculated to the credit company CR. When receiving from the credit company CR a reply to the effect that the company CR has accepted the settlement request, the customer center passes control to step 32j, where the center CC creates a license code for each of the key telephone apparatuses BT1 to BT4 on the basis of the added functions and the system IDs of the key telephone apparatuses BT1 to BT4 and, in step 32k, sends to the key telephone apparatuses BT1 to BT4 a request for setting use of the license codes and functions possible.

Then, after the additional setting of functions is completed in the key telephone apparatuses BT1 to BT4, the customer center CC, in step 32m, updates the function information of the corresponding user stored in the user database DB and, in step 32o, informs the requesting dealer DL that the addition of the functions is completed.

As described above, according to the function changing method of the fourth embodiment, as in the third embodiment, a series of processes ranging from the user's request for the change of functions to the addition of functions to the user's key telephone apparatuses BT1 to BT4 is performed automatically via a communication network without human intervention, with the dealer DL intervening between the user system CM and the customer center CC. This enables the time required to add functions to be shortened, the expenses the user pays to be reduced, and the labor and costs needed to change the functions at the dealer DL or the customer center CC to be reduced remarkably.

Furthermore, as in the second embodiment, it is determined whether the communication between the customer center CC and the key telephone apparatuses BT1 to BT4 can be performed or whether functions can be changed, on the basis of the user information accumulated and managed in the user database DB. This makes it unnecessary to acquire information about functions from the key telephone apparatuses BT1 to BT4 each time the user uses the telephone apparatus. As a result, a suitable function changing process can be carried out according to a simple procedure.

Moreover, after the process of adding functions is completed, the customer center CC updates the corresponding function information in the user database DB. This makes it possible to always update the accumulated management information in the user database DB to the latest one automatically without the maintenance man in charge at the customer center CC carrying out the updating process manually.

(Fifth Embodiment)

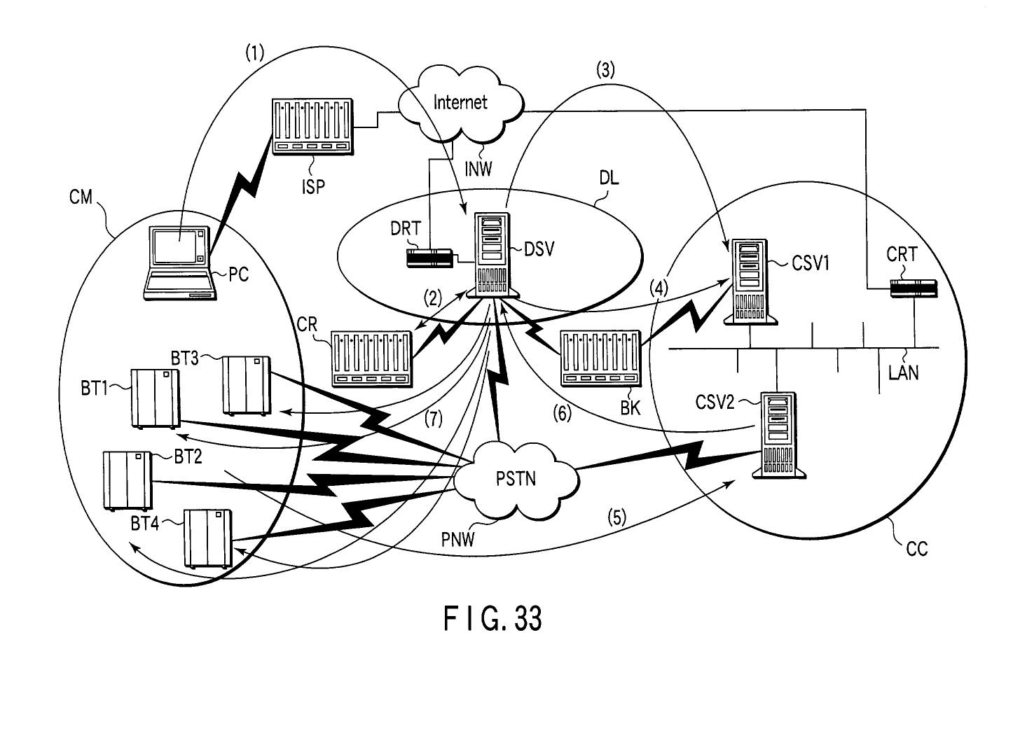

FIG. 33 schematically shows the configuration of a support system that carries out a function changing method according to a fifth embodiment of the present invention. In FIG. 33, the same parts as those in FIG. 20 are indicated by the same reference numerals. A detailed explanation of them will not be given.

The reception/charging/notifying server DSV of the dealer DL is connected via the public network PNW to the key telephone apparatuses BT of the user system CM and the license setting server CSV2 of the customer center CC. The server DSV exchanges the information necessary for a function adding process with the key telephone apparatuses BT and the license setting server CSV2.

Furthermore, the reception/charging/notifying server DSV is connected via an exclusive line to the credit company CR or the bank BK. The server DSV inquires the credit of the user from the credit company CR or bank BK and bills the agent's commission for adding the functions.

First, the user uses its own maintenance personal computer PC to transmit a function add request via the Internet INW to the dealer DL as shown in (1). In the function add request, information representing the functions the user wants to add, the user's credit number, and the telephone numbers of the key telephone apparatuses BT1 to BT4 are included.

Next, the dealer DL accesses the credit company CR on the basis of the credit number included in the function add request as shown in (2) and inquires about the credit of the user. If there is no problem, the dealer DL transfers the function add request to the customer center CC as shown in (3).

The customer center CC accesses the key telephone apparatuses BT1 to BT4 the user has, on the basis of the telephone numbers included in the function add request, requires function information about the key telephone apparatuses BT1 to BT4 as shown in (5), and determines on the basis of the function information whether the functions the user wants can be added. If they can be added, the customer center CC sends an added function license setup request to the reception/charging/notifying server DSV via the public network PNW as shown in (6). Thereafter, as shown in (7), the dealer DL transmits the license codes according to the received license setup request to the key telephone apparatuses BT1 to BT4 via the public network PNW, which enables the functions to be added.

Next, the procedure for adding functions to the key telephone apparatuses BT1 to BT4 in the above system will be explained.

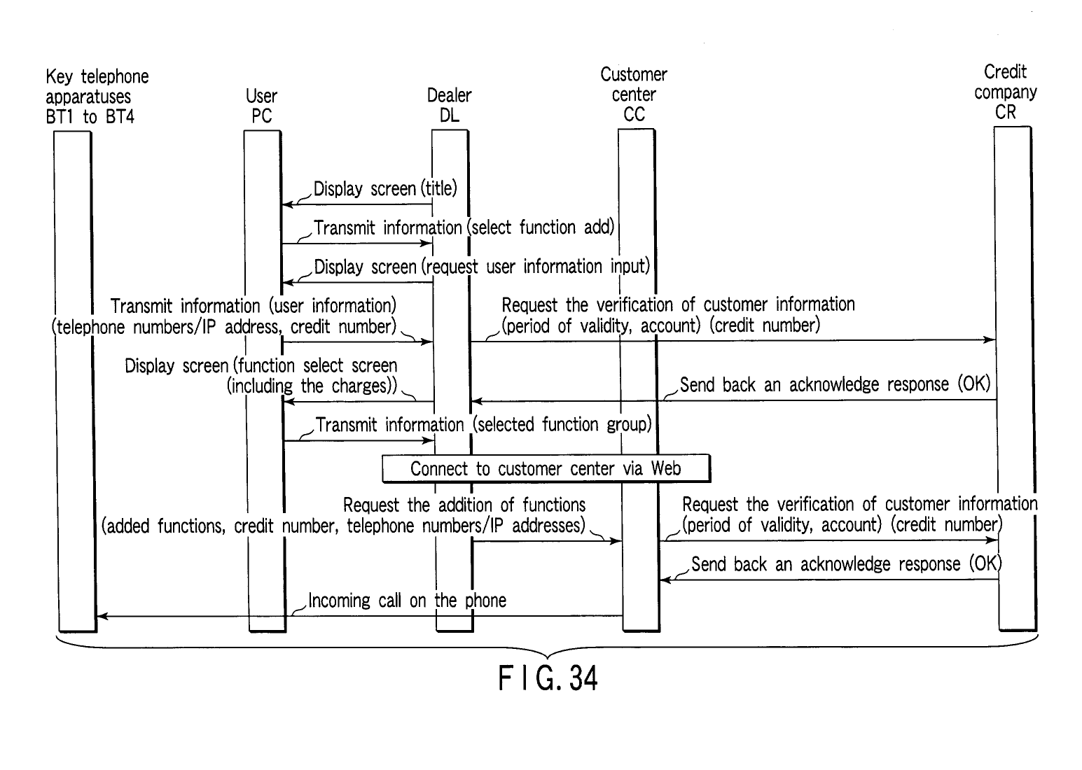

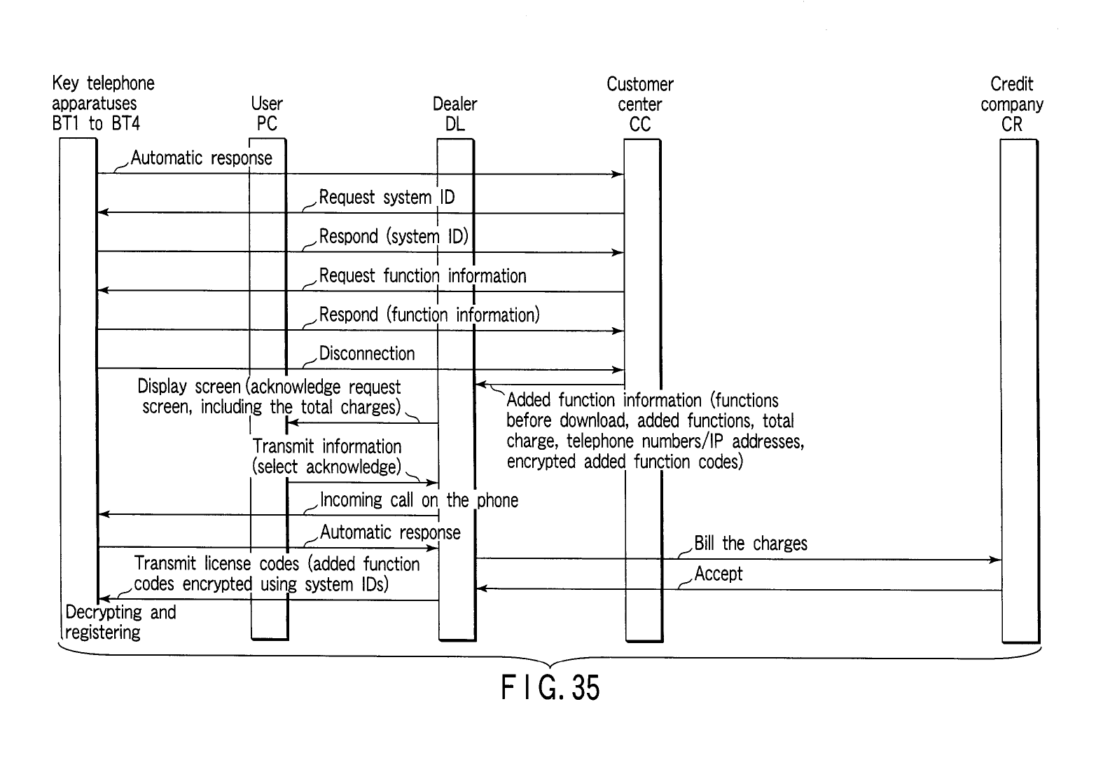

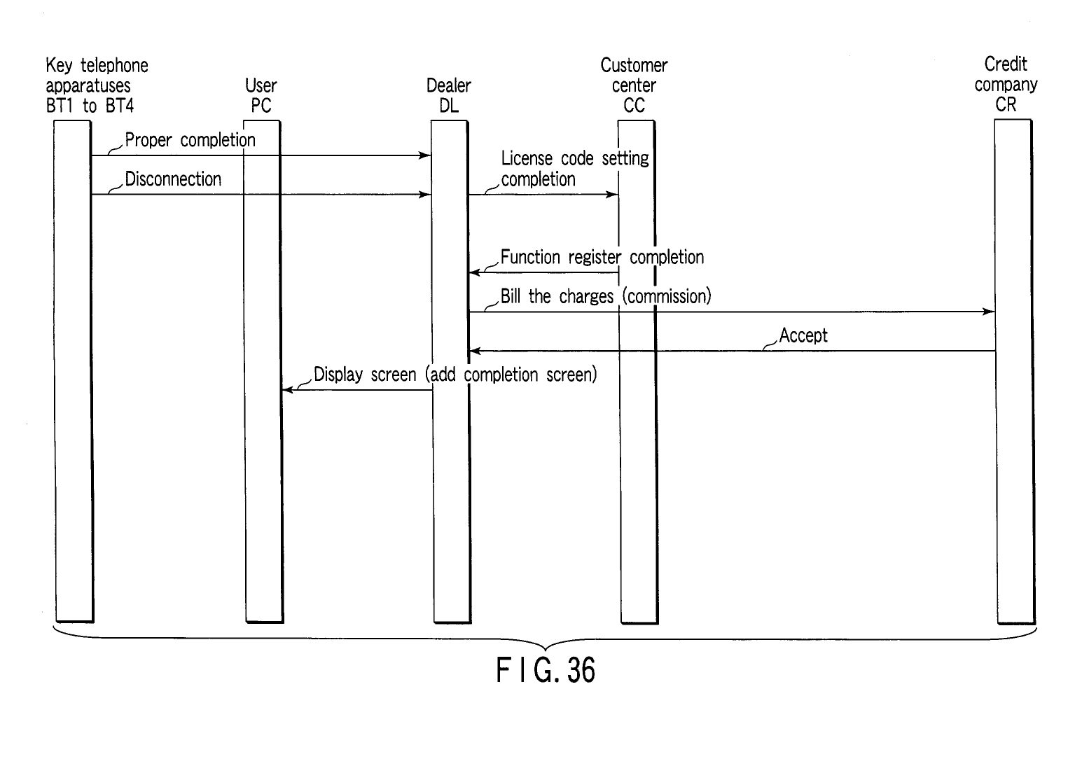

FIGS. 34 to 36 are sequence diagrams to help explain the operation of transmitting and receiving signals between the maintenance personal computer PC (or user PC) of the user system CM, the dealer DL, the customer center CC, and the credit company CR.

To add functions to the key telephone apparatuses BT1 to BT4, the user uses the maintenance personal computer PC to access the home page of the dealer DL by way of the Internet INW and inputs the necessary items related to the addition of functions according to the guidance on the screen downloaded from the dealer DL. The necessary items to be inputted include information representing the functions to be added, the user's credit number, and the telephone numbers or IP addresses allocated by the public network PNW to the key telephone apparatuses BT1 to BT4. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses each of the user's key telephone apparatuses BT1 to BT4 via the public network PNW on the basis of the telephone numbers included in the function add request and acquires the function information and system IDs from the key telephone apparatuses BT1 to BT4. Then, the customer center CC informs the dealer DL by way of the Internet INW of added function information including the acquired function information and a list of charges for adding functions. The dealer DL transfers the notified function information and list of charges to the user's maintenance personal computer PC by way of the Internet INW. When receiving an acknowledge response from the user to the notice of the function information and list of charges, the dealer DL accesses the credit company CR and bills the charges for the added functions. When receiving from the credit company CR a reply to the effect that the settlement request has been accepted, the dealer DR accesses the user's key telephone apparatuses BT1 to BT4 via the public network PNW and transmits a license code to each of the key telephone apparatuses BT1 to BT4 via the public network PNW. In the license codes, instruction codes for setting the functions to be added “usable” are inserted. The instruction codes are encrypted using the system IDs previously acquired from the key telephone apparatuses BT.

When receiving the license code from the dealer DL, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT1 to BT4 send back to the dealer DL information to the effect that the function adding process is completed properly.

When receiving a notice of the completion of the addition of functions from the key telephone apparatuses BT, the dealer DL disconnects the lines with the key telephone apparatuses BT1 to BT4 and informs the customer center CC that the setting of the license codes is completed.

Receiving the notice of the completion of the license code setting, the customer center CC informs the dealer DL of the function adding process is completed. Receiving the notice of the completion of the process, the dealer DL asks the credit company CR to pay the agent's commission.

As a result, the functions the user wants to add are set in the key telephone apparatuses BT1 to BT4 in such a manner that they are usable. Thereafter, in the key telephone apparatuses BT1 to BT4, the added optional service functions can be used.

The configuration of each section of the support system that carries out the above-described function changing method is as follows.

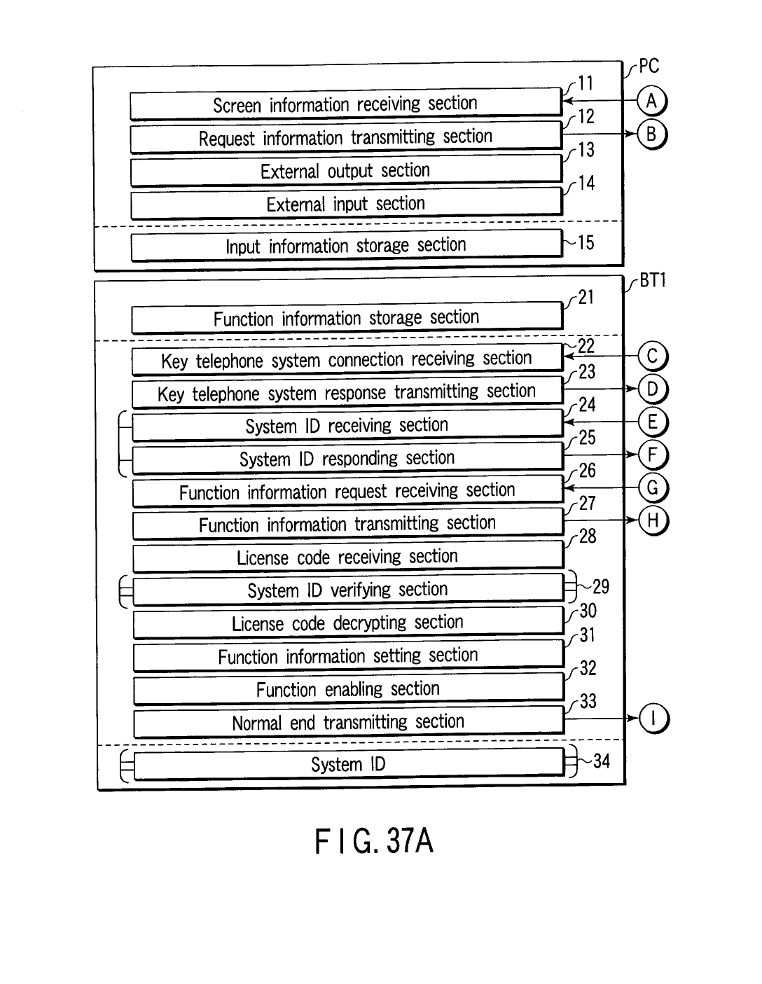

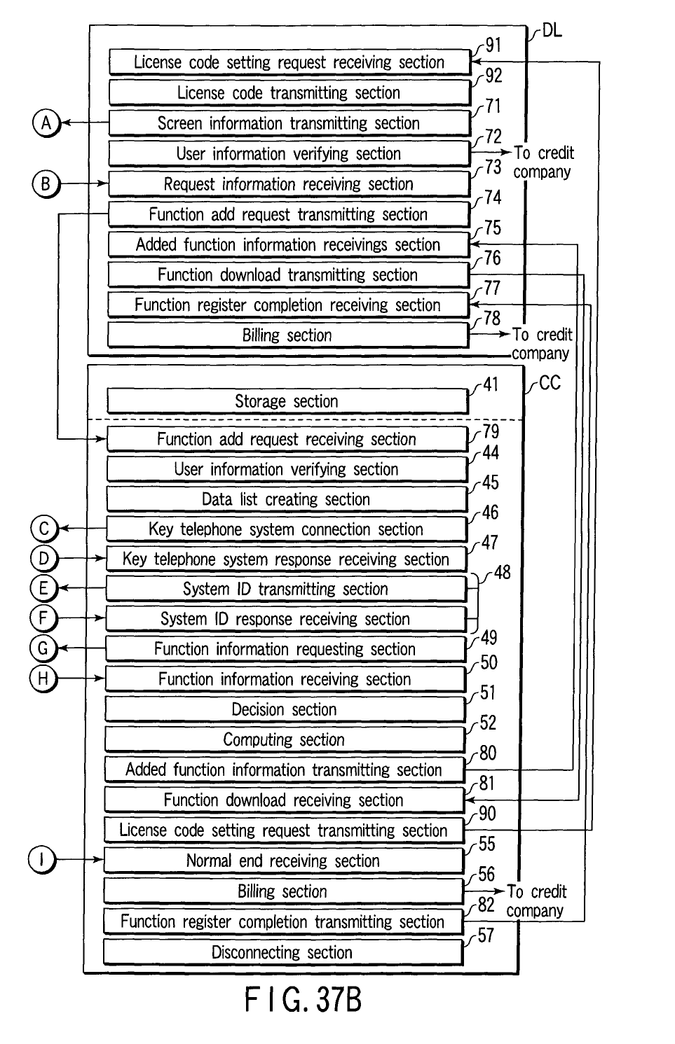

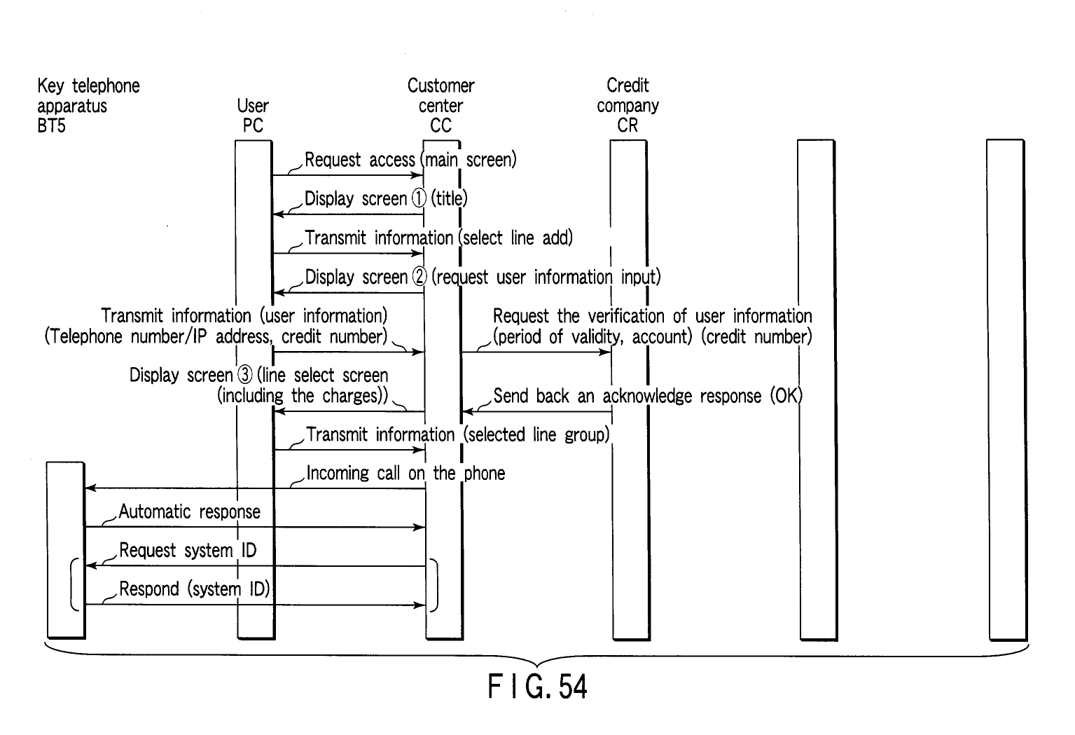

FIG. 37 is a block diagram showing a functional configuration of the maintenance personal computer PC, key telephone apparatuses BT1 to BT4, dealer DL, and customer center CC. In FIG. 37, the same parts as those in FIG. 54 are indicated by the same reference numerals. A detailed explanation of them will not be given.

The customer center CC includes a license code setting request transmitting section 90. The license code setting request transmitting section 90 transmits to the dealer DL the function add request information received by the function add request receiving section 79 from the maintenance personal computer PC and the function information about and the system IDs of the key telephone apparatuses BT1 to BT4 received by the function information receiving section 50.

The dealer DL further includes a license code setting request receiving section 91 and a license code transmitting section 92.

The license code setting request receiving section 91 receives the function add request information transmitted by the customer center CC and the function information about and the system IDs of the key telephone apparatuses BT1 to BT4.

The license code transmitting section 92 accesses each of the key telephone apparatuses BT1 to BT4 via the public network PNW on the basis of the telephone numbers included in the received function add request information. In addition, the license code transmitting section 92 encrypts the license codes using the respective system IDs included in the function information and transmits the encrypted license codes to the key telephone apparatuses BT1 to BT4.

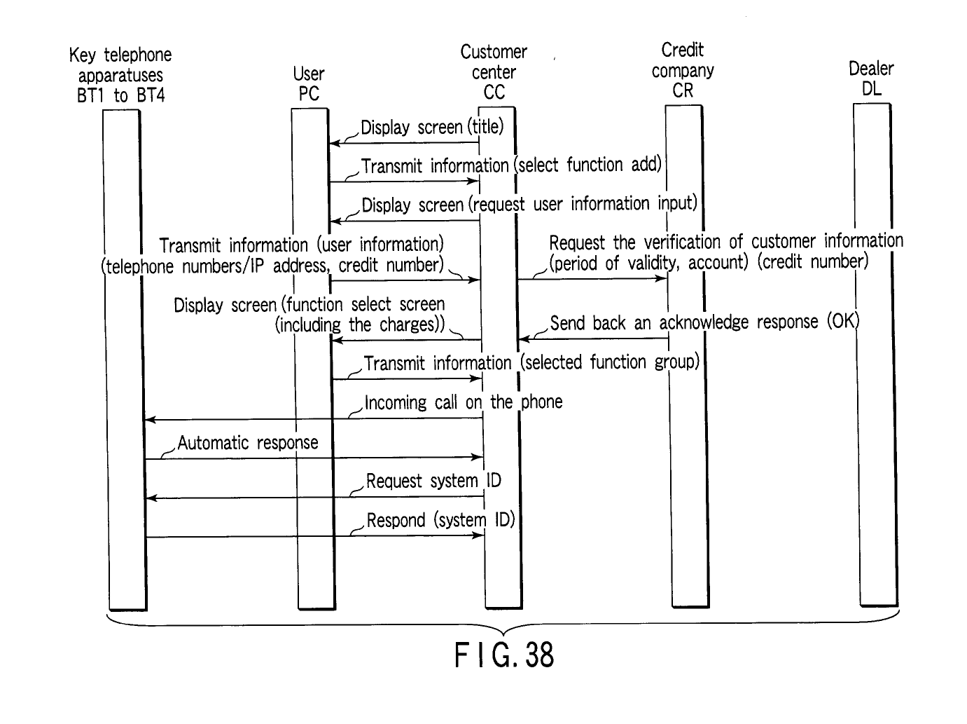

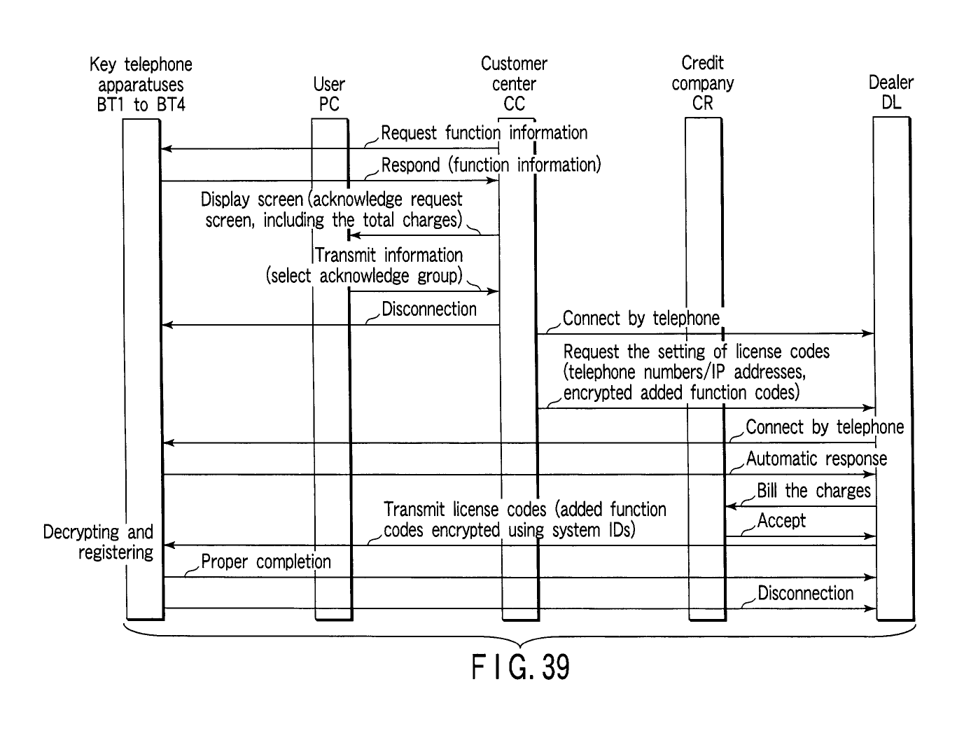

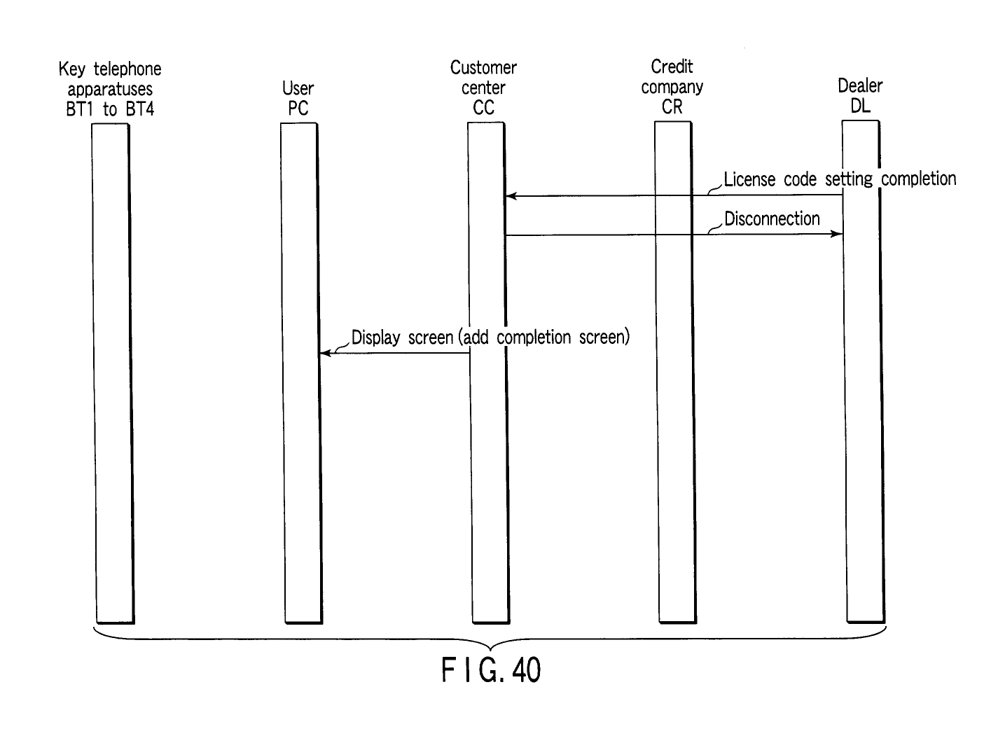

While in the above transmission and reception procedure, the dealer DL has intervened from the beginning, the dealer DL may intervene when the functions are set in the key telephone apparatuses BT1 to BT4 as shown in FIGS. 38 to 40.

In this case, to add the functions to the key telephone apparatuses BT1 to BT4, the user uses the maintenance personal computer PC to access the customer center CC by way of the Internet INW and inputs the necessary items related to the addition of functions according to the guidance on the screen downloaded from the customer center CC. The necessary items to be inputted include information representing the functions to be added, the credit number, and the telephone numbers or IP addresses allocated by the public network PNW to the key telephone apparatuses BT1 to BT4. After finishing the input of the necessary items, the user transmits a function add request including those pieces of information to the customer center CC.

Receiving the function add request, the customer center CC accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the customer center CC.

On the basis of the reply from the credit company CR, the customer center CC judges the credit of the user. If there is no problem, the customer center CC causes the maintenance personal computer PC to display the function select screen together with the charges. When a selection is made, the customer center CC accesses each of the user's key telephone apparatuses BT1 to BT4 via the public network PNW on the basis of the telephone numbers included in the function add request and acquires the function information about and the system IDs of the key telephone apparatuses BT1 to BT4. Then, on the basis of the acquired function information, the customer center CC determines whether the functions the user wants to add are already in use and, if they are not in use, they can be added. The customer center CC then informs the user's maintenance personal computer PC of the result of the determination and the expenses for adding the functions.

Receiving an acknowledge response to the notice from the user, the customer center CC disconnects the lines with the key telephone apparatuses BT1 to BT4. Then, the customer center CC accesses the dealer DL via the public network PNW and transmits to the dealer DL of information about the functions the user wants to add and license code setting request including the telephone numbers or IP addresses allocated by the public network PNW to the key telephone apparatuses BT1 to BT4.

Then, the dealer DL accesses and asks the credit company CR to settle the charges for the added functions. At that time, the dealer DL calculates the amount billed for each of the functions actually set usable among those the user wants to add and creates a detailed electronic bill. The dealer DL then includes the detailed electronic bill in the settlement request information and transmits the information to the customer center CC.

Receiving the settlement request information, the credit company CR authenticates the user on the basis of the user's credit number included in the settlement request information and determines whether to conduct a transaction. If it is possible to conduct a transaction, the credit company CR accepts the settlement of the charges on the basis of the detailed electronic bill included in the settlement request information. After finishing the acceptance of the settlement, the credit company CR sends back to the requesting dealer DL a reply to the effect that the company CR has accepted the settlement request.

When receiving the response to the settlement request from the credit company CR, the dealer DL accesses each of the user's key telephone apparatuses BT1 to BT4 via the public network PNW on the basis of the telephone numbers included in the license code setting request and transmits license codes as function change control information. In the license codes, instruction codes for setting the functions to be added “usable” are inserted. The instruction codes are encrypted using the system IDs previously acquired from the key telephone apparatuses BT1 to BT4.

When receiving the license code from the dealer DL, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT1 to BT4 send back to the dealer DL information to the effect that the function adding process is completed properly.

When receiving a notice of the completion of the addition of functions from the key telephone apparatuses BT1 to BT4, the dealer DL disconnects the lines with the key telephone apparatuses BT1 to BT4 and transmits to the customer center CC information to the effect that the license setting is completed.

Receiving the information, the customer center CC disconnects the line with the dealer DL and accesses the credit company CR to ask the credit company CR to pay the charges for the added functions. Then, receiving from the credit company CR a reply to the effect that the settlement request has been accepted, the customer center CC informs the user's maintenance personal computer PC that the function adding process is completed.

As a result, the functions the user wants to add are set in the key telephone apparatuses BT1 to BT4 in such a manner that they are usable. Thereafter, in the user's key telephone apparatuses BT1 to BT4, the added optional service functions can be used.

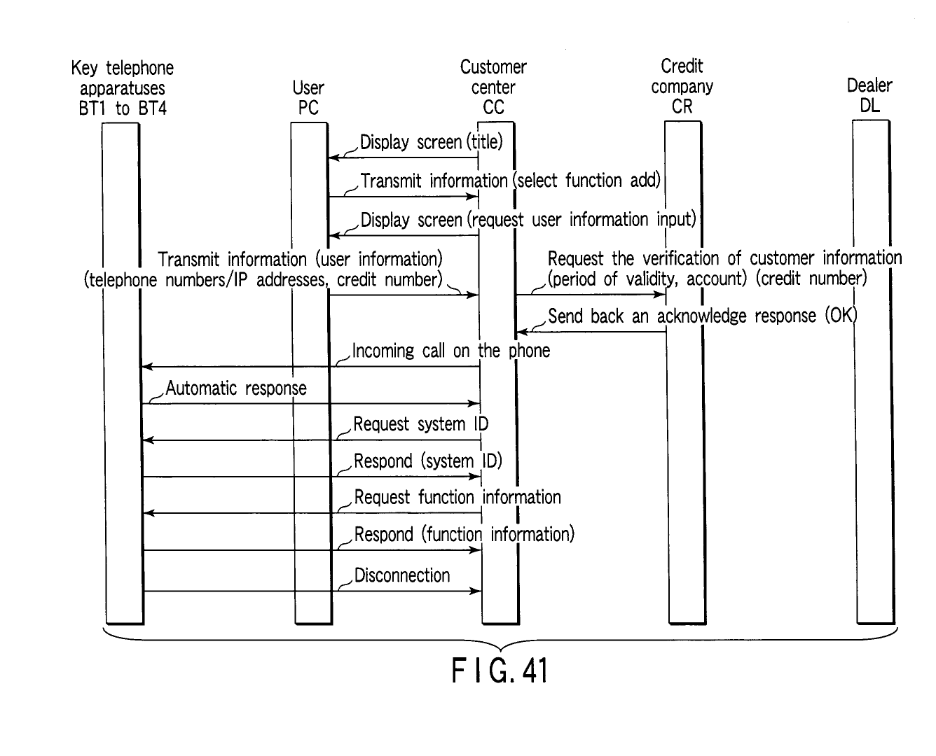

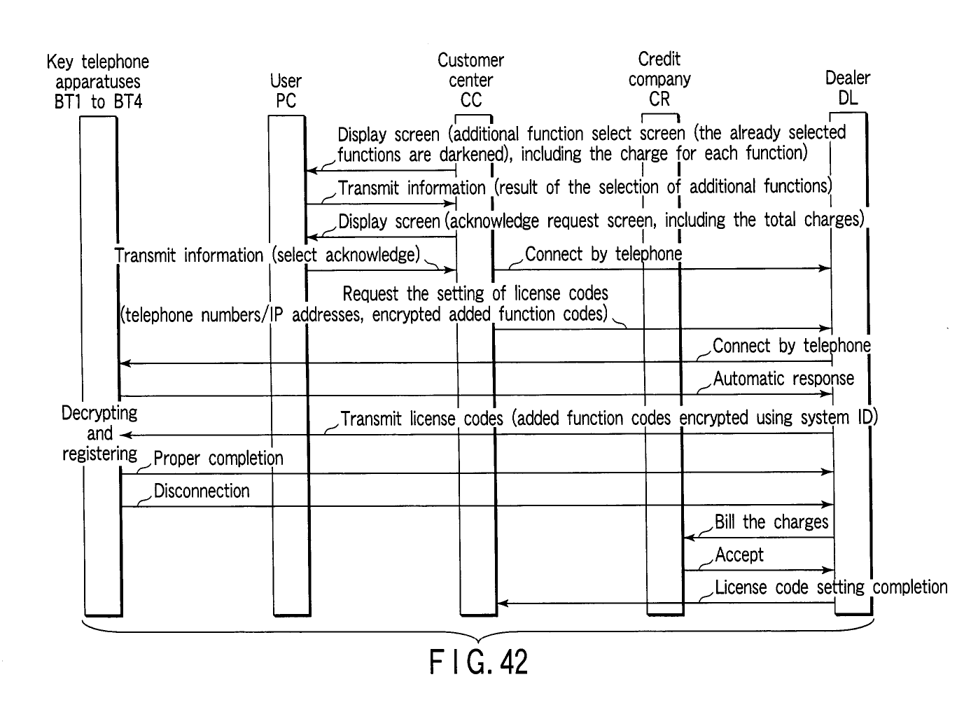

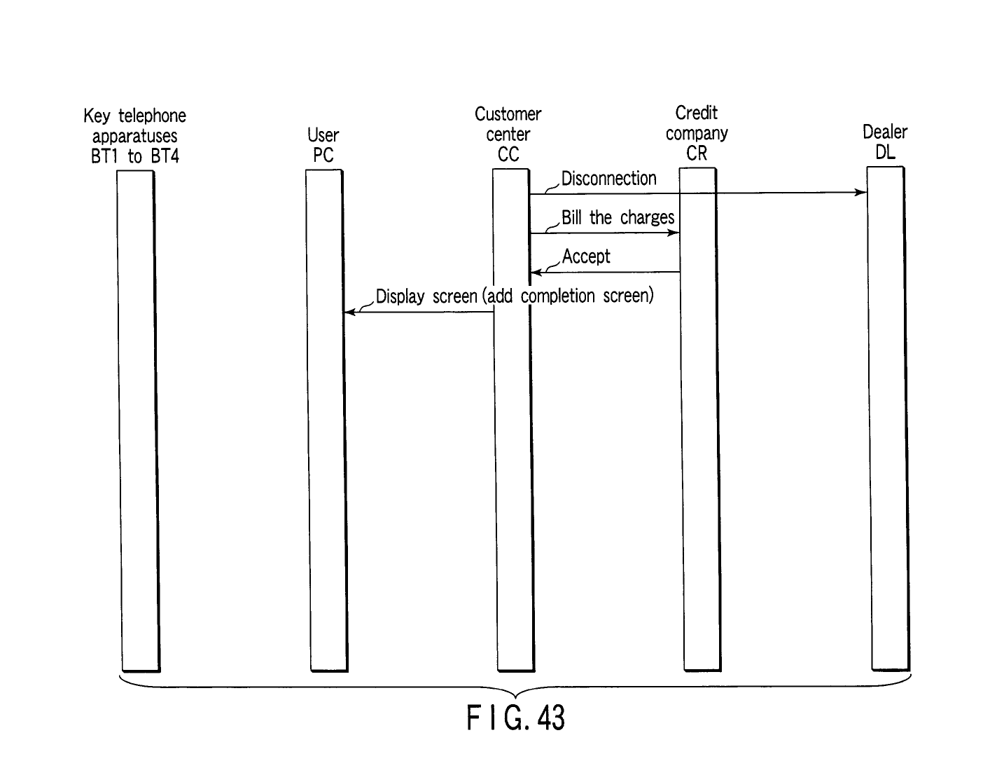

While in the above transmitting and receiving operations, the user has been prompted to check the present functions in each of the key telephone apparatuses BT1 to BT4 and request the functions the user wants to add, the user may input the desired functions from the beginning without checking the present functions as shown in FIGS. 41 to 43.

As described above, according to the function changing method of the fifth embodiment, a series of processes ranging from the user's request for the change of functions to the addition of functions to the user's key telephone apparatuses BT1 to BT4 is performed automatically via a communication network without human intervention, with the dealer DL intervening between the user system CM and the customer center CC. This enables the time required to add functions to be shortened, the expenses the user pays to be reduced, and the labor and costs needed to change the functions at the dealer DL or the customer center CC to be reduced remarkably.

Since the dealer DL determines whether functions can be added, on the basis of the function information acquired from the key telephone apparatuses BT1 to BT4 to which the functions to be added, the function adding process can be carried out properly for each of the key telephone apparatuses BT1 to BT4, which alleviates the processing load on the customer center CC accordingly. In addition, since the license codes are encrypted using the respective system IDs of the key telephone apparatuses BT1 to BT4 and sent to the key telephone apparatuses BT1 to BT4, it is possible to prevent the wrong function or an unauthorized function from being added.

(Sixth Embodiment)

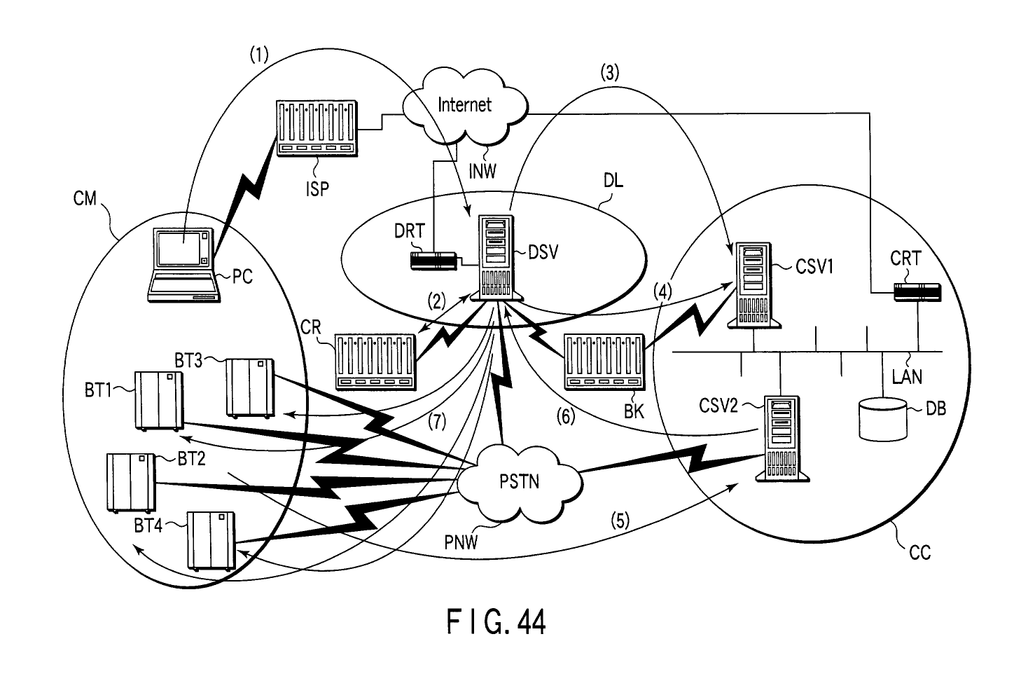

FIG. 44 schematically shows the configuration of a support system that carries out a function changing method according to a sixth embodiment of the present invention. In FIG. 44, the same parts as those in FIG. 27 are indicated by the same reference numerals. A detailed explanation of them will not be given.

The reception/charging/notifying server DSV of the dealer DL is connected via the public network PNW to each of the key telephone apparatuses BT1 to BT4 of the user system CM and the license setting server CSV2 of the customer center CC. Then, the server DSV exchanges the information necessary for a function adding process with the key telephone apparatuses BT1 to BT4 and license setting server CSV2.

Furthermore, the reception/charging/notifying server DSV is connected via an exclusive line to the credit company CR or the bank BK. The server DSV inquires the credit of the user from the credit company CR or bank BK and bills the agent's commission for adding functions.

On the other hand, in the customer center CC, there is provided an user database DB. In the user database DB, the system IDs of, function information about, and telephone numbers of the key telephone apparatuses BT1 to BT4 the user has are stored in such a manner that they are caused to correspond to the user ID uniquely assigned to each user.

When the user's function add request has been transferred from the dealer DL, the reception/charging server CSV1 or license server CSV2 of the customer center CC accesses the user database DB on the basis of the user ID included in the function add request and reads the systems IDs of, function information about, and telephone numbers of the key telephone apparatuses BT1 to BT4 the user has. Then, using the read-out information, the server CSV1 or CSV2 determines whether the functions the user wants can be added, accesses each of the key telephone apparatuses BT1 to BT4, and transmits a license code.

First, as shown in (1), the user's maintenance personal computer PC transmits a function add request to the dealer DL via the Internet INW. Information representing the functions to be added, the user's individual identification information (or user ID), and credit number are included in the function add request.

Next, the dealer DL accesses the credit company CR on the basis of the credit number included in the function add request as shown in (2) and inquires about the credit of the user. If there is no problem, the dealer DL transfers the function add request to the customer center CC as shown in (3).

The customer center CC accesses the user database DB, on the basis of the user identification information included in the function add request, and reads the system IDs of, function information about, and telephone numbers of the key telephone apparatuses BT1 to BT4 as shown in (5). Then, the customer center CC determines on the basis of the function information whether the functions the user wants can be added and informs the user of the result of the determination via the dealer. If the functions can be added, the customer center CC sends a license setup request for added functions via the public network PNW to the reception/charging/notifying server DSV of the dealer DL as shown in (6). Thereafter, the dealer DL transmits the license codes according to the received license setup request to the key telephone apparatuses BT1 to BT4 via the public network PNW as shown in (7), thereby enabling the functions to be added.

Next, the procedure for adding functions to the key telephone apparatuses BT in the above system will be explained.

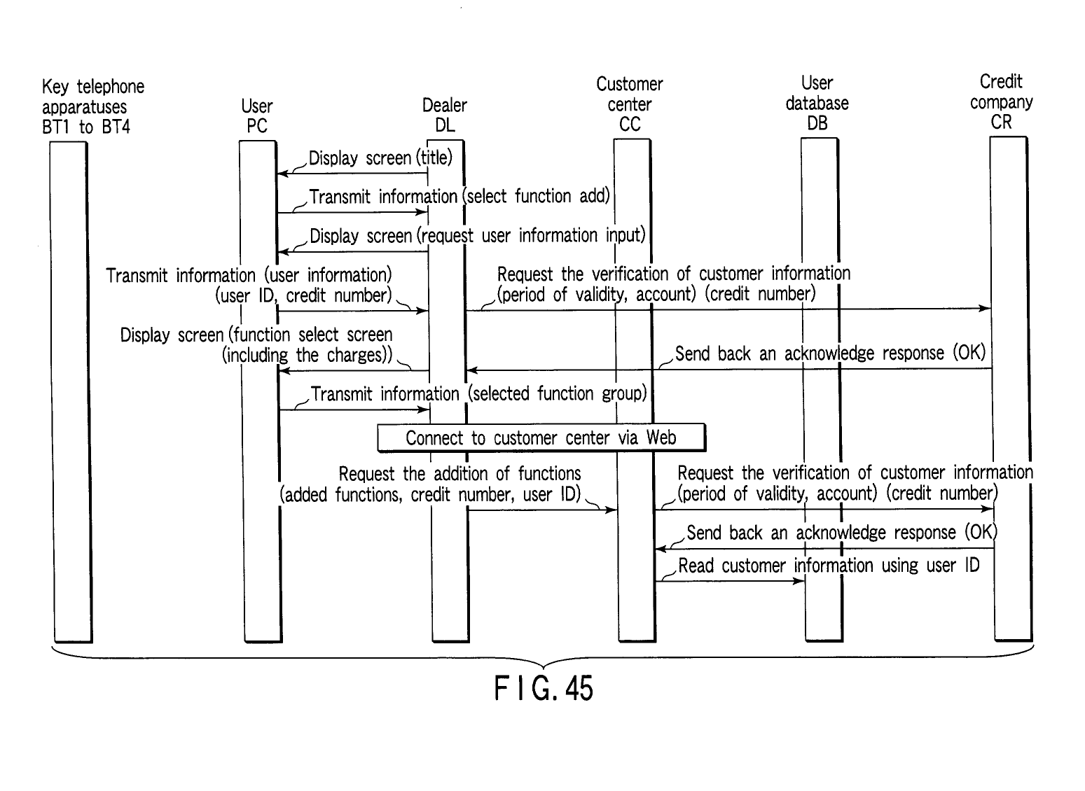

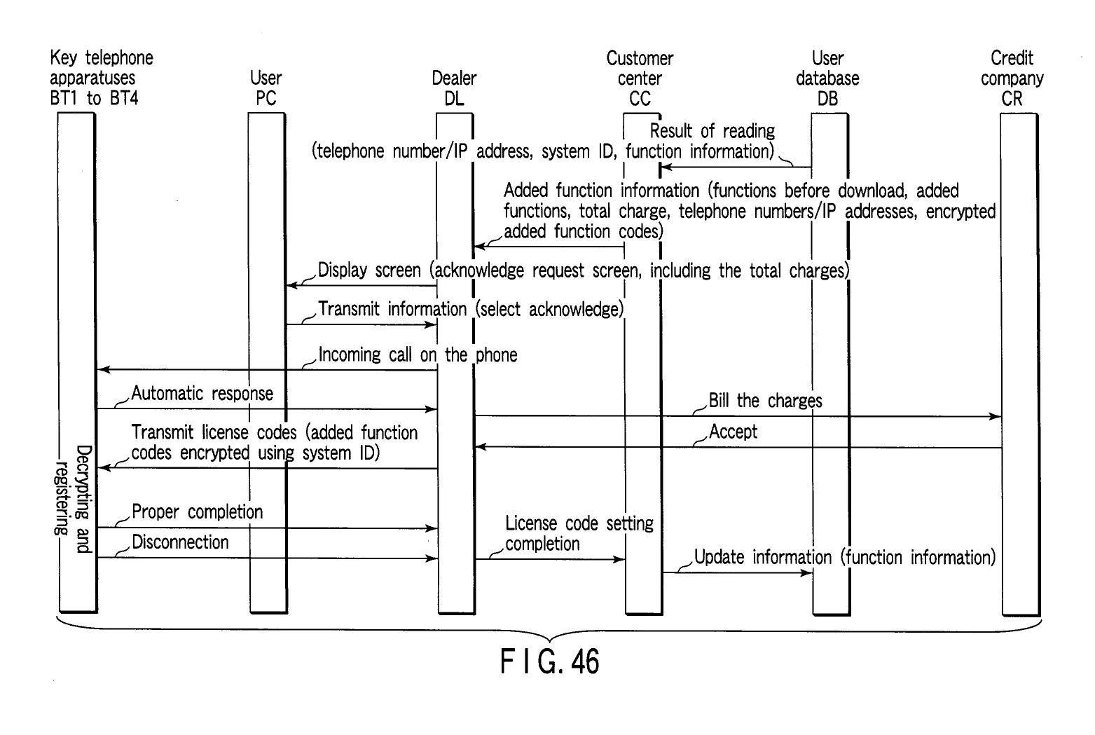

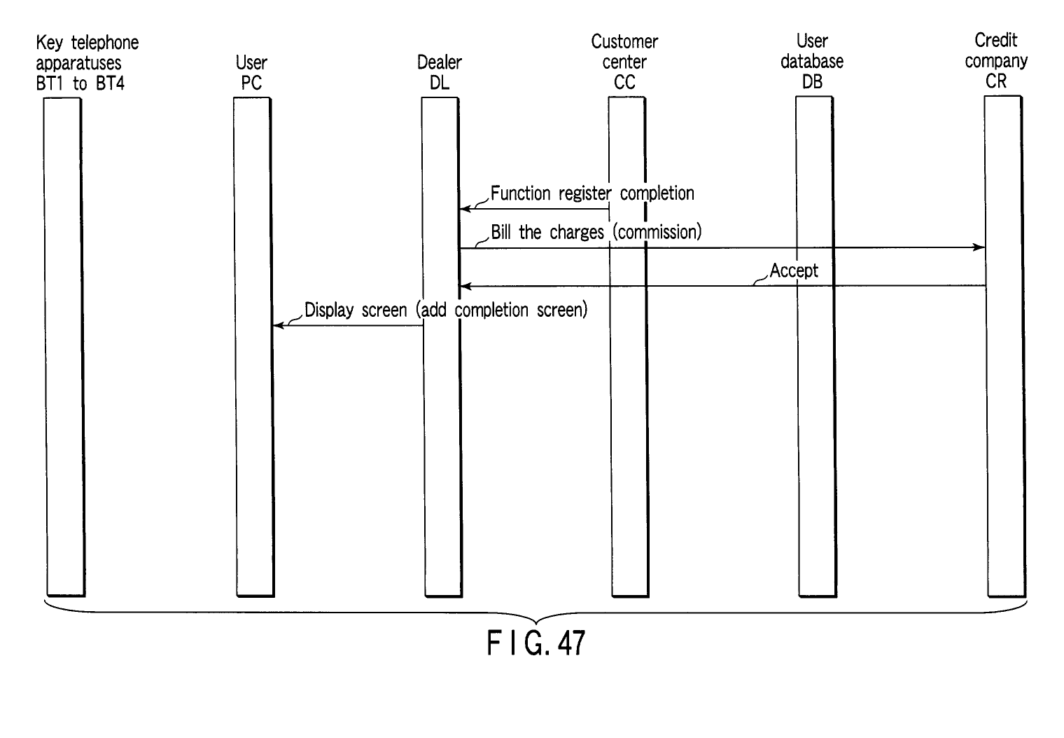

FIGS. 45 to 47 are sequence diagrams to help explain the operation of transmitting and receiving information between the maintenance personal computer PC (or user PC) of the user system CM, the dealer DL, the customer center CC, and the credit company CR.

To add functions to the key telephone apparatuses BT1 to BT4, the user uses the maintenance personal computer PC to access the home page of the dealer DL by way of the Internet INW and inputs the necessary items related to the addition of functions according to the guidance on the screen downloaded from the dealer DL. The necessary items to be inputted include information representing the functions to be added, the user's ID, and the user's credit number. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses the user database DB on the basis of the user ID included in the function add request and reads the system IDs of, function information, and telephone numbers of the key telephone apparatuses BT1 to BT4 the user has.

Then, the customer center CC informs the dealer DL by way of the Internet INW of the read-out function information, the function information before the download, and a list of charges for adding functions. The dealer DL transfers the notified function information and list of charges to the user's maintenance personal computer PC by way of the Internet INW. When receiving from the user an acknowledge response to the notice of the function information and list of charges, the dealer DL accesses the credit company CR and bills the charges for the added functions. When receiving from the credit company CR a reply to the effect that the settlement request has been accepted, the dealer DR accesses the user's key telephone apparatuses BT1 to BT4 via the public network PNW and transmits a license code to each of the user's key telephone apparatuses BT via the public network PNW. In the license codes, instruction codes for setting the functions to be added “usable” are inserted. The instruction codes are encrypted using the system IDs previously acquired from the user database DB.

When receiving the license code from the dealer DL, each of the key telephone apparatuses BT1 to BT4 decrypts the instruction code included in the license code, using the system ID of its own apparatus. Then, according to the decrypted instruction code, the key telephone apparatus changes the flag for the corresponding function in the function information setting table from “unusable” to “usable.” When finishing the process of setting the addition of functions, the key telephone apparatuses BT1 to BT4 send back to the dealer DL information to the effect that the function adding process is completed properly.

When receiving a notice of the completion of the addition of functions from each of the key telephone apparatuses BT1 to BT2, the dealer DL disconnects the lines with the key telephone apparatuses BT and informs the customer center CC that the setting of the license codes is completed.

Receiving the notice of the completion of the license code setting from the dealer DL, the customer center CC not only updates the information in the user database DB but also access the credit company CR and bills the charges for the added functions. Then, when receiving from the credit company CR a response to the effect that the settlement request has been accepted, the customer center CC informs the dealer DL that the function adding process is completed. Receiving the notice of the completion of the process, the dealer DL asks the credit company CR to pay the agent's commission.

As a result, the functions the user wants to add are set in the key telephone apparatuses BT1 to BT4 in such a manner that they are usable. Thereafter, in the user's key telephone apparatuses BT1 to BT4, the added optional service functions can be used.

The configuration of each section of the support system that carries out the above-described function changing method is as follows.

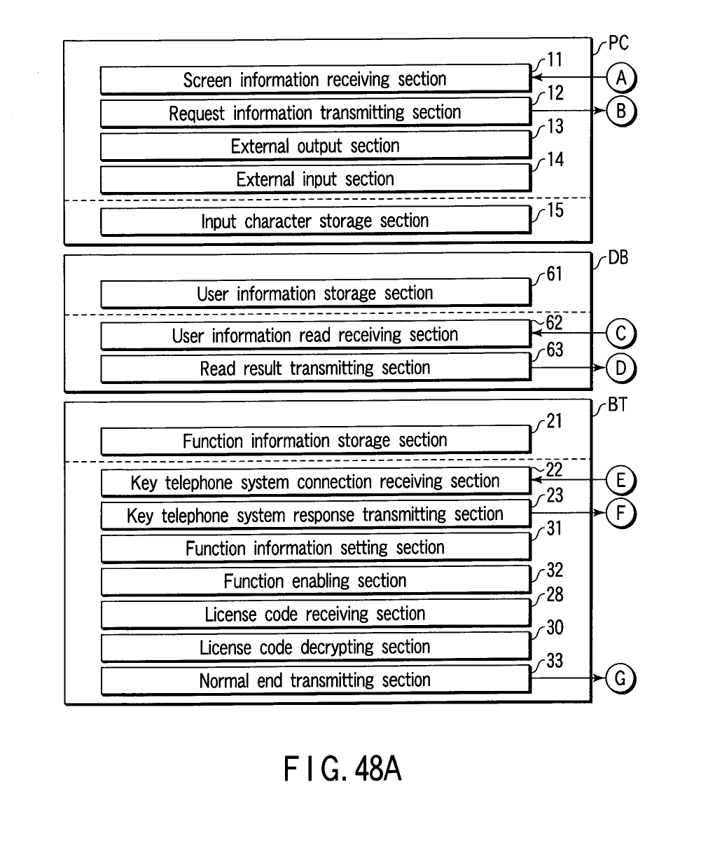

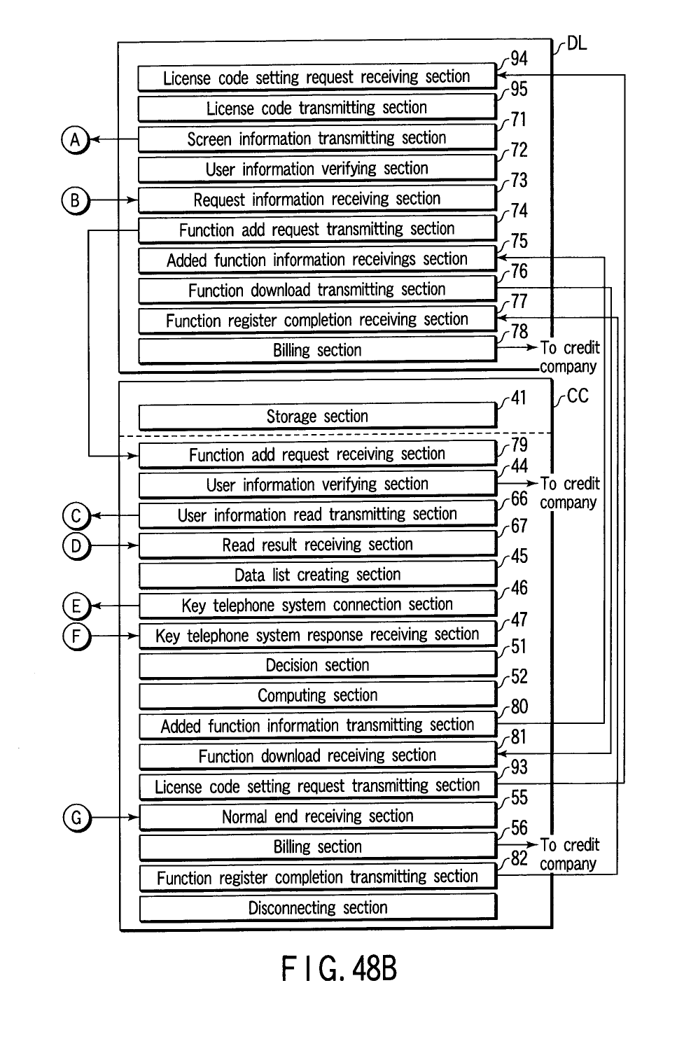

FIG. 48 is a block diagram showing a functional configuration of the maintenance personal computer PC, key telephone apparatus BT1, and customer center CC. In FIG. 48, the same parts as those in FIG. 31 are indicated by the same reference numerals. A detailed explanation of them will not be given.

The customer center CC includes a license code setting request transmitting section 93. The license code setting request transmitting section 93 transmits to the dealer DL the function add request information received by the function add request receiving section 79 from the maintenance personal computer PC and user information including the telephone numbers of, system IDs of, and function information about the key telephone apparatus BT1 read by the read result receiving section 67 from the user database DB.

The dealer DL further includes a license code setting request receiving section 94 and a license code transmitting section 95.

The license code setting request receiving section 94 receives the function add request information and user information transmitted by the customer center CC.

The license code transmitting section 95 accesses the key telephone apparatus BT1 via the public network PNW on the basis of the telephone number included in the received user information. In addition, the license code transmitting section 95 encrypts the license code using the system ID included in the user information and transmits the encrypted license code to the key telephone apparatuses BT.

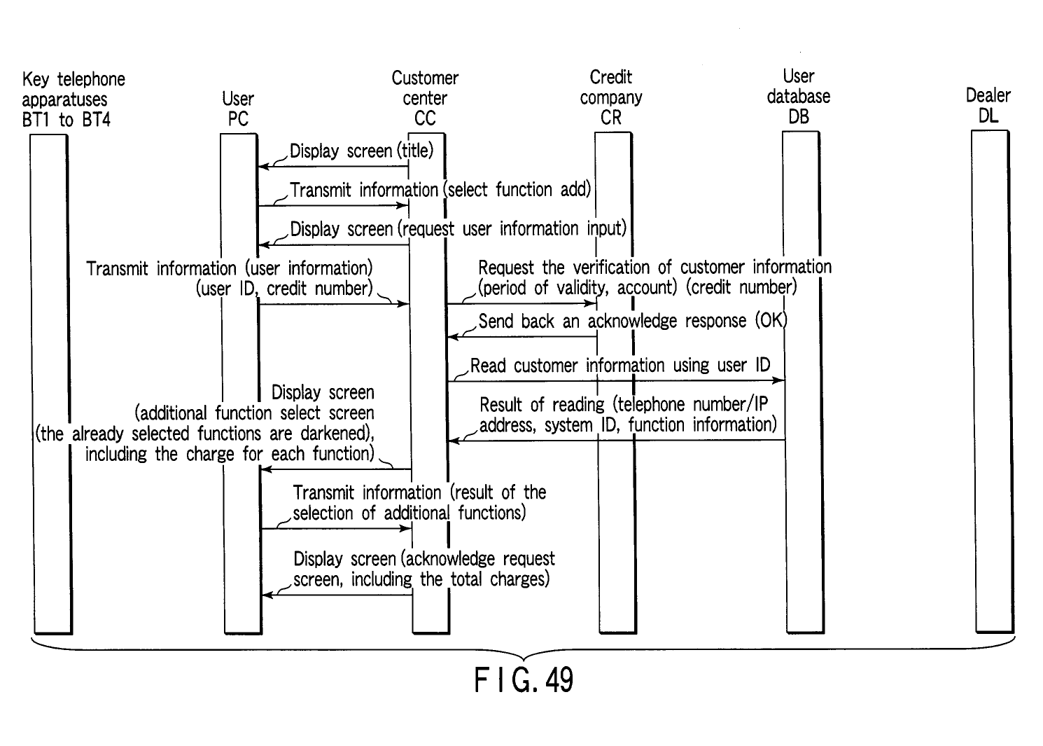

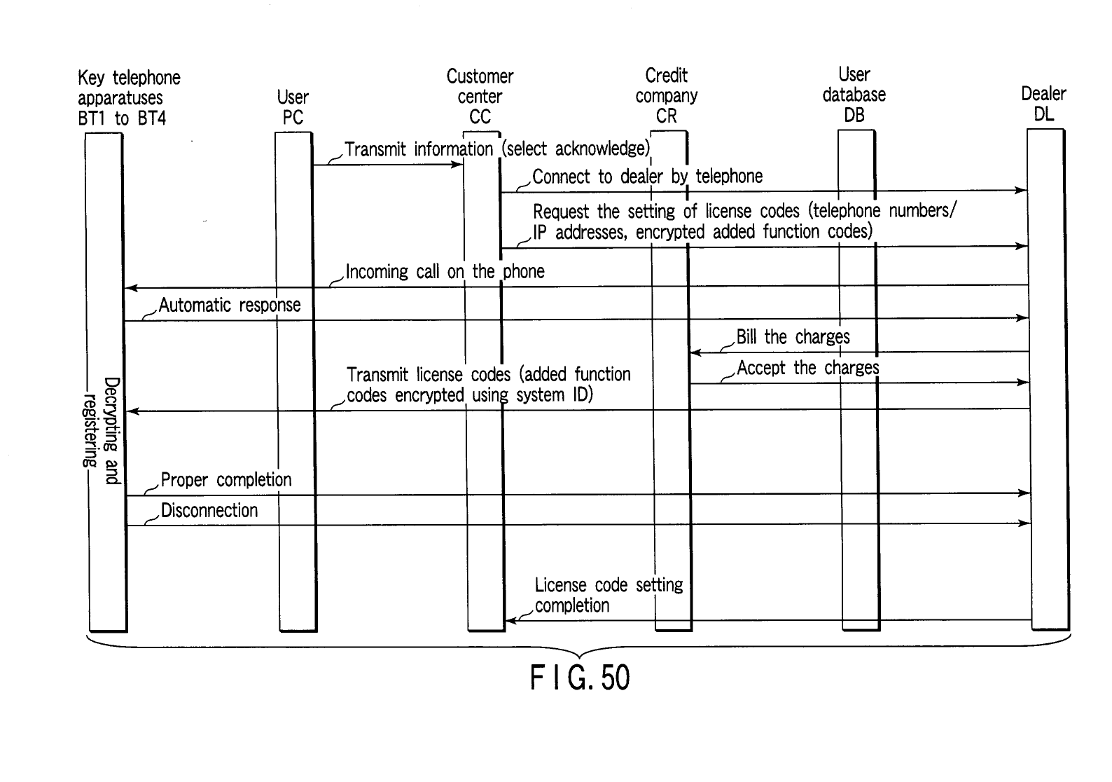

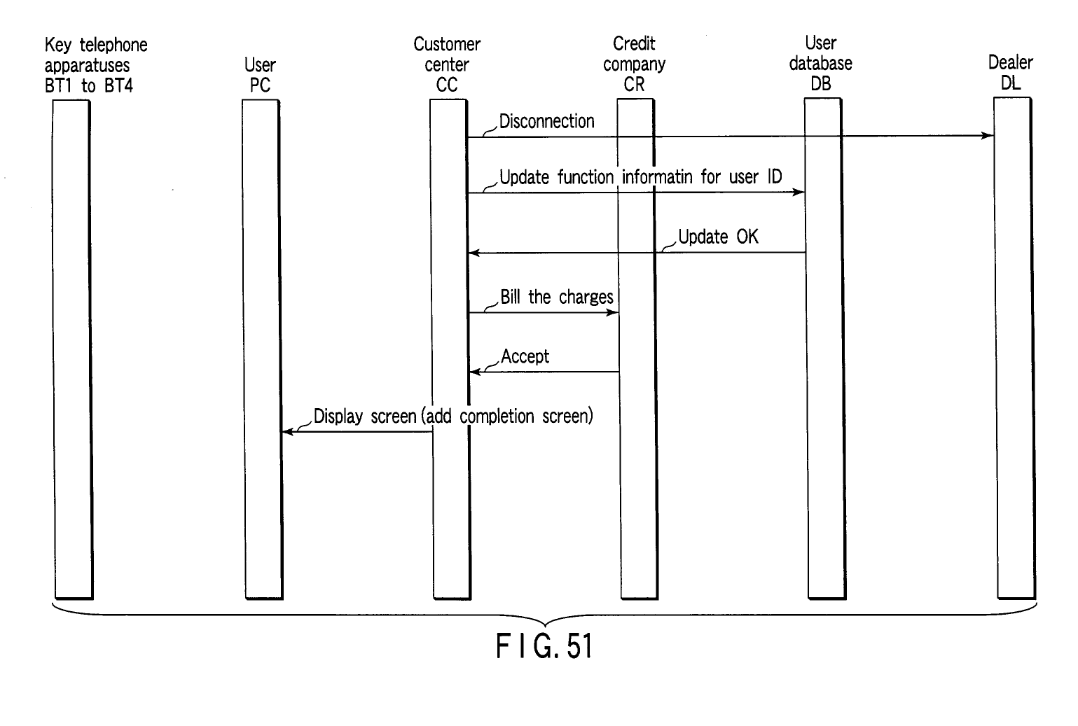

While in the above transmission and reception procedure, the dealer DL has intervened from the beginning, the dealer DL may intervene when the functions are set in the key telephone apparatuses BT1 to BT4 as shown in FIGS. 49 to 51.

In this case, to add the functions to the key telephone apparatuses BT1 to BT4, the user uses the maintenance personal computer PC to access the customer center CC by way of the Internet INW and inputs the necessary items related to the addition of functions according to the guidance on the screen downloaded from the customer center CC. The necessary items to be inputted include information representing the functions to be added, the user ID, and the user's credit number. After finishing the input of the necessary items, the user transmits a function add request including those pieces of information to the customer center CC.

Receiving the function add request, the customer center CC accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the customer center CC.

On the basis of the reply from the credit company CR, the customer center CC judges the credit of the user. If there is no problem, the customer center CC accesses the user database DB on the basis of the user ID included in the function add request and reads the system IDs, function information about, and telephone numbers of the key telephone apparatuses BT1 to BT4 the user has.

Next, the customer center CC causes the maintenance personal computer PC to display the function select screen together with the charges. When a selection is made, the customer center CC accesses dealer DL via the public network PNW and transmits to the dealer DL information representing the functions to be added and a license code setting request including the telephone numbers or IP addresses assigned by the public network PNW to the key telephone apparatuses BT1 to BT4.

Then, the dealer DL accesses and asks the credit company CR to settle the charges for the added functions. At that time, the dealer DL calculates the amount billed for each of the functions actually set usable among those the user wants to add and creates a detailed electronic bill. The dealer DL then includes the detailed electronic bill in the settlement request information and transmits the information to the credit company CR.

Receiving the settlement request information, the credit company CR authenticates the user on the basis of the user's credit number included in the settlement request information and determines whether to conduct a transaction. If it is possible to conduct a transaction, the credit company CR accepts the settlement of the charges on the basis of the detailed electronic bill included in the settlement request information. After finishing the acceptance of the settlement, the credit company CR sends back to the requesting dealer DL a reply to the effect that the company CR has accepted the settlement request.

When receiving the response to the settlement request from the credit company CR, the dealer DL accesses each of the user's key telephone apparatuses BT1 to BT4 via the public network PNW on the basis of the telephone numbers included in the license code setting request and transmits license codes as function change control information. In the license codes, instruction codes for setting the functions to be added “usable” are inserted. The instruction codes are encrypted using the system IDs previously acquired from the key telephone apparatuses BT1 to BT4.

When receiving a notice of the completion of the addition of functions from the key telephone apparatuses BT1 to BT4, the dealer DL disconnects the lines with the key telephone apparatuses BT1 to BT4 and transmits to the customer center CC information to the effect that the license setting is completed.

Receiving the information, the customer center CC disconnects the line with the dealer DL. Thereafter, the customer center CC not only updates the information in the user database DB but also accesses the credit company CR to ask the credit company CR to pay the charges for the added functions. Then, receiving from the credit company CR a reply to the effect that the settlement request has been accepted, the customer center CC informs the user's maintenance personal computer PC that the function adding process is completed.

As a result, the functions the user wants to add are set in the key telephone apparatuses BT1 to BT4 in such a manner that they are usable. Thereafter, in the user's key telephone apparatuses BT1 to BT4, the added optional service functions can be used.

As described above, according to the function changing method of the sixth embodiment, a series of processes ranging from the user's request for the change of functions to the addition of functions to the user's key telephone apparatuses BT1 to BT4 is performed automatically via a communication network without human intervention, with the dealer DL intervening between the user and the customer center CC. This enables the time required to add functions to be shortened, the expenses the user pays to be reduced, and the labor and costs needed to change the functions at the dealer DL or the customer center CC to be reduced remarkably.

Furthermore, as in the second embodiment, it is determined whether the communication between the customer center CC and the key telephone apparatuses BT1 to BT4 can be performed or whether functions can be changed, on the basis of the user information accumulated and managed in the user database DB. This makes it unnecessary to acquire information about the functions from the key telephone apparatuses BT1 to BT4 each time the user uses the telephone apparatus. As a result, a suitable function changing process can be carried out according to a simple procedure.

Moreover, after the function adding process is completed, the customer center CC updates the corresponding function information in the user database DB. This makes it possible to always update the accumulated management information in the user database DB to the latest one automatically without the maintenance man in charge at the customer-center CC carrying out the updating process manually.

(Seventh Embodiment)

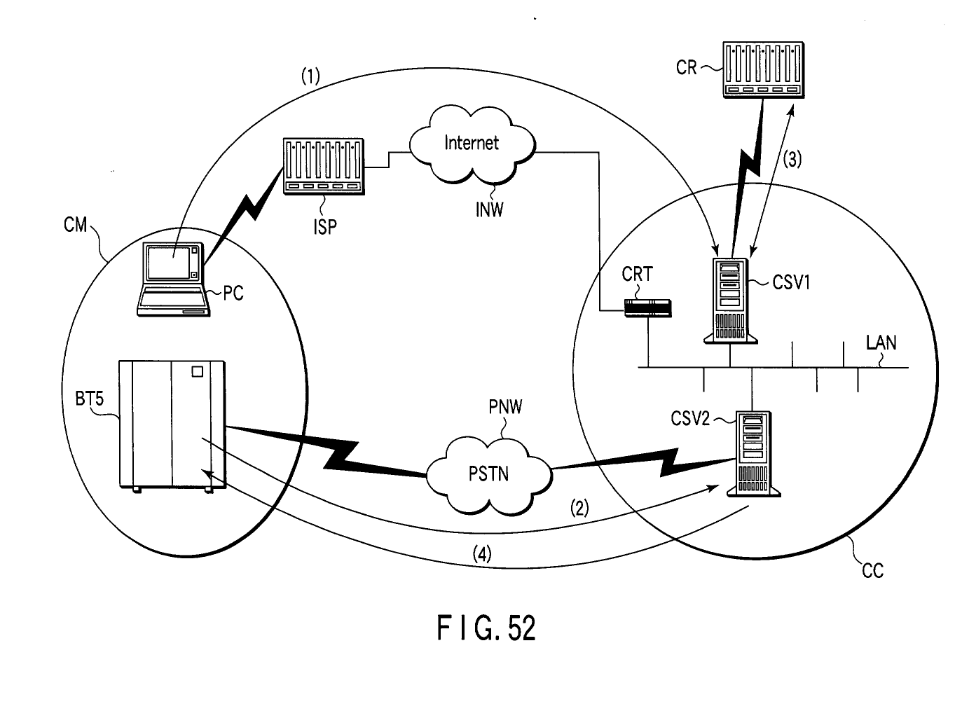

FIG. 52 schematically shows the configuration of a support system that carries out a number-of-lines changing method according a seventh embodiment of the present invention, wherein CM indicates an user system, CC a customer center, and CR a credit company.

The user system CM includes a key telephone apparatus BT5 and a maintenance personal computer PC. The basic function of the key telephone apparatus BT is to switch between a plurality of extension terminals (not shown) and between those extension terminals and subscriber lines to a public network PNW according to outgoing or incoming calls. The key telephone apparatus further has a plurality of optional service functions related to the switching process.

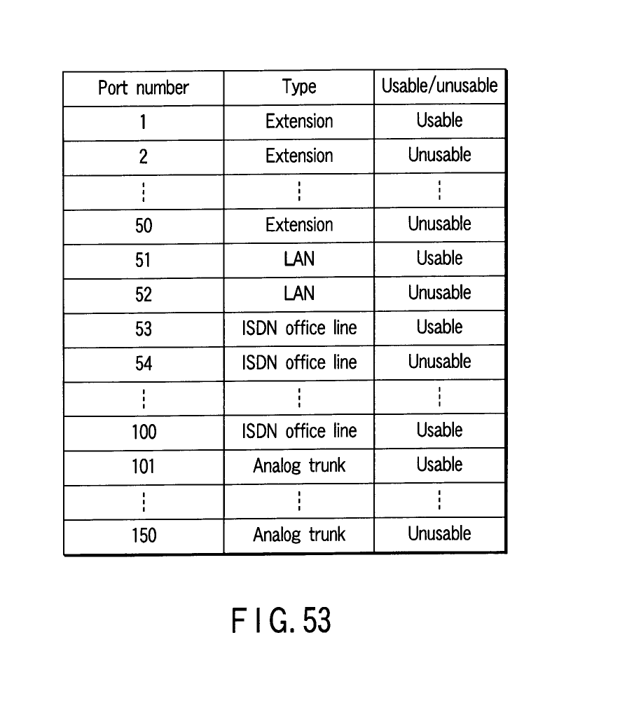

All of the programs that realize those optional service functions are stored beforehand in the program memory of the key telephone apparatus BT. To manage the setting state of the optional service functions, there is provided a line information setting table (or service execute table) in the key telephone apparatus BT. FIG. 53 shows an example of the table, in which flags indicating whether use is allowed or not are stored in such a manner that they correspond to the port numbers of the lines and respective types of lines. When a usable/unusable flag is set to “usable,” the line is executable. On the other hand, if it is set to “unusable,” the line is inexecutable.

The maintenance personal computer PC is connected to the Internet INW via a provider ISP. The computer PC is further connected to the customer center CC via the Internet INW.

The customer center CC, which includes a reception/charging server CSV1, a license server CSV2, and a router CRT, connects these one another via a LAN. The reception/charging server CSV1, which is connected to the Internet INW via the router CRT, receives a number-of-lines increase request from the maintenance personal computer PC of the user system CM. Furthermore, the reception/charging server CSV1 is connected to the credit company CR via, for example, an exclusive line, thereby settling the charge for increasing the number-of-lines with the credit company CR.

The license server CSV2 is connected to the key telephone apparatus BT5 of the user system CM via the public network PNW. The license server CSV2 has device identification numbers (or system IDs) uniquely assigned to each key telephone apparatus BT5, the function of acquiring line information from each key telephone apparatus BT5, and the function of setting the addition of lines by sending a license code to the key telephone apparatus BT. The line information is created on the basis of the line information setting table provided in the key telephone apparatus BT5. The function information is composed of a list of already usable lines and additionally usable lines. In the license code, an instruction code for activating an additional line and a system ID are inserted.

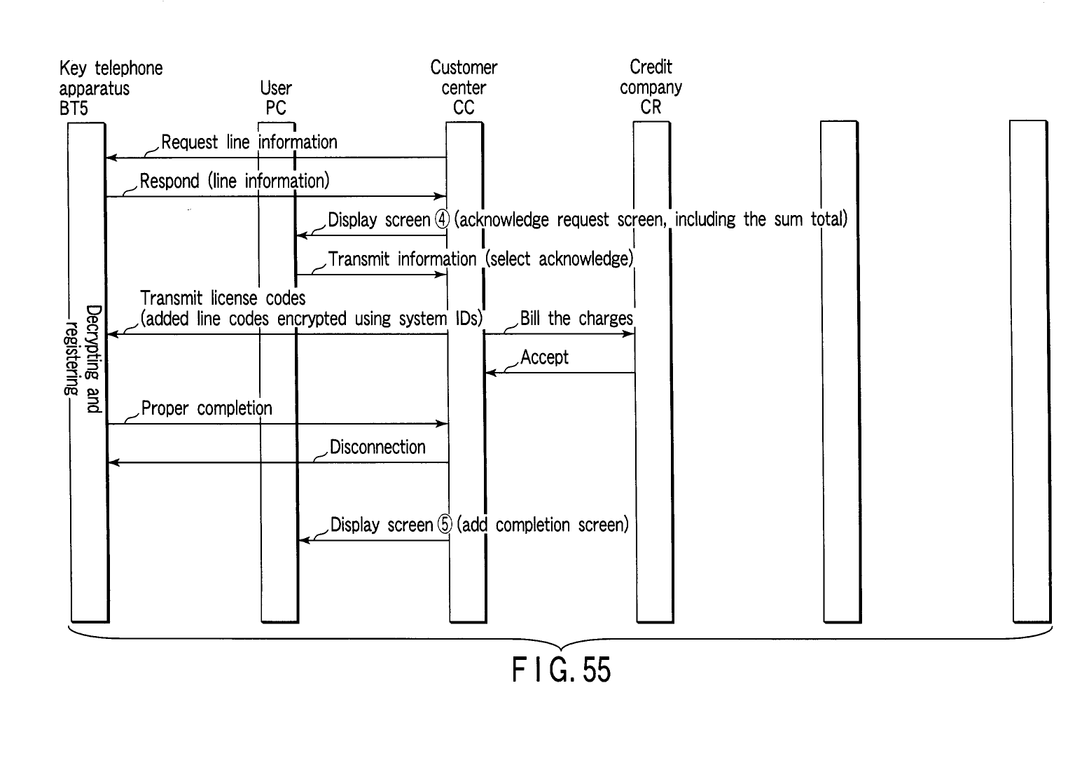

Next, the procedure for increasing the number of lines for the key telephone apparatus BT5 in the system will be explained. FIGS. 54 and 55 are schematic sequence diagrams to help explain the operation of transmitting and receiving information between the maintenance personal computer PC (or user PC) of the user system CM, the customer center CC, and the credit company CR.

To increase the number of lines for the key telephone apparatus BT5, the user uses the maintenance personal computer PC to access the customer center CC by way of the Internet INW and inputs the necessary items related to the increase of the number of lines according to the guidance on the screen downloaded from the customer center CC. The necessary items inputted include information about the types of lines to be added and the number of lines, the credit number, and the telephone number or IP address allocated by the public network PNW to the key telephone apparatus BT5. After having inputted these necessary items, the user transmits a number-of-lines increase request including these pieces of information to the customer center CC.

Receiving the number-of-lines increase request, the customer center CC first accesses the credit company CR via the exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends the reply to the customer center CC.

On the basis of the reply from the credit company CR, the customer center CC judges the credit of the user. If there is no problem, the customer center CC accesses the key telephone apparatus BT5 of the user via the public network PNW on the basis of the telephone number included in the number-of-lines increase request and acquires the line information and system ID from the key telephone apparatus BT5. Then, on the basis of the acquired line information, the customer center CC determines whether the lines the user wants to add are already in use. If they are not in use, the customer center CC determines whether the lines can be added. Then, the customer center CC notifies the user's maintenance personal computer PC of the result of the determination and the expenses needed to increase the number of lines.

Then, when receiving an acknowledge response to the notice from the user, the customer center CC accesses the credit company CR to ask the credit company CR to settle the charges for the increase of the number of lines. At that time, the customer center CC calculates the amount billed for each line actually set usable and makes a detailed electronic bill. Then, the customer center CC includes the detailed electronic bill in the settlement request information and transmits the resulting information to the credit company CR.

Receiving the settlement request information, the credit company CR authenticates the user on the basis of the user's credit number included in the settlement request information and determines whether to conduct a transaction. If it is possible to conduct a transaction, the credit company CR accepts the settlement of the charges on the basis of the detailed electronic bill included in the settlement request information. After finishing the acceptance of the settlement, the credit company CR sends back to the customer center CC a reply to the effect that the company CR has accepted the settlement request.

Then, the customer center CC transmits via the public network PNW to the user's key telephone apparatus BT a license code as number-of-lines change control information. In the license code, an instruction code for setting the lines to be added to “usable” is inserted. At this time, the instruction code is encrypted using the system ID acquired from the key telephone apparatus BT5.

Receiving the license code from the customer center CC, the key telephone apparatus BT decrypts the instruction code included in the license code using the system ID of its own apparatus. Then, according to the decrypted instruction code, the key telephone apparatus BT changes the flag for the corresponding line in the line information setting table from “unusable” to “usable.” After finishing the process of setting the increase of the number of lines, the key telephone apparatus BT5 sends back to the customer center CC information to the effect that the number-of-lines increasing process is completed properly.

Receiving a notice of the completion of the increase of the number of lines from the key telephone apparatus BT5, the customer center CC disconnects the lines with the key telephone apparatus BT5. Thereafter, the customer center CC transmits to the user's maintenance personal computer PC information to the effect that the number-of-lines increasing process is completed and causes the computer PC to display the information.

As a result, the lines the user wants to add are set in the key telephone apparatus BT5 in such a manner that they are usable. Thereafter, in the user's key telephone apparatus BT5, the added lines can be used.

The configuration of each section of the support system that realizes the above-described number-of-lines changing method is as follows.

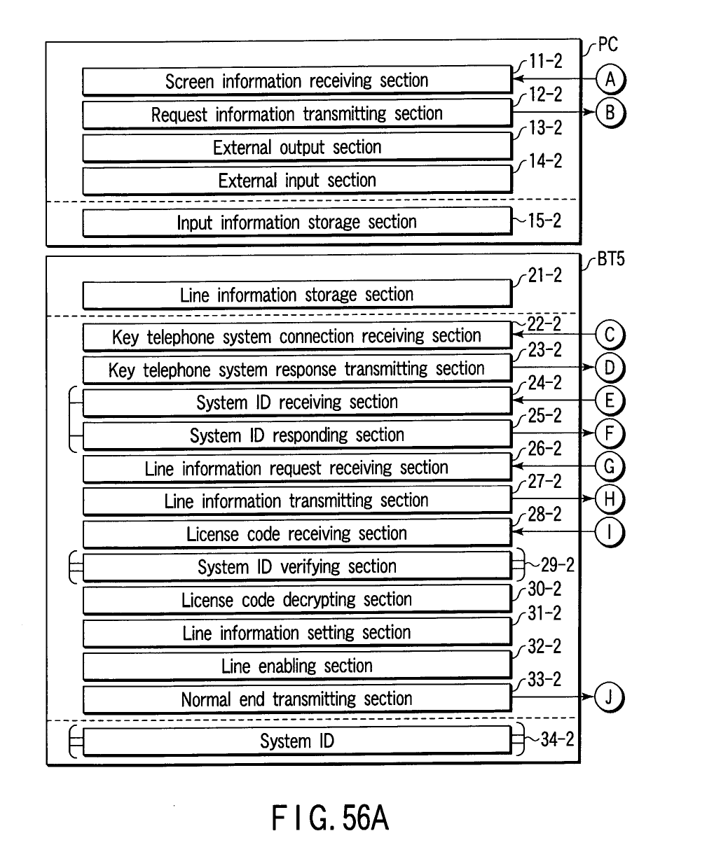

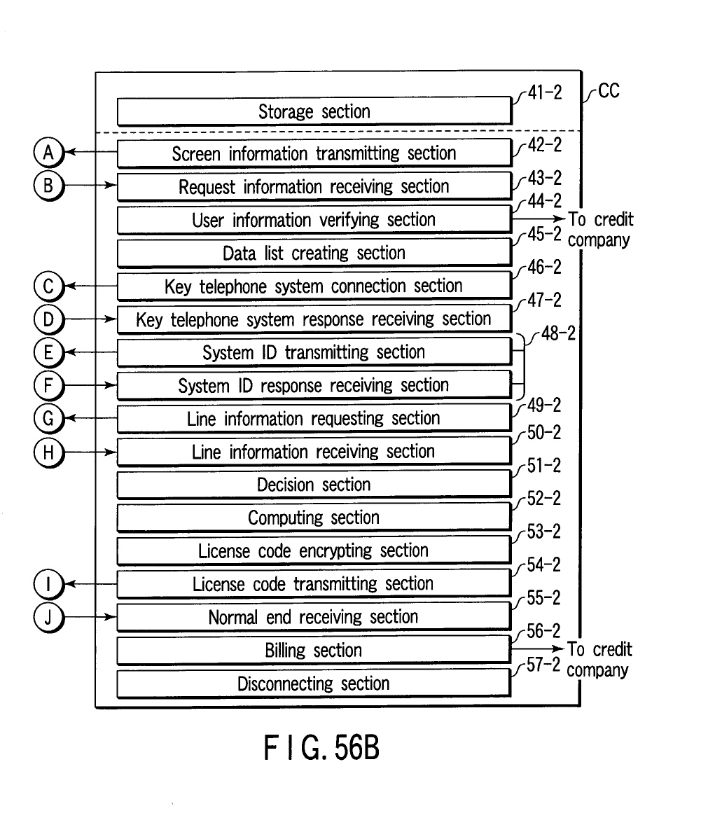

FIG. 56 is a block diagram showing a functional configuration of the maintenance personal computer PC, key telephone apparatus BT5, and customer center CC.

The maintenance personal computer PC includes a screen information receiving section 11-2, a request information transmitting section 122, an external output section 13-2, an external input section 14-2, and an input information storage section 15-2.

The screen information receiving section 11-2 receives various pieces of screen information downloaded from the customer center CC in the course of executing the procedure for increasing the number of lines and displays them. The request information transmitting section 12-2 inserts information indicating the added lines the user has inputted, the credit number, and the telephone number or IP address of the key telephone apparatus BT5 into the request information and transmits the resulting request information to the customer center CC.

The key telephone apparatus BT5 includes, as functions related to the present invention, a line information storage section 21-2, a key telephone system connection receiving section 22-2, a key telephone system automatic response transmitting section 23-2, a system ID request receiving section 24-2, a system ID transmitting section 25-2, a line information request receiving section 26-2, a line information transmitting section 27-2, a license code receiving section 28-2, a system ID verifying section 29-2, a license code decrypting section 30-2, a line information setting section 31-2, a line enabling section 32-2, a normal end transmitting section 33-2, and a system ID storage section 34-2.

In the line information storage section 21-2, the line information shown in FIG. 53 is stored. In the system ID storage section 34-2, the unique system ID fixedly assigned to its own apparatus is stored. For example, the serial number of the key telephone apparatus is used as the system ID.

The key telephone system connection receiving section 22-2 and key telephone system automatic response transmitting section 23-2 receive and respond to an incoming call when the call arrives from the customer center CC. The system ID request receiving section 24-2 and system ID transmitting section 25-2 receive a system ID acquisition request and transmit the system ID when the acquisition request arrives from the customer center CC. The line information request receiving section 26-2 and line information transmitting section 27-2 receive a line information acquisition request and transmit a line information list when the acquisition request arrives from the customer center CC.

The license code decrypting section 30-2 decrypts the license code received by the license code receiving section 28-2, using its own apparatus'system ID. The line information setting section 31-2 and line enabling section 32-2 set the flag for the line to be added to “usable” according to the decrypted license code.

The customer center CC includes a line list storage section 41-2, a screen information transmitting section 42-2, a request information receiving section 43-2, an user information verifying section 44-2, a data list creating section 45-2, a key telephone system connection section 46-2, a key telephone system response receiving section 47-2, a system ID requesting section and system ID receiving section 48-2, a line information requesting section 49-2, a line information receiving section 50-2, a requested line decision section 51-2, an additional line charge computing section 52-2, a license code encrypting section 53-2, a license code transmitting section 54-2, a normal end receiving section 55-2, and a billing section 56-2, and a disconnecting section 57-2.

The screen information transmitting section 42-2, when being accessed by the user's maintenance personal computer PC, transmits screen information to cause the maintenance personal computer PC to input a number-of-lines increase request and transmit it. The request information receiving section 43-2 receives information about the number-of-lines increase request sent from the maintenance personal computer PC. The user information verifying section 44-2 accesses the credit company CR on the basis of the credit number included in the received number-of-lines increase request information and inquires about the credit of the user.

The key telephone system connection section 46-2 and key telephone system response receiving section 47-2 access the key telephone apparatus BT5 via the public network PNW on the basis of the telephone number included in the received number-of-lines increase request information and receive the response. The system ID requesting section and system ID receiving section 48-2 not only transmits a system ID transmit request to the key telephone apparatus BT5 but also receives the system ID from the key telephone apparatus BTS.

The line information requesting section 49-2 and line information receiving section 50-2 not only transmit a line information transmit request to the key telephone apparatus BT5 but also receive the line information from the key telephone apparatus BT5. The decision section 51-2, on the basis of the received line information list, determines whether the requested number of lines can be added. The computing section 52-2 calculates the charges for the added lines on the basis of the list of lines.

The license code encrypting section 53-2 and license code transmitting section 54-2 encrypt the license code, using the system ID acquired from the key telephone apparatus BT5 and transmit the encrypted license code to the key telephone apparatus BTS. The normal end receiving section 55-2 receives a normal end signal sent from the key telephone apparatus BT5 after the number-of-lines increasing process and informs the maintenance personal PC that the normal end signal has been received. The billing section 56-2 transmits to the credit company CR a bill for the charges calculated previously at the additional line charge computing section 52-2.

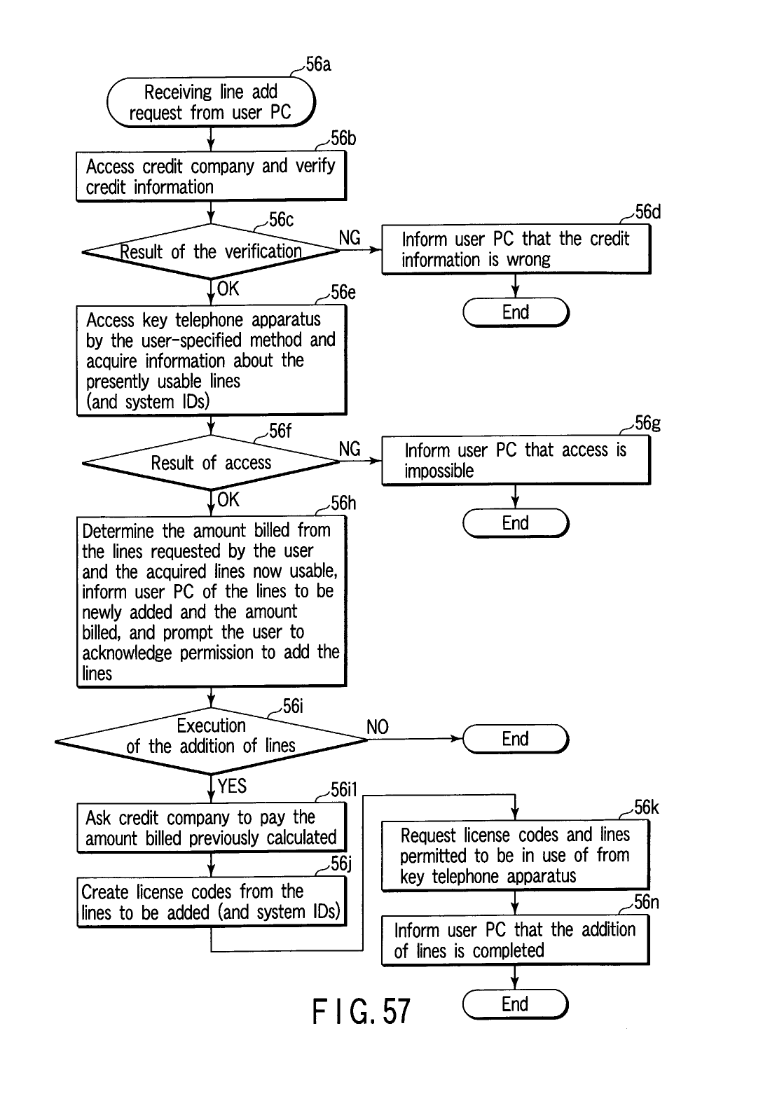

FIG. 57 is a flowchart for the operation of the customer center CC. The process of increasing the number of lines is carried out according to the procedure shown in step 56a to step 56n.

When receiving a number-of-lines increase request from the user's maintenance personal computer PC via the Internet INW in step 9a, the customer center CC accesses the credit company CR in step 56b to verify the credit information. If the credit information is invalid, the customer center CC passes control from step 56c to step 56d, where the customer center CC informs the requesting maintenance personal computer PC that the credit execute information is wrong.

On the other hand, if the credit information is valid, the customer center CC passes control from step 56c to step 56e, where the customer center CC accesses the user's key telephone apparatus BT5, using the telephone number or mail address of the key telephone apparatus BT5 sent from the user, and acquires information about the lines allowed to be used now and the system ID from the key telephone apparatus BT5. When the key telephone apparatus BT5 cannot be accessed, the customer center CC passes control from step 56f to step 56g, where the center CC informs the user that the key telephone apparatus BT5 cannot be accessed.

Next, the customer center CC, in step 56h, calculates the amount billed on the basis of the lines required by the user and the line information acquired from the key telephone apparatus BT5, informs the user's maintenance personal computer PC of the names of the newly added lines and the amount billed, and inquires whether to execute the addition of the lines. When the user transmits an execute request in response to the inquiry, the customer center CC passes control from step 56i to 56il, where the center CC transmits to the credit company CR settlement request information about the amount billed previously calculated. When receiving from the credit company CR a reply to the effect that the company CR has accepted the settlement request, the customer center passes control to step 56j, where the center CC creates a license code on the basis of the added lines and the system ID of the key telephone apparatus BT5 and, in step 56k, sends to the key telephone apparatus BT5 a request for setting use of the license code and lines possible.

Then, after the setting of the additional lines is completed in the key telephone apparatus BT5, the customer center CC, in step 56n, informs the requesting user's maintenance personal computer PC that the addition of the lines is completed.

On the other hand, when receiving the title screen, user information input request screen, line select screen including the charges, acknowledge request screen, increase completion screen, user information reenter screen, and number-of-lines increasing process NG from the customer center CC in the middle of the number-of-lines increasing process, the maintenance personal computer PC carries out the same procedure for processing as shown in FIGS. 10 and 11 in the first embodiment.

As described above, according to the number-of-lines changing method of the seventh embodiment, a series of procedures ranging from the transmission of a number-of-lines increase request by the user to the process of setting the increase of the number of lines on the user's key telephone apparatus BT5, and to the process of settling the charges for increasing the number of lines is performed automatically via a communication network without human intervention. This eliminates business trips of maintenance servicemen, changing work with the hands, and the work of billing the expenses by the person in charge, which enables the user to increase the number of lines for the user's key telephone apparatus BT5 in a short time at less expenses. On the other hand, the customer center CC can reduce remarkably the labor and cost required to increase the number of lines.

Since the license setup for the key telephone apparatus BT5 is carried out using the existing lines, special lines for the license setup and an interface circuit for connecting the lines need not be newly provided and functions can be changed easily from the customer center in a remote control manner, which is advantageous in costs.

Before the execution of the process of increasing the number of lines for the key telephone apparatus BT5, the customer center CC accesses the key telephone apparatus BT5 to acquire the line information, that is, a list of the lines already set and the lines that can be newly set, and, on the basis of the list, determines whether the number of lines can be increased. Therefore, the number-of-lines increasing process can be performed properly for each key telephone apparatus BT5. This makes it possible to increase the number of lines with high reliability.

The license code, when being transferred from the customer center CC to the key telephone apparatus BT5, is encrypted using the system ID acquired from the key telephone apparatus BT5. This prevents the number of lines from being increased wrongly or illegally, even when the license code is transferred erroneously to a different key telephone apparatus BT5, or when another user tries to increase the number of lines for his or her key telephone apparatus BT5 by stealing the license code addressed to the authorized key telephone apparatus.

Furthermore, since the telephone number of and the line information about the user's key telephone apparatus BT5 are acquired from the user or the key telephone apparatus BT5, there is no need to provide an user database for accumulating and managing those pieces of user information. This helps simplify the user management and the system configuration accordingly.

While in the above explanation, the user has inputted the lines the user wants to add from the initial screen, the customer center CC may transfer the line information acquired from the key telephone apparatus BT5 to the user and cause the user to display the information. On the basis of the information, the user may verify the lines that are already set and the lines that can be additionally set and then specify the lines the user wants to add.

By doing this, the user can send a request for the increase of the number of lines after verifying the lines presently set in the key telephone apparatus BT5 and the lines that can be newly set. This enables the user to always make a accurate request for the increase of the number of lines.

(Eighth Embodiment)

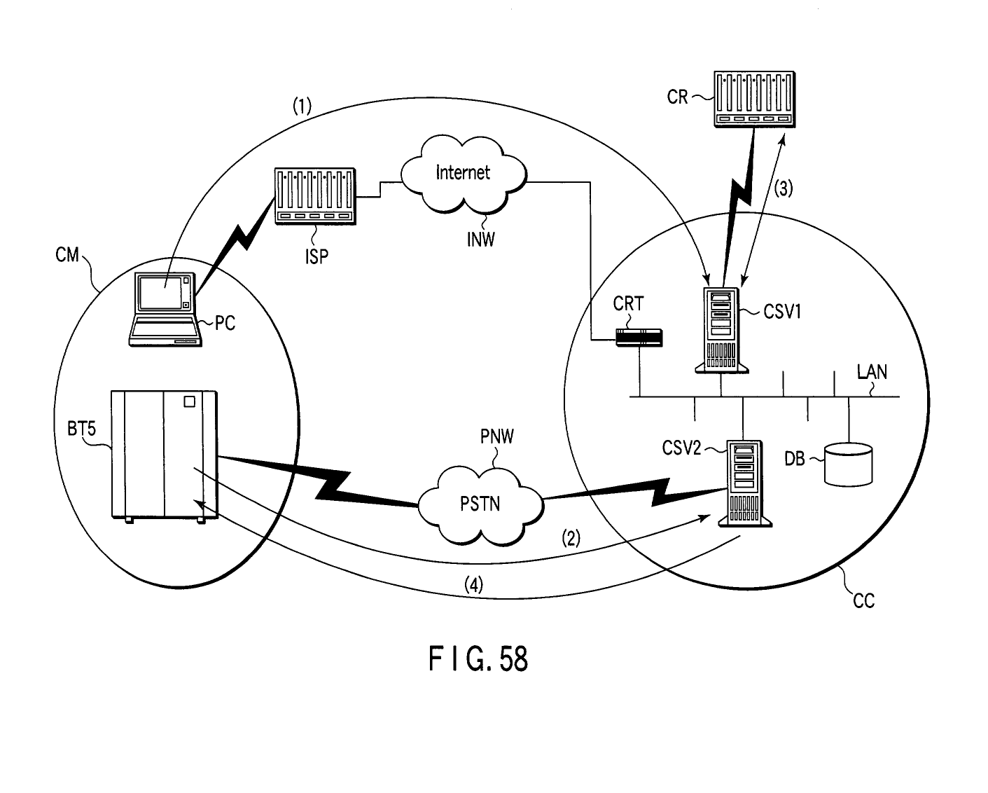

FIG. 58 schematically shows the configuration of a support system for realizing an eighth embodiment of the present invention. In FIG. 58, the same parts as those in FIG. 52 are indicated by the same reference numerals. A detailed explanation of them will not be given.

In the customer center CC, there is provided an user database DB. In the user database DB, the system ID of, line information about, and telephone number of the key telephone apparatus BT5 the user has are stored in such a manner that they are caused to correspond to an individual identification number (or user number) assigned to each user.

When a number-of-lines increase request has arrived from the user, the reception/charging server CSV1 or license server CSV2 of the customer center CC accesses the user database DB on the basis of the user ID included in the number-of-lines increase request and reads the system ID of, line information about, and telephone number of the key telephone apparatus BT5 the user has. Then, using the read-out information, the server CSV1 or CSV2 determines whether the number of lines can be increased as the user wants, accesses the key telephone apparatus BT5, and transmits a license code.

Next, the procedure for increasing the number of lines for the key telephone apparatus BT5 in the above system will be explained.

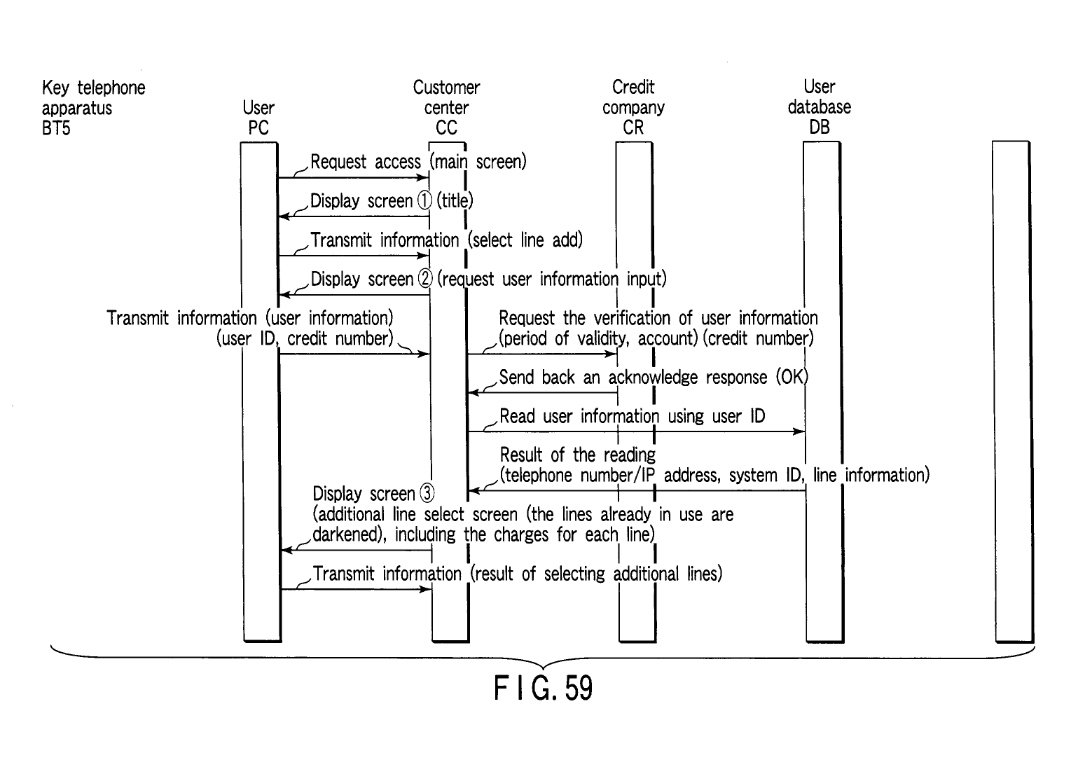

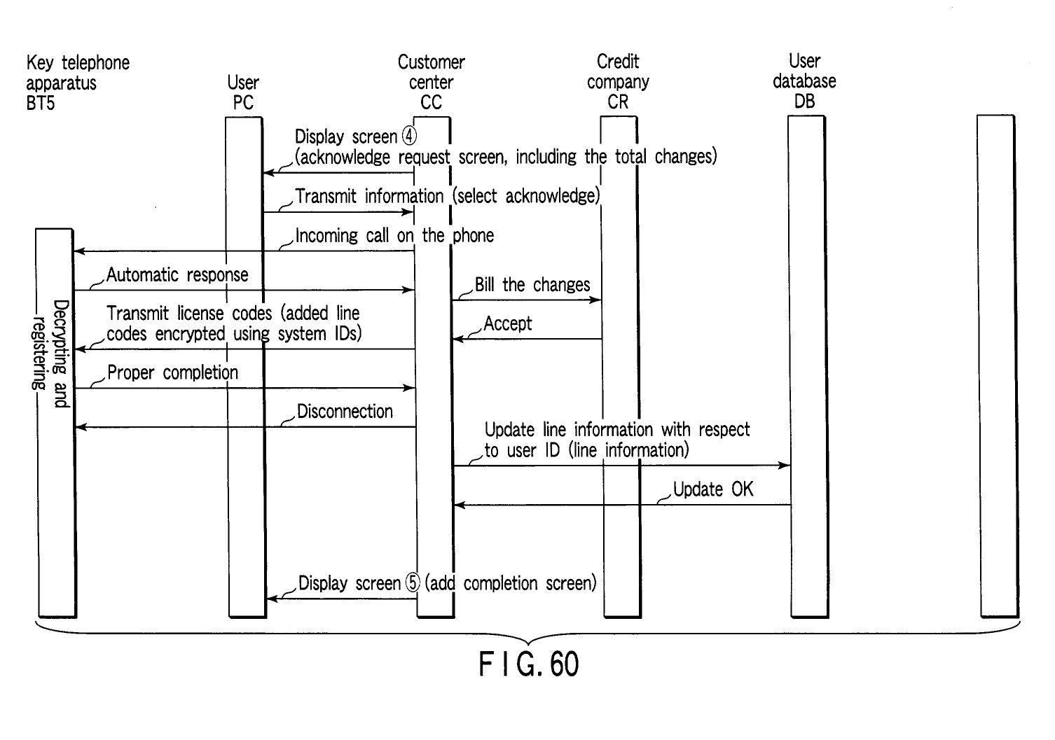

FIGS. 59 and 60 are schematic sequence diagrams to help explain the operation of transmitting and receiving signals between the maintenance personal computer PC (or user PC) of the user system CM, the customer center CC, and the credit company CR.

To increase the number of lines for the key telephone apparatus BT5, the user uses the maintenance personal computer PC to access the home page of the customer center CC by way of the Internet INW and inputs the necessary items related to the increase of the number of lines according to the guidance on the screen downloaded from the customer center CC. The necessary items to be inputted include information representing the types of lines to be added, the number of lines, the user ID, and the credit number. After finishing the input of the necessary items, the user transmits a number-of-lines increase request including those pieces of information to the customer center CC.

Receiving the number-of-lines increase request, the customer center CC accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the customer center CC.

On the basis of the reply from the credit company CR, the customer center CC judges the credit of the user. If there is no problem, the customer center CC accesses the user database DB on the basis of the user ID included in the number-of-lines increase request sent from the user and reads the system ID of, line information about, and telephone number of the key telephone apparatus BT5 the user has. Then, on the basis of the line information, the customer center CC determines whether the lines the user wants can be added. Then, the customer center CC transmits the result of the determination, the lines already usable, the lines required to be added, and the charges for the added lines to the user's maintenance personal computer PC.

Receiving the acknowledge response to the notice from the user, the customer center CC accesses the credit company CR via an exclusive line to ask the credit company CR to settle the charges for the increase of the number of lines. Then, when receiving from the credit company CR a response to the effect that the settlement request has been accepted, the customer center CC accesses the user's key telephone apparatus BT5 via the public network PNW on the basis of the telephone number read from the database DB and transmits a license code to the key telephone apparatus BT5. In the license code, an instruction code to set the line to be added “usable” is inserted. At this time, the instruction code is encrypted using the system ID read form the user database DB.

When receiving the license code from the customer center CC, the key telephone apparatus BT5 decrypts the instruction code included in the license code, using the system ID of its own apparatus. Then, according to the decrypted instruction code, the key telephone apparatus changes the flag for the corresponding line in the line information setting table from “unusable” to “usable.” When finishing the number-of-lines increase setting process, the key telephone apparatus BT5 sends back to the customer center CC information to the effect that the number-of-lines increasing process is completed properly.

When receiving a notice of the completion of the increase of the number of lines from the key telephone apparatus BT5, the customer center CC disconnects the lines with the key telephone apparatus BTS. Thereafter, the customer center CC accesses the user database DB and updates the information about the additionally set lines by setting them “usable.” Then, the customer center CC receives an update completion notice from the user database DB. Thereafter, the customer center CC transmits to the user's maintenance personal computer PC information to the effect that the number-of-line increasing process is completed and causes the computer PC to display the information.

As a result, the lines the user wants to add are set in the key telephone apparatus BT5 in such a manner that they are usable. Thereafter, in the key telephone apparatus BT5, the added lines can be used.

The configuration of each section of the support system that realizes the above-described number-of lines changing method is as follows.

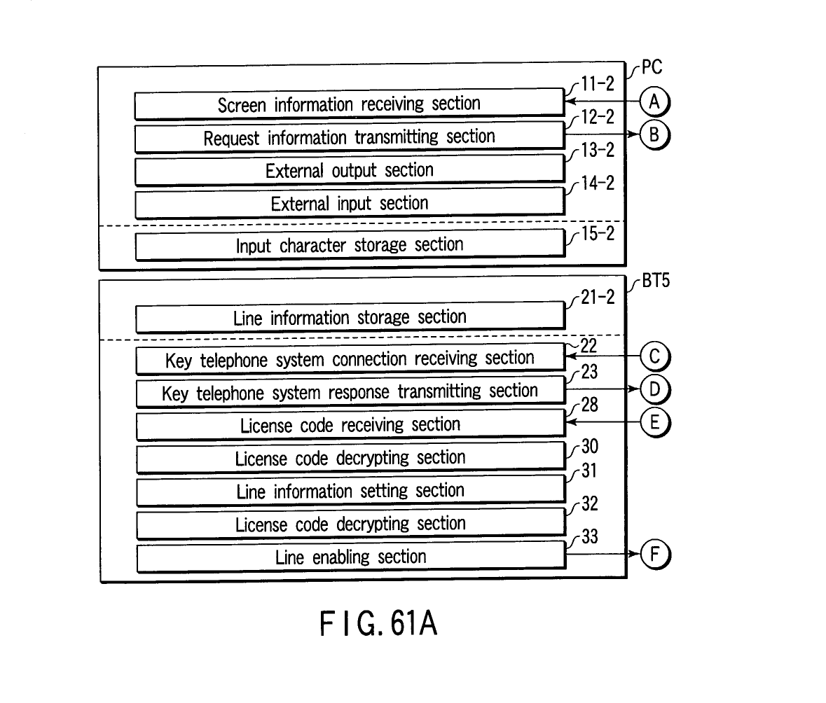

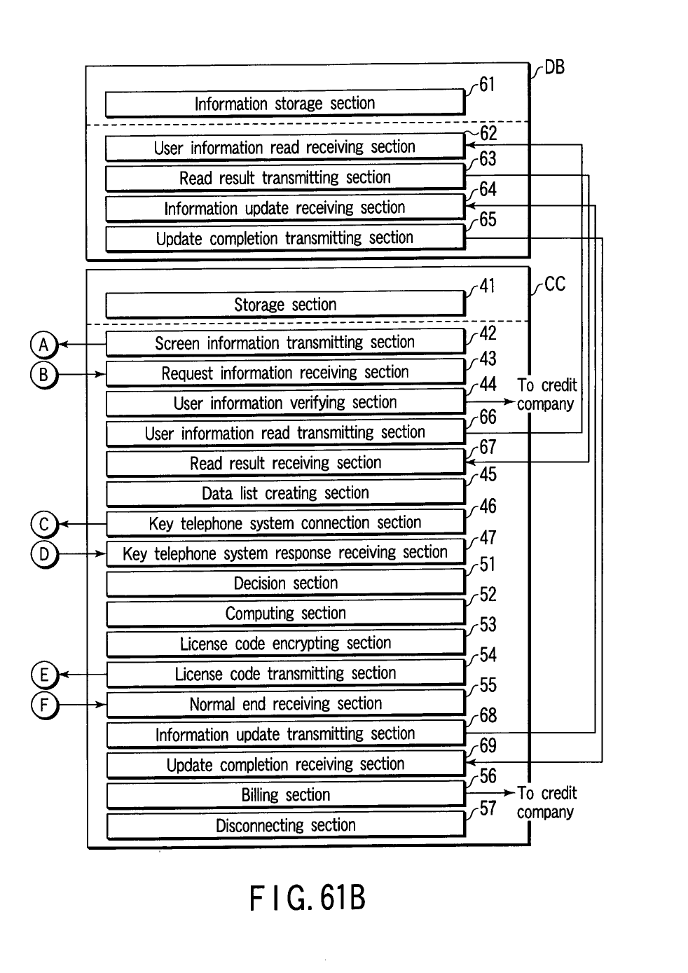

FIG. 61 is a block diagram showing a functional configuration of the maintenance personal computer PC, key telephone apparatus BT5, customer center CC, and user database DB. In FIG. 61, the same parts as those in FIG. 56 are indicated by the same reference numerals. A detailed explanation of them will not be given.

The user database DB includes an user information storage section 61-2, an user information read receiving section 62-2, a read result transmitting section 63-2, a function information update receiving section 64-2, and an update completion transmitting section 65-2.

In the user information storage section 61-2, the system ID of, line information about, and telephone number of the key telephone apparatus BT5 the user has are stored in such a manner that they are caused to correspond to the user ID unique to each user. The user information read receiving section 62-2 and read result transmitting section 63-2 read the corresponding storage information according to access by the reception/charging server CSV1 or license setting server CSV2 and send back the read-out storage information to the accessing reception/charging server CSV1 or license setting server CSV2.

When the setting of the increase of the number of lines for the key telephone apparatus BT5 is completed, the line information update receiving section 64-2 and update completion transmitting section 65-2 update the corresponding line information according to access by the license setting server CSV2. Then, the line information update receiving section 64-2 and update completion transmitting section 65-2 send back update completion to the license setting server CSV2.

The customer center CC further include an user information read transmitting section 66-2 that has the function of accessing the user database DB, a read result receiving section 67-2, a line information update transmission control section 68-2, and an update completion receiving section 69-2.

The user information read transmitting section 66-2 and read result receiving section 67-2 access the user database DB using the user ID as an address and receive the storage information read from the user database DB through the access. The line information update transmission control section 68-2 and update completion receiving section 69-2, after the setting of the increase of the number of lines for the key telephone apparatus BT5 is completed, update the storage information by giving the updated line information to the user database DB and receives the update completion notice.

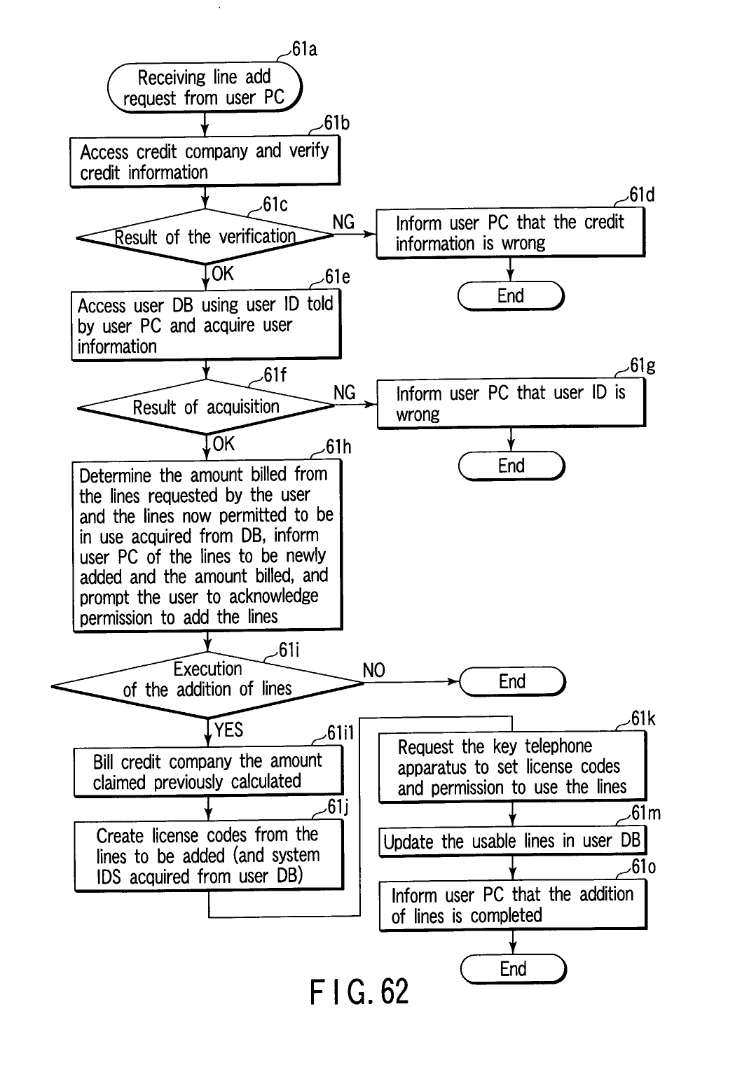

FIG. 62 is a flowchart for the operation of the customer center CC. The process of increasing the number of lines is carried out according to the procedure shown in step 61a to step 61o.

When receiving a number-of-lines increase request from the user's maintenance personal computer PC via the Internet INW in step 19a, the customer center CC accesses the credit company CR in step 61b to verify the credit information. If the credit information is invalid, the customer center CC passes control from step 61c to step 61d, where the customer center CC informs the requesting maintenance personal computer PC that the credit execute information is wrong.

On the other hand, if the credit information is valid, the customer center CC passes control from step 61c to step 61e, where the customer center CC access the user database DB on the basis of the user ID sent from the user's maintenance personal computer PC and acquires the user information. The user information includes line information about the key telephone apparatus BT5 the user has. If the user database DB cannot be accessed, the customer center CC passes control from step 61f to step 61g, where the customer center CC informs the user's maintenance personal computer PC that the user ID is wrong.

Next, the customer center CC, in step 61h, calculates the amount billed on the basis of the lines required by the user and the line information read from the user database DB, informs the user's maintenance personal computer PC of the names of the newly added lines and the amount billed, and inquires whether to execute the addition of the functions. When the user transmits an execute request in response to the inquiry, the customer center CC passes control from step 61i to 61il, where the center CC transmits to the credit company CR settlement request information about the amount billed previously calculated. Then, when receiving from the credit company CR a reply to the effect that the settlement request has been accepted, the customer center CC passes control to step 61j, where the customer center CC creates a license code on the basis of the added lines and the system ID of the key telephone apparatus BT5. In step 61k, the customer center CC transmits to the key telephone apparatus BT5 the license code and a request to set the lines usable.

Then, when the setting of the addition of lines is completed in the key telephone apparatus BT5, the customer center CC, in step 61o, informs the requesting user's maintenance personal computer PC that the addition of the lines is completed.

On the other hand, when receiving the title screen, user information input screen, verify request screen, add completion screen, user information reenter screen, and function adding process NG from the customer center CC in the middle of the number-of-lines increasing process, the user's maintenance personal computer PC executes the same procedure for processing as in FIGS. 10 and 11 of the first embodiment.

As described above, according to the number-of-lines changing method of the eighth embodiment, a series of processes ranging from the user requesting the increase of the number of lines to the number-of-lines increasing process at the user's key telephone apparatus BT5 is performed automatically via a communication network without human intervention as in the seventh embodiment. This enables the time required to increase the number of lines to be shortened, the expenses the user pays to be reduced, and the labor and cost needed to change the number of lines at the customer center CC to be reduced remarkably.

Since it is determined whether the number of lines can be increased, on the basis of line information about the key telephone apparatus BT5, the number-of-lines increasing process can be carried out properly for each key telephone apparatus BT5. In addition, since the license code is encrypted using the system ID of the key telephone apparatus BT5 and transferred to the key telephone apparatus BT5, it is possible to prevent the number of lines from being increased wrongly or illegally.

Furthermore, in the eighth embodiment, it is determined whether the communication between the customer center CC and the key telephone apparatus BT5 can be performed or whether the number of lines can be changed, on the basis of the user information accumulated and managed in the user database DB. This makes it unnecessary to acquire information about lines from the key telephone apparatus BT5 each time the user uses the telephone apparatus. As a result, a suitable number-of-lines changing process can be carried out according to a simple procedure.

Moreover, after the process of adding lines to the key telephone apparatus BT5 is completed, the customer center CC updates the corresponding line information in the user database DB. This makes it possible to always update the accumulated management information in the user database DB to the latest one automatically without the maintenance man in charge at the customer center carrying out the updating process manually.

(Ninth Embodiment)

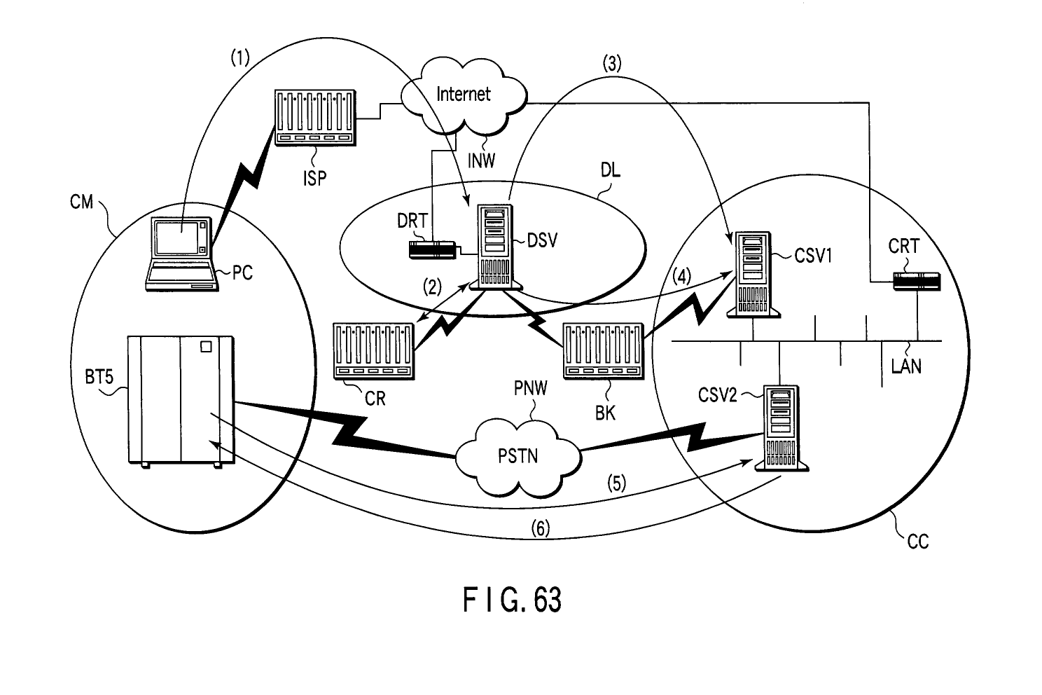

FIG. 63 schematically shows the configuration of a support system that carries out a number-of-lines changing method according to a ninth embodiment of the present invention. In FIG. 63, the same parts as those in FIG. 52 are indicated by the same reference numerals. A detailed explanation of them will not be given.

In the support system of the ninth embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a number-of-lines increasing process with the maintenance personal computer PC and customer center CC.

Furthermore, the reception/charging/notifying server DSV is connected via an exclusive line to the credit company CR or the bank BK. The server DSV inquires of the credit company CR or bank BK the credit of the user and bills the agent's commission for increasing the number of lines.

Next, the procedure for increasing the number of lines for the key telephone apparatus BT5 in the above system will be explained.

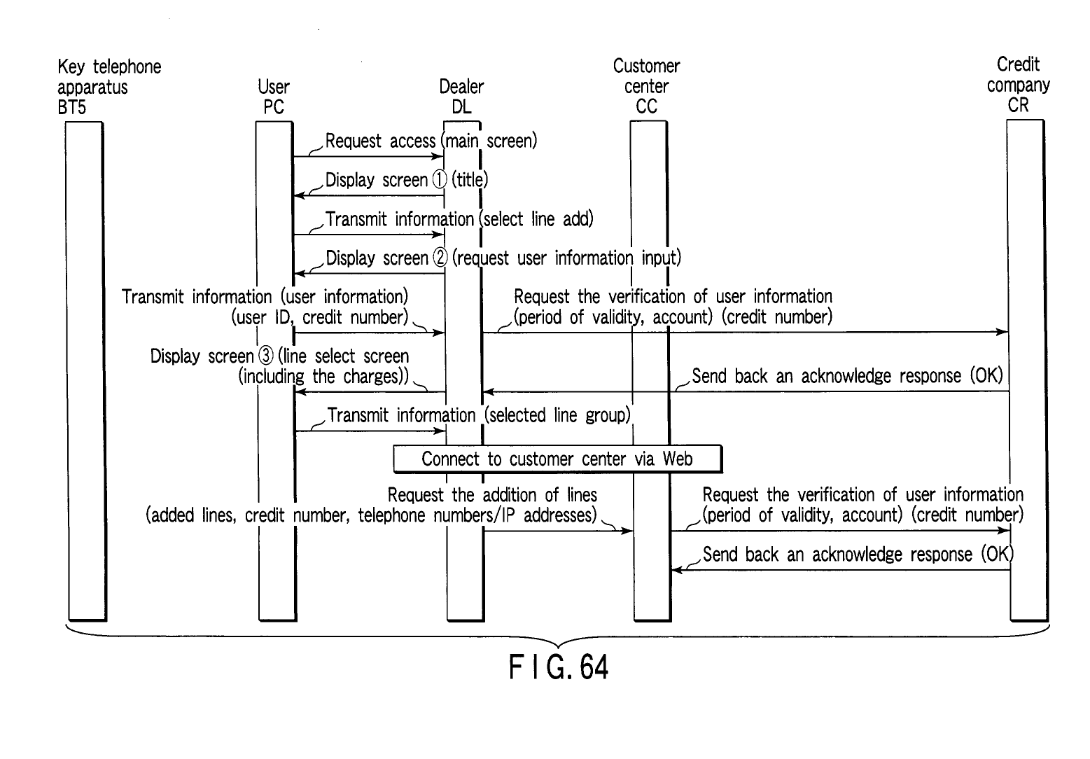

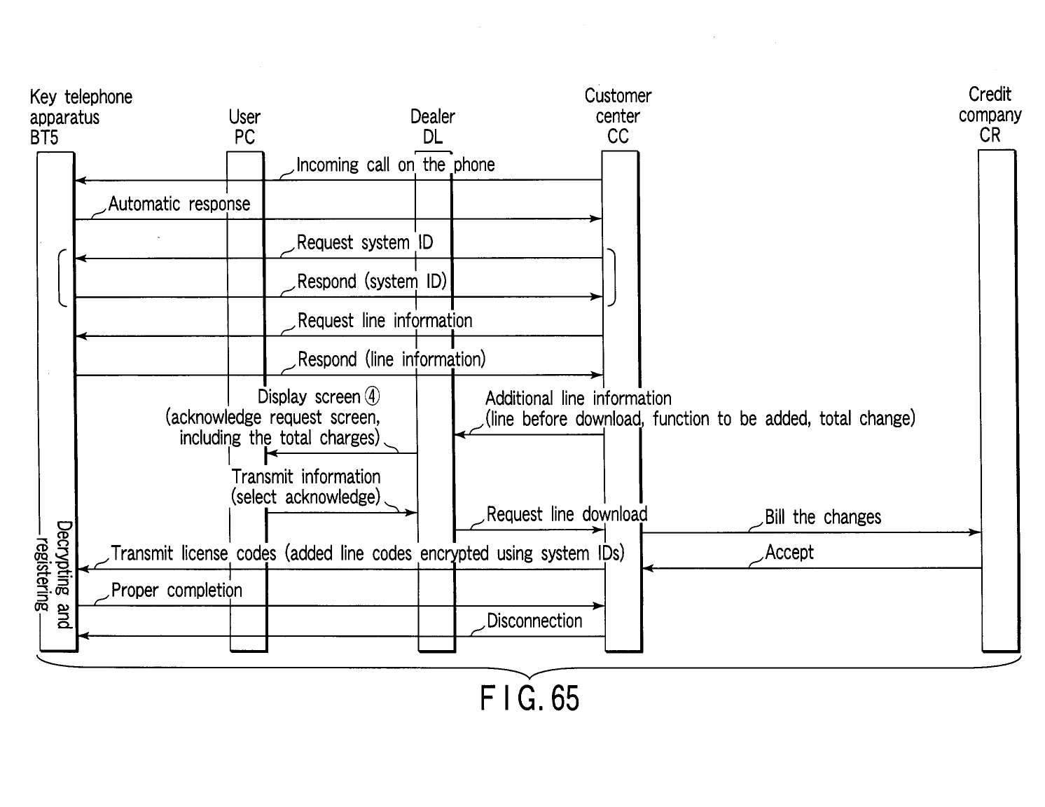

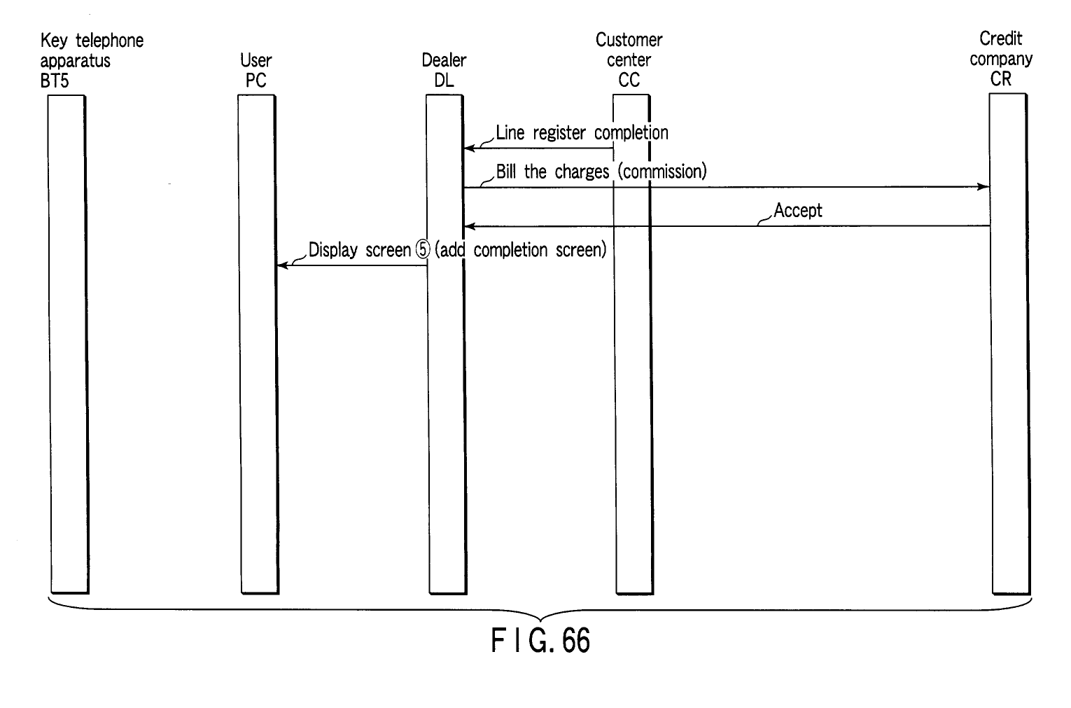

FIGS. 64 to 66 are schematic sequence diagrams to help explain the operation of transmitting and receiving signals between the maintenance personal computer PC (or user PC) of the user system CM, the dealer DL, the customer center CC, and the credit company CR.

To increase the number of lines for the key telephone apparatus BT5, the user uses the maintenance personal computer PC to access the home page of the dealer DL by way of the Internet INW and inputs the necessary items related to the increase of the number of lines according to the guidance on the screen downloaded from the dealer DL. The necessary items to be inputted include information representing the names of the lines to be added and the number of lines, the user's credit number, and the telephone number or IP address allocated by the public network PNW to the key telephone apparatus BT5. After finishing the input of the necessary items, the user transmits a number-of-lines increase request including those pieces of information to the dealer DL.

Receiving the number-of-lines increase request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the number-of-lines increase request sent from the user to the customer center CC by way of the Internet INW.

Receiving the number-of-lines increase request, the customer center CC itself accesses the credit company CR to inquire about the credit of the user. If there is no problem, the customer center CC accesses the user's key telephone apparatus BT5 via the public network PNW on the basis of the telephone number included in the number-of-lines increase request and acquires the line information and system ID from the key telephone apparatus BT5. The customer center CC determines on the basis of the acquired line information whether the lines the user wants to add are already in use and, if they are not in use, whether they can be added.

Then, on the basis of the result of the determination, the customer center CC informs the dealer DL by way of the Internet INW of a list of the lines already in use and the addable lines and a table of the charges for increasing the number of lines. The dealer DL transfers the notified line list and the list of charges to the user's maintenance personal computer PC by way of the Internet INW. When receiving an acknowledge response from the user to the line list and the list of charges, the dealer DL transmits a line download request to the customer center CC.

When receiving the line download request from the dealer DL, the customer center CC accesses the credit company CR to ask the company CR to pay the charges for the added lines. Then, receiving from the credit company CR a reply to the effect that the settlement request has been accepted, the customer center CC transmits the license code to the user's key telephone apparatus BT5 via the public network PNW. In the license code, an instruction code for setting the line to be added “usable” is inserted. At this time, the instruction code is encrypted using the system ID previously acquired from the key telephone apparatus BT5.

When receiving the license code from the customer center CC, the key telephone apparatus BT5 decrypts the instruction code included in the license code, using the system ID of its own apparatus. Then, according to the decrypted instruction code, the key telephone apparatus changes the flag for the corresponding line in the line information setting table from “unusable” to “usable.” When finishing the process of increasing the number of lines, the key telephone apparatus BT5 sends back to the customer center CC information to the effect that the number-of-lines increasing process is completed properly.

When receiving a notice of the completion of the increase of the number of lines from the key telephone apparatus BT5, the customer center CC disconnects the lines with the key telephone apparatus BT5 and informs the dealer DL of the completion of the number-of-lines increasing process. Receiving the notice of the completion of the process, the dealer DL asks the credit company CR to pay the agent's commission.

As a result, the lines the user wants to add are set in the key telephone apparatus BT5 in such a manner that they are usable. Thereafter, in the user's key telephone apparatus BT5, the added lines can be used.

The customer center CC's request to the credit company CR for a credit check of the user may be omitted. Instead of the customer center CC, the dealer DL may charge the expenses. Furthermore, the bank BK may settle the expenses in place of the credit company CR.

The configuration of each section of the support system that carries out the above-described number-of-lines changing method is as follows.

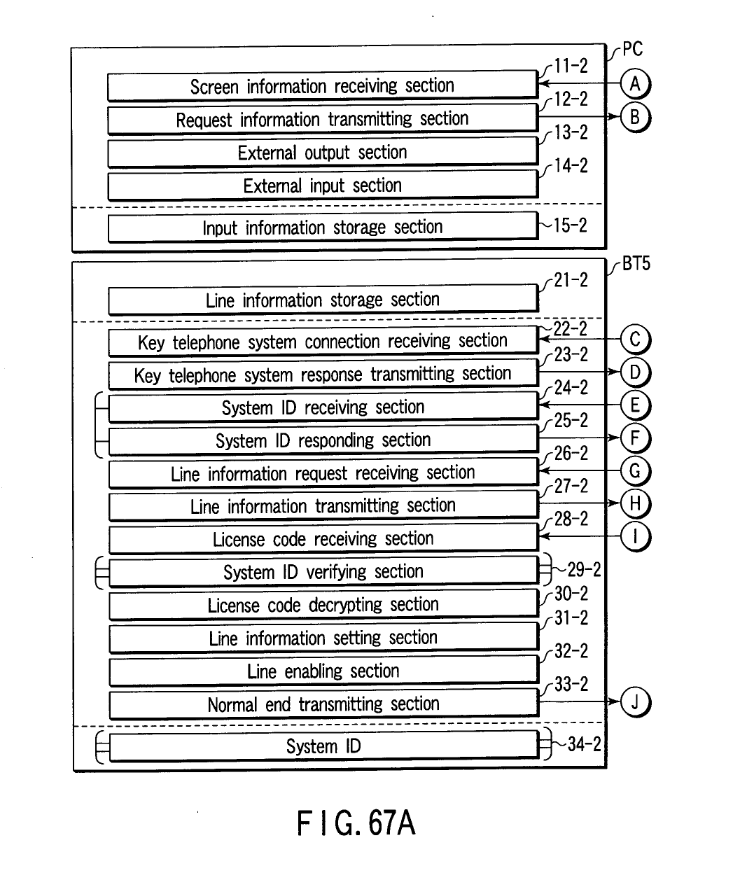

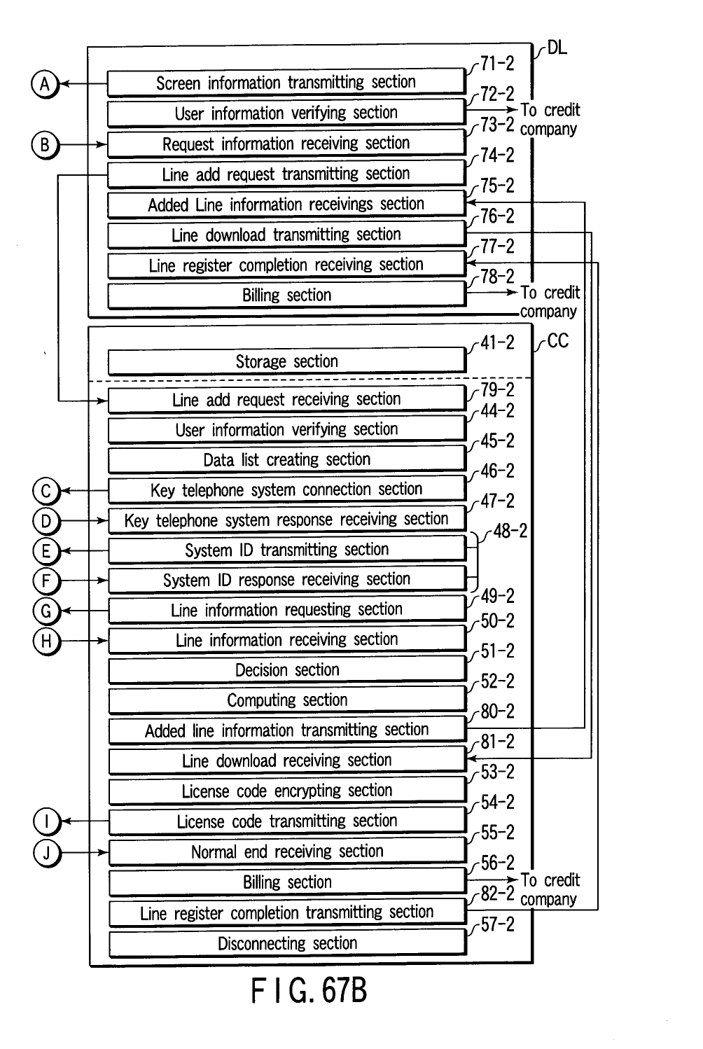

FIG. 67 is a block diagram showing a functional configuration of the maintenance personal computer PC, key telephone apparatus BT5, dealer DL, and customer center CC. In FIG. 67, the same parts as those in FIG. 56 are indicated by the same reference numerals. A detailed explanation of them will not be given.

The dealer DL includes a screen information transmitting section 71-2, an user information verifying section 72-2, a request information receiving section 73-2, a number-of-lines increase request transmitting section 74-2, an added line information receiving section 75-2, a line download transmitting section 76-2, a line register completion receiving section 77-2, and a billing section 78-2.

The screen information transmitting section 71-2, when being accessed by the user's maintenance personal computer PC, transmits a series of pieces of screen information for a number-of-lines increase request to the maintenance personal computer PC. The user information verify section 72-2 accesses the credit company CR on the basis of the credit number included in the received number-of-lines increase request information and inquires about the credit of the user. The request information receiving section 73-2 receives the number-of-lines increase request information sent from the maintenance personal computer PC.

The number-of-lines increase request transmitting section 74-2 transfers the number-of-lines increase request information coming from the user's maintenance personal computer PC to the customer center CC. The added line information receiving section 75-2 receives the added line notice information sent from the customer center CC and transfers this information to the requesting user's maintenance personal computer PC. When the maintenance personal computer PC sends back an acknowledge reply in response to the transfer of the added line notice information, the line download transmitting section 76-2 transmits a line download request to the customer center CC.

The line register completion receiving section 77-2 receives the line register completion notice sent from the customer center CC. After receiving the line register completion notice, the billing section 78-2 asks the credit company CR to bill the charges for the increase of the number of lines.

The customer center CC includes as means for transmitting and receiving information to and from the dealer DL a number-of-lines increase request receiving section 79-2, an added line information transmitting section 80-2, a line download receiving section 81-2, and a line register completion transmitting section 82-2.

The number-of-lines increase request receiving section 79-2 receives the number-of-lines increase request information sent from the dealer DL. The added line information transmitting section 80-2 sends the line information acquired from the key telephone apparatus BT5 to the dealer DL. When the dealer DL sends a line download request, the line download receiving section 81-2 receives this request and starts a line downloading process, or a license code transmitting process to the key telephone apparatus BT5. The line register completion transmitting section 82-2 transmits a line register completion notice to the dealer DL after the lines have been downloaded to the key telephone apparatus BT5 and the credit company CR has been asked to bill the charges.

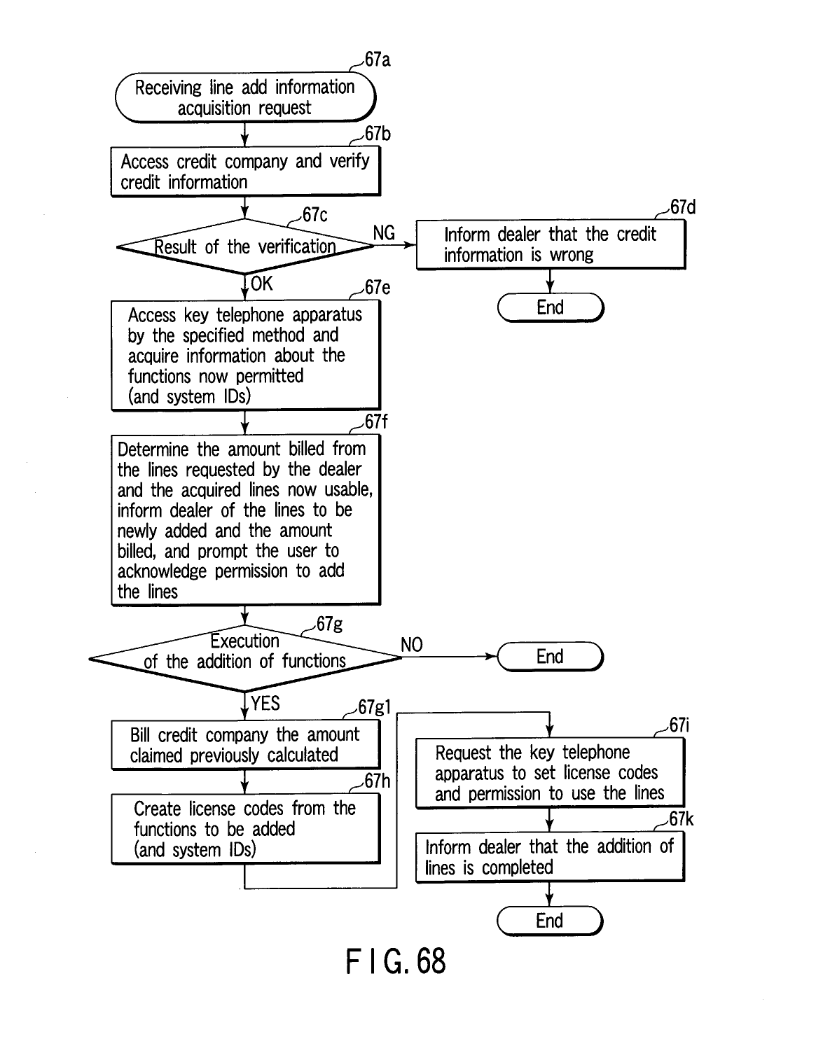

FIG. 68 is a flowchart for the operation of the customer center CC. The process of increasing the number of lines is carried out according to the procedure shown in step 67a to step 67k.

When receiving the user's number-of-lines increase request from the dealer DL via the Internet INW in step 67a, the customer center CC accesses the credit company CR in step 67b to verify the credit information. If the credit information is invalid, the customer center CC passes control from step 67c to step 67d, where the customer center CC informs the requesting maintenance personal computer PC that the credit execute information is wrong.

On the other hand, if the credit information is valid, the customer center CC passes control from step 67c to step 67e, where the customer center CC accesses the user's key telephone apparatus BT5 using the telephone number or mail address of the key telephone apparatus BT5 sent from the user and acquires information about the lines allowed to be used now and the system ID from the key telephone apparatus BT5.

Next, the customer center CC, in step 67f, calculates the amount billed on the basis of the lines required by the dealer DL and the line information acquired from the key telephone apparatus BT5, informs the dealer DL of the names of the newly added lines and the amount billed, and inquires whether to execute the addition of the lines. When the dealer DL transmits an execute request in response to the inquiry, the customer center CC passes control from step 67g to 67gl, where the center CC transmits settlement request information about the amount billed previously calculated to the credit company CR. When receiving from the credit company CR a reply to the effect that the company CR has accepted the settlement request, the customer center passes control to step 67h, where the center CC creates a license code for the key telephone apparatus BT5 on the basis of the added lines and the system ID of the key telephone apparatus BT5 and, in step 67i, sends to the key telephone apparatus BT5 a request for setting use of the license code and lines possible.

Then, after the setting of the addition of lines is completed in the key telephone apparatus BT5, the customer center CC, in step 67k, informs the requesting user's maintenance personal computer PC that the addition of the lines is completed.

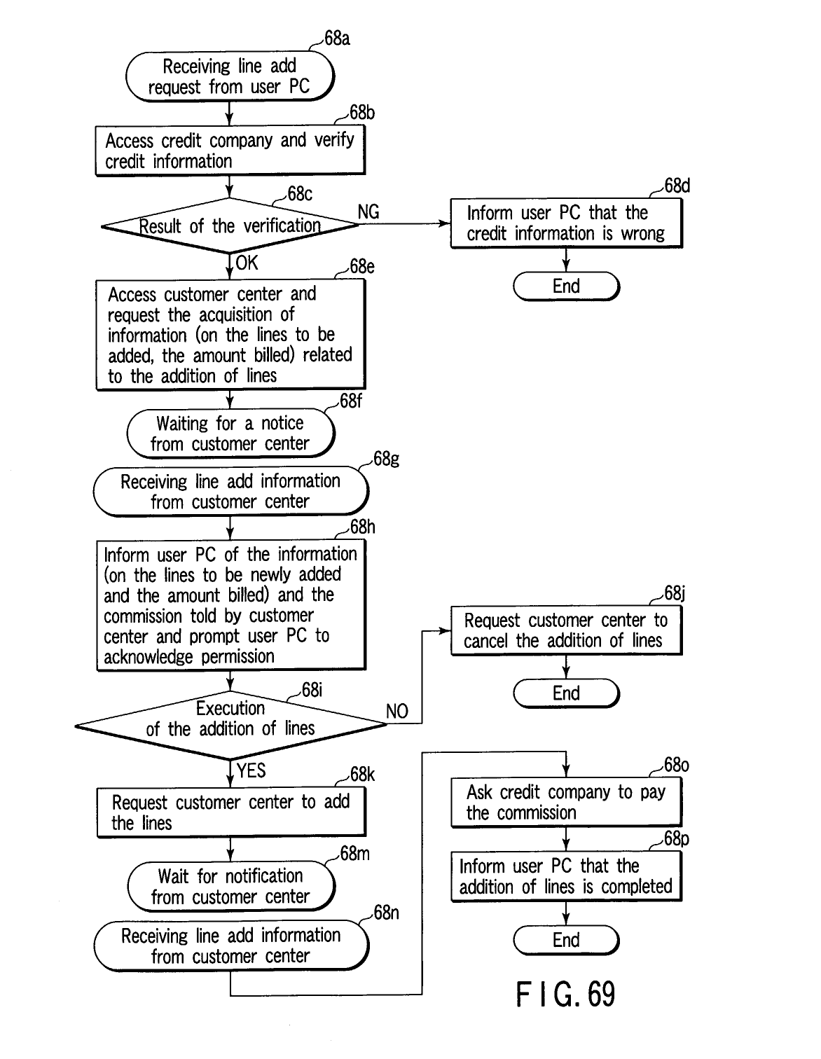

On the other hand, FIG. 69 is a flowchart for the processing operation at the dealer DL. A series of processing operations for increasing the number of lines is carried out according to the procedure shown in step 68a to step 68p.

When receiving a number-of-lines increase request from the user's maintenance personal computer PC via the Internet INW in step 68a, the dealer DL accesses the credit company CR in step 68b to verify the credit information. If the credit information is invalid, the dealer DL passes control from step 68c to step 68d, where the dealer DL informs the requesting maintenance personal computer PC that the credit execute information is wrong.

On the other hand, if the credit information is valid, the dealer DL passes control from step 68c to step 68e, where the dealer DL accesses the customer center CC and requests information about the increase of the number of lines, that is, the lines to be added and the charges. Then, in step 68f, the dealer DL waits for a notice from the customer center CC.

In this state, when receiving the number-of-lines increase information from the customer center CC, the dealer DL passes control from step 68g to step 68h, where the dealer DL informs the user's maintenance personal computer PC of the number-of-lines increase information notified by the customer center CC, that is, the names of the lines to be added and the amount billed for the lines. Then, the dealer DL inquires whether to execute the addition of the lines. When the user transmits an execute request in response to the inquiry, the dealer DL passes control from step 68i to 68k, where the dealer DL transmits a number-of-lines increase execute request to the customer center CC. Then, in step 68m, the dealer DL waits for a notice from the customer center CC. When the user transmits a number-of-lines increase cancel request, the dealer DL passes control from step 68i to step 68j, where the dealer DL informs the customer center CC of the cancellation of the increase of the number of lines.

When receiving the number-of-lines increase information from the customer center cc, the dealer DL receives the information in step 68n and passes control to step 68o, where the dealer DL transmits to the credit company CR the settlement request information about the amount billed previously calculated. When receiving from the credit company CR a reply to the effect that the company CR has accepted the settlement request, the dealer DL, in step 68p, informs the requesting user's maintenance personal computer PC that the addition of lines is completed.

The procedure for the maintenance personal computer PC making an access request for the main page and the procedure for receiving the user information are the same as the procedure for processing at the customer center CC of the seventh embodiment.

The procedure for processing at the maintenance personal computer PC when receiving the title screen, user information input request screen, function select screen, acknowledge request screen, add completion screen, user information reenter request screen, and function adding process NG screen is the same as the procedure for processing at the maintenance personal computer PC when receiving a display screen sent from the customer center CC in the seventh embodiment. Moreover, the procedure for processing at the key telephone apparatus BT5 and the procedure for processing at the credit company are the same as those in the seventh embodiment.

As described above, according to the number-of-lines changing method of the ninth embodiment, a series of processes ranging from the user's request for the change of the number of lines to the increase of the number of lines for the user's key telephone apparatus BTS is performed automatically via a communication network without human intervention, with the dealer DL intervening between the user and the customer center CC. This enables the time required to increase the number of lines to be shortened, the expenses the user pays to be reduced, and the labor and costs needed to change the number of lines at the dealer DL or the customer center CC to be reduced remarkably.

Since it is determined whether the number of lines can be increased, on the basis of line information acquired from the key telephone apparatus BT5 for which the number of lines is to be changed, the number-of-lines increasing process can be carried out properly for each key telephone apparatus BT5. In addition, since the license code is encrypted using the system ID of the key telephone apparatus BT5 and sent to the key telephone apparatus BT5, it is possible to prevent the number of lines from being increased wrongly or illegally.

(Tenth Embodiment)

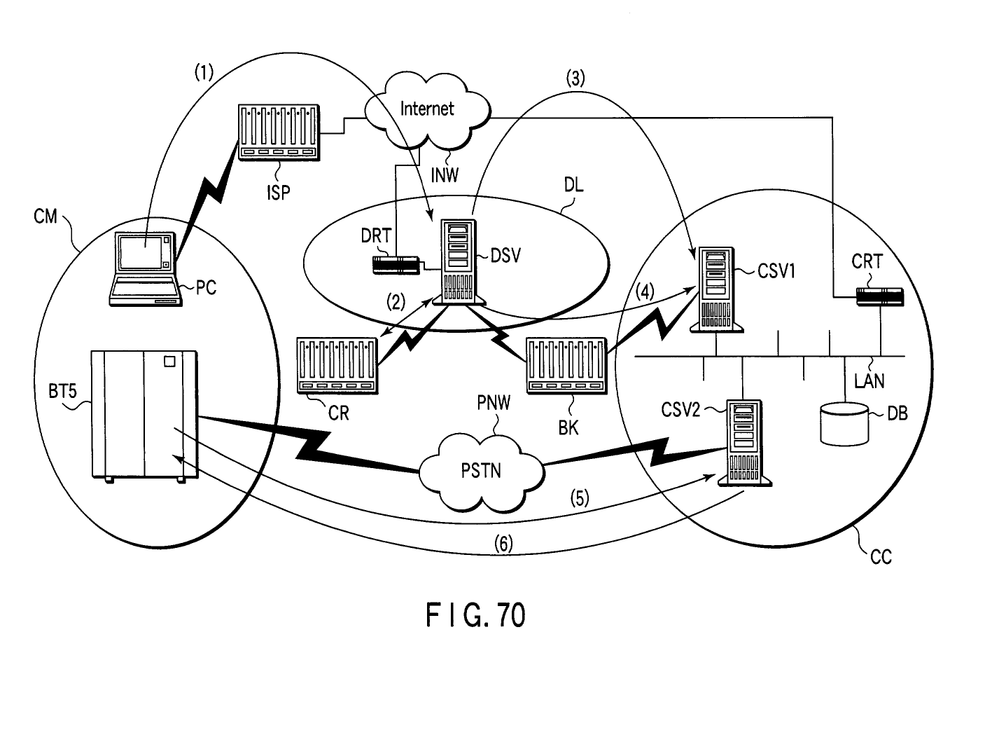

FIG. 70 schematically shows the configuration of a support system that carries out a number-of-lines changing method according to a tenth embodiment of the present invention. In FIG. 70, the same parts as those in FIGS. 58 and 63 are indicated by the same reference numerals.

In the support system of the tenth embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a number-of-lines increasing process with the maintenance personal computer PC and customer center CC.

Furthermore, the reception/charging/notifying server DSV is connected via an exclusive line to the credit company CR or the bank BK. The server DSV inquires the credit of the user from the credit company CR or bank BK and bills the agent's commission for increasing the number of lines.

On the other hand, in the customer center CC, there is provided an user database DB. In the user database DB, the system ID of, line information about, and telephone number of the key telephone apparatus BT5 the user has are stored in such a manner that they are caused to correspond to the user ID uniquely assigned to each user.

When a number-of-lines increase request has been transferred from the dealer DL, the reception/charging server CSV1 or license server CSV2 of the customer center CC accesses the user database DB on the basis of the user ID included in the number-of-lines increase request and reads the systems ID of, function information about, and telephone number of the key telephone apparatus BT5 the user has. Then, using the read-out information, the server CSV1 or CSV2 determines whether the number of lines the user wants can be increased, accesses the key telephone apparatus BT5, and transmits a license code.

Next, the procedure for increasing the number of liens for the key telephone apparatus BT5 in the above system will be explained.

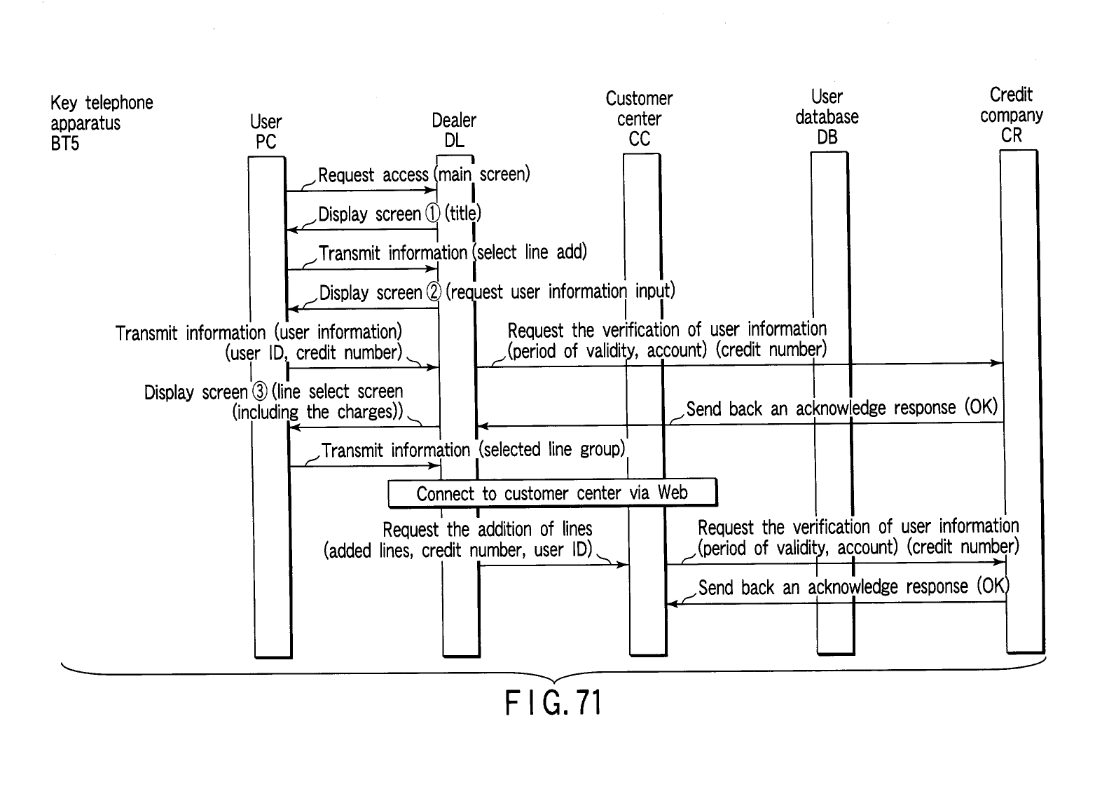

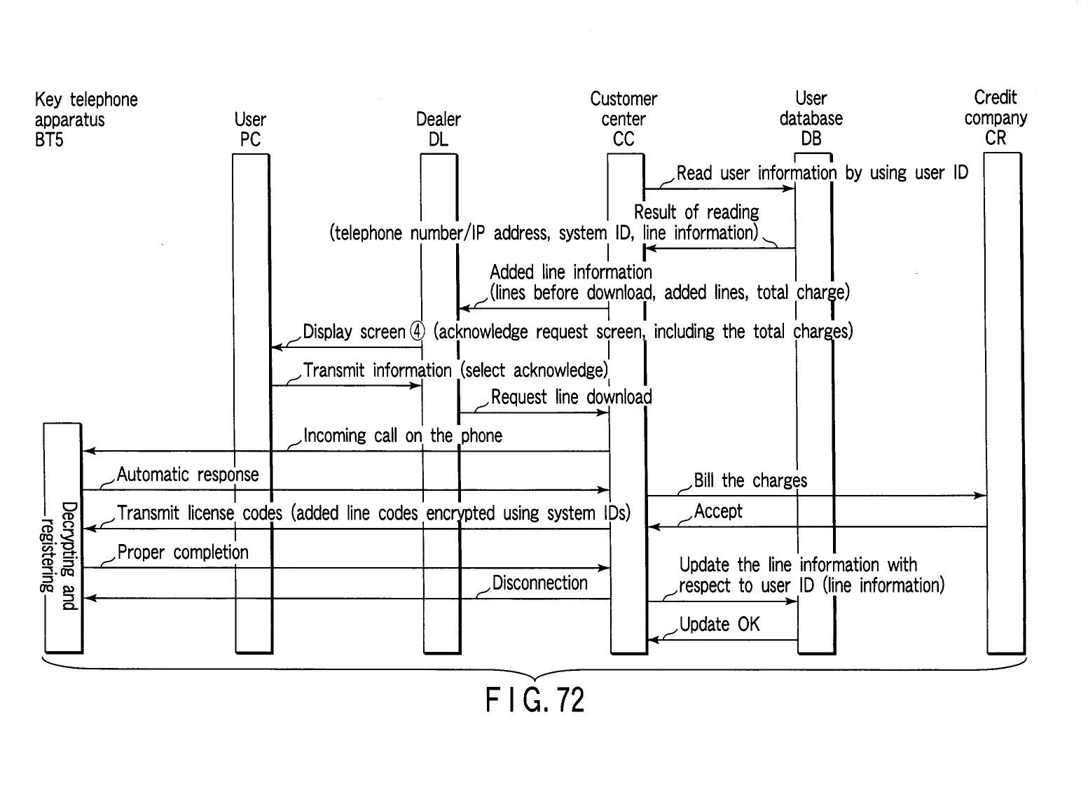

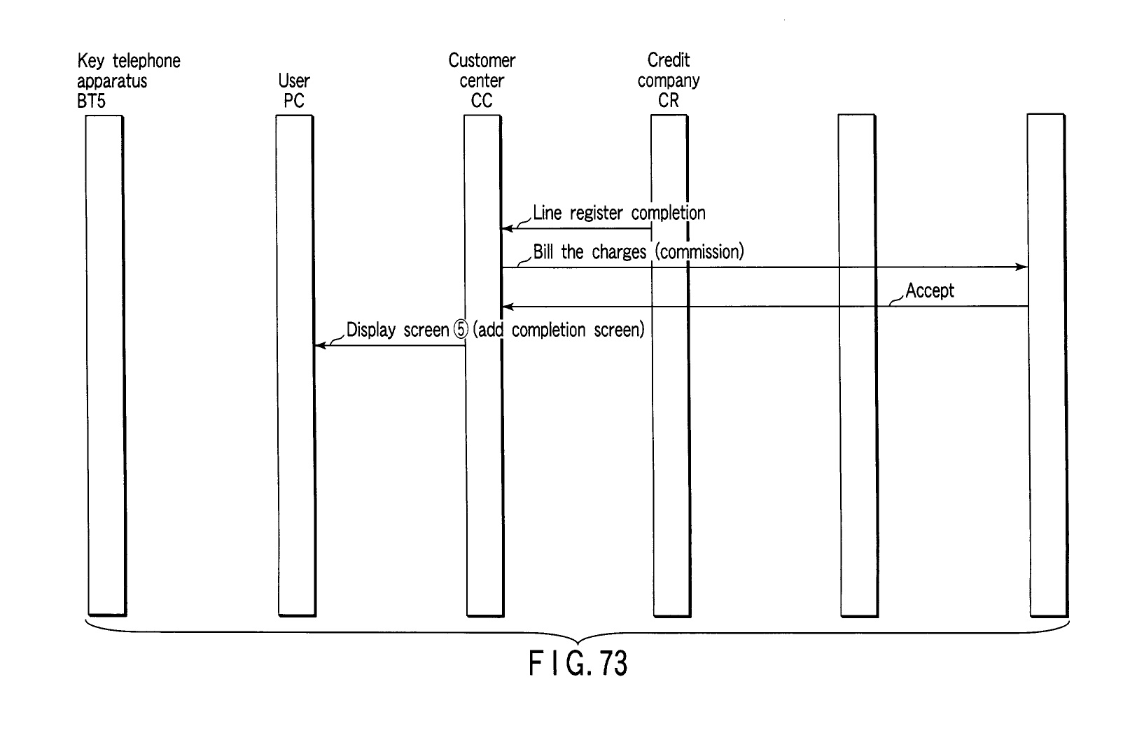

FIGS. 71 to 73 are schematic sequence diagrams to help explain the operation of transmitting and receiving signals between the maintenance personal computer PC (or user PC) of the user system CM, the dealer DL, the customer center CC, and the credit company CR.

To increase the number of lines for the key telephone apparatus BT5, the user uses the maintenance personal computer PC to access the home page of the dealer DL by way of the Internet INW and inputs the necessary items related to the increase of the number of lines according to the guidance on the screen downloaded from the dealer DL. The necessary items to be inputted include information representing the lines to be added, the user ID, and the credit number. After finishing the input of the necessary items, the user transmits a number-of-lines increase request including those pieces of information to the dealer DL.

Receiving the number-of-lines increase request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the number-of-lines increase request sent from the user to the customer center CC by way of the Internet INW.

Receiving the number-of-lines increase request, the customer center CC itself accesses the credit company CR to inquire about the credit of the user. If there is no problem, the customer center CC accesses the user database DB on the basis of the user ID included in the number-of-lines increase request and reads the system ID of, line information about, and telephone number of the telephone apparatus BT5 the user has.

Next, on the basis of the read-out line information, the customer center CC determines whether the lines the user wants can be added, and, on the basis of the result of the determination, informs the dealer DL via the Internet INW of a list of the lines already in use and the addable lines and a list of the charges for increasing the number of lines. The dealer DL transfers the notified line list and the list of the charges to the user's maintenance personal computer PC by way of the Internet INW. Receiving an acknowledge response to a notice of the line list and the list of charges from the user, the dealer DL transmits a line download request to the customer center CC.

When receiving the line download request from the dealer DL, the customer center CC not only calls up the user's key telephone apparatus BT5 via the public network PNW on the basis of the telephone number of the key telephone apparatus BT5 read from the user database DB but also accesses the credit company CR to ask the company CR to pay the charges for the added lines. Then, receiving from the credit company CR a reply to the effect that the settlement request has been accepted, the customer center CC transmits a license code to the key telephone apparatus BT5. In the license code, an instruction code for setting the lines to be added “usable” is inserted. At this time, the instruction code is encrypted using the system ID of the key telephone apparatus BT5 previously read from the user database DB.

When receiving the license code from the customer center CC, the key telephone apparatus BT5 decrypts the instruction code included in the license code, using the system ID of its own apparatus. Then, according to the decrypted instruction code, the key telephone apparatus changes the flag for the corresponding line in the line information setting table from “unusable” to “usable.” When finishing the process of setting the increase of the number of lines, the key telephone apparatus BTS sends back to the customer center CC information to the effect that the number-of-lines increasing process is completed properly.

When receiving a notice of the completion of the increase of the number of lines from the key telephone apparatus BT5, the customer center CC disconnects the lines with the key telephone apparatus BT5 and informs the dealer DL of the completion of the number-of-lines increasing process. Receiving the notice of the completion of the process, the dealer DL asks the credit company CR to pay the agent's commission.

As a result, the lines the user wants to add are set in the key telephone apparatus BT5 in such a manner that they are usable. Thereafter, in the user's key telephone apparatus BT5, the added lines can be used.

As described in the ninth embodiment, the customer center CC's request to the credit company CR for a credit check of the user may be omitted. Instead of the customer center CC, the dealer DL may charge the expenses. Furthermore, the bank BK may settle the expenses in place of the credit company CR.

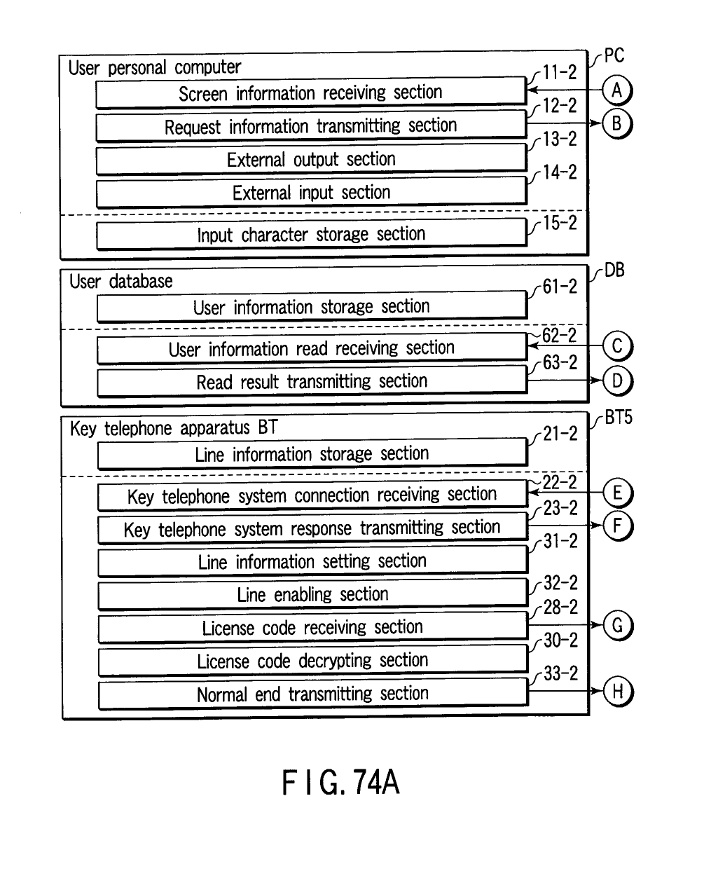

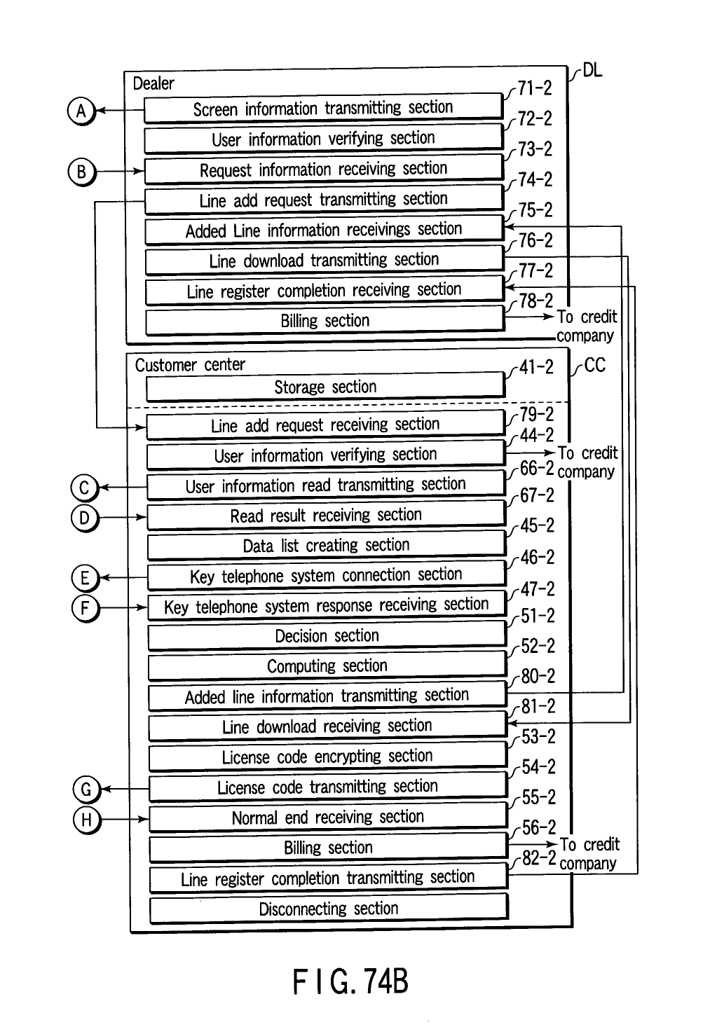

The configuration of each section of the support system that carries out the above-described number-of-lines changing method is as shown in, for example, FIG. 74. Since the functional configuration shown in FIG. 74 is the same as those in FIGS. 61 and 67 in the eight and ninth embodiments, its explanation will be omitted.

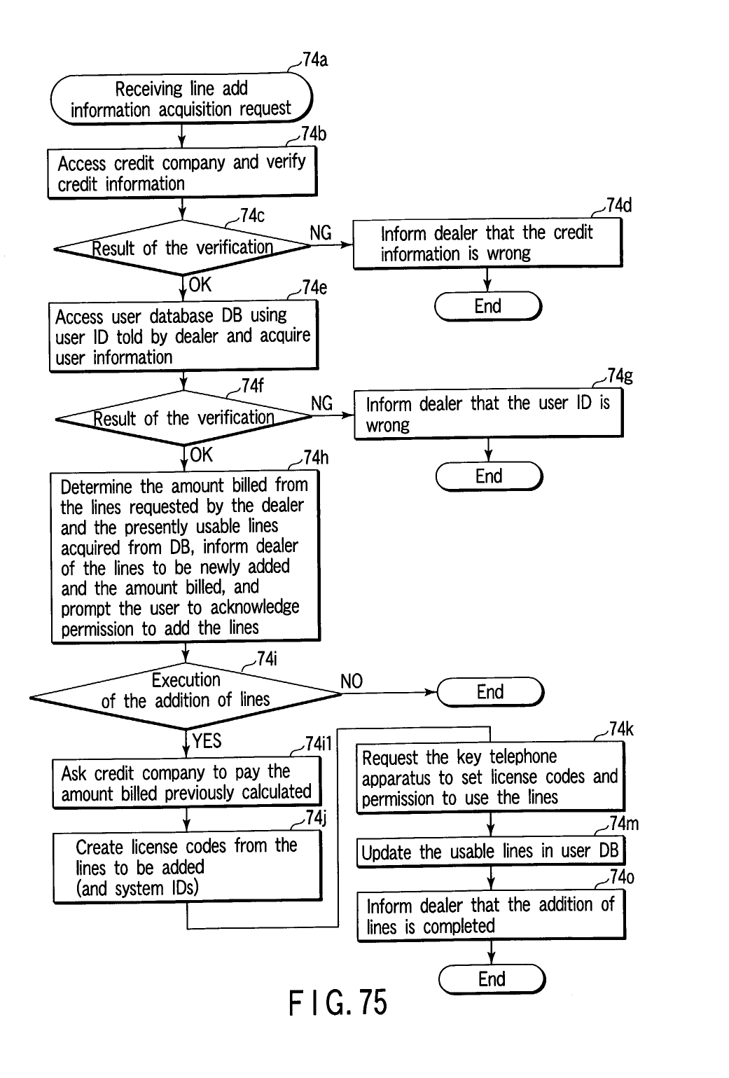

FIG. 75 is a flowchart for the operation of the customer center CC. The process of increasing the number of lines is carried out according to the procedure shown in step 74a to step 74o.

When receiving the user's number-of-lines increase request from the dealer DL via the Internet INW in step 32a, the customer center CC accesses the credit company CR in step 74b to verify the credit information. If the credit information is invalid, the customer center CC passes control from step 74c to step 74d, where the customer center CC informs the dealer DL that the credit execute information is wrong. On the other hand, if the credit information is valid, the customer center CC passes control from step 74c to step 74e, where the customer center CC accesses the user database DB on the basis of the user ID sent from the dealer DL and acquires user information. The user information includes line information about the key telephone apparatus BT5 the user has. If the user database DB cannot be accessed, the customer center CC passes control from step 74f to step 74g, where the customer center CC informs the dealer that the user ID is wrong.

Next, the customer center CC, in step 74h, calculates the amount billed, on the basis of the lines required by the dealer DL and the line information read from the user database DB, informs the dealer DL of the names of the newly added lines and the amount billed, and inquires whether to execute the addition of the lines. When the dealer DL transmits an execute request in response to the inquiry, the customer center CC passes control from step 74i to 74il, where the center CC transmits settlement request information about the amount billed previously calculated to the credit company CR. When receiving from the credit company CR a reply to the effect that the company CR has accepted the settlement request, the customer center passes control to step 74j, where the center CC creates a license code for the key telephone apparatus BT5 on the basis of the added lines and the system ID of the key telephone apparatus BT5 and, in step 74k, sends to the key telephone apparatus BTS a request for setting use of the license code and lines possible.

Then, after the setting of the addition of lines is completed in the key telephone apparatus BT5, the customer center CC, in step 74m, updates the line information of the corresponding user stored in the user database DB and, in step 74o, informs the requesting dealer DL that the addition of the lines is completed.

As described above, according to the number-of-lines changing method of the tenth embodiment, as in the ninth embodiment, a series of processes ranging from the user's request for the change of the number of lines to the increase of the number of lines for the user's key telephone apparatus BT5 is performed automatically via a communication network without human intervention, with the dealer DL intervening between the user and the customer center CC. This enables the time required to increase the number of lines to be shortened, the expenses the user pays to be reduced, and the labor and costs needed to change the number of lines at the dealer DL or the customer center CC to be reduced remarkably.

Furthermore, as in the eighth embodiment, it is determined whether the communication between the customer center CC and the key telephone apparatus BT5 can be performed or whether the number of lines can be changed, on the basis of the user information accumulated and managed in the user database DB. This makes it unnecessary to acquire information about lines from the key telephone apparatus BT5 each time the user uses the telephone apparatus. As a result, a suitable number-of-lines changing process can be carried out according to a simple procedure.

Moreover, after the number-of-lines increasing process is completed, the customer center CC updates the corresponding line information in the user database DB. This makes it possible to always update the accumulated management information in the user database DB to the latest one automatically without the maintenance man in charge at the customer center CC carrying out the updating process manually.

(Eleventh Embodiment)

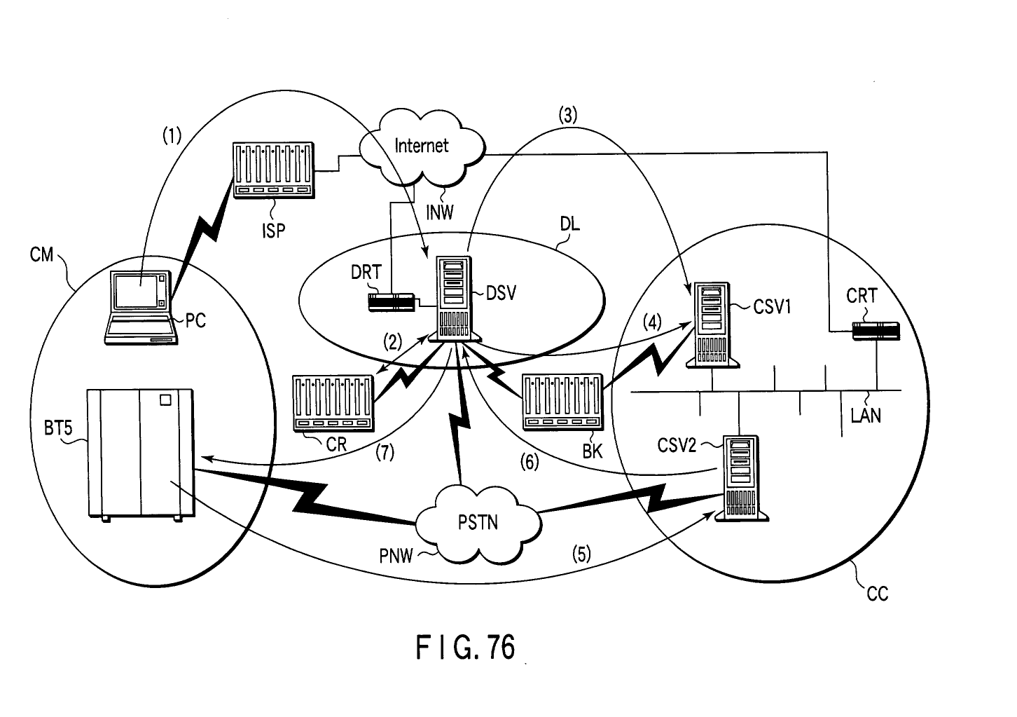

FIG. 76 schematically shows the configuration of a support system that carries out a number-of-lines changing method according to an eleventh embodiment of the present invention. In FIG. 76, the same parts as those in FIG. 63 are indicated by the same reference numerals. A detailed explanation of them will not be given.

The reception/charging/notifying server DSV of the dealer DL is connected via the public network PNW to the key telephone apparatus BT5 of the user system CM and the license setting server CSV2 of the customer center CC. The server DSV exchanges the information necessary for a number-of-lines increasing process with the key telephone apparatus BT5 and the license setting server CSV2.

Furthermore, the reception/charging/notifying server DSV is connected via an exclusive line to the credit company CR or the bank BK. The server DSV inquires the credit of the user from the credit company CR or bank BK and bills the agent's commission for increasing the number of lines.

First, the user uses its own maintenance personal computer PC to transmit a number-of-lines increase request via the Internet INW to the dealer DL as shown in (1). In the number-of-lines increase request, information representing the types of lines the user wants to add and the number of lines, the user's credit number, and the telephone number of the key telephone apparatus BT5 are included.

Next, the dealer DL accesses the credit company CR on the basis of the credit number included in the number-of-lines increase request as shown in (2) and inquires about the credit of the user. If there is no problem, the dealer DL transfers the number-of-lines increase request to the customer center CC as shown in (3).

The customer center CC accesses the user's key telephone apparatus BT5, on the basis of the telephone number included in the number-of-lines increase request, requires line information about the key telephone apparatus BT5 as shown in (5), and determines on the basis of the line information whether the lines the user wants can be added. If they can be added, the customer center CC sends an added line license setup request to the reception/charging/notifying server DSV of the dealer DL via the public network PNW as shown in (6). Thereafter, as shown in (7), the dealer DL transmits the license code according to the received license setup request to the key telephone apparatus BT5 via the public network PNW, thereby setting the addition of the lines.

Next, the procedure for increasing the number of lines for the key telephone apparatus BT5 in the above system will be explained.

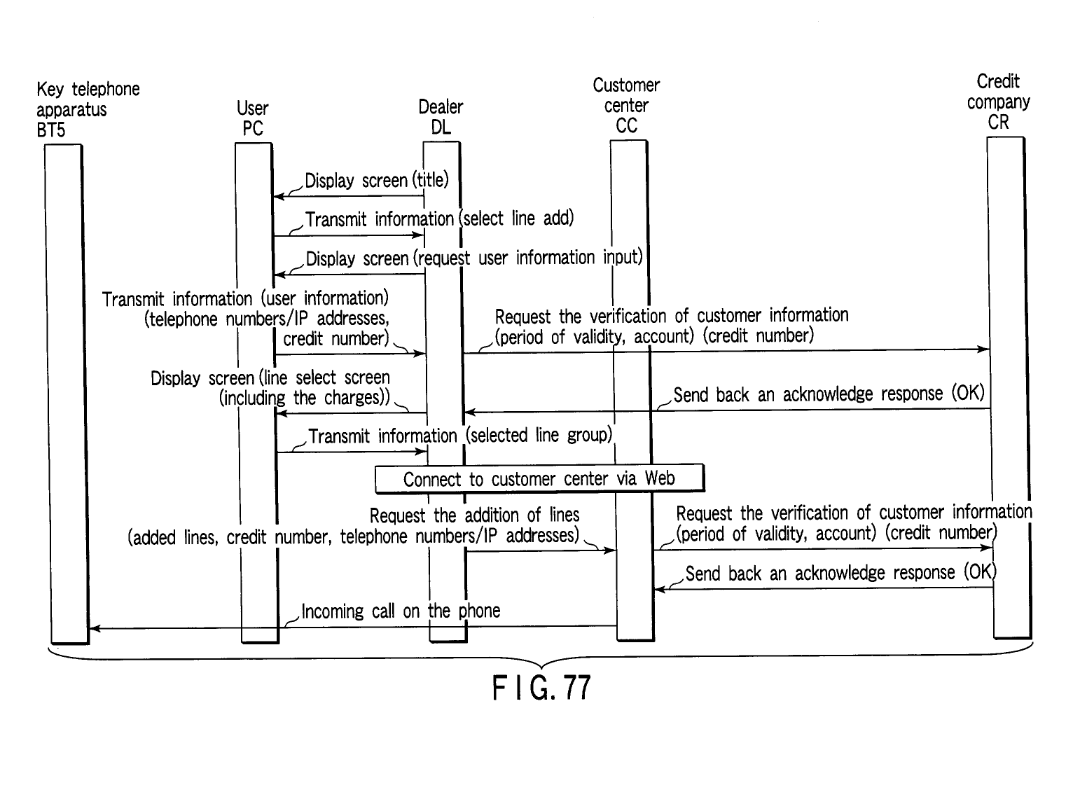

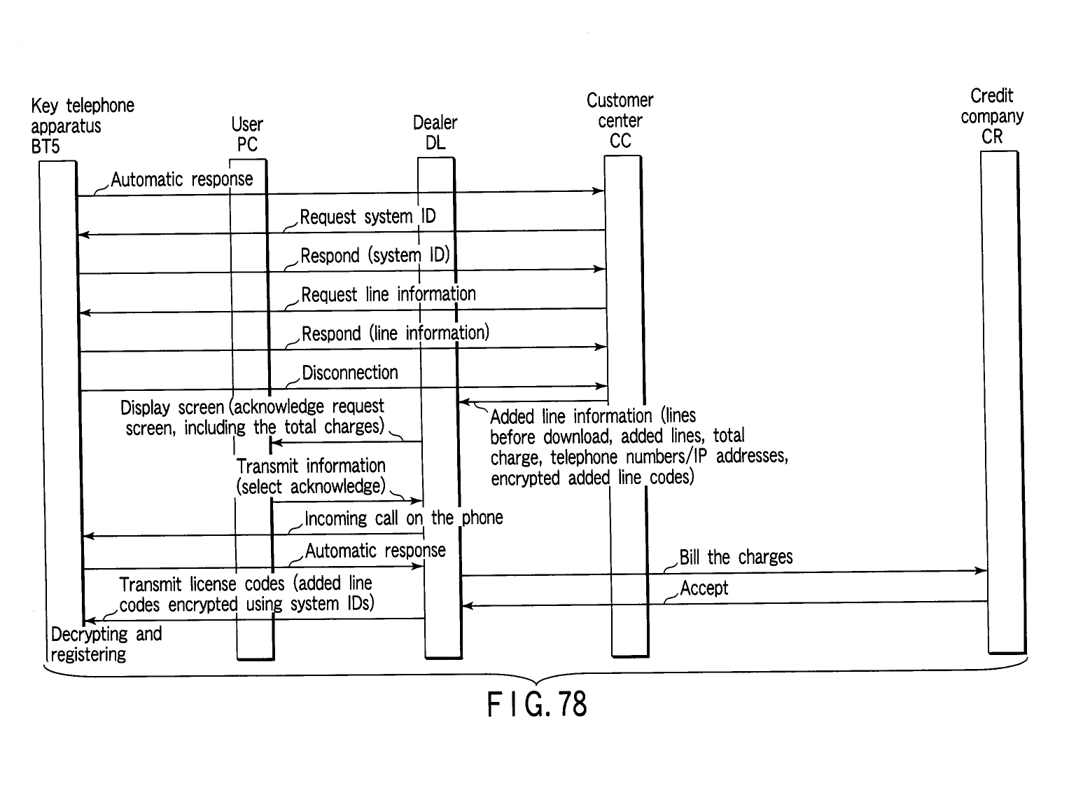

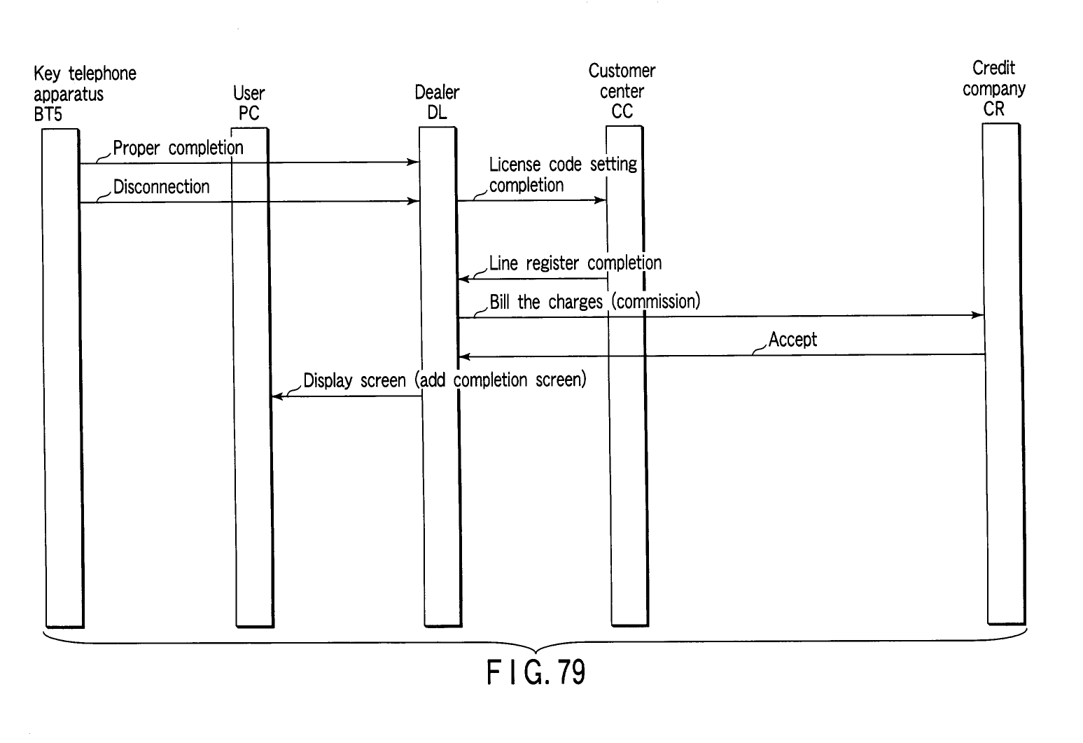

FIGS. 77 to 79 are sequence diagrams to help explain the operation of transmitting and receiving signals between the maintenance personal computer PC (or user PC) of the user system CM, the dealer DL, the customer center CC, and the credit company CR.

To increase the number of lines for the key telephone apparatus BT5, the user uses the maintenance personal computer PC to access the home page of the dealer DL by way of the Internet INW and inputs the necessary items related to the increase of the number of lines according to the guidance on the screen downloaded from the dealer DL. The necessary items to be inputted include information representing the lines to be added, the user's credit number, and the telephone number or IP address allocated by the public network PNW to the key telephone apparatus BT5. After finishing the input of the necessary items, the user transmits a number-of-lines increase request including those pieces of information to the dealer DL.

Receiving the number-of-lines increase request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the number-of-lines increase request sent from the user to the customer center CC by way of the Internet INW.

Receiving the number-of-lines increase request, the customer center CC itself accesses the credit company CR to inquire about the credit of the user. If there is no problem, the customer center CC accesses the user's key telephone apparatus BT5 via the public network PNW on the basis of the telephone number included in the number-of-lines increase request and acquires the line information and system ID from the key telephone apparatus BT5. Then, the customer center CC informs the dealer DL by way of the Internet INW of added line information including the acquired line information and a list of the charges for increasing the number of lines. The dealer DL transfers the notified line information and list of charges to the user's maintenance personal computer PC by way of the Internet INW. When receiving an acknowledge response from the user to the notice of the line information and list of charges, the dealer DL not only accesses the user's key telephone apparatus BT5 via the public network PNW but also accesses the credit company CR to ask the credit company to settle the charges for the added functions. When receiving from the credit company CR a reply to the effect that the settlement request has been accepted, the dealer DR transmits a license code to the key telephone apparatus BT5 via the public network PNW. In the license code, an instruction code for setting the lines to be added “usable” is inserted. The instruction code is encrypted using the system ID previously acquired from the key telephone apparatus BT5.

When receiving the license code from the dealer DL, the key telephone apparatus BT5 decrypts the instruction code included in the license code, using the system ID of its own apparatus. Then, according to the decrypted instruction code, the key telephone apparatus changes the flag for the corresponding line in the line information setting table from “unusable” to “usable.” When finishing the process of setting the increase of the number of lines, the key telephone apparatus BT5 sends back to the dealer DL information to the effect that the number-of-lines increasing process is completed properly.

When receiving a notice of the completion of the increase of the number of lines from the key telephone apparatus BT5, the dealer DL disconnects the lines with the key telephone apparatus BT5 and informs the customer center CC that the setting of the license codes is completed.

Receiving the notice of the completion of the license code setting from the dealer DL, the customer center CC informs the dealer DL of the number-of-lines increasing process is completed. Receiving the notice of the completion of the process, the dealer DL asks the credit company CR to pay the agent's commission.

As a result, the lines the user wants to add are set in the key telephone apparatus BT5 in such a manner that they are usable. Thereafter, in the user's key telephone apparatus BT5, the added lines can be used.

The configuration of each section of the support system that carries out the above-described number-of-lines changing method is as follows.

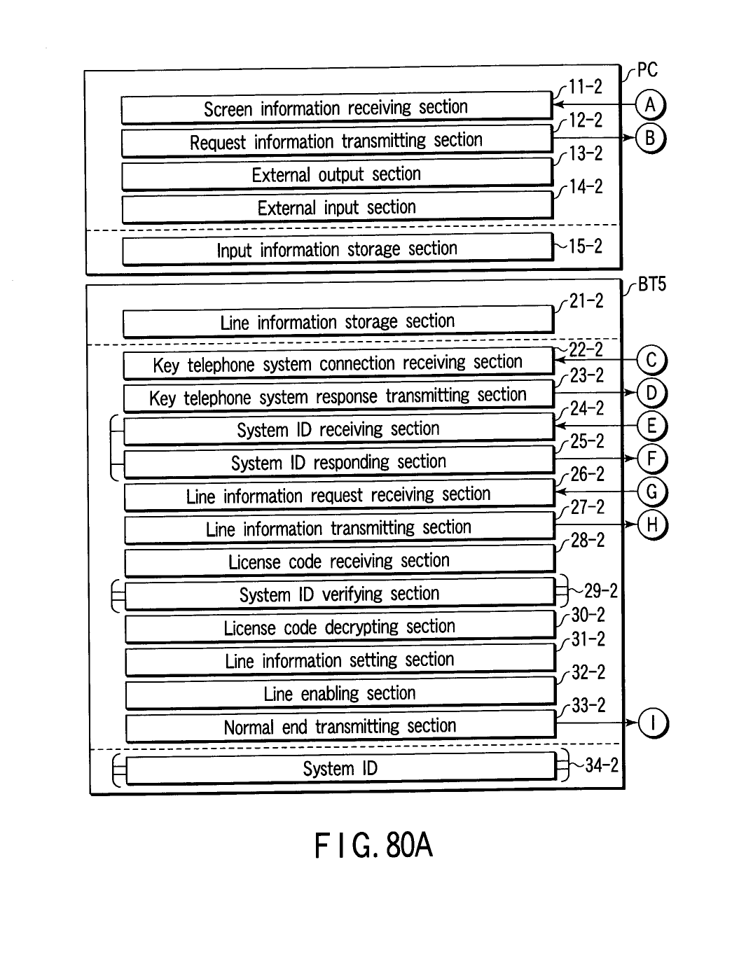

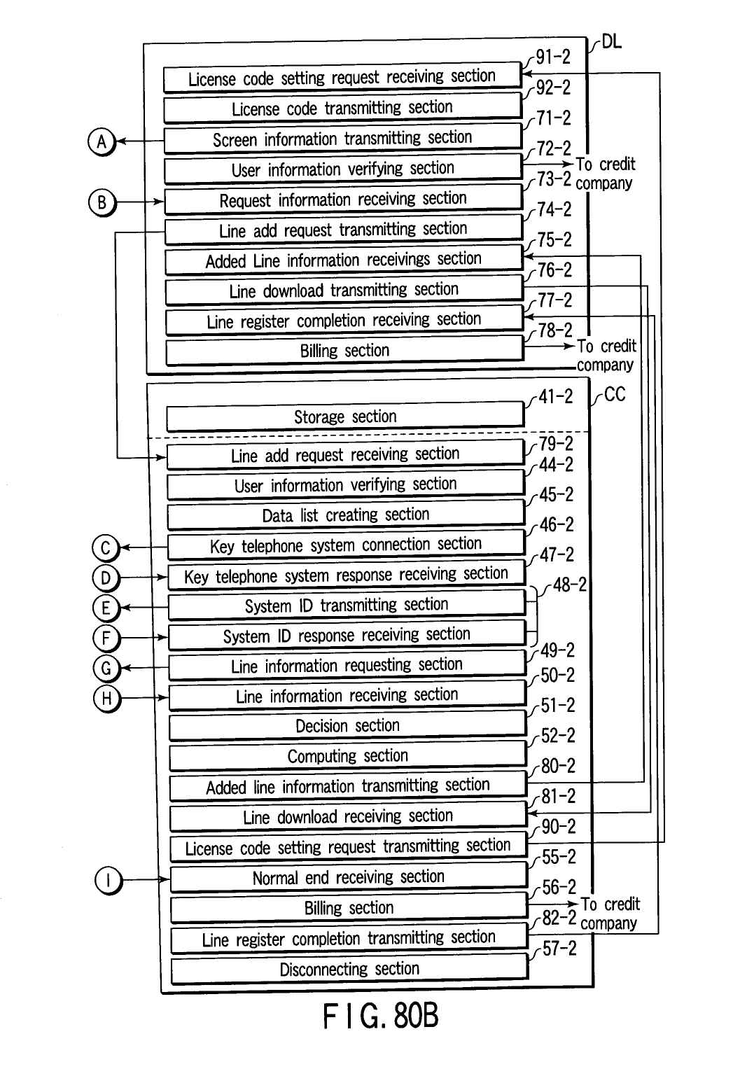

FIG. 80 is a block diagram showing a functional configuration of the maintenance personal computer PC, key telephone apparatus BT5, dealer DL, and customer center CC. In FIG. 80, the same parts as those in FIG. 67 are indicated by the same reference numerals. A detailed explanation of them will not be given.

The customer center CC includes a license code setting request transmitting section 90-2. The license code setting request transmitting section 90-2 transmits to the dealer DL the number-of-lines increase request information received by the number-of-lines increase request receiving section 79-2 from the maintenance personal computer PC and the line information about and the system ID of the key telephone apparatus BT5 received by the line information receiving section 50-2.

The dealer DL further includes a license code setting request receiving section 91-2 and a license code transmitting section 92-2.

The license code setting request receiving section 91-2 receives the number-of-lines increase request information transmitted by the customer center CC and the line information about and the system ID of the key telephone apparatus BT5.

The license code transmitting section 92-2 accesses the key telephone apparatus BT5 via the public network PNW on the basis of the telephone number included in the received number-of-lines increase request information. In addition, the license code transmitting section 92-2 encrypts the license code using the system ID included in the line information and transmits the encrypted license code to the key telephone apparatus BT5.

While in the above transmission and reception procedure, the dealer DL has intervened from the beginning, the dealer DL may intervene when the lines are set in the key telephone apparatus BT5.

While in the above transmitting and receiving operations, the user has been prompted to request the lines the user wants to add, the user may input the desired lines from the beginning without checking the present lines.

As described above, according to the function changing method of the eleventh embodiment, a series of processes ranging from the user's request for the change of the number of lines to the increase of the number of lines for the user's key telephone apparatus BT5 is performed automatically via a communication network without human intervention, with the dealer DL intervening between the user system CM and the customer center CC. This enables the time required to increase the number of lines to be shortened, the expenses the user pays to be reduced, and the labor and costs needed to change the number of lines at the dealer DL or the customer center CC to be reduced remarkably.

Since the dealer DL determines whether the number of lines can be increased, on the basis of the line information acquired from the key telephone apparatus BT5 for which the number of lines is to be increased, the number-of-lines increasing process can be carried out properly for each key telephone apparatus BT5, which alleviates the processing load on the customer center CC accordingly. In addition, since the license code is encrypted using the system ID of the key telephone apparatus BT5 and sent to the key telephone apparatus BT5, it is possible to not only prevent the number of lines from being increased wrongly or illegally but also alleviate the processing load on the customer center CC.

(Twelfth Embodiment)

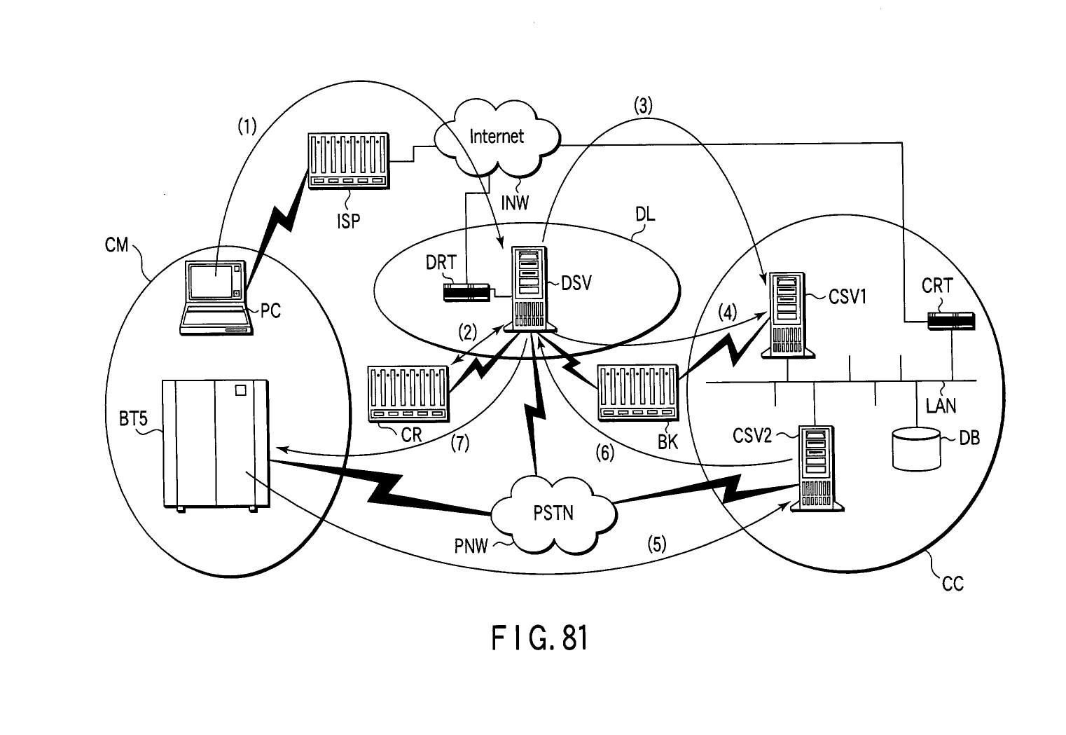

FIG. 81 schematically shows the configuration of a support system that carries out a number-of-lines changing method according to a twelfth embodiment of the present invention. In FIG. 81, the same parts as those in FIG. 70 are indicated by the same reference numerals. A detailed explanation of them will not be given.

The reception/charging/notifying server DSV of the dealer DL is connected via the public network PNW to the key telephone apparatus BT5 of the user system CM and the license setting server CSV2 of the customer center CC. Then, the server DSV exchanges the information necessary for a number-of-lines increasing process with the key telephone apparatus BT5 and license setting server CSV2.

Furthermore, the reception/charging/notifying server DSV is connected via an exclusive line to the credit company CR or the bank BK. The server DSV inquires the credit of the user from the credit company CR or bank BK and bills the agent's commission for increasing the number of lines.

On the other hand, in the customer center CC, there is provided an user database DB. In the user database DB, the system ID of, function information about, and telephone number of the key telephone apparatus BT5 the user has are stored in such a manner that they are caused to correspond to the user ID uniquely assigned to each user.

When the user's number-of-lines increase request has been transferred from the dealer DL, the reception/charging server CSV1 or license server CSV2 of the customer center CC accesses the user database DB on the basis of the user ID included in the number-of-lines increase request and reads the systems ID of, function information about, and telephone number of the key telephone apparatus BT5 the user has. Then, using the read-out information, the server CSV1 or CSV2 determines whether the number of lines the user wants can be increased, accesses the key telephone apparatus BT5, and transmits a license code.

First, as shown in (1), the user's maintenance personal computer PC transmits a number-of-lines increase request to the dealer DL via the Internet INW. Information representing the types of lines to be added, the number of lines, the user's individual identification information (or user ID), and credit number are included in the number-of-lines increase request.

Next, the dealer DL accesses the credit company CR on the basis of the credit number included in the number-of-lines increase request as shown in (2) and inquires about the credit of the user. If there is no problem, the dealer DL transfers the number-of-lines increase request to the customer center CC as shown in (3).

The customer center CC accesses the user database DB, on the basis of the user identification information included in the number-of-lines increase request, and reads the system ID of, function information about, and telephone number of the key telephone apparatus BT5 as shown in (5). Then, the customer center CC determines on the basis of the line information whether the lines the user wants can be added and informs the user of the result of the determination via the dealer. If the lines can be added, the customer center CC sends a license setup request for added lines via the public network PNW to the reception/charging/notifying server DSV of the dealer DL as shown in (6). Thereafter, the dealer DL transmits the license code according to the received license setup request to the key telephone apparatus BT5 via the public network PNW as shown in (7), thereby enabling the lines to be added.

Next, the procedure for increasing the number of lines for the key telephone apparatus BT5 in the above system will be explained.

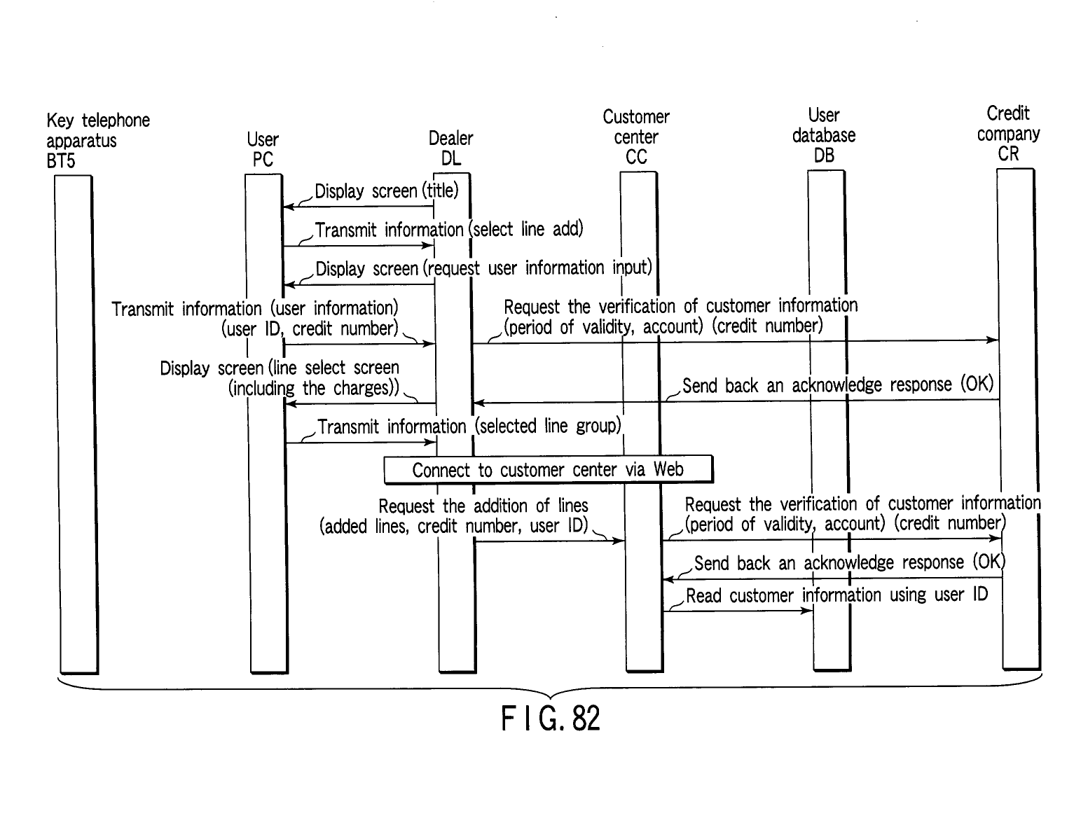

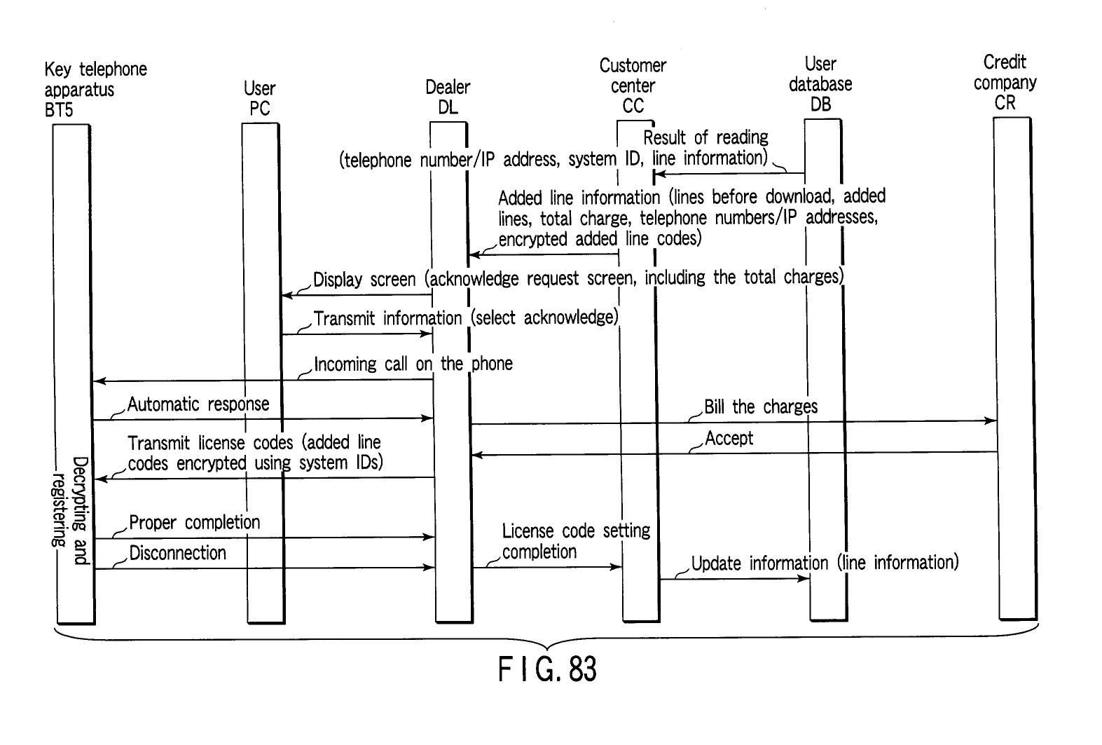

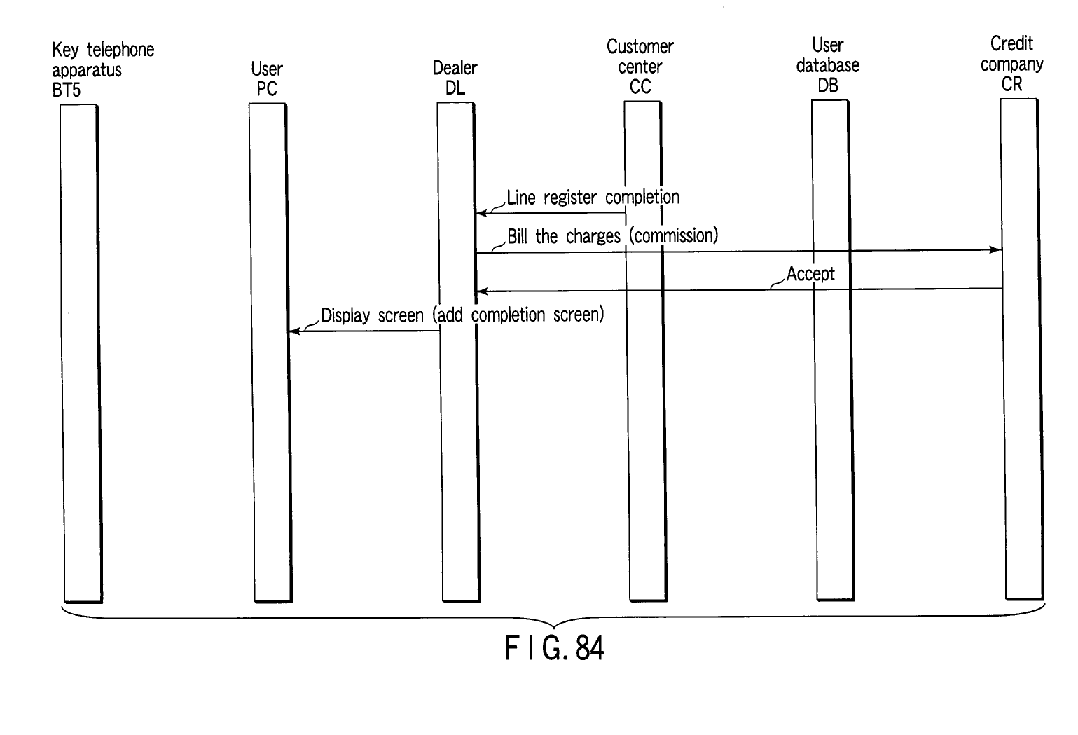

FIGS. 82 to 84 are sequence diagrams to help explain the operation of transmitting and receiving information between the maintenance personal computer PC (or user PC) of the user system CM, the dealer DL, the customer center CC, and the credit company CR.

To increase the number of lines for the key telephone apparatus BT5, the user uses the maintenance personal computer PC to access the home page of the dealer DL by way of the Internet INW and inputs the necessary items related to the increase of the number of lines according to the guidance on the screen downloaded from the dealer DL. The necessary items to be inputted include information representing the lines to be added, the user's ID, and the user's credit number. After finishing the input of the necessary items, the user transmits a number-of-lines increase request including those pieces of information to the dealer DL.

Receiving the number-of-lines increase request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the number-of-lines increase request sent from the user to the customer center CC by way of the Internet INW.

Receiving the number-of-lines increase request, the customer center CC itself accesses the credit company CR to inquire about the credit of the user. If there is no problem, the customer center CC accesses the user database DB on the basis of the user ID included in the number-of-lines increase request and reads the system ID of, function information, and telephone number of the key telephone apparatus BT5 the user has.

Then, the customer center CC informs the dealer DL by way of the Internet INW of the read-out line information, the line information before the download, and a list of charges for increasing the number of lines. The dealer DL transfers the notified line information and list of charges to the user's maintenance personal computer PC by way of the Internet INW. When receiving from the user an acknowledge response to the notice of the line information and list of charges, the dealer DL not only accesses the user's key telephone apparatus BTS via the public network PNW but also accesses the credit company CR to settle the charges for the added lines. When receiving from the credit company CR a reply to the effect that the settlement request has been accepted, the dealer DR accesses the user's key telephone apparatus BT5 via the public network PNW and transmits a license code to the key telephone apparatus BT5. In the license code, an instruction code for setting the lines to be added “usable” is inserted. The instruction code is encrypted using the system ID previously acquired from the user database DB.

When receiving the license code from the dealer DL, the key telephone apparatus BT5 decrypts the instruction code included in the license code, using the system ID of its own apparatus. Then, according to the decrypted instruction code, the key telephone apparatus changes the flag for the corresponding line in the line information setting table from “unusable” to “usable.” When finishing the process of setting the increase of the number of lines, the key telephone apparatus BT5 sends back to the dealer DL information to the effect that the number-of-lines increasing process is completed properly.

When receiving a notice of the completion of the increase of the number lines from the key telephone apparatus BT5, the dealer DL disconnects the lines with the key telephone apparatus BT5 and informs the customer center CC that the setting of the license codes is completed.

Receiving the notice of the completion of the license code setting from the dealer DL, the customer center CC not only updates the information in the user database DB but also informs the dealer DL that the number-of-line increasing process is completed. Receiving the notice of the completion of the process, the dealer DL asks the credit company CR to pay the agent's commission.

As a result, the lines the user wants to add are set in the key telephone apparatus BT5 in such a manner that they are usable. Thereafter, in the user's key telephone apparatus BT5, the added lines can be used.

The configuration of each section of the support system that carries out the above-described number-of-lines changing method is as follows.

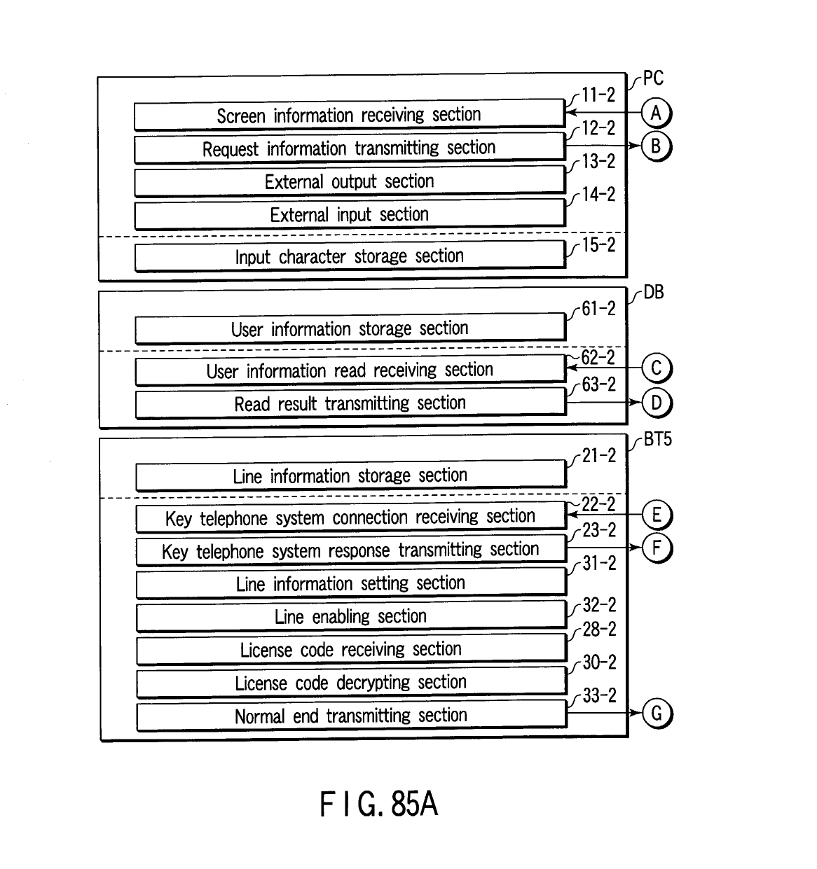

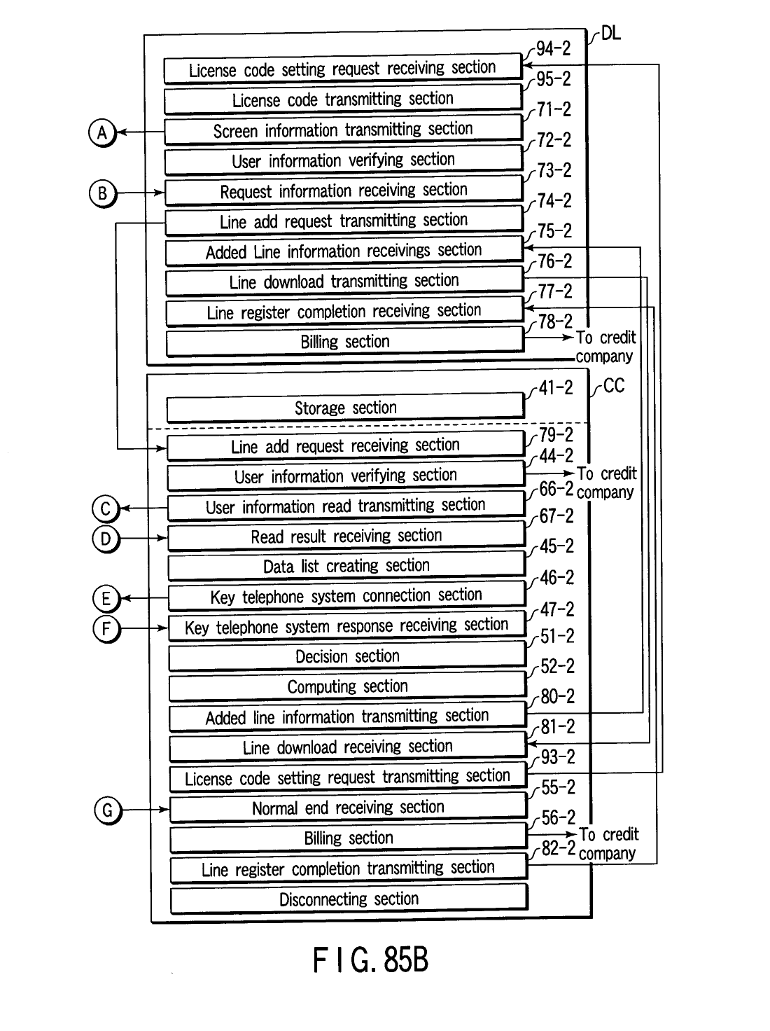

FIG. 85 is a block diagram showing a functional configuration of the maintenance personal computer PC, key telephone apparatus BT5, and customer center CC. In FIG. 85, the same parts as those in FIG. 74 are indicated by the same reference numerals. A detailed explanation of them will not be given.

The customer center CC includes a license code setting request transmitting section 93-2. The license code setting request transmitting section 93-2 transmits to the dealer DL the number-of-lines increase request information received by the number-of-lines increase request receiving section 79-2 from the maintenance personal computer PC and user information including the telephone number of, system ID of, and line information about the key telephone apparatus BT5 read by the read result receiving section 67-2 from the user database DB.

The dealer DL further includes a license code setting request receiving section 94-2 and a license code transmitting section 95-2.

The license code setting request receiving section 94-2 receives the number-of-lines increase request information and user information transmitted by the customer center CC.

The license code transmitting section 95-2 accesses the key telephone apparatus BT5 via the public network PNW on the basis of the telephone number included in the received user information. In addition, the license code transmitting section 95-2 encrypts the license code using the system ID included in the user information and transmits the encrypted license code to the key telephone apparatus BT5.

While in the above transmission and reception procedure, the dealer DL has intervened from the beginning, the dealer DL may intervene when the lines are set in the key telephone apparatus BT5.

As described above, according to the function changing method of the twelfth embodiment, a series of processes ranging from the user's request for the change of the number of lines to the increase of the number of lines for the user's key telephone apparatus BT5 is performed automatically via a communication network without human intervention, with the dealer DL intervening between the user and the customer center CC. This enables the time required to increase the number of lines to be shortened, the expenses the user pays to be reduced, and the labor and costs needed to change the number of lines at the dealer DL or the customer center CC to be reduced remarkably.

Furthermore, as in the tenth embodiment, it is determined whether the communication between the customer center CC and the key telephone apparatus BT5 can be performed or whether the number of lines can be changed, on the basis of the user information accumulated and managed in the user database DB. This makes it unnecessary to acquire information about the functions from the key telephone apparatus BT5 each time the user uses the telephone apparatus. As a result, a suitable number-of-lines changing process can be carried out according to a simple procedure.

Moreover, after the number-of-lines increasing process is completed, the customer center CC updates the corresponding line information in the user database DB. This makes it possible to always update the accumulated management information in the user database DB to the latest one automatically without the maintenance man in charge at the customer center CC carrying out the updating process manually.

(Thirteenth Embodiment)

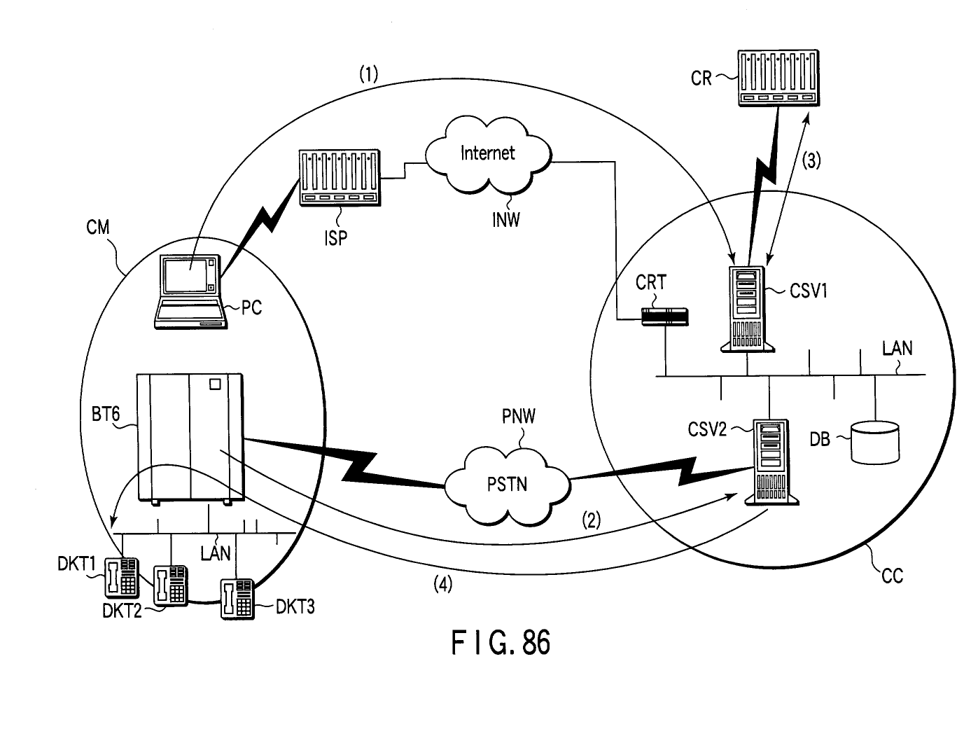

FIG. 86 schematically shows the configuration of a support system for realizing a thirteenth embodiment of the present invention. In FIG. 86, the same parts as those in FIG. 58 are indicated by the same reference numerals. A detailed explanation of them will not be given.

The user system CM includes a key telephone apparatus BT6 as a main unit, extension terminals DKT1 to DKT3 connected via a LAN to the key telephone apparatus BT6, and a maintenance personal computer PC. The basic function of the key telephone apparatus BT6 is to switch between the extension terminals DKT1 to DKT3 and between the extension terminals DKT1 to DKT3 and subscriber lines to a public network PNW according to outgoing or incoming calls. The key telephone apparatus BT6 further has a plurality of optional service functions related to the switching process.

All of the programs that realize those optional service functions are stored beforehand in the program memories of the key telephone apparatus BT6 and extension terminals DKT1 to KDT3. To manage the setting state of the optional service functions, there is provided a function information setting table (or service execute table) in the key telephone apparatus BT6 and extension terminals DKT1 to DKT3. In the function information setting table, flags indicating whether use is allowed or not are stored in such a manner that they correspond to the respective optional service functions. Of the flags, when a usable/unusable flag is set to “usable,” the function is executable. On the other hand, if it is set to “unusable,” the line is inexecutable.

In the customer center CC, there is provided an user database DB. In the user database DB, the system ID of, function information about, and telephone numbers of the key telephone apparatus BT6 and extension terminals DKT1 to DKT3 the user has are stored in such a manner that they are caused to correspond to an individual identification number (or user number) assigned to each user. The system ID is common to the key telephone apparatus BT6 and extension terminals DKT1 to DKT3.

When a number-of-lines increase request has arrived from the user, the reception/charging server CSV1 or license server CSV2 of the customer center CC accesses the user database DB on the basis of the user ID included in the number-of-lines increase request and reads the system ID of, line information about, and telephone numbers of the key telephone apparatus BT6 and extension terminals DKT1 to DKT3 the user has. Then, using the read-out information, the server CSV1 or CSV2 determines whether the functions the user wants can be added, accesses the key telephone apparatus BT6 and extension terminals DKT1 to DKT3, and transmits a license code.

Next, the procedure for adding functions to, for example, the extension terminal DKT1 in the above system will be explained.

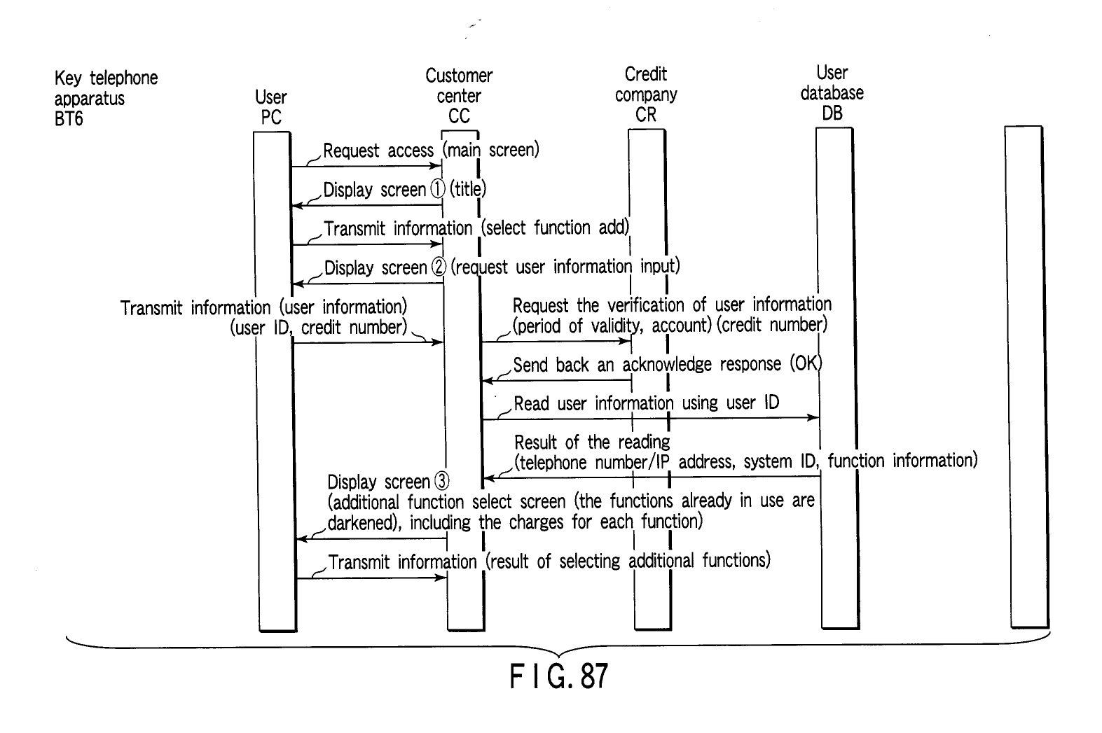

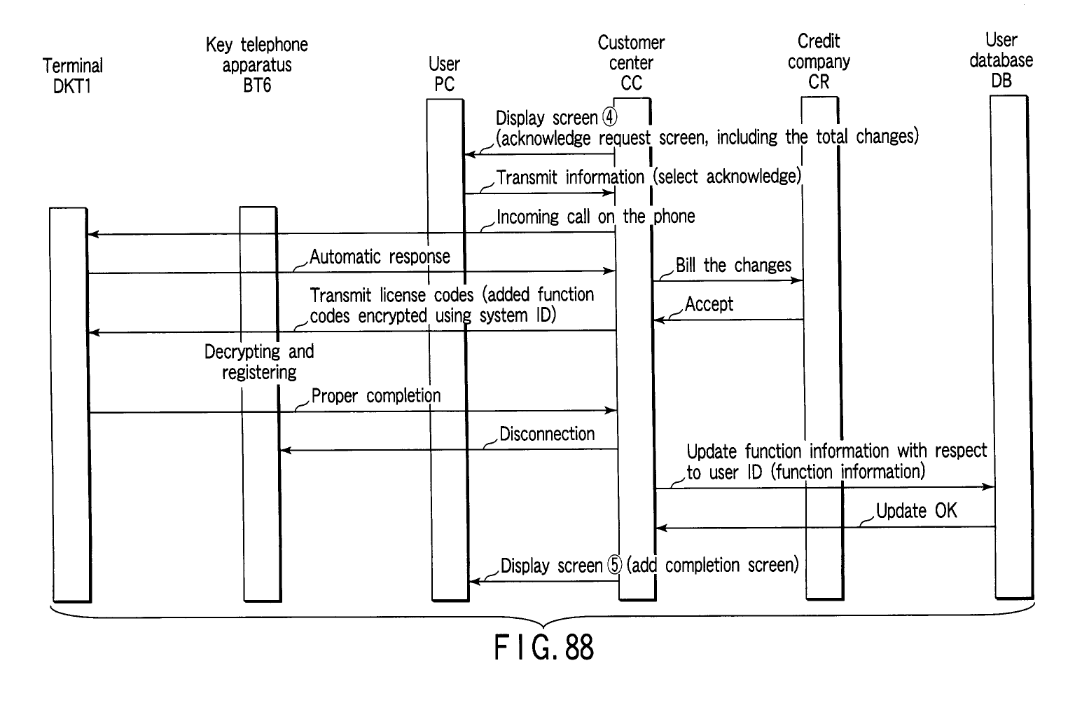

FIGS. 87 and 88 are schematic sequence diagrams to help explain the operation of transmitting and receiving signals between the maintenance personal computer PC (or user PC) of the user system CM, the key telephone apparatus BT6, the extension terminal DKT1, the customer center CC, and the credit company CR.

To add functions to the extension terminal DKT1, the user uses the maintenance personal computer PC to access the home page of the customer center CC by way of the Internet INW and inputs the necessary items related to the addition of the functions according to the guidance on the screen downloaded from the customer center CC. The necessary items to be inputted include information representing the functions to be added, the user ID, and the credit number. After finishing the input of the necessary items, the user transmits a function add request including those pieces of information to the customer center CC.

Receiving the function add request, the customer center CC accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the customer center CC.

On the basis of the reply from the credit company CR, the customer center CC judges the credit of the user. If there is no problem, the customer center CC accesses the user database DB on the basis of the user ID included in the function add request sent from the user and reads the system ID, function information, and telephone numbers. Then, on the basis of the function information, the customer center CC determines whether the functions the user wants can be added. Then, the customer center CC transmits the result of the determination, the functions already usable, the functions required to be added, and the charges for the added lines to the user's maintenance personal computer PC.

Receiving the acknowledge response to the notice from the user, the customer center CC not only accesses the user's extension terminal DKT1 via the public network PNW and key telephone apparatus BT6 on the basis of the telephone number read from the user database DB but also accesses the credit company CR via an exclusive line to ask the credit company CR to settle the charges for the addition of the functions. Then, when receiving from the credit company CR a response to the effect that the settlement request has been accepted, the customer center CC transmits a license code to extension terminal DKT1. In the license code, an instruction code to set the function to be added “usable” is inserted. At this time, the instruction code is encrypted using the system ID read form the user database DB.

When receiving the license code from the customer center CC, the extension terminal DKT1 decrypts the instruction code included in the license code, using the system ID of its own terminal. Then, according to the decrypted instruction code, the extension terminal DKT1 changes the flag for the corresponding function in the function information setting table from “unusable” to “usable.” When finishing the function adding process, the extension terminal DKT1 sends back to the customer center CC information to the effect that the function adding process is completed properly.

When receiving a notice of the completion of the addition of the functions from the extension terminal DKT1, the customer center CC disconnects the line with the extension terminal DKT1. Thereafter, the customer center CC accesses the user database DB and updates the information about the additionally set functions by setting them “usable.” Then, the customer center CC receives an update completion notice from the user database DB. Thereafter, the customer center CC transmits to the user's maintenance personal computer PC information to the effect that the function adding process is completed and causes the computer PC to display the information.

As a result, the functions the user wants to add are set in the extension terminal DKT1 in such a manner that they are usable. Thereafter, in the user's extension terminal DKT1, the added optional service functions can be used. Functions can be added to the extension terminals DKT2, DKT3 in the same manner as described above.

The configuration of each section of the support system that realizes the above-described function changing method is as follows.

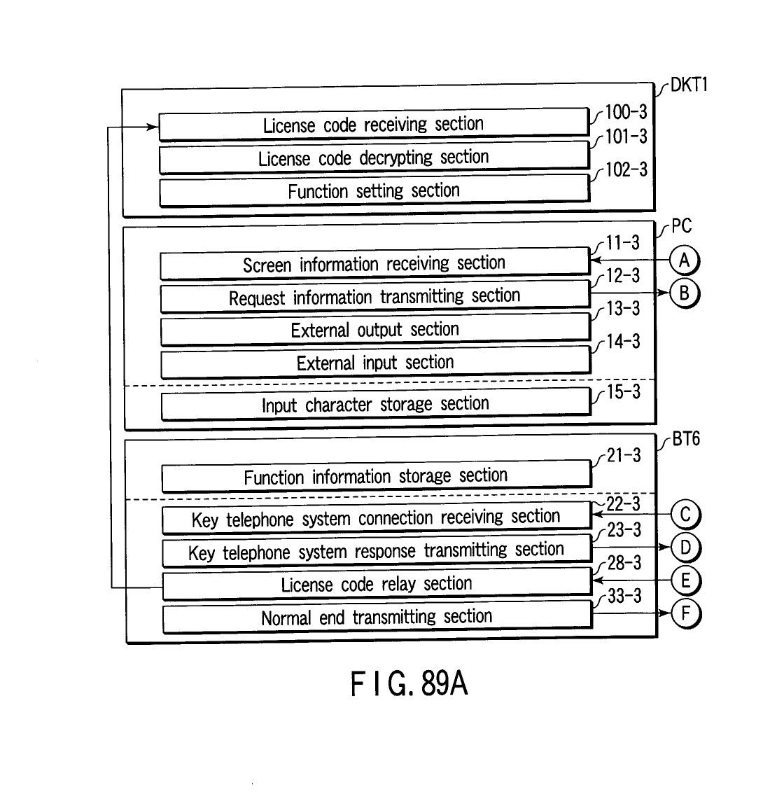

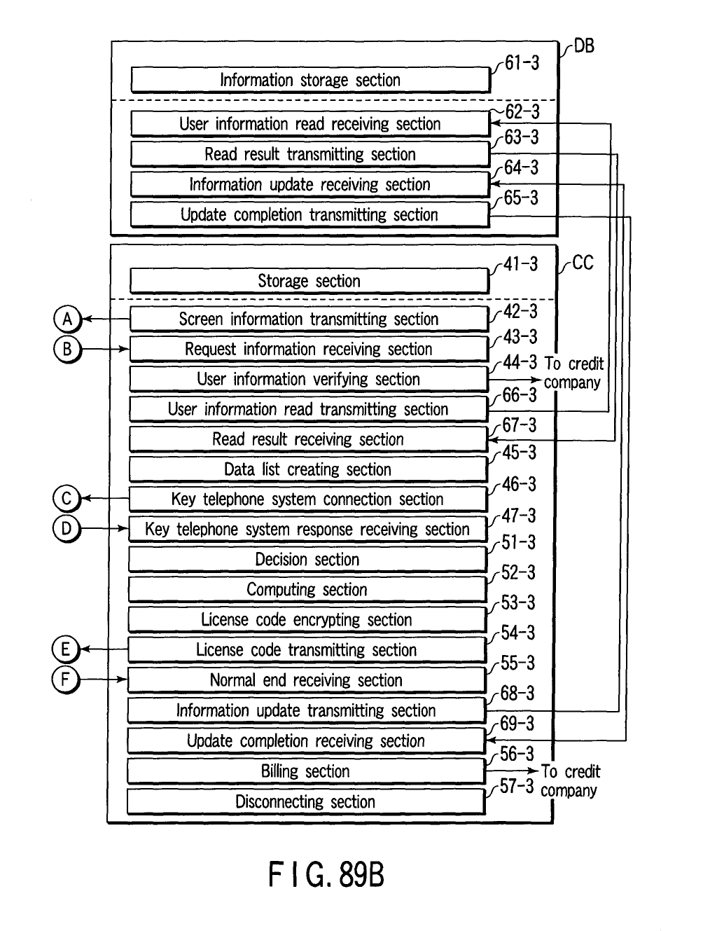

FIG. 89 is a block diagram showing a functional configuration of the maintenance personal computer PC, key telephone apparatus BT6, extension terminal DKT1, customer center CC, and user database DB.

The maintenance personal computer PC includes a screen information receiving section 11-3, a request information transmitting section 12-3, an external output section 13-3, an external input section 14-3, and an input information storage section 15-3.

The screen information receiving section 11-3 receives various pieces of screen information downloaded from the customer center CC in the course of executing the procedure for adding functions to the extension terminal DKT1 and displays them. The request information transmitting section 12-3 inserts information indicating the additional functions of the extension terminal DKT1 the user has inputted, the credit number, and the telephone number or IP address of the key telephone apparatus BT6 into the request information and transmits the resulting request information to the customer center CC.

The key telephone apparatus BT6 includes, as functions related to the present invention, a function information storage section 21-3, a key telephone system connection receiving section 22-3, a key telephone system response transmitting section 23-3, a license code relay section 28-3, and a normal end transmitting section 33-3.

In the function information storage section 21-3, the function information about the extension terminal DKT1 is stored.

The key telephone system connection receiving section 22-3 and key telephone system response transmitting section 23-3 receive and respond to an incoming call when the call arrives from the customer center CC.

The license code relay section 28-3 transmits to the extension terminal DKT1 a license code addressed to the extension terminal DKT1 arrived from the customer center CC.

The extension terminal DKT1 includes a license code receiving section 100-3, a license code decrypting section 101-3, and a function setting section 102-3.

The license code receiving section 100-3 receives the license code sent from the key telephone apparatus BT6. The license code decrypting section 101-3 decrypts the license code received by the license code receiving section 100-3, using the system ID of its own terminal. The function information setting section 102-3 sets the flag for the function to be added to “usable” according to the decrypted license code.

The customer center CC includes a function list storage section 41-3, a screen information transmitting section 42-3, a request information receiving section 43-3, an user information verifying section 44-3, a data list creating section 45-3, a key telephone system connection section 46-3, a key telephone system response receiving section 47-3, a requested function decision section 51-3, an additional function charge computing section 52-3, a license code encrypting section 53-3, a license code transmitting section 54-3, a normal end receiving section 55-3, and a billing section 56-3, and a disconnecting section 57-3.

The screen information transmitting section 42-3, when being accessed by the user's maintenance personal computer PC, transmits screen information to cause the maintenance personal computer PC to input a function add request for the extension terminal DKT1 and transmit it. The request information receiving section 43-3 receives information about the function add request sent from the maintenance personal computer PC. The user information verifying section 44-3 accesses the credit company CR on the basis of the credit number included in the received function add request information and inquires about the credit of the user.

The key telephone system connection section 46-3 and key telephone system response receiving section 47-3 access the key telephone apparatus BT6 via the public network PNW on the basis of the telephone number included in the received function add request information and receive the response. The decision section 51-3, on the basis of the received function information list, determines whether the requested function can be added. The computing section 52-3 calculates the charges for the added functions on the basis of the list of functions.

The license code encrypting section 53-3 and license code transmitting section 54-3 encrypt the license code for each extension terminal DKTI, using the system ID and transmit the encrypted license code to the key telephone apparatus BT6. The normal end receiving section 55-3 receives a normal end signal sent from the key telephone apparatus BT6 after the function adding process and informs the maintenance personal PC that the normal end signal has been received. After receiving the normal end signal, the billing section 56-3 transmits to the credit company CR a bill for the charges calculated previously at the additional function charge computing section 52-3.

The user database DB includes an user information storage section 61-3, an user information read receiving section 62-3, a read result transmitting section 63-3, a function information update receiving section 64-3, and an update completion transmitting section 65-3.

In the user information storage section 61-3, the system ID of, function information about, and telephone numbers of the key telephone apparatus BT6 and extension terminal DKT1 the user has are stored in such a manner that they are caused to correspond to the user ID unique to each user. The user information read receiving section 62-3 and read result transmitting section 63-3 read the corresponding storage information according to access by the reception/charging server CSV1 or license setting server CSV2 and send back the read-out storage information to the accessing reception/charging server CSV1 or license setting server CSV2.

When the setting of the addition of functions to the extension terminal DKT1 is completed, the function information update receiving section 64-3 and update completion transmitting section 65-3 update the corresponding function information according to access by the license setting server CSV2. Then, the function information update receiving section 64-3 and update completion transmitting section 65-3 send back update completion to the license setting server CSV2.

The customer center CC further includes an user information read transmitting section 66-3 that has the function of accessing the user database DB, a read result receiving section 67-3, a function information update transmission control section 68-3, and an update completion receiving section 69-3.

The user information read transmitting section 66-3 and read result receiving section 67-3 access the user database DB using the user ID as an address and receive the storage information read from the user database DB through the access. The function information update transmission control section 68-3 and update completion receiving section 69-3, after the setting of the addition of functions to the extension terminal DKT1 is completed, update the storage information by giving the updated function information to the user database DB and receive the update completion notice.

On the other hand, when receiving the title screen, user information input screen, verify request screen, add completion screen, user information reenter screen, and function adding process NG from the customer center CC, the user's maintenance personal computer PC executes the same procedure as in the second embodiment.

As described above, according to the function changing method of the thirteenth embodiment, a series of procedures ranging from the user's request for the addition of functions to the extension terminals DKTI to DKT3 to the process of adding functions to the user's extension terminals DKT1 to DTT3 is performed automatically via a communication networks without human intervention. This enables the time required to add functions to be shortened, the expenses the user pays to be reduced, and the labor and cost needed to change the functions at the customer center CC to be decreased remarkably.

Since the license setup for the extension terminals DKT1 to DKT3 is carried out using the existing lines, special lines for the license setup and an interface circuit for connecting the lines need not be newly provided and functions can be changed easily from the customer center in a remote control manner, which is advantageous in costs.

Since it is determined whether functions can be added, on the basis of function information about the extension terminals DKT1 to DTK3, the function adding process can be carried out properly for each of the extension terminals DKT1 to DKT3. In addition, since the license code is encrypted using the system ID of the extension terminals DKT1 to DKT3 and transferred to the extension terminals DKT1 to DKT3, it is possible to prevent the wrong function or an authorized function from being added.

Furthermore, in the thirteenth embodiment, it is determined whether the communication between the customer center CC and the key telephone apparatus BT6 and extension terminals DKT1 to DKT3 can be performed or whether functions can be changed, on the basis of the user information accumulated and managed in the user database DB. This makes it unnecessary to acquire information about the extension terminals DKT1 to DKT3 from the key telephone apparatus BT6 each time the user uses the telephone apparatus. As a result, a suitable function changing process can be carried out according to a simple procedure.

Moreover, after the process of adding functions to the extension terminals DKT1 to DKT3 is completed, the customer center CC updates the corresponding function information in the user database DB. This makes it possible to always update the accumulated management information in the user database DB to the latest one automatically without the maintenance man in charge at the customer center CC carrying out the updating process manually.

(Fourteenth Embodiment)

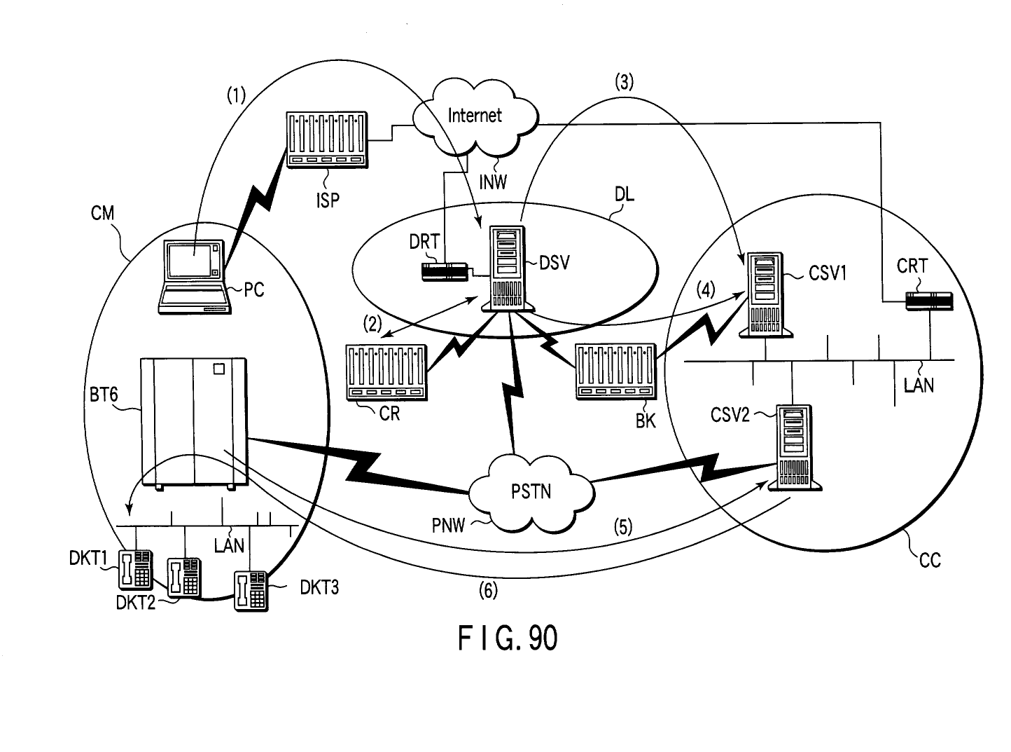

FIG. 90 schematically shows the configuration of a support system that carries out a terminal function changing method according to a fourteenth embodiment of the present invention. In FIG. 90, the same parts as those in FIG. 86 are indicated by the same reference numerals. A detailed explanation of them will not be given.

In the support system of the fourteenth embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a function adding process with the maintenance personal computer PC and customer center CC.

Furthermore, the reception/charging/notifying server DSV is connected via an exclusive line to the credit company CR or the bank BK. The server DSV inquires the credit of the user from the credit company CR or bank BK and bills the charges for the addition of functions.

Next, the procedure for adding functions to the extension terminal DKT1 in the above system will be explained.

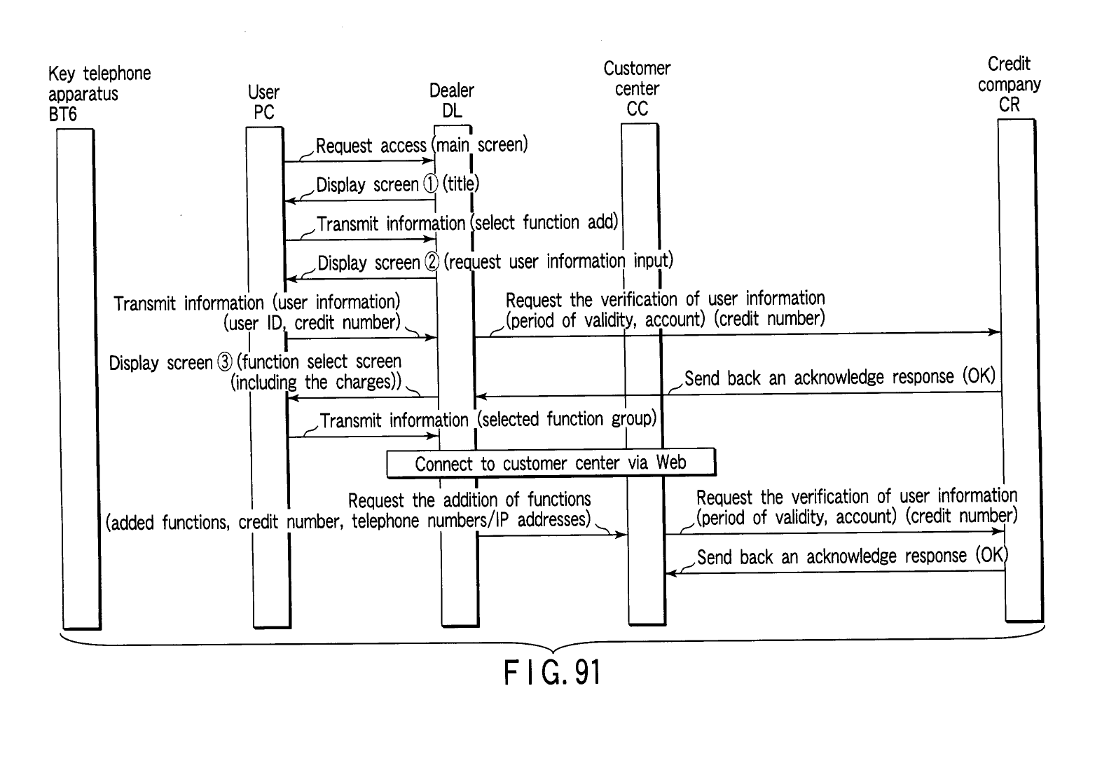

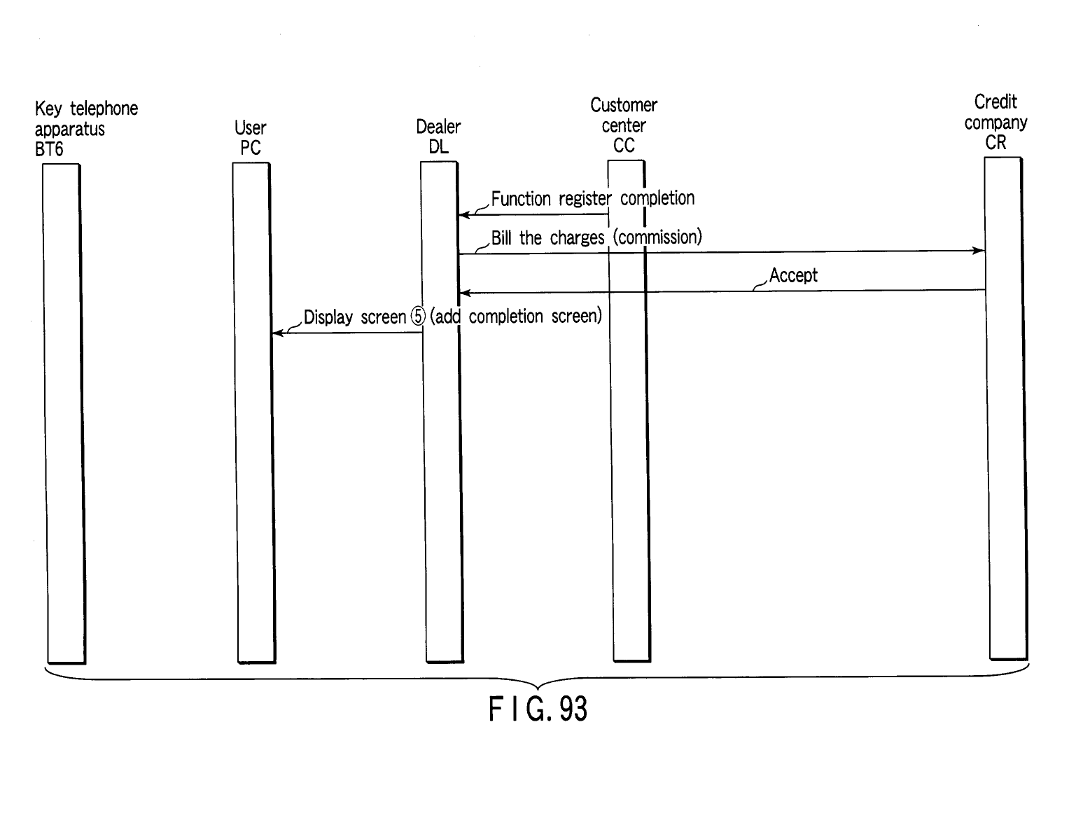

FIGS. 91 and 93 are schematic sequence diagrams to help explain the operation of transmitting and receiving signals between the maintenance personal computer PC (or user PC) of the user system CM, the key telephone apparatus BT6, the extension terminal DKT1, the dealer DL, the customer center CC, and the credit company CR.

To add functions to the extension terminal DKT1, the user uses the maintenance personal computer PC to access the home page of the dealer DL by way of the Internet INW and inputs the necessary items related to the addition of functions according to the guidance on the screen downloaded from the dealer DL. The necessary items to be inputted include information representing the functions to be added to the extension terminal DKT1, the user's credit number, and the telephone number or IP address allocated by the public network PNW to the key telephone apparatus BT6. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses the user's key telephone apparatus BT6 via the public network PNW on the basis of the telephone number included in the function add request and acquires the function information and system ID from the key telephone apparatus BT6. The customer center CC determines on the basis of the acquired function information whether the functions the user wants to add are already in use and, if they are not in use, whether they can be added.

Then, on the basis of the result of the determination, the customer center CC informs the dealer DL by way of the Internet INW of a list of the functions already in use and the addable functions and a table of the charges for adding functions. The dealer DL transfers the notified function list and table of charges to the user's maintenance personal computer PC by way of the Internet INW. When receiving an acknowledge response from the user to the function list and table of charges, the dealer DL transmits a function download request to the customer center CC.

When receiving the function download request from the dealer DL, the customer center CC accesses the credit company CR to ask the company CR to settle the charges for the added functions. Then, receiving from the credit company CR a reply to the effect that the settlement request has been accepted, the customer center CC transmits the license code to the user's extension terminal DKT1 via the public network PNW. In the license code, an instruction code for setting the functions to be added “usable” is inserted. At this time, the instruction code is encrypted using the system ID previously acquired from the key telephone apparatus BT6.

When receiving the license code from the customer center CC, the extension terminal DKT1 decrypts the instruction code included in the license code, using the system ID of its own apparatus. Then, according to the decrypted instruction code, the extension terminal DKT1 changes the flag for the corresponding function in the function information setting table from “unusable” to “usable.” When finishing the process of setting the addition of functions, the extension terminal DKT1 sends back to the customer center CC information to the effect that the function adding process is completed properly.

When receiving a notice of the completion of the addition of functions from the extension terminal DKT1, the customer center CC disconnects the line with the extension terminal DKT1 and informs the dealer DL of the completion of the function adding process. Receiving the notice of the completion of the process, the dealer DL asks the credit company CR to pay the agent's commission.

As a result, the functions the user wants to add are set in the extension terminal DKT1 in such a manner that they are usable. Thereafter, in the user's extension terminal DKT1, the added optional service functions can be used.

The customer center CC's request to the credit company CR for a credit check of the user may be omitted. Instead of the customer center CC, the dealer DL may charge the expenses. Furthermore, the bank may settle the expenses in place of the credit company CR.

The configuration of each section of the support system that carries out the above-described function changing method is as follows.

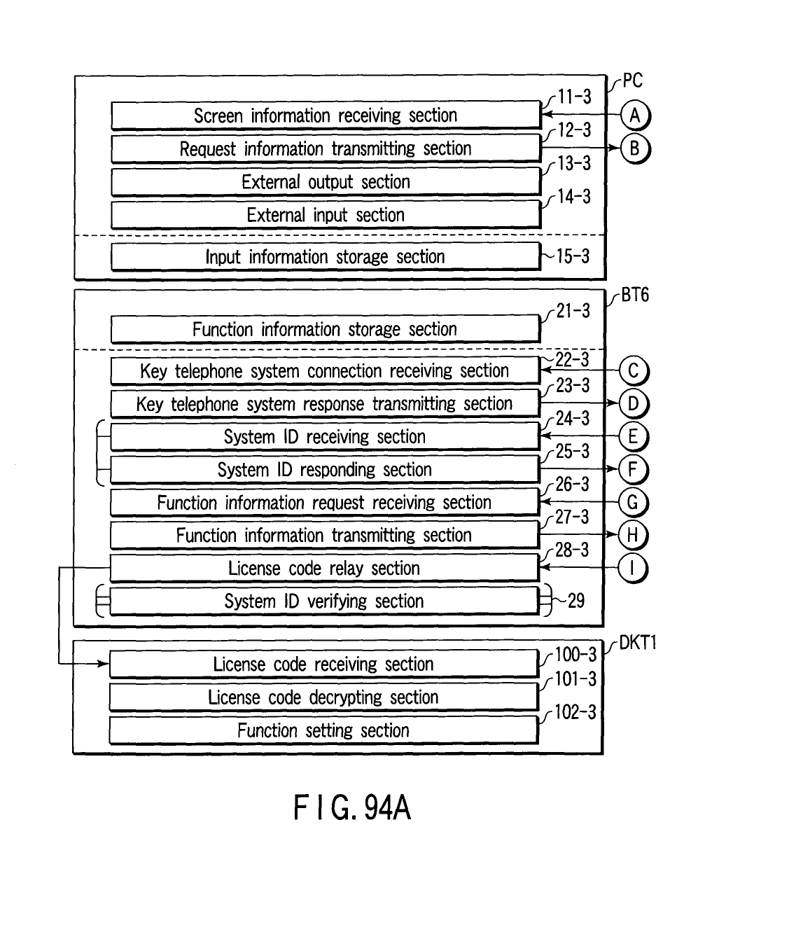

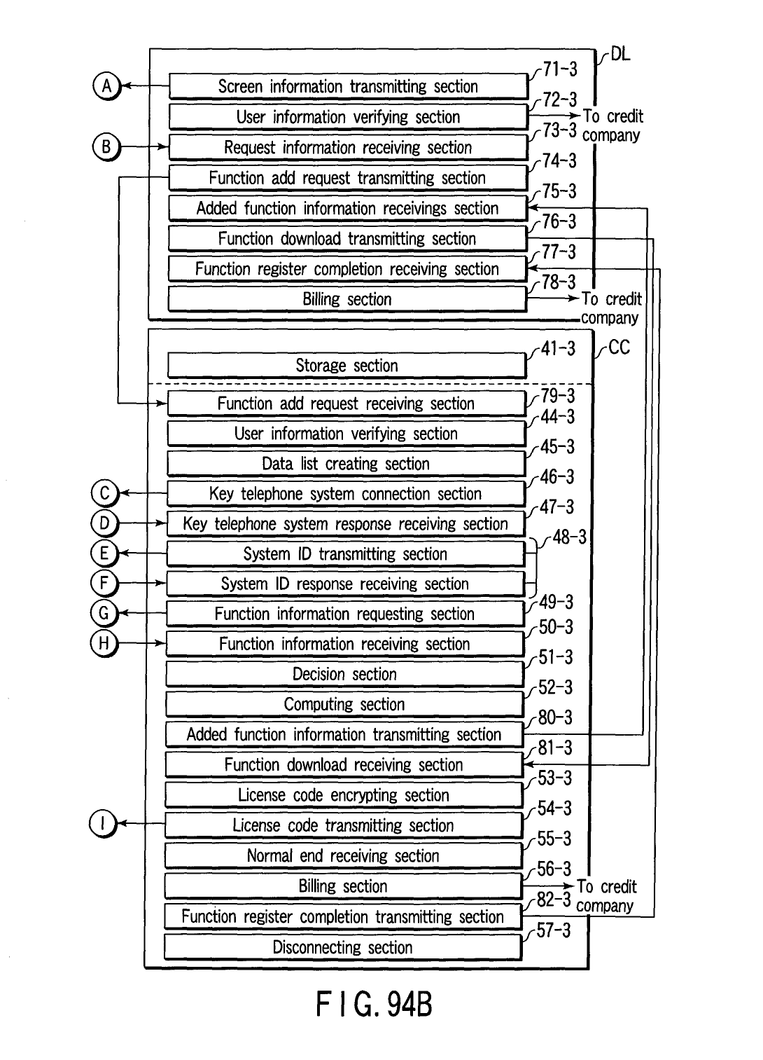

FIG. 94 is a block diagram showing a functional configuration of the maintenance personal computer PC, extension terminal DKT1, dealer DL, and customer center CC. In FIG. 94, the same parts as those in FIG. 89 are indicated by the same reference numerals. A detailed explanation of them will not be given.

The dealer DL includes a screen information transmitting section 71-3, an user information verifying section 72-3, a request information receiving section 73-3, a function add request transmitting section 74-3, an added function information receiving section 75-3, a function download transmitting section 76-3, a function register completion receiving section 77-3, and a billing section 78-3.

The screen information transmitting section 71-3, when being accessed by the user's maintenance personal computer PC, transmits a series of pieces of screen information for a function add request to the maintenance personal computer PC. The user information verify section 72-2 accesses the credit company CR on the basis of the credit number included in the received function add request information and inquires about the credit of the user. The request information receiving section 73-3 receives the function add request information sent from the maintenance personal computer PC.

The function add request transmitting section 74-3 transfers the function add request information coming from the user's maintenance personal computer PC to the customer center CC. The added function information receiving section 75-3 receives the added function notice information sent from the customer center CC and transfers this information to the requesting user's maintenance personal computer PC. When the maintenance personal computer PC sends back an acknowledge reply in response to the transfer of the added function notice information, the function download transmitting section 76-3 transmits a function download request to the customer center CC.

The function register completion receiving section 77-3 receives the function register completion notice sent from the customer center CC. After receiving the function register completion notice, the billing section 78-3 asks the credit company CR to bill the charges for the addition of functions.

The customer center CC includes as means for transmitting and receiving information to and from the dealer DL a function add request receiving section 79-3, an added function information transmitting section 80-3, a function download receiving section 81-3, and a function register completion transmitting section 82-3.

The function add request receiving section 79-3 receives the function add request information sent from the dealer DL. The added function information transmitting section 80-3 sends the function information about the extension terminal DKT1 acquired from the key telephone apparatus BT6 to the dealer DL. When the dealer DL sends a function down load request, the function download receiving section 8-31 receives this request and starts a function downloading process, or a license code transmitting process to the extension terminal DKT1. The function register completion transmitting section 82-3 transmits a function register completion notice to the dealer DL after the functions have been downloaded to the extension terminal DKT1 and the credit company CR has been asked to bill the charges.

The customer center CC executes the function adding process in the same procedure as shown in FIG. 25.

The dealer DL carries out the function adding process in the same procedure as shown in FIG. 26.

On the other hand, when receiving the title screen, user information input screen, verify request screen, add completion screen, user information reenter screen, and function adding process NG from the customer center CC, the user's maintenance personal computer PC executes the same procedure as in the third embodiment.

As described above, according to the function changing method of the fourteenth embodiment, a series of processes ranging from the user's request for the change of functions for the extension terminals DKT1 to DKT3 to the addition of functions to the user's extension terminals DKT1 to DKT3 is performed automatically via a communication network without human intervention, with the dealer DL intervening between the user and the customer center CC. This enables the time required to add functions to be shortened, the expenses the user pays to be reduced, and the labor and costs needed to change the functions at the dealer DL or the customer center CC to be reduced remarkably.

Since it is determined whether functions can be added, on the basis of function information about the extension terminals DKT1 to DKT3 acquired from the key telephone apparatus BT6, the function adding process can be carried out properly for each of the extension terminals DKT1 to DKT3. In addition, since the license code is encrypted using the system ID of the key telephone apparatus BT6 and extension terminals DKT1 to DKT3 and sent to the corresponding extension terminals DKT1 to DKT3, it is possible to prevent the wrong function or an unauthorized function from being added.

(Fifteenth Embodiment)

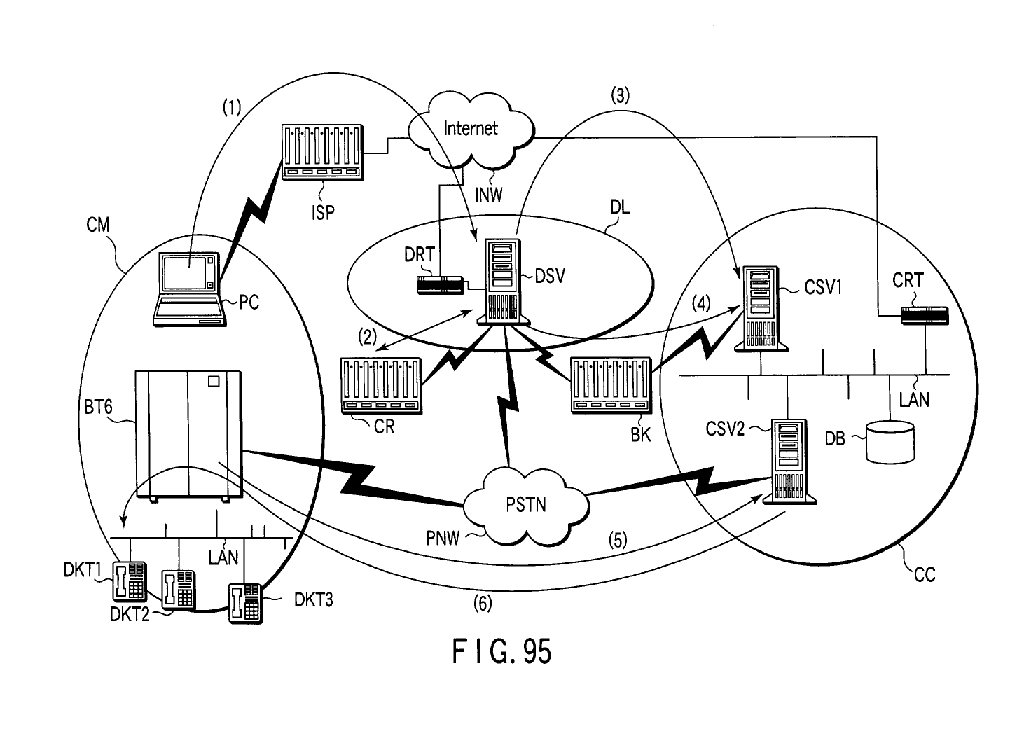

FIG. 95 schematically shows the configuration of a support system that carries out a function changing method according to a fifteenth embodiment of the present invention. In FIG. 95, the same parts as those in FIGS. 86 and 90 are indicated by the same reference numerals.

In the support system of the fifteenth embodiment, a dealer DL is further provided. The dealer DL includes a reception/charging/notifying server DSV and a router DRT. The reception/charging/notifying server DSV is connected to the Internet INW via the router DRT. The reception/charging/notifying server DSV is further connected via the Internet INW to the maintenance personal computer PC of the user system CM and the customer center CC. Then, the server DSV exchanges the information necessary for a function adding process with the maintenance personal computer PC and customer center CC.

Furthermore, the reception/charging/notifying server DSV is connected via an exclusive line to the credit company CR or the bank BK. The server DSV inquires the credit of the user from the credit company CR or bank BK and bills the agent's commission for adding functions.

On the other hand, in the customer center CC, there is provided an user database. In the user database DB, the system ID of, function information about, and telephone numbers of the key telephone apparatus BT6 and extension terminal 1 DKT1 to DKT3 the user has are stored in such a manner that they are caused to correspond to the user ID uniquely assigned to each user.

When a function add request has been transferred from the dealer DL, the reception/charging server CSV1 or license server CSV2 of the customer center CC accesses the user database DB on the basis of the user ID included in the function add request and reads the systems ID of, function information about, and telephone numbers of the key telephone apparatus BT6 and extension terminals DKT1 to DKT3 the user has. Then, using the read-out information, the server CSV1 or CSV2 determines whether the functions the user wants can be added, accesses the extension terminals DKT1 to DKT3, and transmits a license code.

Next, the procedure for adding functions to the extension terminal DKT1 in the above system will be explained.

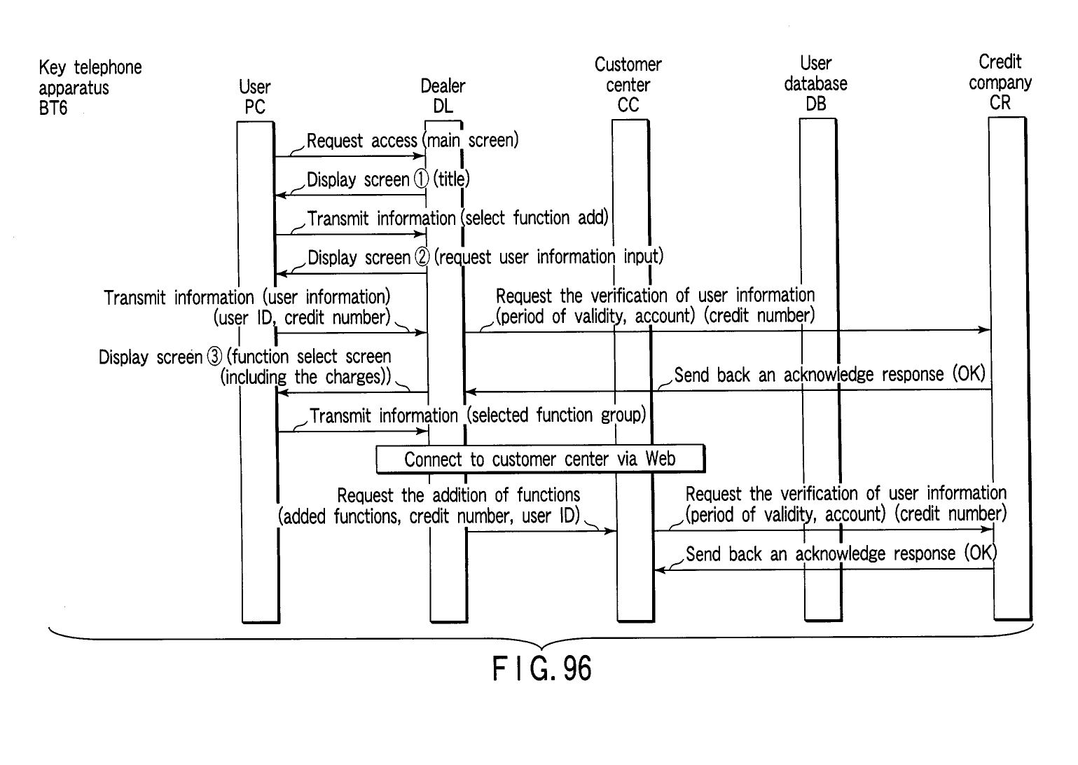

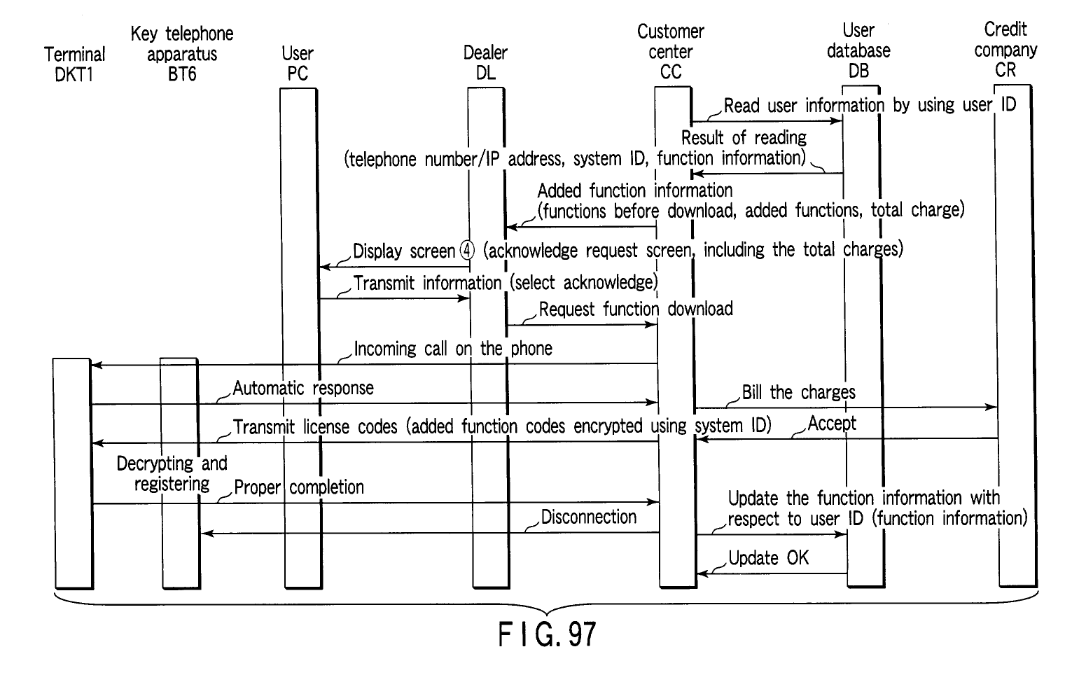

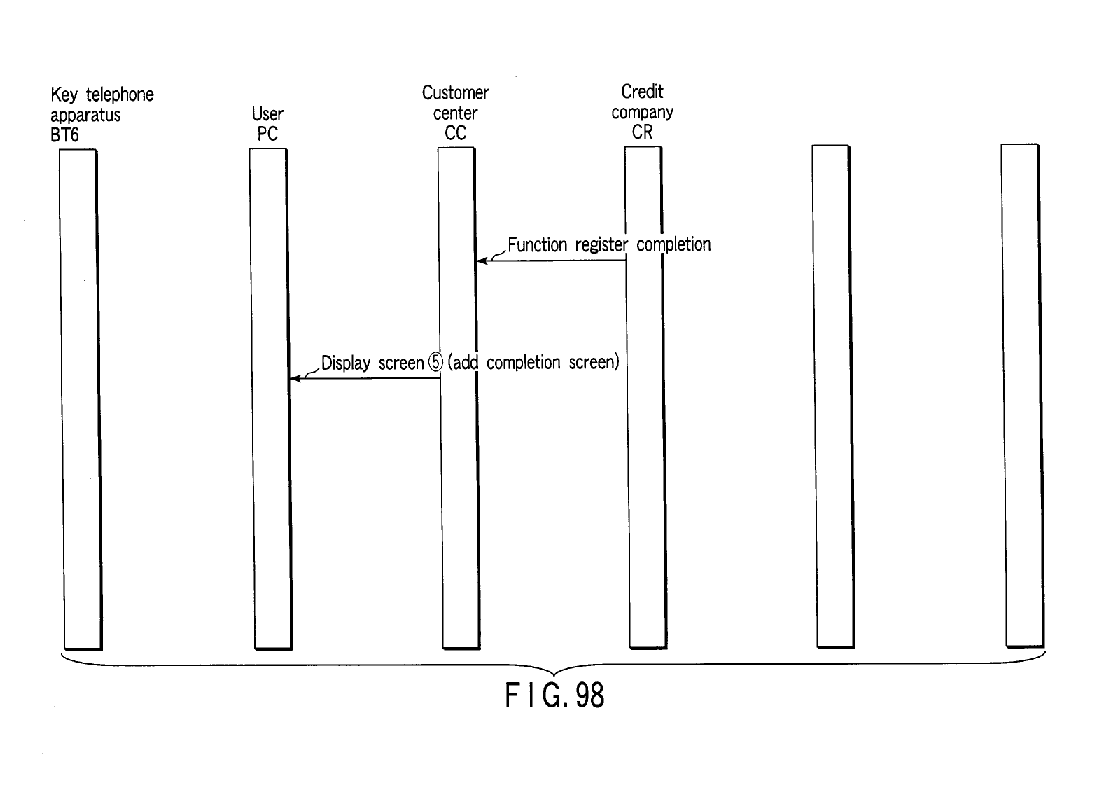

FIGS. 96 to 98 are schematic sequence diagrams to help explain the operation of transmitting and receiving information between the maintenance personal computer PC (or user PC) of the user system CM, the key telephone apparatus BT6, the extension terminal DKT1, the dealer DL, the customer center CC, and the credit company CR.

To add functions to the extension terminal DKT1, the user uses the maintenance personal computer PC to access the home page of the dealer DL by way of the Internet INW and inputs the necessary items related to the addition of functions to the extension terminal DKTl according to the guidance on the screen downloaded from the dealer DL. The necessary items to be inputted include information representing the functions to be added to the extension terminal DKT1, the user ID, and the credit number. After finishing the input of the necessary items, the user transmits a function add request including those pieces of information to the dealer DL.

Receiving the function add request, the dealer DL accesses the credit company CR via an exclusive line and inquires about the credit of the user on the basis of the user's credit number. On the inquiry, the credit company CR determines whether the account corresponding to the credit number is present, whether the expiration date of the credit is within the period of validity, and whether the cessation of use is set. Then, the credit company CR sends back the reply to the dealer DL.

On the basis of the reply from the credit company CR, the dealer DL judges the credit of the user. If there is no problem, the dealer DL transfers the function add request sent from the user to the customer center CC by way of the Internet INW.

Receiving the function add request, the customer center CC itself accesses the credit company CR to inquire about the credit of the user. If there is no problem, the customer center CC accesses the user database DB on the basis of the user ID included in the function add request and reads the system ID common to the key telephone apparatus BT6 and extension terminal DKT1 the user has, and function information about and telephone numbers of the key telephone apparatus BT6 and extension terminal DKT1.

Next, on the basis of the read-out function information about the extension terminal DKT1, the customer center CC determines whether the functions the user wants can be added, and, on the basis of the result of the determination, informs the dealer DL via the Internet INW of a list of the functions already in use and the addable functions and a list of the charges for adding functions. The dealer DL transfers the notified function list and the list of the charges to the user's maintenance personal computer PC by way of the Internet INW. Receiving an acknowledge response to a notice of the function list and the list of charges from the user, the dealer DL transmits a function download request to the customer center CC.

When receiving the function download request from the dealer DL, the customer center CC not only calls up the user's extension terminal DKT1 via the public network PNW on the basis of the telephone number of the key telephone apparatus BT6 read from the user database DB but also accesses the credit company CR to ask the company CR to settle the charges for the added functions. Then, receiving from the credit company CR a reply to the effect that the settlement request has been accepted, the customer center CC transmits a license code to the extension terminal DKT1. In the license code, an instruction code for setting the functions to be added “usable” is inserted. At this time, the instruction code is encrypted using the system ID common to the key telephone apparatus BT6 and extension terminal DKT1 previously read from the user database DB.

When receiving the license code from the customer center CC, the extension terminal DKT1 decrypts the instruction code included in the license code, using the system ID of its own terminal. Then, according to the decrypted instruction code, the extension terminal DKT1 changes the flag for the corresponding function in the function information setting table from “unusable” to “usable.” When finishing the process of setting the addition of functions, the extension terminal DKT1 sends back to the customer center CC information to the effect that the function adding process is completed properly.

When receiving a notice of the completion of the addition of functions from the extension terminal DKT1, the customer center CC disconnects the line with the extension terminal DKT1 and informs the dealer DL of the completion of the function adding process. Receiving the notice of the completion of the process, the dealer DL asks the credit company CR to pay the agent's commission.

As a result, the functions the user wants to add are set in the extension terminal DKT1 in such a manner that they are usable. Thereafter, in the user's extension terminal DKT1, the added optional service functions can be used.

As described in the fourteenth embodiment, the customer center CC's request to the credit company CR for a credit check of the user may be omitted. Instead of the customer center CC, the dealer DL may charge the expenses. Furthermore, the bank BK may settle the expenses in place of the credit company CR.

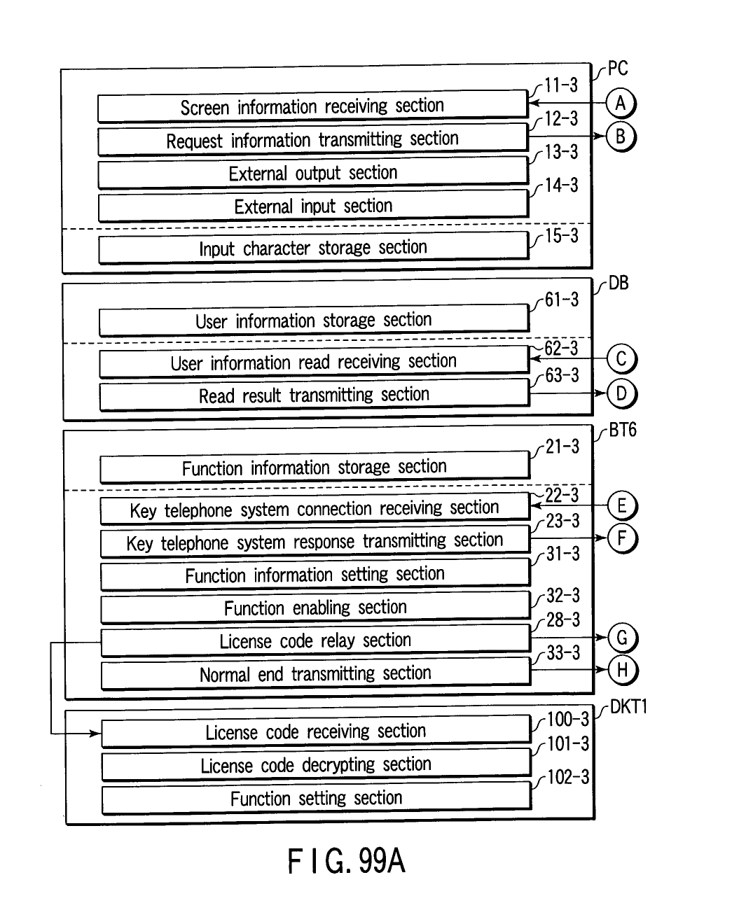

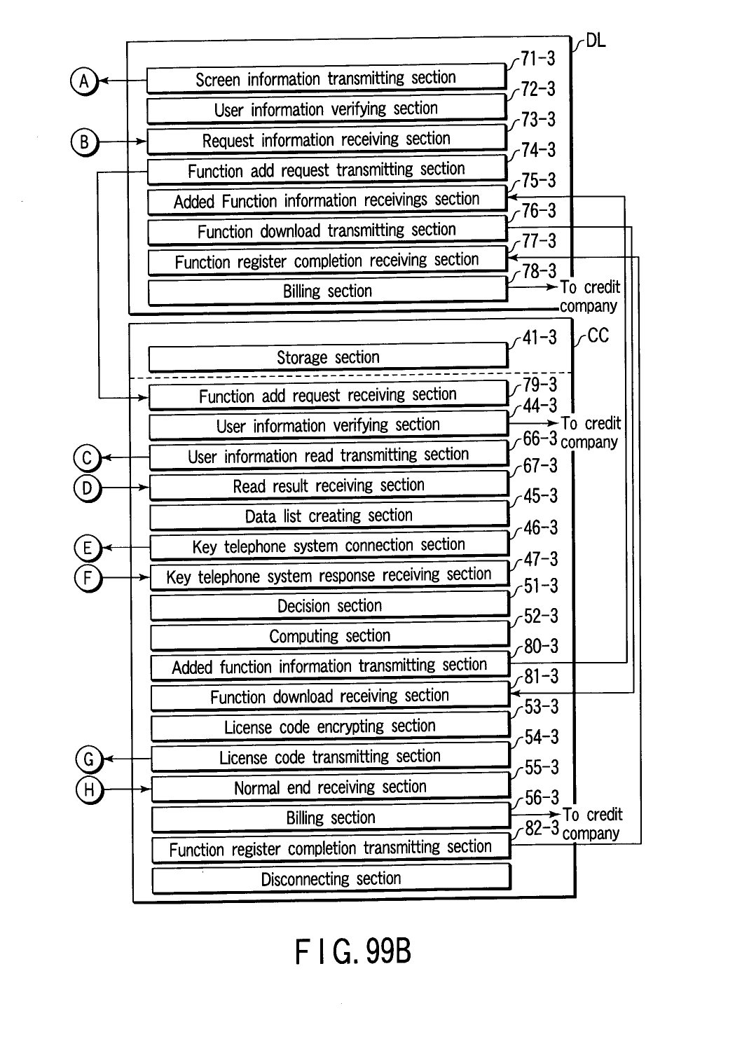

The configuration of each section of the support system that carries out the above-described function changing method is as shown in, for example, FIG. 99. Since the functional configuration shown in FIG. 99 is the same as those in FIGS. 89 and 94 in the thirteenth and fourteenth embodiments, its explanation will be omitted.

The customer center CC executes the function adding process in the same procedure as shown in FIG. 25.

The dealer DL carries out the function adding process in the same procedure as shown in FIG. 26.

On the other hand, when receiving the title screen, user information input screen, verify request screen, add completion screen, user information reenter screen, and function adding process NG from the customer center CC, the user's maintenance personal computer PC executes the same procedure as in the third embodiment.

As described above, according to the function changing method of the fifteenth embodiment, as in the fourteenth embodiment, a series of processes ranging from the user's request for the change of functions in the extension terminals DKT1 to DKT3 to the addition of functions to the user's extension terminals DKT1 to DKT3 is performed automatically via a communication network without human intervention, with the dealer DL intervening between the user and the customer center CC. This enables the time required to add functions to be shortened, the expenses the user pays to be reduced, and the labor and costs needed to change the functions at the dealer DL or the customer center CC to be reduced remarkably.

Furthermore, as in the thirteenth embodiment, it is determined whether the communication between the customer center CC and the extension terminals DKT1 to DKT3 can be performed or whether functions can be changed, on the basis of the user information accumulated and managed in the user database DB. This makes it unnecessary to acquire information about functions from the key telephone apparatus BT6 and extension terminals DKTJ to DKT3 each time the user uses the telephone apparatus. As a result, a suitable function changing process can be carried out according to a simple procedure.

Moreover, after the process of adding functions is completed, the customer center CC updates the corresponding function information in the user database DB. This makes it possible to always update the accumulated management information in the user database DB to the latest one automatically without the maintenance man in charge at the customer center CC carrying out the updating process manually.

(Other Embodiments)

While in the second, fourth, sixth, eighth, tenth, twelfth, thirteenth, and fifteenth embodiments, the user database DB has been provided in the customer center CC, it may be provided in the dealer DL. Alternatively, the user database DB may be provided in a third-party system.

In each of the embodiment, the user has transmitted the credit number when transmitting a function add request. The present invention is not limited to this. For instance, the credit number may be stored in the user database DB in advance in such a manner that it corresponds to the user ID. Then, the customer center CC or dealer DL may access the user database DB and get the credit number on the basis of the user ID sent from the user. This enables the user's credit number to be transferred only when the user information is registered in the user database DB. As a result, there is no possibility that the credit number will not be peeped at during the transmission of the function add request, which assures a better security.

Furthermore, in each of the embodiments, the programs for carrying out various optional service functions or the increase of the number of lines have been stored in the key telephone apparatuses beforehand. The use of each function has been managed using the corresponding usable/unusable flag in the service information table. The addition of a function is set by sending the license code from the customer center CC to change the flag to “usable.” The present invention is not restricted to this. For instance, the program that executes the function the user wants to add may be downloaded from the customer center into the key telephone apparatus, which then executes the function.

In addition, in each of the embodiments, the customer center has sent to the key telephone apparatus only the license code corresponding to the function to be added and caused the license code to set the flag for the added function to “usable.” Alternatively, the license codes for all the functions including the license code corresponding to the added function may be sent and used to update all of the service information table in the key telephone apparatus BT.

While in each of the embodiments, the addition of functions and the increase of the number of lines have been explained, functions and lines now in use can be eliminated in a similar manner.

Furthermore, while in each of the embodiments, the customer center has accessed the key telephone apparatus on the basis of the telephone number of the key telephone apparatus included in the function add request information sent from the user system and acquired function information about and the system ID of the key telephone apparatus, the present invention is not limited to this. For instance, when a personal computer is connected to the key telephone apparatus, function information about and the system ID of the key telephone apparatus may be included in the function add request information and sent.

While in the thirteenth embodiment, the user database DB has been provided in the customer center CC, the user database DB may not be provided there. In this case, the configuration of the customer center CC and key telephone apparatus BT6 is as shown in FIG. 8.

The fourteenth embodiment may have a configuration as shown in FIG. 76 of the eleventh embodiment. Moreover, the fifteenth embodiment may have a configuration as shown in FIG. 81 of the twelfth embodiment.

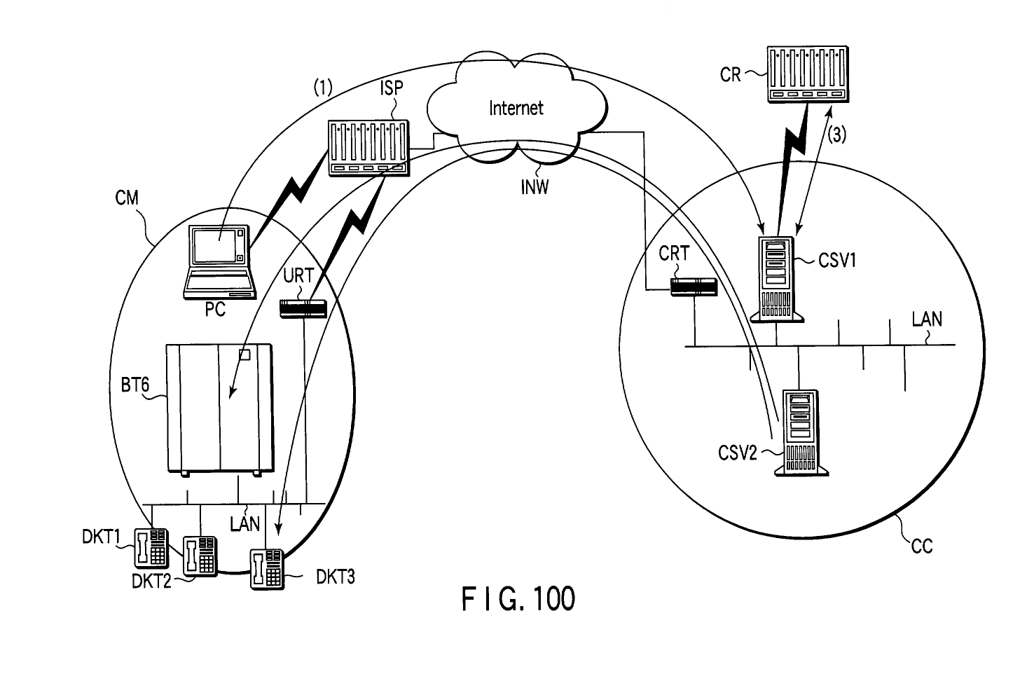

In the thirteenth to fifteenth embodiments, when a LAN that connects the extension terminals DKT1 to DKT3 as shown in FIG. 100 is connected via a router URT to the Internet INW, the license setup code may be transmitted directly to the extension terminal DKT3, not by way of the key telephone apparatus BT6.

While in the thirteenth to fifteenth embodiments, the customer center CC has accessed the key telephone apparatus to acquire the system ID and function information about the extension terminal, the customer center CC may access the extension terminal directly and acquires the system ID of and function information about the extension terminal.

As for the procedure for changing functions, the contents of the procedure, the configuration of the support system, the contents of the operation, the types of telephone apparatuses, and others, this invention may be practiced or embodied in still other ways without departing from the spirit or essential character thereof.

What is claimed is:

1. A method of changing functions of a plurality of telephone apparatuses by making an exchange of information via a communication network between an user system that includes the plurality of telephone apparatuses, and a customer center that supports the operation of the plurality of telephone apparatuses, the method comprising:
causing the user system to transmit to the customer center a function change request which includes an identification information to identify the telephone apparatuses whose functions are to be changed, a function change description of each of the telephone apparatuses whose functions are to be changed, and subscriber information allocated by the communication network to each of the telephone apparatuses; and
causing the customer center to create function change control information on each telephone apparatus on the basis of the identification information and the function change descriptions of the telephone apparatuses included in the function change request and transmit the plurality of pieces of function change control information via the communication network to the corresponding telephone apparatuses and thereby changing the function of each of the telephone apparatuses on the basis of the plurality of pieces of function change control information.

2. A method of changing functions of a plurality of telephone apparatuses by making an exchange of information via a communication network between an user system that includes the plurality of telephone apparatuses, and a customer center that supports the operation of the plurality of telephone apparatuses, the method comprising:
causing the user system to transmit to the customer center a function change request which includes an identification information to identify the telephone apparatuses whose functions are to be changed, a function change description of each of the telephone apparatuses whose functions are to be changed, and subscriber information allocated by the communication network to each of the telephone apparatuses; and
causing the customer center to access the corresponding telephone apparatuses via the communication network on the basis of the subscriber information included in the function change request transmitted from the user system and acquire information about the function from each of the telephone apparatuses; and
causing the customer center to create function change control information on each telephone apparatus on the basis of the information on the function acquired from each of the telephone apparatuses and the identification information and the function change descriptions included in the function change request, and transmit the plurality of pieces of function change control information via the communication network to the corresponding telephone apparatuses, and thereby changing the function of each of the telephone apparatuses on the basis of the plurality of pieces of function change control information.

3. A method of changing functions of a plurality of telephone apparatuses by making an exchange of information between an user system that includes the plurality of telephone apparatuses, and a customer center that supports the operation of the plurality of telephone apparatuses in a system which uses a communication network to connect the user system with the customer center and has an user database that stores subscriber information allocated by the communication network to each of the plurality of telephone apparatuses so as to correspond to individual identification information previously assigned to the user, private device identification information previously assigned to each of the plurality of telephone apparatuses, and information on the function of each of the plurality of telephone apparatuses, the method comprising:
causing the user system to transmit to the customer center a function change request which includes an identification information to identify the telephone apparatuses whose functions are to be changed, a function change description of each of the telephone apparatuses whose functions are to be changed, and individual identification information on the user;
causing the customer center to read the subscriber information and function information about each of the corresponding telephone apparatuses from the user database on the basis of the individual identification information on the user included in the function change request transmitted from the user system; and
causing the customer center to create function change control information on each telephone apparatus on the basis of the function information read from the user database and the identification information and the function change descriptions included in the function change request, access the corresponding telephone apparatuses via the communication network on the basis of the subscriber information on each of the telephone apparatuses read from the user database, and transmit the plurality of function change control information, and thereby changing the function of each of the telephone apparatuses on the basis of the plurality of pieces of function change control information.

4. A method of changing functions of a plurality of telephone apparatuses by making an exchange of information via a communication network between an user system that includes the plurality of telephone apparatuses, a customer center that supports the operation of the plurality of telephone apparatuses, and a dealer system that mediates between the user system and the customer center to help them to support the operation, the method comprising:
causing the user system to transmit to the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
causing the dealer system to transfer to the customer center the function change request transmitted from the user system; and
causing the customer center to create function change control information on each telephone apparatus on the basis of the identification information and the function change descriptions included in the function change request transferred from the dealer system, and transmit the plurality of pieces of function change control information via the communication network to the corresponding telephone apparatuses, and thereby changing the function of each of the telephone apparatuses on the basis of the plurality of pieces of function change control information.

5. A method of changing functions of a plurality of telephone apparatuses by making an exchange of information via a communication network between an user system that includes the plurality of telephone apparatuses, a customer center that supports the operation of the plurality of telephone apparatuses, and a dealer system that mediates between the user system and the customer center to help them to support the operation, the method comprising:
causing the user system to transmit to the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
causing the dealer system to transfer to the customer center the function change request transmitted from the user system;
causing the customer center to access the corresponding telephone apparatuses via the communication network on the basis of the subscriber information included in the function change request transferred from the dealer system and acquire function information from each of the telephone apparatuses; and
causing the customer center to create function change control information on each telephone apparatus on the basis of the function information acquired from each of the telephone apparatuses and the identification information and the function change descriptions included in the function change request, and transmit the plurality of pieces of function change control information via the communication network to the corresponding telephone apparatuses, and thereby changing the function of each of the telephone apparatuses on the basis of the plurality of pieces of function change control information.

6. A method of changing functions of a plurality of telephone apparatuses by making an exchange of information via a communication network between an user system that includes the plurality of telephone apparatuses, a customer center that supports the operation of the plurality of telephone apparatuses, and a dealer system that mediates between the user system and the customer center to help them to support the operation, the method comprising:
causing the user system to transmit to the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
causing the dealer system to transfer to the customer center the function change request transmitted from the user system;
causing the customer center to access the corresponding telephone apparatuses via the communication network on the basis of the subscriber information included in the function change request transferred from the dealer system and acquire function information from each of the telephone apparatuses;
causing the customer center to transfer to the dealer system the function information acquired from each of the telephone apparatuses and the function change request; and
causing the dealer system to create function change control information on each telephone apparatus on the basis of the function information transferred from the customer center and the identification information and the function change descriptions included in the function change request, and transmit the plurality of pieces of function change control information via the communication network to the corresponding telephone apparatuses on the basis of the subscriber information on the telephone apparatuses included in the function change request, and thereby changing the function of each of the telephone apparatuses on the basis of the plurality of pieces of function change control information.

7. A method of changing functions of a plurality of telephone apparatuses by making an exchange of information via a communication network between an user system that includes the plurality of telephone apparatuses, a customer center that supports the operation of the plurality of telephone apparatuses, and a dealer system that mediates between the user system and the customer center to help them to support the operation, the method comprising:
causing the user system to transmit to the customer center a function change request which includes an identification information to identify the telephone apparatuses whose functions are to be changed, a function change description of each of the telephone apparatuses whose functions are to be changed, and subscriber information allocated by the communication network to each of the telephone apparatuses;
causing the customer center to access the corresponding telephone apparatuses via the communication network on the basis of the subscriber information included in the function change request transmitted from the user system and acquire function information from each of the telephone apparatuses;
causing the customer center to transfer to the dealer system the function information acquired from the telephone apparatuses and the function change request; and
causing the dealer system to create function change control information on each telephone apparatus on the basis of the function information transferred from the customer center and the identification information and the function change descriptions included in the function change request, and transmit the plurality of pieces of function change control information via the communication network to the corresponding telephone apparatuses, and thereby changing the function of each of the telephone apparatuses on the basis of the plurality of pieces of function change control information.

8. A method of changing functions of a plurality of telephone apparatuses by making an exchange of information between an user system that includes the plurality of telephone apparatuses, a customer center that supports the operation of the plurality of telephone apparatuses, and a dealer system that mediates between the user system and the customer system to help them to support the operation in a system which uses a communication network to connect the user system, the customer center, and the dealer system to each other and has an user database that stores subscriber information allocated by the communication network to each of the plurality of telephone apparatuses so as to correspond to individual identification information previously assigned to the user, private device identification information previously assigned to each of the plurality of telephone apparatuses, and information on the function of each of the plurality of telephone apparatuses, the method comprising:
causing the user system to transmit to the dealer system a function change request which includes an identification information to identify the telephone apparatuses whose functions are to be changed, a function change description of each of the telephone apparatuses whose functions are to be changed, and individual identification information on the user;
causing the dealer system to transfer to the customer center the function change request transmitted from the user system;
causing the customer center to read the subscriber information and function information about each of the corresponding telephone apparatuses from the user database on the basis of the individual identification information on the user included in the function change request transmitted from the user system; and
causing the customer center to create function change control information on each telephone apparatus on the basis of the function information read from the user database and the identification information and the function change descriptions included in the function change request, access the corresponding telephone apparatuses via the communication network on the basis of the subscriber information on each of the telephone apparatuses read from the user database, and transmit the plurality of pieces of function change control information, and thereby changing the function of each of the telephone apparatuses on the basis of the plurality of pieces of function change control information.

9. A method of changing functions of a plurality of telephone apparatuses by making an exchange of information between an user system that includes the plurality of telephone apparatuses, a customer center that supports the operation of the plurality of telephone apparatuses, and a dealer system that mediates between the user system and the customer system to help them to support the operation in a system which uses a communication network to connect the user system, the customer center, and the dealer system to each other and has an user database that stores subscriber information allocated by the communication network to each of the plurality of telephone apparatuses so as to correspond to individual identification information previously assigned to the user, private device identification information previously assigned to each of the plurality of telephone apparatuses, and information on the function of each of the plurality of telephone apparatuses, the method comprising:
causing the user system to transmit to the dealer system a function change request which includes an identification information to identify the telephone apparatuses whose functions are to be changed, a function change description of each of the telephone apparatuses whose functions are to be changed, and individual identification information on the user;
causing the dealer system to transfer to the customer center the function change request transmitted from the user system;
causing the customer center to read the subscriber information and function information about each of the corresponding telephone apparatuses from the user database on the basis of the individual identification information on the user included in the function change request transmitted from the dealer system;
causing the customer center to transfer to the dealer system the subscriber information and function information about the telephone apparatuses read from the user database and the function change request; and
causing the dealer system to create function change control information on each telephone apparatus on the basis of the function information transferred from the customer center and the identification information and the function change descriptions included in the function change request, access the corresponding telephone apparatuses via the communication network on the basis of the subscriber information on each of the telephone apparatuses transferred from the customer center, and transmit the plurality of pieces of function change control information, and thereby changing the function of each of the telephone apparatuses on the basis of the plurality of pieces of function change control information.

10. A method of changing functions of a plurality of telephone apparatuses by making an exchange of information between an user system that includes the plurality of telephone apparatuses, a customer center that supports the operation of the plurality of telephone apparatuses, and a dealer system that mediates between the user system and the customer system to help them to support the operation in a system which uses a communication network to connect the user system, the customer center, and the dealer system to each other and has an user database that stores subscriber information allocated by the communication network to each of the plurality of telephone apparatuses so as to correspond to individual identification information previously assigned to the user, private device identification information previously assigned to each of the plurality of telephone apparatuses, and information on the function of each of the plurality of telephone apparatuses, the method comprising:
causing the user system to transmit to the customer center a function change request which includes an identification information to identify the telephone apparatuses whose functions are to be changed, a function change description of each of the telephone apparatuses whose functions are to be changed, and individual identification information on the user;
causing the customer center to read the subscriber information and function information about each of the corresponding telephone apparatuses from the user database on the basis of the individual identification information on the user included in the function change request transmitted from the user system;
causing the customer center to transfer to the dealer system the function change request transmitted from the user system and the subscriber information and function information about the telephone apparatuses read from the user database; and
causing the dealer system to create function change control information on each telephone apparatus on the basis of the function information transferred from the customer center and the identification information and the function change descriptions included in the function change request, access the corresponding telephone apparatuses via the communication network on the basis of the subscriber information on each of the telephone apparatuses transferred from the customer center, and transmit the plurality of pieces of function change control information, and thereby changing the function of each of the telephone apparatuses on the basis of the plurality of pieces of function change control information.

11. A customer center which is connected via a communication network to an user system that includes a plurality of telephone apparatuses, and which changes functions of the plurality of telephone apparatuses by exchanging information with the user system, the customer center comprising:
a function change request receiving circuit configured to receive from the user system a function change request which includes an identification information to identify the telephone apparatuses whose functions are to be changed, a function change description of each of the telephone apparatuses whose functions are to be changed, and subscriber information allocated by the communication network to each of the telephone apparatuses;
a creating circuit configured to create function change control information on each telephone apparatus to cause the telephone apparatuses to change function, on the basis of the identification information and the function change descriptions of the telephone apparatuses included in the function change request; and
a control information transmitting circuit configured to transmit the plurality of pieces of function change control information via the communication network to the corresponding telephone apparatuses.

12. A customer center which is connected via a communication network to an user system that includes a plurality of telephone apparatuses, and which changes functions of the plurality of telephone apparatuses by exchanging information with the user system, the customer center comprising:
a function change request receiving circuit configured to receive from the user system a function change request which includes an identification information to identify the telephone apparatuses whose functions are to be changed, a function change description of each of the telephone apparatuses whose functions are to be changed, and subscriber information allocated by the communication network to each of the telephone apparatuses;
a function information acquiring circuit configured to access the corresponding telephone apparatuses via the communication network on the basis of the subscriber information included in the function change request and to acquire function information from each of the telephone apparatuses;
a creating circuit configured to create function change control information on each telephone apparatus to cause the telephone apparatuses to change function, on the basis of the acquired function information and the identification information and the function change descriptions included in the function change request; and
a control information transmitting circuit configured to transmit the plurality of pieces of function change control information via the communication network to the corresponding telephone apparatuses.

13. A customer center which is connected via a communication network to an user system that includes a plurality of telephone apparatuses, and which changes functions of the plurality of telephone apparatuses by exchanging information with the user system, the customer center comprising:
an user database which stores subscriber information allocated by the communication network to each of the plurality of telephone apparatuses so as to correspond to individual identification information previously assigned to the user system, private device identification information previously assigned to each of the plurality of telephone apparatuses, and information on the function of each of the plurality of telephone apparatuses;
a function change request receiving circuit configured to receive from the user system a function change request which includes an identification information to identify the telephone apparatuses whose functions are to be changed, a function change description of each of the telephone apparatuses whose functions are to be changed, and individual identification information on the user system;
a reading circuit configured to read the subscriber information and function information about each of the corresponding telephone apparatuses from the user database on the basis of the individual identification information on the user system included in the function change request;
a creating circuit configured to create function change control information on each telephone apparatus to cause the telephone apparatuses to change function, on the basis of the read-out function information and the identification information and the function change descriptions included in the function change request; and
a control information transmitting circuit configured to access the corresponding telephone apparatuses via the communication network on the basis of the subscriber information on each of the telephone apparatuses read from the user database, to transmit the plurality of pieces of function change control information.

14. A customer center which is connected via a communication network to an user system that includes a plurality of telephone apparatuses, and to a dealer system and which changes functions of the plurality of telephone apparatuses by exchanging information with the user system via the dealer system, the customer center comprising:
a function change request receiving circuit configured to receive from the user system via the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
a creating circuit configured to create function change control information on each telephone apparatus to cause the telephone apparatuses to change function, on the basis of the identification information and the function change descriptions included in the function change request; and
a control information transmitting circuit configured to transmit the plurality of pieces of function change control information via the communication network to the corresponding telephone apparatuses.

15. A customer center which is connected via a communication network to an user system that includes a plurality of telephone apparatuses, and to a dealer system and which changes functions of the plurality of telephone apparatuses by exchanging information with the user system via the dealer system, the customer center comprising:
a function change request receiving circuit configured to receive from the user system via the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
a function information acquiring circuit configured to access the corresponding telephone apparatuses via the communication network on the basis of the subscriber information included in the function change request and to acquire function information from the telephone apparatuses;
a creating circuit configured to create function change control information on each telephone apparatus to cause the telephone apparatuses to change function, on the basis of the function information on each of the telephone apparatuses, and the identification information and the function change descriptions included in the function change request; and
a control information transmitting circuit configured to transmit the plurality of pieces of function change control information via the communication network to the corresponding telephone apparatuses.

16. A customer center which is connected via a communication network to an user system that includes a plurality of telephone apparatuses, and a dealer system and which changes functions of the plurality of telephone apparatuses by exchanging information with the user system via the dealer system, the customer center comprising:
a function change request receiving circuit configured to receive from the user system via the dealer system a function change request which includes an identification information to identify the telephone apparatuses whose functions are to be changed, a function change description of each of the telephone apparatuses whose functions are to be changed, and subscriber information allocated by the communication network to each of the telephone apparatuses;
a function information acquiring circuit configured to access the corresponding telephone apparatuses via the communication network on the basis of the subscriber information included in the function change request and to acquire function information from each of the telephone apparatuses; and
an information transferring circuit configured to transfer to the dealer system the function information acquired from the telephone apparatuses and the function change request.

17. A customer center which is connected via a communication network to an user system that includes a plurality of telephone apparatuses, and a dealer system and which changes functions of the plurality of telephone apparatuses by exchanging information with the user system via the dealer system, the customer center comprising:
a function change request receiving circuit configured to receive from the user system a function change request which includes an identification information to identify the telephone apparatuses whose functions are to be changed, a function change description of each of the telephone apparatuses whose functions are to be changed, and subscriber information allocated by the communication network to each of the telephone apparatuses;
a function information acquiring circuit configured to access the corresponding telephone apparatuses via the communication network on the basis of the subscriber information included in the function change request and to acquire function information from each of the telephone apparatuses; and
an information transferring circuit configured to transfer to the dealer system the function information acquired from each of the telephone apparatuses and the function change request.

18. A customer center which is connected via a communication network to an user system that includes a plurality of telephone apparatuses, and a dealer system and which changes functions of the plurality of telephone apparatuses by exchanging information with the user system via the dealer system, the customer center comprising:
an user database which stores subscriber information allocated by the communication network to each of the plurality of telephone apparatuses so as to correspond to individual identification information previously assigned to the user system, private device identification information previously assigned to each of the plurality of telephone apparatuses, and information on the function of each of the plurality of telephone apparatuses;
a function change request receiving circuit configured to receive from the user system via the dealer system a function change request which includes an identification information to identify the telephone apparatuses whose functions are to be changed, a function change description of each of the telephone apparatuses whose functions are to be changed, and individual identification information on the user system;
a reading circuit configured to read the subscriber information and function information about each of the corresponding telephone apparatuses from the user database on the basis of the individual identification information on the user system included in the function change request;
a creating circuit configured to create function change control information on each telephone apparatus to cause the telephone apparatuses to change function, on the basis of the function information read from the user database and the identification information and the function change descriptions included in the function change request; and
a control information transmitting circuit configured to access the corresponding telephone apparatuses via the communication network on the basis of the subscriber information on each of the telephone apparatuses read from the user database, to transmit the plurality of pieces of function change control information.

19. A customer center which is connected via a communication network to an user system that includes a plurality of telephone apparatuses, and a dealer system and which changes functions of the plurality of telephone apparatuses by exchanging information with the user system via the dealer system, the customer center comprising:
an user database which stores subscriber information allocated by the communication network to each of the plurality of telephone apparatuses so as to correspond to individual identification information previously assigned to the user system, private device identification information previously assigned to each of the plurality of telephone apparatuses, and information on the function of each of the plurality of telephone apparatuses;
a function change request receiving circuit configured to receive from the user system via the dealer system a function change request which includes an identification information to identify the telephone apparatuses whose functions are to be changed, a function change description of each of the telephone apparatuses whose functions are to be changed, and individual identification information on the user system;
a reading circuit configured to read the subscriber information and function information about each of the corresponding telephone apparatuses from the user database on the basis of the individual identification information on the user system included in the function change request; and
an information transferring circuit configured to transfer to the dealer system the subscriber information and function information about each of the telephone apparatuses read from the user database and the function change request.

20. A customer center which is connected via a communication network to an user system that includes a plurality of telephone apparatuses, and a dealer system and which changes functions of the plurality of telephone apparatuses by exchanging information with the user system via the dealer system, the customer center comprising:
an user database which stores subscriber information allocated by the communication network to each of the plurality of telephone apparatuses so as to correspond to individual identification information previously assigned to the user system, private device identification information previously assigned to each of the plurality of telephone apparatuses, and information on the function of each of the plurality of telephone apparatuses;
a function change request receiving circuit configured to receive from the user system a function change request which includes an identification information to identify the telephone apparatuses whose functions are to be changed, a function change description of each of the telephone apparatuses whose functions are to be changed, and individual identification information on the user system;
a reading circuit configured to read the subscriber information and function information about each of the corresponding telephone apparatuses from the user database on the basis of the individual identification information on the user system included in the function change request; and
an information transferring circuit configured to transfer to the dealer system the subscriber information and function information about each of the telephone apparatuses read from the user database and the function change request.

21. The customer center according to claim 12, further comprising a device identification information acquiring circuit configured to acquire from the plurality of telephone apparatuses not only function information but also device identification information previously assigned to each of the plurality of telephone apparatuses, wherein the control information transmitting circuit encrypts the plurality of pieces of function change control information using the acquired device identification information on each telephone apparatus and transmits the encrypted pieces of function change control information to the corresponding telephone apparatuses.

22. The customer center according to claim 13, further comprising a device identification information reading circuit configured to read device identification information on each of the corresponding telephone apparatuses from the user database on the basis of the individual identification information sent from the user system, wherein the control information transmitting circuit encrypts the plurality of pieces of function change control information using the device identification information on each telephone apparatus read from the user database and transmits the encrypted pieces of function change control information to the corresponding telephone apparatuses.

23. The customer center according to claim 12, further comprising a determining circuit configured to determine whether the function required by the user system can be changed, on the basis of the function information acquired from each of the telephone apparatuses and the function change descriptions included in the function change request, and to generate a decision signal indicating that the function change can be made, wherein the control information transmitting circuit transmits function change control information to the corresponding telephone apparatus via the communication network in response to the decision signal.

24. The customer center according to claim 13, further comprising a determining circuit configured to determine whether the requested function can be changed, on the basis of the function information read from the user database and the function change descriptions included in the function change request, and to generate a decision signal indicating that the function change can be made, wherein the control information transmitting circuit accesses the corresponding telephone apparatuses via the communication network in response to the decision signal, on the basis of the subscriber information on each of the telephone apparatuses read from the user database, transmits the function change control information on each telephone apparatus.

25. An user system which is connected to the customer center defined in claim 11 or 12, the user system comprising:
a receiving circuit configured to receive function change control information sent from the customer center; and
a function changing circuit configured to decrypt the function change control information by using device identification information previously assigned to its own telephone apparatus, and to give permission to execute function change according to the decrypted function change control information.

26. An user system which includes a plurality of telephone apparatuses, and which is connected to a customer center via a communication network, the user system comprising:
a function table which stores setting information about the effectiveness/ineffectiveness of at least part of all the functions in the plurality of telephone apparatuses;
a receiving circuit configured to receive function change control information on each telephone apparatus sent from the customer center via the communication network; and
a setting change circuit configured to change the setting information about the corresponding function in the function table to change the setting of the function, according to the contents of the function change control information.

27. A method of changing the number of lines which are usable in a telephone apparatus by making an exchange of information via a communication network between an user system includes the telephone apparatus that includes line interface of at least one type, and a customer center that supports the operation of the telephone apparatus, the method comprising:
causing the user system to transmit to the customer center a number-of-lines change request which includes a number-of-lines change description of each line type of the telephone apparatus and subscriber information allocated by the communication network to the telephone apparatus; and
causing the customer center to create number-of-lines change control information on the basis of the change description included in the number-of-lines change request and transmit the number-of-lines change control information via the communication network to the corresponding telephone apparatus and thereby changing the number of lines which are usable on the basis of the number-of-lines change control information.

28. A method of changing the number of lines which are usable in a telephone apparatus by making an exchange of information via a communication network between an user system includes the telephone apparatus that includes line interface of at least one type, and a customer center that supports the operation of the telephone apparatus, the method comprising:
causing the user system to transmit to the customer center a number-of-lines change request which includes a number-of-lines change description of each line type of the telephone apparatus and subscriber information allocated by the communication network to the telephone apparatus;
causing the customer center to access the corresponding telephone apparatus via the communication network on the basis of the subscriber information included in the number-of-lines change request transmitted from the user system and acquire information on the number of lines of each line type from the telephone apparatus; and
causing the customer center to create number-of-lines change control information on the basis of the information on the number of lines of each line type acquired from the telephone apparatus and the change description included in the number-of-lines change request and transmit the number-of-lines change control information via the communication network to the corresponding telephone apparatus and thereby changing the number of lines which are usable on the basis of the number-of-lines change control information.

29. A method of changing the number of lines which are usable in a telephone apparatus by making an exchange of information between an user system includes the telephone apparatus that includes line interface of at least one type, and a customer center that supports the operation of the telephone apparatuses in a system which uses a communication network to connect the user system with the customer center and has an user database that stores subscriber information allocated by the communication network to the telephone apparatuses so as to correspond to individual identification information previously assigned to the user, private device identification information previously assigned to the telephone apparatuses, and information on the number of lines of each line type of the telephone apparatuses, the method comprising:
causing the user system to transmit to the customer center a number-of-lines change request which includes a number-of-lines change description of each line type of the telephone and individual identification information on the user;
causing the customer center to read the subscriber information on the corresponding telephone apparatus and information on the number of lines of each line type of the corresponding telephone apparatus from the user database on the basis of the individual identification information on the user included in the number-of-lines change request transmitted from the user system; and
causing the customer center to create number-of-lines change control information on the basis of the information on the number of lines read from the user database and the number-of-lines change description included in the number-of-lines change request, access the corresponding telephone apparatus via the communication network on the basis of the subscriber information on the telephone apparatus read from the user database, and transmit the number-of-lines change control information, and thereby changing the number of lines which are usable on the basis of the number-of-lines change control information.

30. A method of changing the number of lines which are usable in a telephone apparatus by making an exchange of information via a communication network between an user system includes the telephone apparatus that includes line interface of at least one type, a customer center that supports the operation of the telephone apparatus, and a dealer system that mediates between the user system and the customer center to help them to support the operation, the method comprising:
causing the user system to transmit to the dealer system a number-of-lines change request which includes a number-of-lines change description of each line type of the telephone apparatus and subscriber information allocated by the communication network to the telephone apparatus;
causing the dealer system to transfer the number-of-lines change request transmitted from the user system to the customer center; and
causing the customer center to create number-of-lines change control information on the basis of the number-of-lines change description included in the number-of-lines change request transferred from the dealer system and transmit the number-of-lines change control information via the communication network to the corresponding telephone apparatus and thereby changing the number of lines which are usable on the basis of the number-of-lines change control information.

31. A method of changing the number of lines which are usable in a telephone apparatus by making an exchange of information via a communication network between an user system includes the telephone apparatus that includes line interface of at least one type, a customer center that supports the operation of the telephone apparatuses, and a dealer system that mediates between the user system and the customer center to help them to support the operation, the method comprising:
causing the user system to transmit to the dealer system a number-of-lines change request which includes a number-of-lines change description of each line type of the telephone apparatus and subscriber information allocated by the communication network to the telephone apparatus;
causing the dealer system to transfer the number-of-lines change request transmitted from the user system to the customer center;
causing the customer center to access the corresponding telephone apparatus via the communication network on the basis of the subscriber information included in the number-of-lines change request transferred from the dealer system and acquire information on the number of lines of each line type from the telephone apparatus; and
causing the customer center to create number-of-lines change control information on the basis of the information on the number of lines acquired from each of the telephone apparatus and the number-of-lines change description included in the function change request and transmit the number-of-lines change control information via the communication network to the corresponding telephone apparatus and thereby changing the number of lines which are usable on the basis of the number-of-lines change control information.

32. A method of changing the number of lines which are usable in a telephone apparatus by making an exchange of information via a communication network between an user system includes the telephone apparatus that includes line interface of at least one type, a customer center that supports the operation of the telephone apparatus, and a dealer system that mediates between the user system and the customer center to help them to support the operation, the method comprising:
causing the user system to transmit to the dealer system a number-of-lines change request which includes a number-of-lines change description of each line type of the telephone apparatuses and subscriber information allocated by the communication network to the telephone apparatuses;
causing the dealer system to transfer the number-of-lines change request transmitted from the user system to the customer center;
causing the customer center to access the corresponding telephone apparatus via the communication network on the basis of the subscriber information included in the number-of-lines change request transferred from the dealer system and acquire information on the number of lines of each line type from the telephone apparatus;
causing the customer center to transfer to the dealer system the information on the number of lines acquired from the telephone apparatus and the number-of-lines change request; and
causing the dealer system to create number-of-lines change control information on the basis of the information on the number of lines transferred from the customer center and the change description included in the number-of-lines change request and transmit the number-of-lines change control information via the communication network to the corresponding telephone apparatus on the basis of the subscriber information on the telephone apparatus included in the number-of-lines change request and thereby changing the number of lines which are usable on the basis of the number-of-lines change control information.

33. A method of changing the number of lines which are usable in a telephone apparatus by making an exchange of information via a communication network between an user system includes the telephone apparatus that includes line interface of at least one type, a customer center that supports the operation of the telephone apparatus, and a dealer system that mediates between the user system and the customer center to help them to support the operation, the method comprising:
causing the user system to transmit to the customer center a number-of-lines change request which includes a number-of-lines change description of each line type of the telephone apparatus and subscriber information allocated by the communication network to the telephone apparatus;
causing the customer center to access the corresponding telephone apparatus via the communication network on the basis of the subscriber information included in the number-of-lines change request transmitted from the user system and acquire information on the number of lines of each line type from the telephone apparatus;
causing the customer center to transfer to the dealer system the information on the number of lines acquired from the telephone apparatus and the number-of-lines change request; and
causing the dealer system to create number-of-lines change control information on the basis of the information on the number of lines transferred from the customer center and the number-of-lines change description included in the number-of-lines change request and transmit the number-of-lines change control information via the communication network to the corresponding telephone apparatus and thereby changing the number of lines which are usable on the basis of the number-of-lines change control information.

34. A method of changing the number of lines which are usable in a telephone apparatus by making an exchange of information between an user system includes the telephone apparatus that includes line interface of at least one type, a customer center that supports the operation of the telephone apparatuses, and a dealer system that mediates between the user system and the customer system to help them to support the operation in a system which uses a communication network to connect the user system, the customer center, and the dealer system to each other and has an user database that stores subscriber information allocated by the communication network to the telephone apparatus so as to correspond to individual identification information previously assigned to the user, private device identification information previously assigned to the telephone apparatus, and information on the number of lines of each line type of the telephone apparatuses, the method comprising:
causing the user system to transmit to the dealer system a number-of-lines change request which includes a number-of-lines change description of each line type of the telephone apparatuses and individual identification information on the user;
causing the dealer system to transfer to the customer center the number-of-lines change request transmitted from the user system;
causing the customer center to read the subscriber information on the corresponding telephone apparatus and the number of lines of each line type of the corresponding telephone apparatus from the user database on the basis of the individual identification information on the user included in the number-of-lines change request transmitted from the user system; and
causing the customer center to create number-of-lines change control information on the basis of the information on the number of lines read from the user database and the number-of-lines change description included in the number-of-lines change request, access the corresponding telephone apparatus via the communication network on the basis of the subscriber information on the telephone apparatus read from the user database, and transmit the number-of-lines change control information, and thereby changing the number of lines which are usable on the basis of the number-of-lines change control information.

35. A method of changing the number of lines which are usable in a telephone apparatus by making an exchange of information between an user system includes the telephone apparatus that includes line interface of at least one type, a customer center that supports the operation of the telephone apparatus, and a dealer system that mediates between the user system and the customer system to help them to support the operation in a system which uses a communication network to connect the user system, the customer center, and the dealer system to each other and has an user database that stores subscriber information allocated by the communication network to the telephone apparatus so as to correspond to individual identification information previously assigned to the user, private device identification information previously assigned to the telephone apparatus, and information on the number of lines of each line type of the telephone apparatus, the method comprising:
causing the user system to transmit to the dealer system a number-of-lines change request which includes a number-of-lines change description of each line type of the telephone apparatus and individual identification information on the user;
causing the dealer system to transfer to the customer center the number-of-lines change request transmitted from the user system;
causing the customer center to read the subscriber information on the corresponding telephone apparatus and the number of lines of each line type of the corresponding telephone apparatus from the user database on the basis of the individual identification information on the user included in the number-of-lines change request transmitted from the dealer system;
causing the customer center to transfer to the dealer system the subscriber information on the telephone apparatus and the information on the number of lines of the telephone apparatus read from the user database and the number-of-lines change request; and
causing the dealer system to create number-of-lines change control information on the basis of the information on the number of lines transferred from the customer center and the function change description included in the number-of-lines change request, access the corresponding telephone apparatus via the communication network on the basis of the subscriber information on the telephone apparatus transferred from the customer center, and transmit the number-of-lines change control information, and thereby changing the number of lines which are usable on the basis of the number-of-lines change control information.

36. A method of changing the number of lines which are usable in a telephone apparatus by making an exchange of information between an user system includes the telephone apparatus that includes line interface of at least one type, a customer center that supports the operation of the telephone apparatus, and a dealer system that mediates between the user system and the customer system to help them to support the operation in a system which uses a communication network to connect the user system, the customer center, and the dealer system to each other and has an user database that stores subscriber information allocated by the communication network to the telephone apparatus so as to correspond to individual identification information previously assigned to the user, private device identification information previously assigned to the telephone apparatuses, and information on the number of lines of each line type of the telephone apparatus, the method comprising:
causing the user system to transmit to the customer center a number-of-lines change request which includes a function change description of each line type of the telephone apparatuses and individual identification information on the user;
causing the customer center to read the subscriber information on the corresponding telephone apparatus and the information on the number of lines of each line type of the corresponding telephone apparatus from the user database on the basis of the individual identification information on the user included in the number-of-lines change request transmitted from the user system;
causing the customer center to transfer to the dealer system the number-of-lines change request transmitted from the user system and the subscriber information and information on the number of lines of each line type of each of the telephone apparatus read from the user database; and
causing the dealer system to create number-of-lines change control information on the basis of the information on the number of lines of each line type transferred from the customer center and the change description included in the number-of-lines change request, access the corresponding telephone apparatus via the communication network on the basis of the subscriber information on the telephone apparatus transferred from the customer center, and transmit the number-of-lines change control information, and thereby changing the number of lines which are usable on the basis of the number-of-lines change control information.

37. A customer center which is connected via a communication network to an user system includes a telephone apparatus that includes line interface of at least one type, and which changes the number of lines which are usable in the telephone apparatus by exchanging information with the user system, the customer center comprising:
a number-of-lines change request receiving circuit configured to receive from the user system a number-of-lines change request which includes a number-of-lines change description of the telephone apparatus and subscriber information allocated by the communication network to the telephone apparatuses;
a creating circuit configured to create number-of-lines change control information to cause the telephone apparatus to change the number of lines which are usable, on the basis of the change description included in the number-of-lines change request; and
a control information transmitting circuit configured to transmit the number-of-lines change control information via the communication network to the corresponding telephone apparatus.

38. A customer center which is connected via a communication network to an user system includes a telephone apparatus that includes line interface of at least one type, and which changes the number of lines which are usable in the telephone apparatus by exchanging information with the user system, the customer center comprising:
a number-of-lines change request receiving circuit configured to receive from the user system a number-of-lines change request which includes a number-of-lines change description of the telephone apparatuses and subscriber information allocated by the communication network to the telephone apparatuses;
a line information acquiring circuit configured to access the corresponding telephone apparatus via the communication network on the basis of the subscriber information included in the number-of-lines change request and to acquire information on the number of lines of each line type from the telephone apparatus;
a creating circuit configured to create number-of-lines change control information to cause the telephone apparatus to change the number of lines which are usable, on the basis of the information on the number of lines of each line type and the change description included in the number-of-lines change request; and
a control information transmitting circuit configured to transmit the number-of-lines change control information via the communication network to the corresponding telephone apparatus.

39. A customer center which is connected via a communication network to an user system includes a telephone apparatus that includes line interface of at least one type, and which changes the number of lines which are usable in the telephone apparatus by exchanging information with the user system, the customer center comprising:
an user database which stores subscriber information allocated by the communication network to the telephone apparatus so as to correspond to individual identification information previously assigned to the user system, private device identification information previously assigned to the telephone apparatus, and information on the number of lines of each line type of the telephone apparatus;
a number-of-lines change request receiving circuit configured to receive from the user system a number-of-lines change request which includes a number-of-lines change description of the telephone apparatus and individual identification information on the user system;
a reading circuit configured to read the subscriber information on the corresponding telephone apparatus and the number of lines of each line type of the corresponding telephone apparatus from the user database on the basis of the individual identification information on the user system included in the number-of-lines change request;
a creating circuit configured to create number-of-lines change control information to cause the telephone apparatus to change the number of lines which are usable, on the basis of the information on the number of lines read from the user database and the number-of-lines change description included in the number-of-lines change request; and
a control information transmitting circuit configured to access the corresponding telephone apparatus via the communication network on the basis of the subscriber information on the telephone apparatus read from the user database, to transmit the number-of-lines change control information.

40. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
a number-of-lines change request receiving circuit configured to receive from the user system via the dealer system a number-of-lines change request which includes a number-of-lines change description of the telephone apparatus and subscriber information allocated by the communication network to the telephone apparatus;
a creating circuit configured to create number-of-lines change control information to cause the telephone apparatus to change the number of lines which are usable, on the basis of the function change description included in the number-of-lines change request received by the number-of-lines change request receiving means; and
a control information transmitting circuit configured to transmit the number-of-lines change control information via the communication network to the corresponding telephone apparatus.

41. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
a number-of-lines change request receiving circuit configured to receive from the user system via the dealer system a number-of-lines change request which includes a function change description of the telephone apparatus and subscriber information allocated by the communication network to the telephone apparatus;
a line information acquiring circuit configured to access the corresponding telephone apparatus via the communication network on the basis of the subscriber information included in the number-of-lines change request and to acquire information on the number of lines of each line type from the telephone apparatus;
a creating circuit configured to create number-of-lines change control information to cause the telephone apparatus to change the number of lines which are usable, on the basis of the information on the number of lines of each line type of the telephone apparatus and the number-of-lines change description included in the number-of-lines change request; and
a control information transmitting circuit configured to transmit the number-of-lines change control information via the communication network to the corresponding telephone apparatus.

42. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
a number-of-lines change request receiving circuit configured to receive from the user system via the dealer system a number-of-lines change request which includes a number-of-lines change description of the telephone apparatus and subscriber information allocated by the communication network to the telephone apparatus;
a line information acquiring configured to access the corresponding telephone apparatus via the communication network on the basis of the subscriber information included in the number-of-lines change request, and to acquire information on the number of lines of each line type from the telephone apparatus; and
an information transferring circuit configured to transfer to the dealer system the information on the number of lines of each line type acquired from the telephone apparatus and the number-of-lines change request.

43. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
a number-of-lines change request receiving circuit configured to receive from the user system a number-of-lines change request which includes a number-of-lines change description of each line type of the telephone apparatus and subscriber information allocated by the communication network to the telephone apparatus;
a line information acquiring circuit configured to access the corresponding telephone apparatus via the communication network on the basis of the subscriber information included in the number-of-lines change request, and to acquire information on the number of lines of each line type from the telephone apparatus; and
an information transferring circuit configured to transfer to the dealer system the information on the number of lines of each line type acquired from the telephone apparatus and the number-of-lines change request.

44. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
an user database which stores subscriber information allocated by the communication network to the telephone apparatus so as to correspond to individual identification information previously assigned to the user system, private device identification information previously assigned to the telephone apparatus, and information on the number of lines of each line type of the telephone apparatus;
a number-of-lines change request receiving circuit configured to receive from the user system via the dealer system a number-of-lines change request which includes a number-of-lines change description of the telephone apparatus and individual identification information on the user system;
a reading circuit configured to read the subscriber information on the corresponding telephone apparatus and information on the number of lines of each line type of the corresponding telephone apparatus from the user database on the basis of the individual identification information on the user system included in the number-of-lines change request;
a creating circuit configured to create number-of-lines change control information to cause the telephone apparatus to change the number of lines which are usable, on the basis of the information on the number of lines of each line type read from the user database and the number-of-lines change description included in the number-of-lines change request; and
a control information transmitting circuit configured to access the corresponding telephone apparatus via the communication network on the basis of the subscriber information on the telephone apparatus read from the user database, to transmit the number-of-lines change control information.

45. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
an user database which stores subscriber information allocated by the communication network to the telephone apparatus so as to correspond to individual identification information previously assigned to the user system, private device identification information previously assigned to the telephone apparatus, and information on the number of lines of each lie type of the telephone apparatus;
a number-of-lines change request receiving circuit configured to receive from the user system via the dealer system a number-of-lines change request which includes a number-of-lines change description of the telephone apparatus and individual identification information on the user system;
a reading circuit configured to read the subscriber information on the corresponding telephone apparatus and information on the number of lines of each line type of the corresponding telephone apparatus from the user database on the basis of the individual identification information on the user system included in the number-of-lines change request; and
an information transferring circuit configured to transfer to the dealer system the subscriber information on the telephone apparatus and information on the number of lines of each line type of the telephone apparatus read from the user database and the number-of-lines change request.

46. A customer center which is connected via a communication network to an user system includes a telephone apparatus that includes line interface of at least one type, and to a dealer system and which changes the number of lines which are usable in the telephone apparatus by exchanging information with the user system via the dealer system, the customer center comprising:
an user database which stores subscriber information allocated by the communication network to the telephone apparatus so as to correspond to individual identification information previously assigned to the user system, private device identification information previously assigned to the telephone apparatus, and information on the number of lines of each line type of the telephone apparatus;
a number-of-lines change request receiving circuit configured to receive from the user system a number-of-lines change request which includes a number-of-lines change description of the telephone apparatus and individual identification information on the user system;
a reading circuit configured to read the subscriber information on the corresponding telephone apparatus and information on the number of lines of each line type of the corresponding telephone apparatus from the user database on the basis of the individual identification information on the user system included in the number-of-lines change request; and
an information transferring circuit configured to transfer to the dealer system the subscriber information on the telephone apparatus and information on the number of lines of each line type of the telephone apparatus read from the user database and the number-of-lines change request.

47. The customer center according to claim 38, further comprising a device identification information acquiring circuit configured to acquire from the telephone apparatus not only information on the number of lines of each line type but also device identification information previously assigned to the telephone apparatus, wherein the control information transmitting circuit encrypts the number-of-lines change control information using the acquired device identification information and transmits the encrypted number-of-lines change control information to the corresponding telephone apparatus.

48. The customer center according to claim 43, further comprising a device identification information reading circuit configured to read device identification information on the corresponding telephone apparatus from the user database on the basis of the individual identification information sent from the user system, wherein the control information transmitting circuit encrypts the number-of-lines change control information using the device identification information read from the user database and transmits the encrypted number-of-lines change control information to the corresponding telephone apparatus.

49. The customer center according to claim 42, further comprising a determining circuit configured to determine whether the number of lines required by the user system can be changed, on the basis of the information on the number of lines of each line type acquired from the telephone apparatus and the number-of-lines change description included in the number-of-lines change request, and to generate a decision signal indicating that the number-of-lines change can be made, wherein the control information transmitting circuit transmits number-of-lines change control information to the corresponding telephone apparatus via the communication network in response to the decision signal.

50. The customer center according to claim 39, further comprising a determining circuit configured to determine whether the requested number of lines can be changed, on the basis of the information on the number of lines of each line type read from the user database and the number-of-lines change description included in the number-of-lines change request, and to generate a decision signal indicating that the number-of-lines change can be made, wherein the control information transmitting circuit accesses the corresponding telephone apparatus via the communication network in response to the decision signal, on the basis of the subscriber information on the telephone apparatus read from the user database, transmits the number-of-lines change control information.

51. An user system which is connected to the customer center defined in claim 37 or 38, the user system comprising:
a receiving circuit configured to receive number-of-lines change control information sent from the customer center; and
a number-of-lines changing circuit configured to decrypt the number-of-lines change control information by using device identification information previously assigned to its own telephone apparatus and to give permission to execute number-of-lines change according to the decrypted number-of-lines change control information.

52. An user system includes a telephone apparatus that includes line interface of at least one type, and is connected to a customer center via a communication network, the user system comprising:
a line table which stores setting information about the effectiveness/ineffectiveness of at least part of all the lines in the telephone apparatus;
a receiving circuit configured to receive number-of-lines change control information sent from the customer center via the communication network; and
a setting change circuit configured to change the setting information about the corresponding line in the line table to change the setting of the line, according to the contents of the number-of-lines change control information.

53. A method of changing functions of terminal by making an exchange of information via a communication network between an user system includes a main apparatus that connect at least one terminal via line, and a customer center that supports the operation of the terminals, the method comprising:
causing the user system to transmit to the customer center a function change request which includes a function change description of the terminal and subscriber information allocated by the communication network to the main apparatuses; and
causing the customer center to create function change control information on the basis of the function change description of the terminal included in the function change request, and transmit the function change control information via the communication network to the corresponding terminal, and thereby changing the function of the terminal on the basis of the function change control information.

54. A method of changing functions of terminal by making an exchange of information via a communication network between an user system includes a main apparatus that connect at least one terminals via line, and a customer center that supports the operation of the terminal, the method comprising:
causing the user system to transmit to the customer center a function change request which includes a function change description of the terminal, and subscriber information allocated by the communication network to the main apparatus; and
causing the customer center to access the corresponding main apparatus via the communication network on the basis of the subscriber information included in the function change request transmitted from the user system and acquire information about the functions of the terminal from the main apparatus; and
causing the customer center to create function change control information on the basis of the information on the functions of the terminal acquired from the main apparatus and the function change description included in the function change request, and transmit the function change control information via the communication network to the corresponding terminal, and thereby changing the function of the terminal on the basis of the function change control information.

55. A method of changing functions of terminal by making an exchange of information between an user system includes a main apparatus that connects at least one terminal via line, and a customer center that supports the operation of the terminals in a system which uses a communication network to connect the user system with the customer center and has an user database that stores subscriber information allocated by the communication network to the main apparatuses so as to correspond to individual identification information previously assigned to the user, private device identification information previously assigned to the main apparatus and the terminals, and information on the functions of the terminal, the method comprising:
causing the user system to transmit to the customer center a function change request which includes a function change description of the terminal and individual identification information on the user;
causing the customer center to read the subscriber information on the corresponding main apparatus and the functions of the terminal from the user database on the basis of the individual identification information on the user included in the function change request transmitted from the user system; and
causing the customer center to create function change control information on the basis of the function information on the terminal read from the user database and the function change description included in the function change request, access the corresponding terminal via the communication network on the basis of the subscriber information on the main apparatus read from the user database, and transmit the function change control information, and thereby changing the function of the terminal on the basis of the function change control information.

56. A method of changing functions of terminal by making an exchange of information via a communication network between an user system includes a main apparatuses that connect at least one terminal via line, a customer center that supports the operation of the terminal, and a dealer system that mediates between the user system and the customer center to help them to support the operation, the method comprising:
causing the user system to transmit to the dealer system a function change request which includes a function change description of the terminal and subscriber information allocated by the communication network to the main apparatus;
causing the dealer system to transfer the function change request transmitted from the user system to the customer center; and
causing the customer center to create function change control information on the basis of the function change description included in the function change request transferred from the dealer system, and transmit the function change control information via the communication network to the corresponding terminal and thereby changing the function of the terminal on the basis of the function change control information.

57. A method of changing functions of terminal by making an exchange of information via a communication network between an user system includes a main apparatus that connects at least one terminal via line, a customer center that supports the operation of the terminals, and a dealer system that mediates between the user system and the customer center to help them to support the operation, the method comprising:
causing the user system to transmit to the dealer system a function change request which includes a function change description of the terminals and subscriber information allocated by the communication network to the main apparatuses;
causing the dealer system to transfer the function change request transmitted from the user system to the customer center;
causing the customer center to access the corresponding main apparatus via the communication network on the basis of the subscriber information included in the function change request transferred from the dealer system and acquire information on the functions of the terminal from the main apparatus; and
causing the customer center to create function change control information on the basis of the information on the functions of the terminal acquired from the main apparatus and the function change description included in the function change request, and transmit the function change control information via the communication network to the corresponding terminal, and thereby changing the function of the terminal on the basis of the function change control information.

58. A method of changing functions of terminal by making an exchange of information via a communication network between an user system includes a main apparatus that connects at least one terminal via line, a customer center that supports the operation of the terminal, and a dealer system that mediates between the user system and the customer center to help them to support the operation, the method comprising:
causing the user system to transmit to the dealer system a function change request which includes a function change description of the terminal and subscriber information allocated by the communication network to the main apparatus;
causing the dealer system to transfer the function change request transmitted from the user system to the customer center;
causing the customer center to access the corresponding main apparatus via the communication network on the basis of the subscriber information included in the function change request transferred from the dealer system and acquire information on the function of the terminal from the main apparatus;
causing the customer center to transfer to the dealer system the function information on the terminals acquired from the main apparatus and the function change request; and
causing the dealer system to create function change control information on the basis of the function information transferred from the customer center and the function change description included in the function change request, and transmit the function change control information via the communication network to the corresponding terminal on the basis of the subscriber information on the main apparatus included in the function change request, and thereby changing the function of the terminal on the basis of the function change control information.

59. A method of changing functions of terminal by making an exchange of information via a communication network between an user system includes a main apparatus that connect at least one terminal via line, a customer center that supports the operation of the terminal, and a dealer system that mediates between the user system and the customer center to help them to support the operation, the method comprising:
causing the user system to transmit to the customer center a function change request which includes a function change description of the terminal and subscriber information allocated by the communication network to the main apparatus;
causing the customer center to access the corresponding main apparatus via the communication network on the basis of the subscriber information included in the function change request transmitted from the user system and acquire information on the functions of the terminal from the main apparatus;
causing the customer center to transfer to the dealer system the information on the functions of the terminals acquired from the main apparatus and the function change request; and
causing the dealer system to create function change control information on the basis of the function information transferred from the customer center and the function change description included in the function change request, and transmit the function change control information via the communication network to the corresponding terminal, and thereby changing the function of the terminal on the basis of the function change control information.

60. A method of changing functions of terminal by making an exchange of information between an user system includes a main apparatus that connects at least one terminal via line, a customer center that supports the operation of the terminal, and a dealer system that mediates between the user system and the customer system to help them to support the operation in a system which uses a communication network to connect the user system, the customer center, and the dealer system to each other and has an user database that stores subscriber information allocated by the communication network to the main apparatus so as to correspond to individual identification information previously assigned to the user, private device identification information previously assigned to the main apparatus and the terminals, and information on the functions of the terminal, the method comprising:
causing the user system to transmit to the dealer system a function change request which includes a function change description of the terminal and individual identification information on the user;
causing the dealer system to transfer to the customer center the function change request transmitted from the user system;
causing the customer center to read the subscriber information and function information about the corresponding main apparatus from the user database on the basis of the individual identification information on the user included in the function change request transmitted from the user system; and
causing the customer center to create function change control information on the basis of the function information read from the user database and the function change description included in the function change request, access the corresponding terminal via the communication network on the basis of the subscriber information on the main apparatus read from the user database, and transmit the function change control information, and thereby changing the function of the terminal on the basis of the function change control information.

61. A method of changing functions of terminal by making an exchange of information between an user system includes a main apparatus that connect at least one terminal via line, a customer center that supports the operation of the terminal, and a dealer system that mediates between the user system and the customer center to help them to support the operation in a system which uses a communication network to connect the user system, the customer center, and the dealer system to each other and has an user database that stores subscriber information allocated by the communication network to the main apparatus so as to correspond to individual identification information previously assigned to the user, private device identification information previously assigned to the main apparatus and the terminals, and information on the functions of the terminal, the method comprising:
causing the user system to transmit to the dealer system a function change request which includes a function change description of the terminal and individual identification information on the user;
causing the dealer system to transfer to the customer center the function change request transmitted from the user system;
causing the customer center to read the subscriber information and function information about the corresponding main apparatus from the user database on the basis of the individual identification information on the user included in the function change request transmitted from the dealer system;
causing the customer center to transfer to the dealer system the subscriber information on the main apparatus and information on the functions of the terminal read from the user database and the function change request; and
causing the dealer system to create function change control information on the basis of the information on the functions of the terminal transferred from the customer center and the function change description included in the function change request, access the corresponding terminal via the communication network on the basis of the subscriber information on the main apparatus transferred from the customer center, and transmit the function change control information, and thereby changing the function of the terminal on the basis of the function change control information.

62. A method of changing functions of terminal by making an exchange of information between an user system includes a main apparatus that connect at least one terminal via line, a customer center that supports the operation of the terminal, and a dealer system that mediates between the user system and the customer system to help them to support the operation in a system which uses a communication network to connect the user system, the customer center, and the dealer system to each other and has an user database that stores subscriber information allocated by the communication network to the main apparatus so as to correspond to individual identification information previously assigned to the user, private device identification information previously assigned to the main apparatus and the terminals, and information on the functions of the terminal, the method comprising:
causing the user system to transmit to the customer center a function change request which includes a function change description of the terminal and individual identification information on the user;
causing the customer center to read the subscriber information on the corresponding main apparatus and information on the functions of the terminal from the user database on the basis of the individual identification information on the user included in the function change request transmitted from the user system;
causing the customer center to transfer to the dealer system the function change request transmitted from the user system and the subscriber information on the main apparatus and information on the functions of the terminal read from the user database; and
causing the dealer system to create function change control information on the basis of the function information transferred from the customer center and the function change description included in the function change request, access the corresponding terminal via the communication network on the basis of the subscriber information on the main apparatus transferred from the customer center, and transmit the function change control information, and thereby changing the function of the terminal on the basis of the function change control information.

63. A customer center which is connected via a communication network to an user system includes a main apparatus that connects at least one terminal via line and which changes functions of the terminals by exchanging information with the user system, the customer center comprising:
a function change request receiving circuit configured to receive from the user system a function change request which includes a function change description of the terminal and subscriber information allocated by the communication network to the main apparatuses;
a creating circuit configured to create function change control information to cause the terminal to change functions, on the basis of the function change description included in the function change request; and
a control information transmitting circuit configured to transmit the function change control information via the communication network to the corresponding terminal.

64. A customer center which is connected via a communication network to an user system includes a main apparatus that connects at least one terminal via line and which changes functions of the terminal by exchanging information with the user system, the customer center comprising:
a function change request receiving circuit configured to receive from the user system a function change request which includes a function change description of the terminal and subscriber information allocated by the communication network to the main apparatus;
a function information acquiring circuit configured to access the corresponding terminal via the communication network on the basis of the subscriber information included in the function change request, and to acquire function information from the terminal;
a creating circuit configured to create function change control information to cause the terminal to change functions, on the basis of the acquired function information and the function change description included in the function change request; and
a control information transmitting circuit configured to transmit the function change control information via the communication network to the corresponding terminal.

65. A customer center which is connected via a communication network to an user system includes a main apparatus that connects at least one terminal via line, and which changes functions of the terminals by exchanging information with the user system, the customer center comprising:
an user database which stores subscriber information allocated by the communication network to the main apparatus so as to correspond to individual identification information previously assigned to the user system, private device identification information previously assigned to the main apparatus and the terminals, and information on the functions of the terminal;
a function change request receiving circuit configured to receive from the user system a function change request which includes a function change description of the terminal and individual identification information on the user system;
a reading circuit configured to read the subscriber information and function information about the corresponding terminal from the user database on the basis of the individual identification information on the user system included in the function change request;
a creating circuit configured to create function change control information to cause the terminal to change functions, on the basis of the function information read from the user database and the function change description included in the function change request; and
a control information transmitting circuit configured to access the corresponding terminal via the communication network on the basis of the subscriber information on the main apparatus read from the user database, to transmit the function change control information.

66. A customer center which is connected via a communication network to an user system includes a main apparatus that connects at least one terminal via line, and to a dealer system, and which changes functions of the terminal by exchanging information with the user system via the dealer system, the customer center comprising:
a function change request receiving circuit configured to receive from the user system via the dealer system a function change request which includes a function change description of the terminal and subscriber information allocated by the communication network to the main apparatus;
a creating circuit configured to create function change control information to cause the terminal to change functions, on the basis of the function change description included in the function change request; and
a control information transmitting circuit configured to transmit the function change control information via the communication network to the corresponding terminal.

67. A customer center which is connected via a communication network to an user system includes a main apparatus that connects at least one terminal via line, and to a dealer system, and which changes functions of the terminal by exchanging information with the user system via the dealer system, the customer center comprising:
a function change request receiving circuit configured to receive from the user system via the dealer system a function change request which includes a function change description of the terminal and subscriber information allocated by the communication network to the main apparatus;
a function information acquiring circuit configured to access the corresponding terminal via the communication network on the basis of the subscriber information included in the function change request, and to acquire function information from the terminal;
a creating circuit configured to create function change control information to cause the terminal to change functions, on the basis of the function information on the terminal and the function change description included in the function change request; and
a control information transmitting circuit configured to transmit the function change control information via the communication network to the corresponding terminal.

68. A customer center which is connected via a communication network to an user system includes a main apparatus that connects at least one terminal via line, and to a dealer system, and which changes functions of the terminal by exchanging information with the user system via the dealer system, the customer center comprising:
a function change request receiving circuit configured to receive from the user system via the dealer system a function change request which includes a function change description of the terminal and subscriber information allocated by the communication network to the main apparatus;
a function information acquiring circuit configured to access the corresponding terminal via the communication network on the basis of the subscriber information included in the function change request, and to acquire function information from the terminal; and
an information transferring circuit configured to transfer to the dealer system the function information acquired from the terminal and the function change request.

69. A customer center which is connected via a communication network to an user system includes a main apparatus that connects at least one terminal via line, and to a dealer system, and which changes functions of the terminal by exchanging information with the user system via the dealer system, the customer center comprising:
a function change request receiving circuit configured to receive from the user system a function change request which includes a function change description of the terminal and subscriber information allocated by the communication network to the main apparatus;
a function information acquiring circuit configured to access the corresponding terminal via the communication network on the basis of the subscriber information included in the function change request, and to acquire function information from the terminal; and
an information transferring circuit configured to transfer to the dealer system the function information acquired from the terminal and the function change request.

70. A customer center which is connected via a communication network to an user system includes a main apparatus that connects at least one terminal via line, and to a dealer system, and which changes functions of the terminal by exchanging information with the user system via the dealer system, the customer center comprising:
an user database which stores subscriber information allocated by the communication network to the main apparatuses so as to correspond to individual identification information previously assigned to the user system, private device identification information previously assigned to the main apparatus and the terminals, and information on the functions of the terminal;
a function change request receiving circuit configured to receive from the user system via the dealer system a function change request which includes a function change description of the terminal and individual identification information on the user system;
a reading circuit configured to read the subscriber information on the corresponding main apparatus and information on the functions of the terminal from the user database on the basis of the individual identification information on the user system included in the function change request;
a creating circuit configured to create function change control information to cause the terminal to change functions, on the basis of the function information read from the user database and the function change description included in the function change request; and
a control information transmitting circuit configured to access the corresponding terminal via the communication network on the basis of the subscriber information on the main apparatus read from the user database, to transmit the function change control information.

71. A customer center which is connected via a communication network to an user system includes a main apparatus that connects at least one terminal via line, and to a dealer system, and which changes functions of the terminal by exchanging information with the user system via the dealer system, the customer center comprising:
an user database which stores subscriber information allocated by the communication network to the main apparatus so as to correspond to individual identification information previously assigned to the user system, private device identification information previously assigned to the main apparatus and the terminals, and information on the functions of the terminal;
a function change request receiving circuit configured to receive from the user system via the dealer system a function change request which includes a function change description of the terminal and individual identification information on the user system;
a reading circuit configured to read the subscriber information on the corresponding main apparatus and the information on the functions of the terminal from the user database on the basis of the individual identification information on the user system included in the function change request; and
an information transferring circuit configured to transfer to the dealer system the subscriber information on the main apparatus and information on the functions of the terminal read from the user database and the function change request.

72. A customer center which is connected via a communication network to an user system includes a main apparatus that connects at least one terminal via line, and to a dealer system, and which changes functions of the terminal by exchanging information with the user system via the dealer system, the customer center comprising:
an user database which stores subscriber information allocated by the communication network to the main apparatuses so as to correspond to individual identification information previously assigned to the user system, private device identification information previously assigned to the main apparatus and the terminals, and information on the functions of the terminal;
a function change request receiving circuit configured to receive from the user system a function change request which includes a function change description of the terminal and individual identification information on the user system;
a reading circuit configured to read the subscriber information on the corresponding main apparatus and information on the functions of the terminal from the user database on the basis of the individual identification information on the user system included in the function change request; and
an information transferring circuit configured to transfer to the dealer system the subscriber information on the main apparatus and information on the functions of the terminal read from the user database and the function change request.

73. The customer center according to claim 64, further comprising a device identification information acquiring circuit configured to acquire from the terminals not only function information but also device identification information previously assigned to the terminal, wherein the control information transmitting circuit encrypts the function change control information using the acquired device identification information and transmits the encrypted function change control information to the corresponding terminal.

74. The customer center according to claim 65, further comprising a device identification information reading circuit configured to read device identification information on the corresponding main apparatus and the terminal from the user database on the basis of the individual identification information sent from the user system, wherein the control information transmitting circuit encrypts the function change control information using the device identification information read from the user database and transmits the encrypted function change control information to the corresponding terminal.

75. The customer center according to claim 64, further comprising a determining circuit configured to determine whether the function required by the user system can be changed, on the basis of the function information acquired from the terminals and the function change description included in the function change request, and to generate a decision signal indicating that the function change can be made, wherein the control information transmitting circuit transmits function change control information to the corresponding terminal via the communication network in response to the decision signal.

76. The customer center according to claim 65, further comprising a determining circuit configured to determine whether the requested function can be changed, on the basis of the information on the functions of the terminal read from the user database and the function change description included in the function change request, and to generate a decision signal indicating that the function change can be made, wherein the control information transmitting circuit accesses the corresponding terminal via the communication network in response to the decision signal, on the basis of the subscriber information on the main apparatus read from the user database, and transmits the function change control information.

77. An user system which is connected to the customer center defined in claim 71 or 72, the user system comprising:
a receiving circuit configured to receive function change control information sent from the customer center; and
function changing circuit configured to decrypt the function change control information by using device identification information previously assigned to its own main apparatus and terminals, and to give permission to execute function change according to the decrypted function change control information.

78. An user system which includes a main apparatus that connects at least one terminal via line, and which is connected to a customer center via a communication network, the user system comprising:
a function table which stores setting information about the effectiveness/ineffectiveness of at least part of all the functions in the terminal;
a receiving circuit configured to receive function change control information sent from the customer center via the communication network; and
a setting change circuit configured to change the setting information about the corresponding function in the function table to change the setting of the function, according to the contents of the function change control information.
